(19) United States
(12) Patent Application Publication
(10) Pub. No.: US 2004/0146819 A1
(43) Pub. Date: Jul. 29, 2004

(54) Photothermographic material

(76) Inventor: Kouta Fukui, Kanagawa (JP)

Correspondence Address: MS. YUMI YERKS, 2111 JEFFERSON DAVIS HIGHWAY, APARTMENT #412, NORTH, ARLINGTON, VA, 22202, US

(21) Appl. No.: 10/756,407

(22) Filed: Jan. 14, 2004

(30) Foreign Application Priority Data
Jan. 17, 2003 (JP) 2003-9372

(51) Int. Cl. G03C 1/498

(52) U.S. Cl. 430/619; 430/350; 430/567; 430/945

(57) ABSTRACT

A photothermographic material, including a support; an image forming layer provided on the support and containing a photosensitive silver halide, a non-photosensitive organic silver salt, a reducing agent, and a binder; and a silver-saving agent. Silver iodide is contained in the photosensitive silver halide in an amount of 40 to 100 mol %.

### CROSS-REFERENCE TO RELATED APPLICATION

This application claims priority under 35 USC 119 from Japanese Patent Application No. 2003-009372, the disclosure of which is incorporated by reference herein.

### BACKGROUND OF THE INVENTION

1. Field of the Invention

The present invention relates to a photothermographic material. More particularly, it relates to a photothermographic material excellent in image storability, and improved in film physical properties.

2. Description of the Related Art

Reduction of waste solutions that require a treatment has been strongly desired in recent years in the medical field from the viewpoints of environmental protection and space saving. Under such circumstances, technologies using photosensitive photothermographic materials for medical diagnosis and photography which can be exposed to light efficiently with a laser image setter or a laser imager, and can form a clear black image having high resolution and sharpness have been demanded. With these photosensitive photothermographic materials, it is possible to supply to customers a heat development treatment system which does not use liquid processing chemicals, is more simple, and does not harm the environment.

Similar requirements also exist in the field of general image-forming materials. However, images for medical use are required to have high image quality excellent in sharpness and graininess, because fine details of the image are required. In addition, the medical image is characterized by preferably exhibiting cold black tone from the viewpoint of easy medical diagnosis. Currently, various hard copy systems utilizing pigments or dyes such as inkjet printers and apparatuses for electrophotography are prevailing as general image-forming systems. However, there is no system satisfactory as a medical image-output system.

On the other hand, there are known thermal image-forming systems utilizing an organic silver salt (see e.g., U.S. Pat. Nos. 3,152,904 and 3,457,075, and Thermally Processed Silver Systems, written by D. Klosterboer, (Imaging Processes and Materials) Neblette 8th edition, compiled by J. Sturge, V. Walworth, and A. Shepp, chapter 9, p. 279, 1989.) In particular, the photothermographic material generally has a photosensitive layer in which a catalytically active amount of a photocatalyst (e.g., silver halide), a reducing agent, a reducible silver salt (e.g., organic silver salt), and, if required, a color toning agent for controlling the color tone of silver are dispersed in a binder matrix. The photothermographic materials are, after having been imagewise exposed, heated to a high temperature (for example, to 80° C. or higher) to form black silver images through the oxidation-reduction reaction between the silver halide or the reducible silver salt (which functions as an oxidizing agent) and the reducing agent therein. The oxidation-reduction reaction is accelerated by the catalytic action of the latent image of the silver halide generated through exposure. For this reason, the black silver images are formed in the exposed areas (see, e.g., U.S. Pat. No. 2,910,377 and JP-B No. 43-4924). Fuji Medical Dry Imager FM-DP L has been released as a medical image formation system by a photothermographic material.

For manufacture of thermal image-forming systems utilizing an organic silver salt, there are a manufacturing method by solvent coating, and a manufacturing method by coating/drying of a coating solution containing polymer fine particles in water dispersion form as a main binder. The latter method does not require a step of solvent recovery, or the like, and hence the manufacturing equipment is simple, and the method is advantageous for mass production.

The photothermographic material generally has an image forming layer in which a catalytically active amount of a photocatalyst (e.g., silver halide), a reducing agent, a reducible silver salt (e.g., organic silver salt), and the like are dispersed in a binder matrix.

One of the significant problems with respect to the photothermographic materials is as follows. The process after a heat development treatment has been performed does not include a step of removing unreacted compounds, and the like therein from the photosensitive material. Therefore, the unreacted compounds and the like remain therein as they are. When they are exposed to indoor light after image formation, or exposed to high temperatures during storage, the reduction reaction of silver ions further proceeds, resulting in the occurrence of fog. The problem of image storability referred to as print-out is the problem peculiar to these photothermographic materials, which has been required to be improved.

As a means for improving the image storability, for example, JP-A No. 2001-33911 discloses that a polyhalogen compound is effective which decomposes, in an oxidizing manner, unnecessary fog silver generated when a photothermographic material after treatment has been left standing over time. Alternatively, there is disclosed a complex forming agent for forming a complex with a developer base, and inhibiting the undesired reduction reaction during storage (see, e.g., JP-A No. 2002-156727 and 2002-318431). However, even with these related-art techniques, in particular, there is a limit to the improvement of print-out under bright light. Thus, there has been a demand for the advent of a radically improved technique.

An intense study has been made on the technique for improving the print-out which is a problem peculiar to the photothermographic material from various points of view. As a result, it has been found that use of a silver iodide emulsion as a photosensitive silver halide can largely improve the problem of print-out. However, on the other hand, when the silver iodide emulsion is used, other problems to be solved also have become identified. As one of these problems, there has been identified the following problem or other problems. The tone of the resulting developed silver does not become constant, and differs from one develop treatment to another, or between portions of one developed sheet. The developed silver tone also affects the diagnosis ability when the photothermographic material is used as, particularly, a medical diagnosis material, and hence it has been a serious problem.

Another problem associated with the photothermographic material is that of the physical strength of the film. In particular, there has been a demand for the improvement of the physical characteristic referred to as brittleness. Brittleness denotes the brittleness of the film leading to a failure which causes cracks or the like at sites applied with a pressure upon bending an image sheet subjected to a heat treatment, or cutting a part thereof. Presumably, this is partly caused by the following fact. The stress concentrates because of the large thickness of the image forming layer, so that the film ruptures. However, the reduction in thickness of the film results in sacrifices of the essential characteristics such as the reduction in sensitivity and the reduction in image density, and hence it has never been implemented.

### SUMMARY OF THE INVENTION

It is an object of the present invention to provide an improved photothermographic material excellent in image storability. It is another object of the invention to provide a photothermographic material improved in film physical properties.

The objects of the invention have been achieved by the following photothermographic materials.

A first aspect of the invention is to provide a photothermographic material, including a support; an image forming layer disposed on the support and containing a photosensitive silver halide, a non-photosensitive organic silver salt, a reducing agent, and a binder; and a silver-saving agent, in which silver iodide is contained in the photosensitive silver halide in an amount of 40 to 100 mol %.

The present inventors have found as follows. In the present invention, a photothermographic material includes a photosensitive silver halide having a silver iodide content of 40 to 100 mol %, and utilizes a silver-saving agent. As a result, silver saving becomes possible, so that image storability and physical properties of a film are improved.

Further, a constitution may be adopted in which the image forming layer includes a plurality of layers, which include a silver-saving agent-containing layer, and a silver-saving agent-free layer. The photothermographic material may be designed so as to have an image gradation of 2 or more and 4 or less. A compound represented by the following formula (R) may be used as the reducing agent.

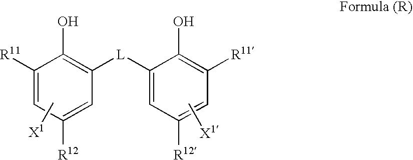

Further, a development accelerator may be added. Exposure may be conducted with a laser light, particularly, a laser light having a wavelength of 350 nm to 450 nm.

### DETAILED DESCRIPTION OF THE INVENTION

Below, the present invention will be described in details.

(Photothermographic Material)

A photothermographic material of the invention has an image forming layer containing a photosensitive silver halide, a non-photosensitive organic silver salt, a reducing agent, and a binder on at least one side of a support. The image forming layer may comprise a single layer or a plurality of layers (a multi-layered structure). Further, the photothermographic material may have an intermediate layer and a surface protective layer on the image forming layer, or a back layer and a back protective layer on the opposite side.

The constitution of each of these layers, and the components thereof will be described in details.

(Explanation of Organic Silver Salt)

1) Composition

The organic silver salt usable in the invention is a silver salt, which is relatively stable to light, but functions as a silver ion source, and forms a silver image when heated to 80° or higher in the presence of a photosensitive silver halide exposed to light and a reducing agent. The organic silver salt may be a given organic substance capable of supplying silver ions reducible by a reducing agent. Such non-photosensitive organic silver salts are described in paragraph Nos. 0048 to 0049 of JP-A No. 10-62899, on page 18, line 24 to page 19, line 37 of EP-A No. 0803764, EP-A No. 0962812, JP-A Nos. 11-349591, 2000-7683, and 2000-72711, and the like. A silver salt of an organic acid, particularly, the silver salt of a long chain aliphatic carboxylic acid (having 10 to 30, and preferably 15 to 28 carbon atoms) is preferred. Preferred examples of the fatty acid silver salt include silver lignocerate, silver behenate, silver arachidate, silver stearate, silver oleate, silver laurate, silver caproate, silver myristate, silver palmitate, and silver erucate, and mixtures thereof. In the invention, out of these fatty acid silvers, it is preferable to use fatty acid silvers having a silver behenate content of preferably 50 mol % or more and 100 mol % or less, more preferably 85 mol % or more and 100 mol % or less, and furthermore preferably 95 mol % or more and 100 mol % or less. Further, it is preferable to use fatty acid silvers having a silver erucate content of 2 mol % or less, more preferably 1 mol % or less, and furthermore preferably 0.1 mol % or less.

The silver stearate content is preferably 1 mol % or less. By setting the silver stearate content at 1 mol % or less, it is possible to obtain a silver salt of an organic acid having a low Dmin, high sensitivity, and excellent image storability. The silver stearate content is more preferably 0.5 mol % or less, and it is particularly preferable that the silver stearate is substantially not contained.

Further, when silver arachidate is contained as the silver salt of an organic acid, it is preferable from the viewpoint of obtaining a low Dmin and obtaining a silver salt of an organic acid excellent in image storability that the silver arachidate content is 6 mol % or less.

2) Shape

The organic silver salt usable in the invention has no particular restriction on its shape, and it may have any of needle-shaped, rod-shaped, tabular, and scale-like shaped.

In the invention, a scale-like shaped organic silver salt is preferred. Short needle-like shaped, rectangular prismatic, cubic, or potato-shaped indefinite-form particles each having a ratio of length between the major axis and the minor axis of 5 or less are also preferably used. These organic silver salt particles have a feature of causing less fog upon heat development than with the minute hand-shaped particles having a ratio of length between the major axis and the minor axis of 5 or more. In particular, the particles with a ratio between the major axis and the minor axis of 3 or less improves the mechanical stability of the resulting coating film, and hence they are preferred. In this specification, the scale-like shaped organic silver salt is defined as follows. The organic acid silver salt is observed by means of an electronic microscope, and the shape of the organic acid silver salt particle is approximated to a rectangular parallelepiped. When the sides of the rectangular parallelepiped are taken as a, b, and c in the order from the shortest (c may be equal to b), x is calculated from the shorter numerical values, a and b, and determined as follows.

x=b/a

Thus, x is determined for each of about 200 particles in this manner, and when the average value is taken as x (average), those satisfying the relationship: x (average)≧1.5, are regarded as scale-like shaped particles. Preferably, 30≧x (average)≧1.5, and more preferably, 15≧x (average)≧1.5. In this connection, needle-shaped particles satisfy the relation: 1≦x (average)<1.5.

In a scale-like shaped particle, a can be regarded as the thickness of a tabular particle having a plane with sides of b and c as the main plane. The average of a is preferably 0.01 μm or more and 0.3 μm or less, and more preferably 0.1 μm or more and 0.23 μm or less. The average of c/b is preferably 1 or more and 9 or less, more preferably 1 or more and 6 or less, furthermore preferably 1 or more and 4 or less, and most preferably 1 or more and 3 or less.

By setting the sphere equivalent diameter at 0.05 μm or more and 1 μm or less, aggregation becomes less likely to occur in the photosensitive material, resulting in favorable image storability. The sphere equivalent diameter is preferably 0.1 μm or more to 1 μm or less. In the invention, the sphere equivalent diameter is measured in the following manner. A sample is directly photographed by means of an electron microscope. Then, the negative is subjected to image processing.

In the scale-like shaped particle, the sphere equivalent diameter/a of the particle is defined as an aspect ratio. The aspect ratio of the scale-like shaped particle is preferably 1.1 or more and 30 or less, and more preferably 1.1 or more and 15 or less from the viewpoints of allowing aggregation to become less likely to occur in the photosensitive material, and making the image storability favorable.

It is preferable that the particle size distribution of the organic silver salt is monodispersed. Being “monodispersed” corresponds to the case where the percentage of a value, obtained by dividing the standard deviations of their respective lengths of a minor axis and a major axis by the lengths of the minor axis and the major axis, respectively, is preferably 100% or less, more preferably 80% or less, and furthermore preferably 50% or less. The shape of an organic silver salt can be determined from a transmission electron microscope image of the organic silver salt dispersion. As another method for determining the monodispesibility, there is a method of determining the standard deviation of the volume weight average diameter of an organic silver salt. The percentage of the value obtained by dividing the standard deviation by the volume weight average diameter (coefficient of variation) is preferably 100% or less, more preferably 80% or less, and furthermore preferably 50% or less. For the measurement, a commercially available laser light scattering type particle size measuring device can be used.

3) Preparation

To the manufacturing and dispersion methods of the organic acid silver for use in this embodiment, known methods and the like can be applied. For example, the following references can serve as a reference: JP-A No. 10-62899, EP-A Nos. 0803763 and 0962812, JP-A Nos. 11-349591, 2000-7683, 2000-72711, 2001-163889, 2001-163890, 2001-163827, 2001-33907, 2001-188313, 2001-83652, 2002-6442, 2002-49117, 2002-31870, and 2002-107868.

Incidentally, when a photosensitive silver salt coexists during dispersing the organic silver salt, fog increases, and the sensitivity is remarkably lowered. For this reason, it is more preferable that a photosensitive silver salt is substantially not included during dispersing. In the invention, the amount of a photosensitive silver salt to be dispersed in an aqueous dispersion is preferably 1 mol % or less, and more preferably 0.1 mol % or less per mole of the organic acid silver salt in the dispersion. Furthermore preferably, the photosensitive silver salt is not positively added.

In the invention, it is possible to manufacture the photosensitive material by mixing an aqueous dispersion of the organic silver salt and an aqueous dispersion of the photosensitive silver salt. The mixing ratio of the organic silver salt and the photosensitive silver salt can be selected according to the intended purpose. The ratio of the photosensitive silver salt to the organic silver salt is preferably in the range of 1 to 30 mol %, more preferably 2 to 20 mol %, and in particular preferably 3 to 15 mol %. For mixing, it is a method preferably used for adjusting the photographic characteristics that two or more kinds of aqueous dispersions of organic silver salts and two or more kinds of aqueous dispersions of photosensitive silver salts are mixed.

4) Amount Added

The organic silver salt of the invention can be used in a desirable amount. It is used in an amount of, preferably 0.1 to 3.0 g/m², more preferably 0.3 to 2.0 g/m², and furthermore preferably 0.5 to 1.5 g/m², in terms of the total amount of silver coated also containing silver halide. It is in particular preferably used in an amount of preferably 0.6 to 1.2 g/m². By using a silver-saving agent of the invention, it has become possible to obtain a sufficient image density even with such a low silver amount.

(Explanation of Reducing Agent)

The photothermographic material of the invention preferably contains a heat developer which is a reducing agent for organic silver salts. The reducing agent for organic silver salts may be a given substance (preferably an organic substance) capable of reducing silver ions into metallic silver. Examples of such a reducing agent are described in paragraph Nos. 0043 to 0045 of JP-A No. 11-65021, and from page 7, line 34 to page 18, line 12 of EP-A No. 0803764.

In the invention, preferred reducing agents are so-called hindered phenol type reducing agents having substituents at the ortho positions of the phenolic hydroxyl group, or bisphenol type reducing agent. The compounds represented by the following formula (R) are more preferred.

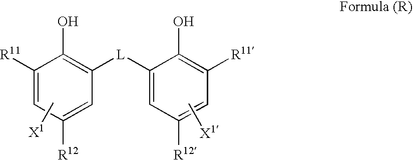

In formula (R), R¹¹ and R^{11′} each independently represent an alkyl group having 1 to 20 carbon atoms; R¹² and R^{12′} each independently represent a hydrogen atom or a group capable of being substituted on a benzene ring; L represents —S— or —CHR¹³—; R¹³ represents a hydrogen atom or an alkyl group having 1 to 20 carbon atoms; and X¹ and X^{1′} each independently represent a hydrogen atom or a group capable of being substituted on a benzene ring.

Formula (R) will be described in details.

1) R¹¹ and R^{11′}

R¹¹ and R^{11′} each independently represent a substituted or unsubstituted alkyl group having 1 to 20 carbon atoms. The substituent of the alkyl group has no particular restriction. Preferably, mention may be made of an aryl group, a hydroxy group, an alkoxy group, an aryloxy group, an alkylthio group, an arylthio group, an acylamino group, a sulfonamido group, a sulfonyl group, a phosphoryl group, an acyl group, a carbamoyl group, an ester group, a ureido group, an urethane group, a halogen atom, and the like.

2) R¹² and R^{12′}, and X¹ and X^{1′}

R¹² and R¹²′ each independently represent a hydrogen atom, or a group capable of being substituted on a benzene ring, and X¹ and X¹ also each independently represent a hydrogen atom, or a group capable of being substituted on a benzene ring. As the respective groups substitutable on a benzene ring, preferably, mention may be made of an alkyl group, an aryl group, a halogen atom, an alkoxy group, and an acylamino group.

3) L

L represents —S— or —CHR¹³—. R¹³ represents a hydrogen atom or an alkyl group having 1 to 20 carbon atoms. The alkyl group may have a substituent. Specific examples of an unsubstituted alkyl group of R¹³ may include: a methyl group, an ethyl group, a propyl group, a butyl group, a heptyl group, an undecyl group, an isopropyl group, a 1-ethylpentyl group, and a 2,4,4-trimethylpentyl group. Examples of the substituent of an alkyl group are the same groups as those for the substituent of R¹¹, and may include: a halogen atom, an alkoxy group, an alkylthio group, an aryloxy group, an arylthio group, an acylamino group, a sulfonamido group, a sulfonyl group, a phosphoryl group, an oxycarbonyl group, a carbamoyl group, and a sulfamoyl group.

4) Preferred Substituents

R¹¹ and R^{11′} are preferably secondary or tertiary alkyl groups each having 3 to 15 carbon atoms. Specifically, mention may be made of an isopropyl group, an isobutyl group, a t-butyl group, a t-amyl group, a t-octyl group, a cyclohexyl group, a cyclopentyl group, a 1-methylcyclohexyl group, a 1-methylcyclopropyl group, and the like. R¹¹ and R^{11′} are more preferably tertiary alkyl groups each having 4 to 12 carbon atoms. Out of these, a t-butyl group, a t-amyl group, and a 1-methylcyclohexyl group are further preferred, and a t-butyl group is most preferred.

R¹² and R^{12′} are preferably alkyl groups each having 1 to 20 carbon atoms. Specific examples thereof may include: a methyl group, an ethyl group, a propyl group, a butyl group, an isopropyl group, a t-butyl group, a t-amyl group, a cyclohexyl group, a 1-methylcyclohexyl group, a benzyl group, a methoxymethyl group, and a methoxyethyl group. More preferred are a methyl group, an ethyl group, a propyl group, an isopropyl group, and a t-butyl group.

X¹ and X^{1′} are each preferably a hydrogen atom, a halogen atom, or an alkyl group, and more preferably a hydrogen atom.

L is preferably a —CHR¹³— group.

R¹³ is preferably a hydrogen atom or an alkyl group having 1 to 15 carbon atoms. The alkyl group is preferably a methyl group, an ethyl group, a propyl group, an isopropyl group, or a 2,4,4-trimethylpentyl group. R¹³ is in particular preferably a hydrogen atom, a methyl group, an ethyl group, a propyl group, or an isopropyl group.

When R¹³ is a hydrogen atom, R¹² and R¹² are each preferably an alkyl group having 2 to 5 carbon atoms. An ethyl group or a propyl group is more preferred, and an ethyl group is most preferred. When R¹³ is a primary or secondary alkyl group having 1 to 8 carbon atoms, R¹² and R^{12′} are preferably methyl groups. The primary or secondary alkyl group having 1 to 8 carbon atoms of R¹³ is more preferably a methyl group, an ethyl group, a propyl group, or an isopropyl group, and further preferably a methyl group, an ethyl group, or a propyl group.

When all of R¹¹, R^{11′}, R¹², and R^{12′} are methyl groups, R¹³ is preferably a secondary alkyl group. In this case, the secondary alkyl group of R¹³ is preferably an isopropyl group, an isobutyl group, or a 1-ethylpentyl group, and more preferably an isopropyl group.

The reducing agent varies in heat developability and developed silver tone according to the combination of R¹¹, R^{11′}, R¹², R^{12′}, and R¹³. It is possible to adjust these properties by combining two or more reducing agents. Therefore, the reducing agents are preferably used in combination of two or more kinds thereof according to the intended purpose.

Below, non-limiting specific examples of the reducing agent of the invention including the compounds represented by formula (R) will be shown.

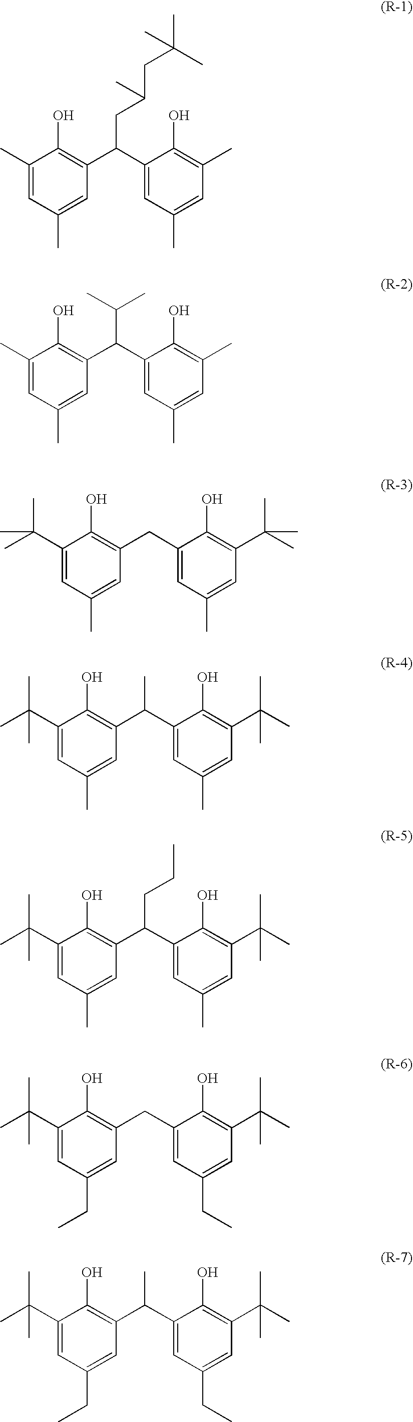

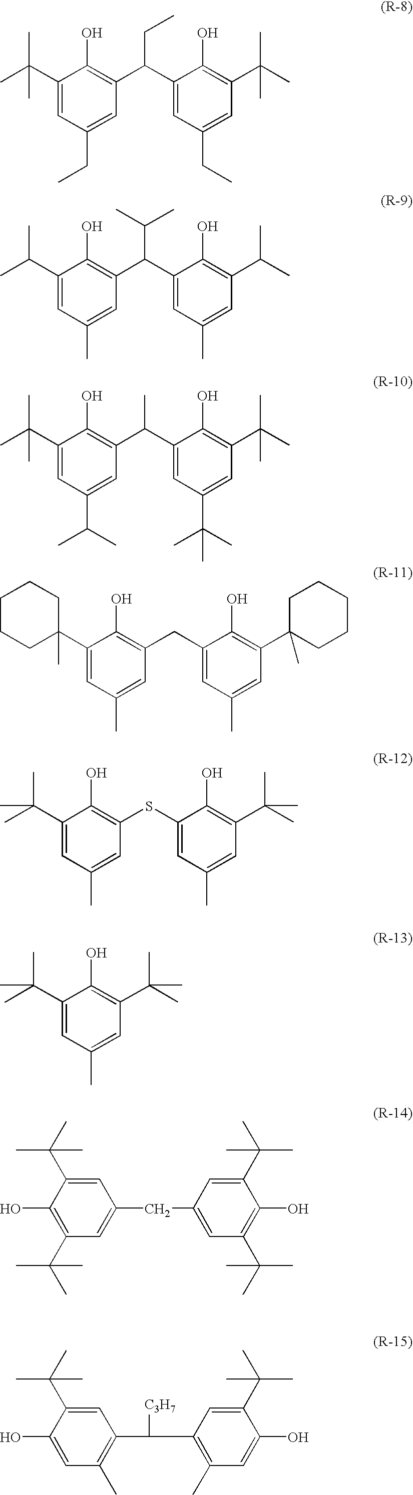

Examples of the preferred reducing agent of the invention other than the foregoing ones are the compounds described in JP-A Nos. 2001-188314, 2001-209145, 2001-350235, and 2002-156727.

In the invention, the amount of the reducing agent to be added is preferably 0.1 to 3.0 g/m², more preferably 0.2 to 1.5 g/m², and further preferably 0.3 to 1.0 g/m². The reducing agent is contained in an amount of preferably 5 to 50 mol %, more preferably 8 to 30 mol %, and further preferably 10 to 20 mol % per mole of silver on the side having an image forming layer. The reducing agent is preferably contained in the image forming layer.

The reducing agent may be incorporated in the coating solution with any process based on a solution form, an emulsified dispersion form, a solid fine particle dispersion form, or the like, and incorporated in the photosensitive material.

As a well-known emulsification dispersion method, mention may be made of a method in which an emulsified dispersion is mechanically prepared by dissolving the reducing agent with an oil such as dibutylphthalate, tricresyl phosphate, glyceryl triacetate, or diethyl phthalate, and with a co-solvent such as ethyl acetate or cyclohexanone.

As a solid fine particle dispersion method, mention may be made of the following method. A powder of a reducing agent is dispersed in an appropriate solvent such as water by means of a ball mill, a colloid mill, a vibration ball mill, a sand mill, a jet mill, or a roller mill, or ultrasonically, thereby to form a solid dispersion. Incidentally, at this step, a protective colloid (e.g., polyvinyl alcohol), and a surfactant (e.g., an anionic surfactant such as sodium triisopropylnaphthalene sulfonate (a mixture of those mutually different in substitution positions of three isopropyl groups) may also be used. In the above-described mills, beads of zirconia or the like are normally used as dispersion medium, so that Zr or the like eluted from these beads may be mixed in the resulting dispersion. Although depending upon the dispersion conditions, the concentration is generally in the range of 1 ppm to 1000 ppm. A content of Zr in the sensitive material of 0.5 mg or less per gram of silver is practically acceptable.

An antiseptic agent (e.g., benzisothiazolinone sodium salt) is preferably incorporated in a water dispersion.

The particularly preferred process is the solid particle dispersion process of the reducing agent, wherein the reducing agent is preferably added in the form of fine particles with an average particle size of 0.01 μm to 10 μm, preferably 0.05 μm to 5 μm, and more preferably 0.1 μm to 2 μm. In this application, other solid dispersions are also preferably dispersed and used in the form of particles with a particle size within this range.

(Silver-Saving Agent)

A silver-saving agent for use in the invention will be described.

The silver-saving agent in accordance with the invention denotes a compound capable of reducing the silver amount necessary to obtain a prescribed silver image density. Although various action mechanisms for the reducing function can be supposed, compounds having a function of enhancing the covering power of developed silver are preferred. Herein the covering power of developed silver denotes the optical density per unit amount of silver.

Preferred examples of the silver-saving agent may include hydrazine derivative compounds represented by the following formula (V), vinyl compounds represented by the following formula (VI), and quaternary onium compounds represented by the following formula (VII):

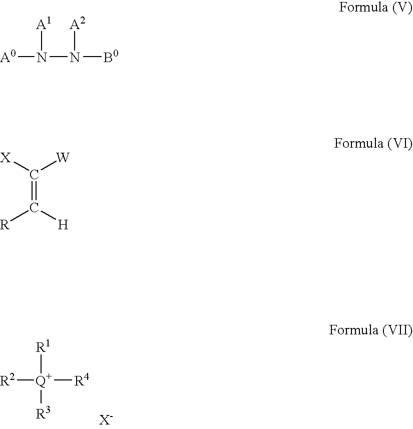

In formula (V), A⁰ represents an aliphatic group, an aromatic group, a heterocyclic group, or -G⁰-D⁰, each of which may have a substituent; B⁰ represents a blocking group; both of A¹ and A² represent hydrogen atoms, or one of them represents a hydrogen atom and the other represents an acyl group, a sulfonyl group, or an oxalyl group, where G⁰ represents —CO—, —COCO—, —CS—, —C(═NG¹D¹)-, —SO—, —SO₂—, or —P(O)(G¹D¹)-, in which G¹ represents a single bond, —O—, —S—, or —N(D¹)—, in which D¹ represents an aliphatic group, an aromatic group, a heterocyclic group, or a hydrogen atom, provided that when a plurality of D¹s are present in the molecule, they may be the same or different, and D⁰ represents a hydrogen atom, an aliphatic group, an aromatic group, a heterocyclic group, an amino group, an alkoxy group, an aryloxy group, an alkylthio group, or arylthio group. As preferred D⁰, mention may be made of a hydrogen atom, an alkyl group, an alkoxy group, an amino group, or the like.

In formula (V), the aliphatic group represented by A⁰ is preferably the one having 1 to 30 carbon atoms, and in particular preferably a straight-chain, branched, or cyclic alkyl group having 1 to 20 carbon atoms. Examples thereof may include a methyl group, an ethyl group, a t-butyl group, an octyl group, a cyclohexyl group, and a benzyl group, each of which may further be substituted by a proper substituent (such as an aryl group, an alkoxy group, an aryloxy group, an alkylthio group, an arylthio, a sulfoxy group, a sulfonamido group, a sulfamoyl group, an acylamino group, or a ureido group).

In formula (V), the aromatic group represented by A⁰ is preferably a monocyclic or condensed-ring aryl group, such as a benzene ring or a naphthalene ring. The heterocyclic group represented by A⁰ is preferably a heterocyclic group which is the monocyclic or condensed-ring one, and contains at least one hetero atom selected from nitrogen, sulfur, and oxygen atoms. Examples thereof may include a pyrrolidine ring, an imidazole ring, a tetrahydrofuran ring, a morpholine ring, a pyridine ring, a pyrimidine ring, a quinoline ring, a thiazole ring, a benzothiazole ring, a thiophene ring, and a furan ring. The aromatic group, the heterocyclic group, or the -G⁰-D⁰ group of A⁰ may have a substituent. A⁰ is in particular preferably an aryl group or a -G⁰-D⁰ group.

In formula (V), A⁰ preferably contains at least one anti-diffusion group or silver halide adsorbing group. The anti-diffusion group is preferably a ballast group which is commonly used in an immobile photographic additive such as a coupler. Examples of the ballast group may include a photographically inactive alkyl group, alkenyl group, alkynyl group, alkoxy group, phenyl group, phenoxy group, and alkylphenoxy group, and the total number of carbon atoms of the substituent moiety is preferably 8 or more.

In formula (V), as the silver halide adsorption promoting group, mention may be made of thiourea, a thiourethane group, a mercapto group, a thioether group, a thione group, a heterocyclic group, a thioamido heterocyclic group, a mercapto-heterocyclic group, a adsorbing group described in JP-A No. 64-90439, or the like.

In formula (V), B⁰ represents a blocking group, and preferably -G⁰-D⁰, where G⁰ represents —CO—, —COCO—, —CS—, —C(═NG¹ D¹)-, —SO—, —SO₂—, or —P(O) (G¹ D¹)-. As a preferred G⁰, mention may be made of —CO— or —COCO—, where G¹ represents a single bond, —O—, —S—, or —N(D¹)—, in which D¹ represents an aliphatic group, an aromatic group, a heterocyclic group, or a hydrogen atom, provided that when a plurality of D¹s are present in the molecule, they may be the same or different. D⁰ represents a hydrogen atom, an aliphatic group, an aromatic group, a heterocyclic group, an amino group, an alkoxy group, an aryloxy group, an alkylthio group, or an arylthio group. As preferred D⁰, mention may be made of a hydrogen atom, an alkyl group, an alkoxy group, an amino group, or the like. Herein, when A⁰ is a heterocyclic group, B⁰ will not be —CONHR-(carbamoyl group), —SO₂NHR-(sulfamoyl group), or —SOR-(sulfonyl group) (where R represents an aliphatic group, an aromatic group, or a heterocyclic group).

Both of A¹ and A² represent hydrogen atoms, or one of them is a hydrogen atom and the other represents an acyl group, (acetyl group, trifluoroacetyl group, benzoyl group, or the like), a sulfonyl group (methanesulfonyl group, toluenesulfonyl group, or the like), or an oxalyl group (ethoxalyl group).

Next, non-limiting specific examples of the compound represented by formula (V) will be shown below:

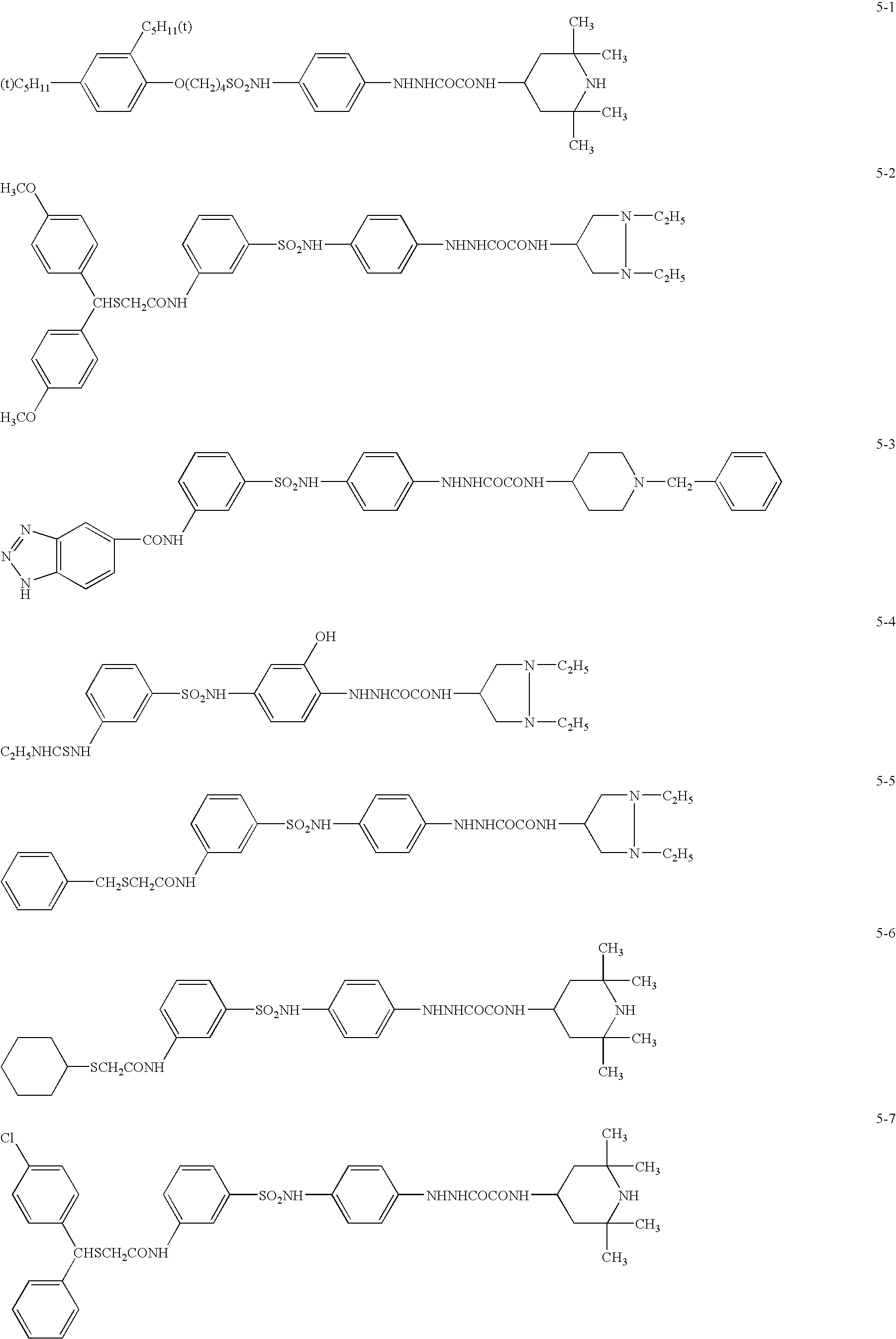

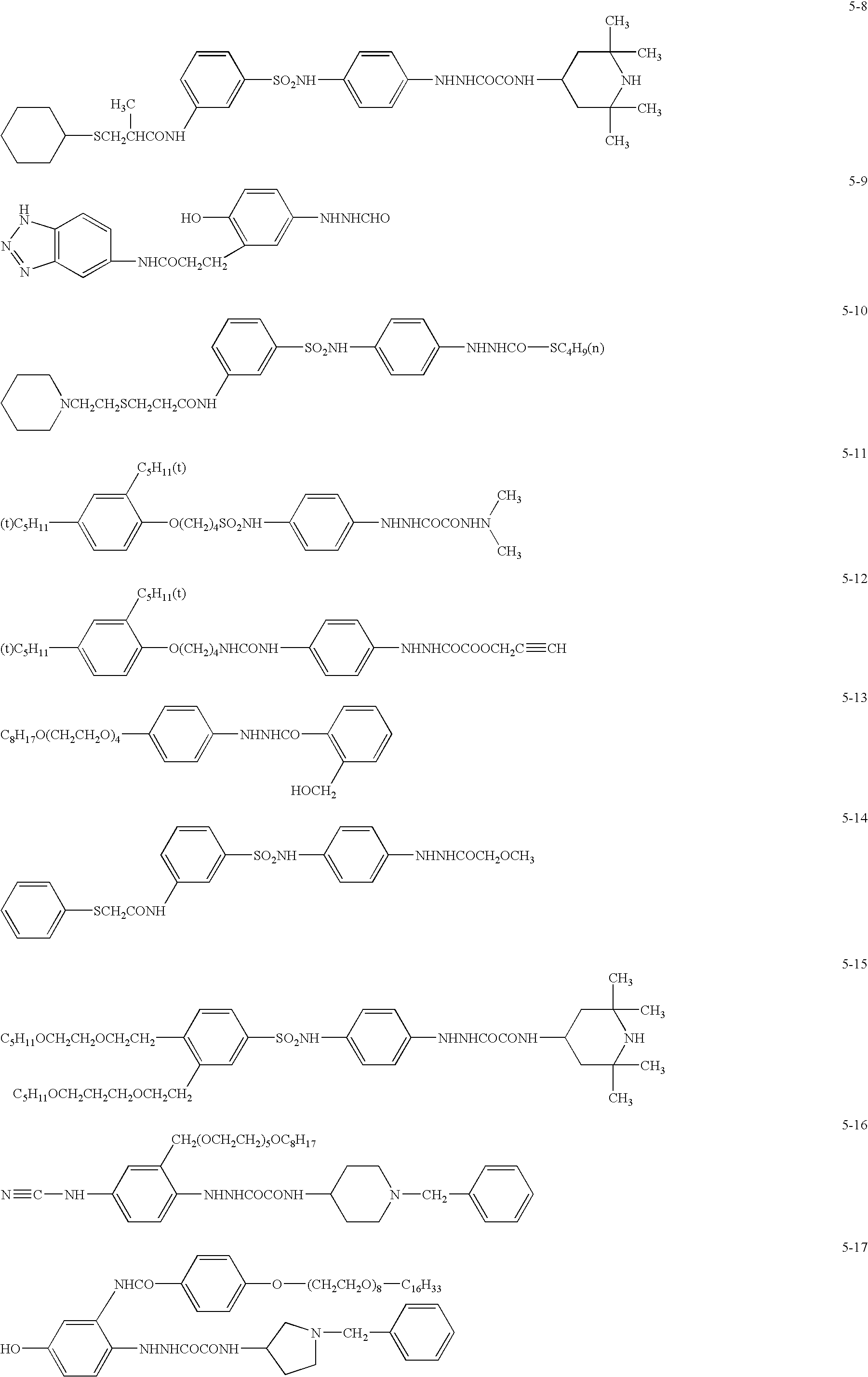

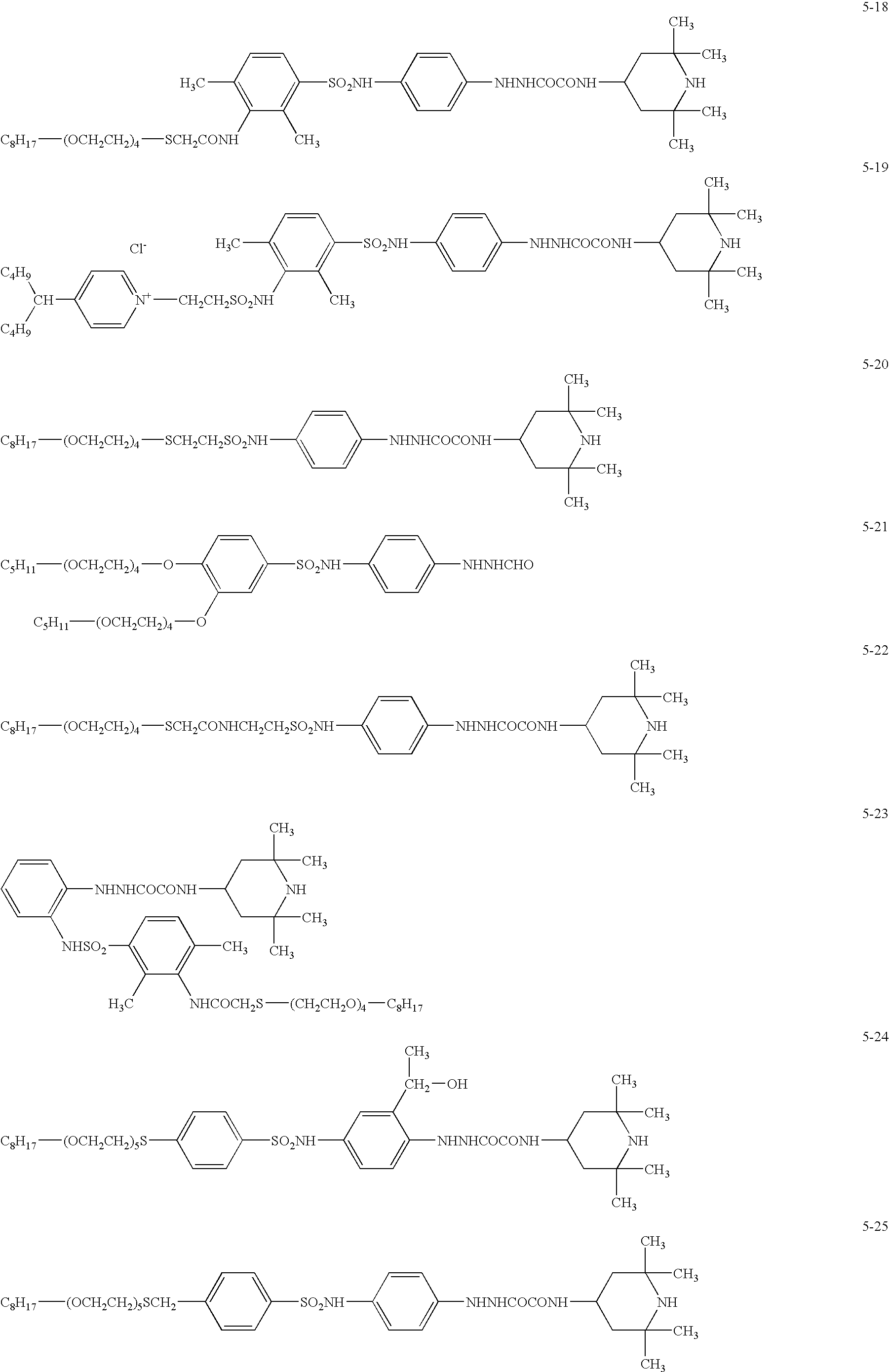

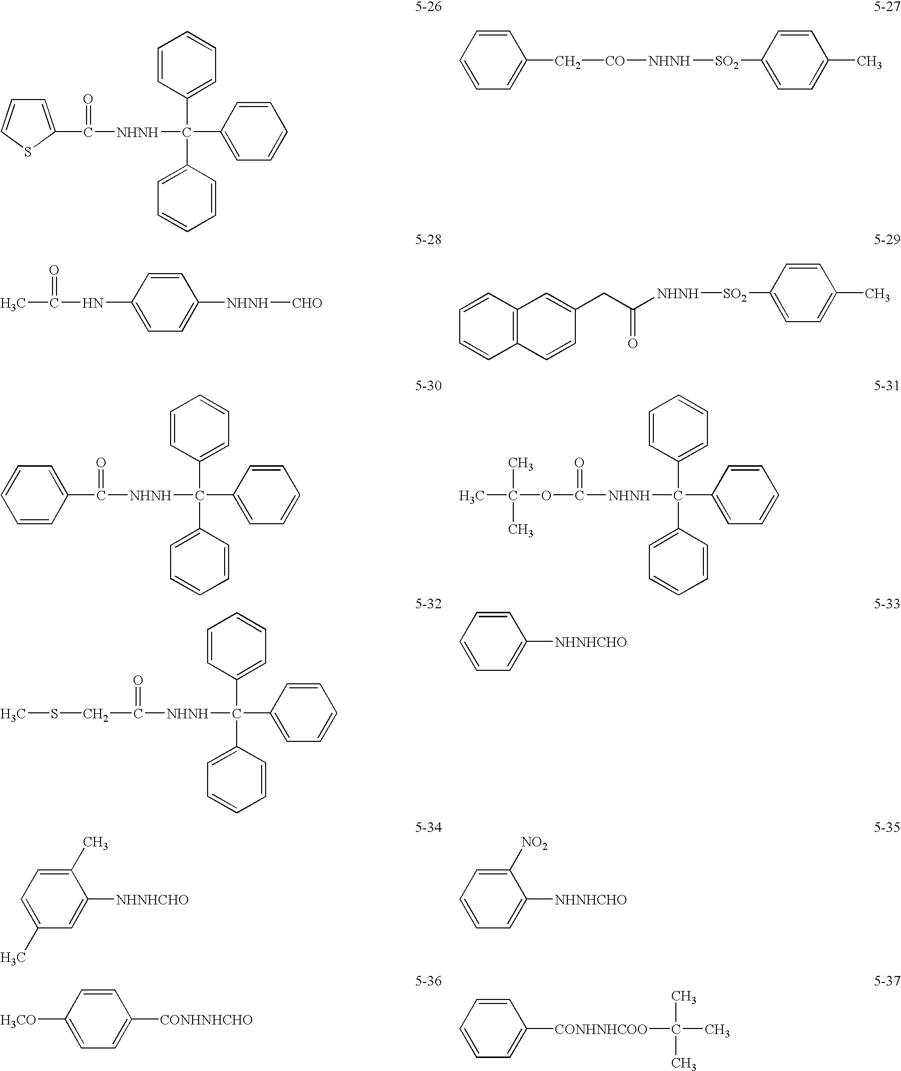

Further preferred hydrazine derivatives are represented by the following formulae (V-1), (V-2), (V-3), and (V-4):

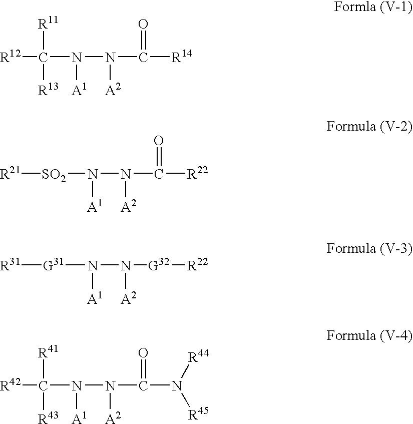

In formula (V-1), R¹¹, R¹², and R¹³ each independently represent a substituted or unsubstituted aryl group or heteroaryl group. Specific examples of the aryl group may include phenyl, p-methylphenyl, and naphthyl. Specific examples of the heteroaryl group may include a triazole residue, an imidazole residue, a pyridine residue, a furan residue, and a thiophene residue. Further, R¹¹, R¹² and R¹³ may bond with each other via an arbitrary linking group. When R¹¹, R¹² and R¹³ have substituents, examples of the substituents include: an alkyl group, an alkenyl group, an alkynyl group, an aryl group, a heterocyclic group, a quaternized nitrogen atom-containing heterocyclic group, a hydroxyl group, an alkoxy group (including groups repeatedly containing ethyleneoxy group or propyleneoxy group units), an aryloxy group, an acyloxy group, an acyl group, an alkoxycarbonyl group, an aryloxycarbonyl group, a carbamoyl group, an urethane group, a carboxyl group, an imido group, an amino group, a carbonamido group, a sulfonamido group, a ureido group, a thioureido group, a sulfamoylamino group, a semicarbazido group, a thiosemicarbazido group, a hydrazino group, a quaternary ammonium group, an (alkyl, aryl, or heterocyclic)thio group, a mercapto group, an (alkyl or aryl)sulfonyl group, an (alkyl or aryl)sulfinyl group, a sulfo group, a sulfamoyl group, an acylsulfamoyl group, an (alkyl or aryl)sulfonylureido group, an (alkyl or aryl)sulfonylcarbamoyl group, a halogen atom, a cyano group, a nitro group, and a phosphoric acid amido group. All of R¹¹, R¹², and R¹³ are preferably substituted or unsubstituted phenyl groups, and more preferably, all of R¹¹, R¹², and R¹³ are unsubstituted phenyl groups.

R¹⁴ represents a heteroaryloxy group or a heteroarylthio group. Specific examples of the heteroaryloxy group may include a pyridyloxy group, a pyrimidyloxy group, an indolyloxy group, a benzothiazolyloxy group, a benzimidazolyloxy group, a furyloxy group, a thienyloxy group, a pyrazolyloxy group, and an imidazolyloxy group. Specific examples of the heteroarylthio group may include a pyridylthio group, a pyrimidylthio group, an indolylthio group, a benzothiazolylthio, a benzimidazolylthio group, a furylthio group, a thienylthio group, a pyrazolylthio group, and an imidazolylthio group. R¹⁴ is preferably a pyridyloxy group or a thienyloxy group.

A¹ and A² are both hydrogen atoms, or one of them is a hydrogen atom and the other is an acyl group (acetyl, trifluoroacetyl, benzoyl, or the like), a sulfonyl group (methanesulfonyl, toluenesulfonyl, or the like), or an oxalyl group (ethoxalyl, or the like). Preferably, A¹ and A² are both hydrogen atoms.

In formula (V-2), R²¹ represents a substituted or unsubstituted alkyl group, aryl group, or heteroaryl group. Specific examples of the alkyl group may include a methyl group, an ethyl group, a t-butyl group, a 2-octyl group, a cyclohexyl group, a benzyl group, and a diphenylmethyl group. Specifically, as the aryl group and the heteroaryl group, mention may be made of the same ones as with R¹¹, R¹², and R¹³. Further, when R²¹ has a substituent, specific examples of the substituent may include the same ones as with the substituents for R¹¹, R¹², and R¹³. R²¹ is preferably an aryl group or a heterocyclic group, and in particular preferably a substituted or unsubstituted phenyl group.

R²² represents a hydrogen atom, an alkylamino group, an arylamino group, or a heteroarylamino group. Specific examples of the alkylamino group may include a methylamino group, an ethylamino group, a propylamino group, a butylamino group, a dimethylamino group, a diethylamino group, and an ethylmethylamino group. As the arylamino group, mention may be made of an anilino group; and as the heteroaryl group, mention may be made of a thiazolylamino group, a benzimidazolylamino group, a benzthiazolylamino group, or the like. R²² is preferably a dimethylamino group or a diethylamino group. A¹ and A² are the same as with A¹ and A² described in formula (V-1).

In formula (V-3), R³¹ and R³² represent monovalent substituents, and as the monovalent substituents, mention may be made of the groups mentioned as the substituents of R¹¹, R¹², and R¹³. Preferably, mention may be made of an alkyl group, an aryl group, a heteroaryl group, an alkoxy group, and an amino group, more preferably an aryl group, and an alkoxy group. In particular preferably, at least one of R³¹ and R³² is a tert-butoxy group, and another preferred structure is the one in which when R³¹ is a phenyl group, R³² is a tert-butoxy group.

G³¹ and G³² each independently represent —CO—, —COCO—, —C(═S)—, a sulfonyl group, a sulfoxy group, —P(═O)R³³—, or an iminomethylene group, in which R³³ represents an alkyl group, an alkenyl group, an alkynyl group, an aryl group, an alkoxy group, an alkenyloxy group, an alkynyloxy group, an aryloxy group, or an amino group, provided that when G³¹ is a sulfonyl group, G³² is not a carbonyl group. G³¹ and G³² are each independently preferably —CO—, —COCO—, a sulfonyl group, or —CS—, and more preferably they are both —CO— groups, or both sulfonyl groups. A¹ and A² are the same as with A¹ and A² described in formula (V-1).

In formula (V-4), R⁴¹, R⁴², and R⁴³ are the groups synonymous with the groups represented by R¹¹, R¹², and R¹³ in formula (H-1). All of R⁴¹, R⁴², and R⁴³ are preferably substituted or unsubstituted phenyl groups, and more preferably all of R⁴¹, R⁴², and R⁴³ are unsubstituted phenyl groups. R⁴⁴ and R⁴⁵ each independently represent a substituted or unsubstituted alkyl group, and specific examples thereof may include a methyl group, an ethyl group, a t-butyl group, a 2-octyl group, a cyclohexyl group, a benzyl group, and a diphenylmethyl group. R⁴⁴ and R⁴⁵ are preferably both ethyl groups. A¹ and A² are the same as with A¹ and A² described in formula (V-1).

Below, non-limiting specific examples of the compounds represented by formulae (V-1) to (V-4) of the invention will be shown.

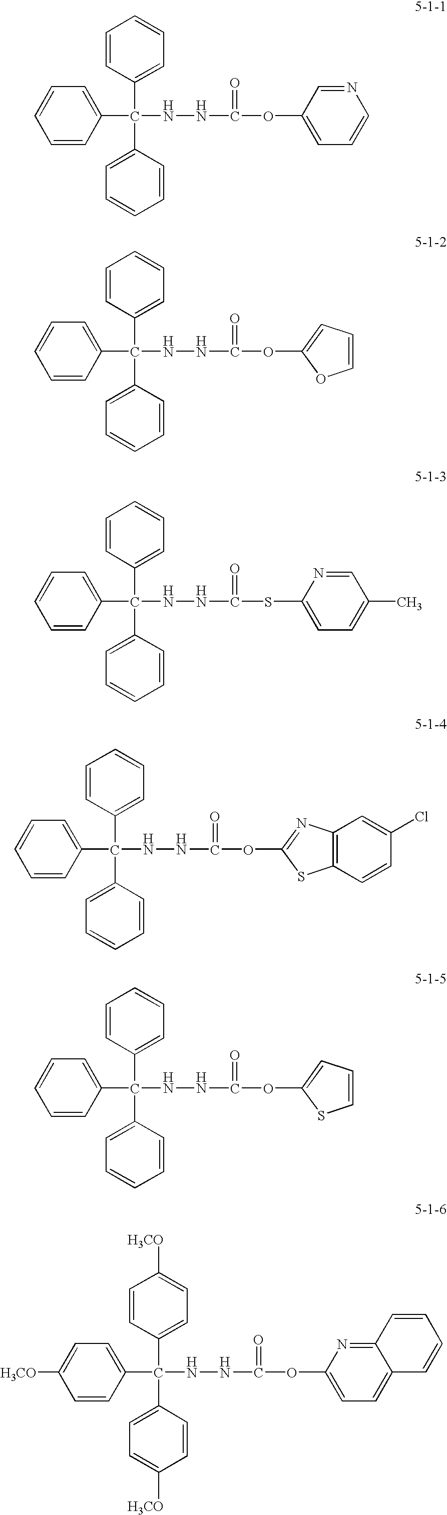

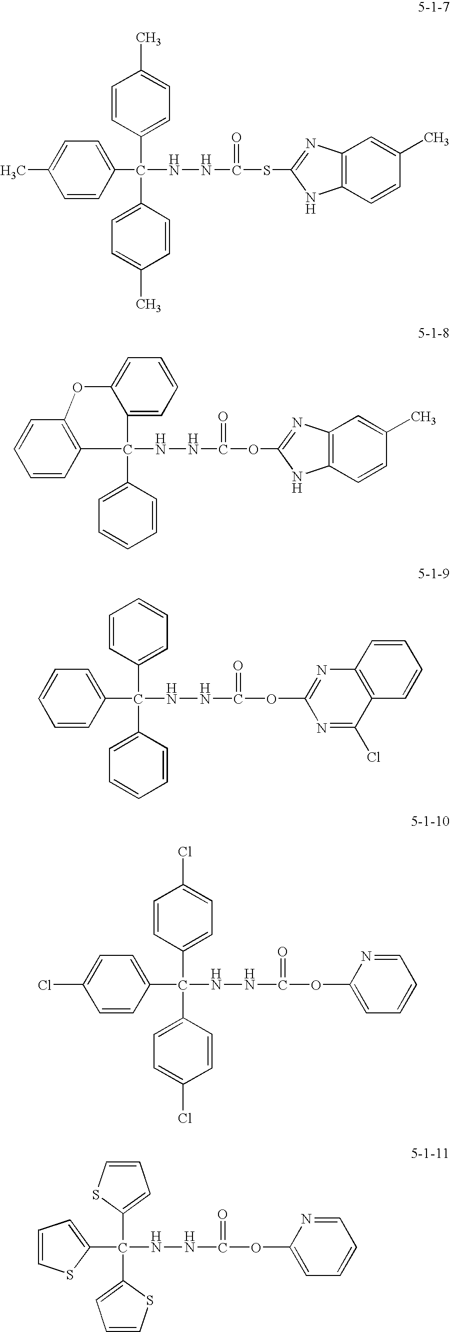

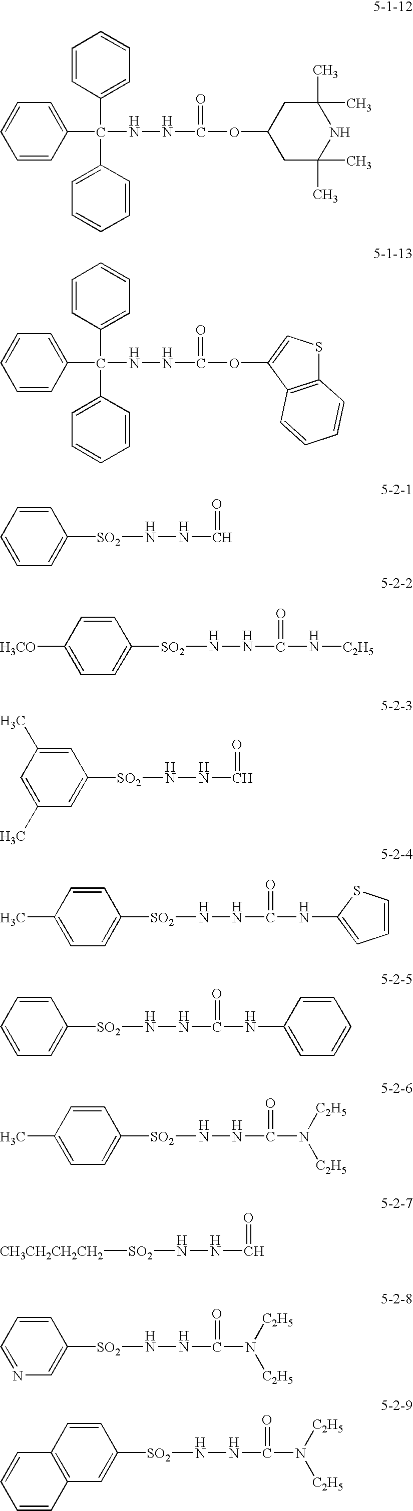

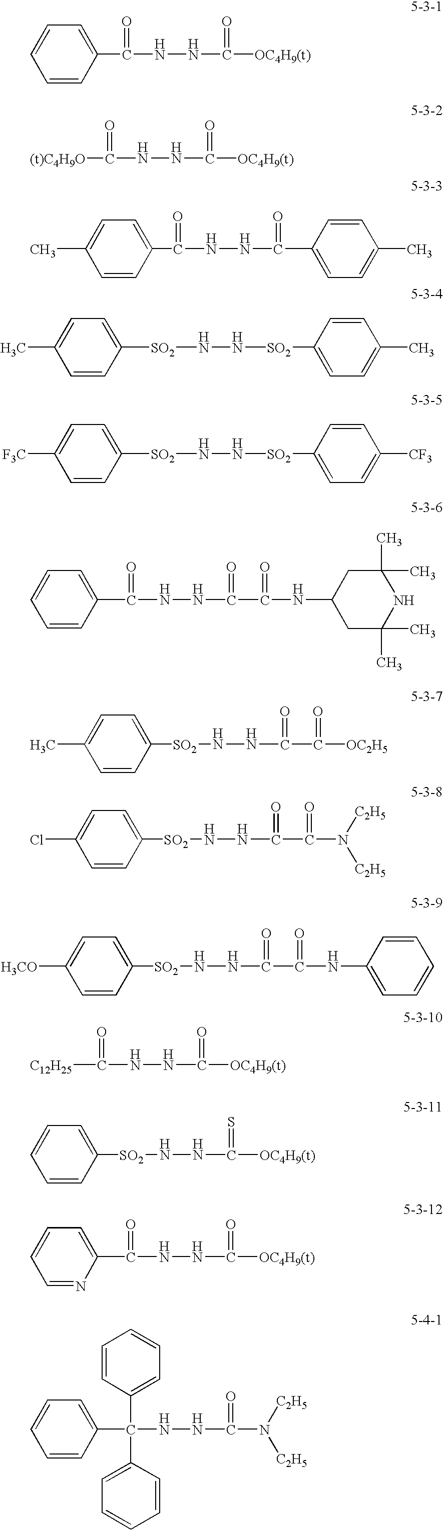

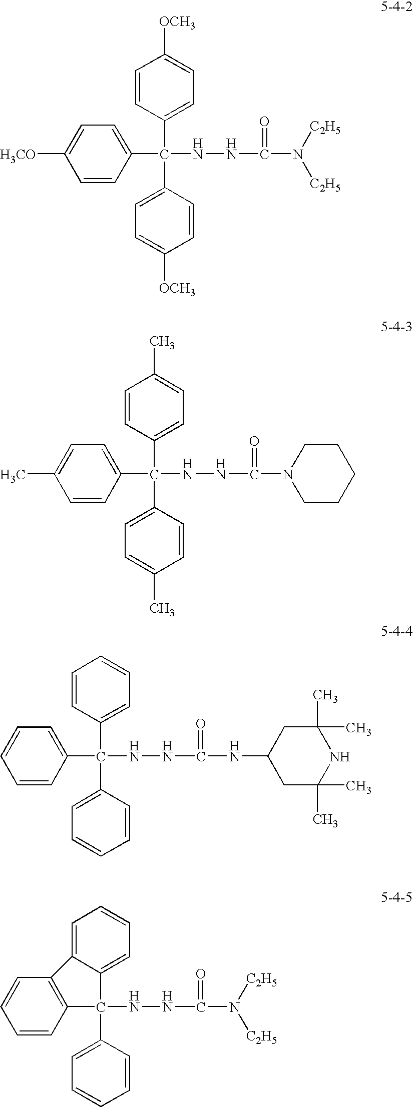

The compounds represented by formulae (H-1) to (H-4) of the invention can be readily synthesized in accordance with known methods. The compounds can be synthesized by reference to, for example, U.S. Pat. Nos. 5,464,738 and 5,496,695.

Other than these, preferably usable hydrazine derivatives are the compounds H-1 to H-29 described in U.S. Pat. No. 5,545,505, col. 11 to 20; and the compounds 1 to 12 described in U.S. Pat. No. 5,464,738, col. 9 to 11. These hydrazine derivatives can be synthesized with known methods.

In formula (VI), X and R are expressed in the cis form. However, the case where X and R are expressed in the trans form is also included in formula (VI). The same also applies to the expression of the structure of a specific compound.

In formula (VI), X represents an electron attracting group, and W represents a hydrogen atom, an alkyl group, an alkenyl group, an alkynyl group, an aryl group, a heterocyclic group, a halogen atom, an acyl group, a thioacyl group, an oxalyl group, an oxyoxalyl group, a thiooxalyl group, an oxamoyl group, an oxycarbonyl group, a thiocarbonyl group, a carbamoyl group, a thiocarbamoyl group, a sulfonyl group, a sulfinyl group, an oxysulfinyl group, a thiosulfinyl group, a sulfamoyl group, an oxysulfinyl, a thiosulfinyl group, a sulfinamoyl group, a phosphoryl group, a nitro group, an imino group, an N-carbonylimino group, an N-sulfinylimino group, a dicyanoethylene group, an ammonium group, a sulfonium group, a phosphonium group, a pyrylium group, or an immonium group.

R represents a halogen atom, a hydroxyl group, an alkoxy group, an aryloxy group, a heterocyclic oxy group, an alkenyloxy group, an acyloxy group, an alkoxycarbonyloxy group, an aminocarbonyloxy group, a mercapto group, an alkylthio group, an arylthio group, a heterocyclic thio group, an alkenylthio group, an acylthio group, an alkoxycarbonylthio group, an aminocarbonylthio group, an organic or inorganic salt (e.g., a sodium salt, a potassium salt, or a silver salt) of a hydroxyl group or a mercapto group, an amino group, an alkylamino group, a cyclic amino group (e.g., a pyrrolidino group), an acylamino group, an oxycarbonylamino group, a heterocyclic group (a 5- or 6-membered nitrogen-containing heterocyclic group such as a benzotriazolyl group, an imidazolyl group, a triazolyl group, or a tetrazolyl group), a ureido group, or a sulfonamido group. X and W, and X and R may respectively bond with each other to form a ring. Examples of the rings formed by X and W may include pyrazolone, pyrazolidinone, cyclopentanedione, β-ketolactone, and β-ketolactam.

The electron attracting group represented by X represents the substituent in which the substituent constant σp can take on a positive value. Specific examples thereof may include: substituted alkyl groups (such as halogen substituted alkyl), substituted alkenyl groups (such as cyanovinyl), substituted and unsubstituted alkynyl groups (such as trifluoromethylacetylenyl and cyanoacetylenyl), substituted aryl groups (such as cyanophenyl), substituted and unsubstituted heterocyclic groups (such as pyridyl, triazinyl, and benzoxazolyl), halogen atoms, cyano groups, acyl groups (such as acetyl, trifluoroacetyl, and formyl), thioacetyl groups (such as thioacetyl and thioformyl), oxalyl groups (such as methyloxalyl), oxyoxalyl groups (such as ethoxalyl), thiooxalyl groups (such as ethylthiooxalyl), oxamoyl groups (such as methyloxamoyl), oxycarbonyl groups (such as ethoxycarbonyl), carboxyl groups, thiocarbonyl groups (such as ethylthiocarbonyl), carbamoyl groups, thiocarbamoyl groups, sulfonyl groups, sulfinyl groups, oxysulfonyl groups (such as ethoxysulfonyl), thiosulfonyl groups (such as ethylthiosulfonyl), sulfamoyl groups, oxysulfinyl groups (such as methoxysulfinyl), thiosulfinyl groups (such as methylthiosulfinyl), sulfinamoyl groups, phosphoryl groups, nitro groups, imino groups, N-carbonylimino groups (such as N-acetylimino), N-sulfonylimino groups (such as N-methanesulfonylimino), dicyanoethylene groups, ammonium groups, sulfonium groups, phosphonium groups, pyrylium groups, and immonium groups. The heterocyclic ones whose rings are formed by an ammonium group, an sulfonium group, a phosphonium group, an immonium group, and the like are also included. Substituents having a σp value of 0.30 or more is in particular preferred.

Examples of the groups represented by W may include: for the alkyl groups, methyl, ethyl, and trifluoromethyl; for the alkenyl groups, vinyl, halogen substituted vinyl, and cyanovinyl; for the alkynyl groups, acetylenyl and cyanoacetylenyl; for the aryl groups, nitrophenyl, cyanophenyl, and pentafluorophenyl; and for the heterocyclic groups, pyridyl, pyrimidyl, triazinyl, succinimido, tetrazolyl, triazolyl, imidazolyl, and benzoxazolyl. W is preferably an electron attracting group having a positive σp value, and further preferably an electron attracting group having a positive σp value of 0.30 or more.

Out of the above-described substituents of R, mention may preferably be made of a hydroxyl group, a mercapto group, an alkoxy group, an alkylthio group, a halogen atom, an organic or inorganic salt of a hydroxyl group or a mercapto group, and a heterocyclic group; mention may more preferably be made of a hydroxyl group, an alkoxy group, an organic or inorganic salt of a hydroxyl group or a mercapto group, and a heterocyclic group; and mention may in particular preferably made of a hydroxyl group, an organic or inorganic salt of a hydroxyl group or a mercapto group.

Further, out of the above-described substituents of X and W, the ones each having a thioether bond in the substituent are preferred.

Next, non-limiting specific examples of the compound represented by formula (VI) will be shown.

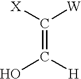

| | W | | | | |
|---|---|---|---|---|---|
| X | —COCH₃ | —COCF₃ | 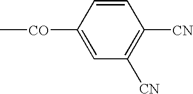 | —CHO | —COCH₂SCH₃ |
| —COOC₂H₅ | 6-1-1 | 6-2-1 | 6-3-1 | 6-4-1 | 6-5-1 |
| —COCOOC₂H₅ | 6-1-2 | 6-2-2 | 6-3-2 | 6-4-2 | 6-5-2 |
| —COCF₃ | 6-1-3 | 6-2-3 | 6-3-3 | 6-4-3 | 6-5-3 |
| —SO₂CH₃ | 6-1-4 | 6-2-4 | 6-3-4 | 6-4-4 | 6-5-4 |
| —CHO | 6-1-5 | — | 6-3-5 | 6-4-5 | 6-5-5 |
| —COCH₃ | 6-1-6 | — | 6-3-6 | — | 6-5-6 |
| —COCH₂SCH₃ | — | — | 6-3-7 | — | 6-5-7 |
| —SO₂CF₃ | 6-1-7 | 6-2-5 | 6-3-8 | 6-4-6 | 6-5-8 |
| 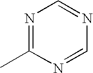 | 6-1-8 | 6-2-6 | 6-3-9 | 6-4-7 | 6-5-9 |
| —COOC₂H₄SCH₃ | 6-1-9 | 6-2-7 | 6-3-10 | 6-4-8 | 6-5-10 |
| —COCOOC₂H₄SCH₃ | 6-1-10 | 6-2-8 | 6-3-11 | 6-4-9 | 6-5-11 |
| —COCONHC₂H₄SCH₃ | 6-1-11 | 6-2-9 | 6-3-12 | 6-4-10 | 6-5-12 |

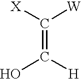

W

| X | —COCOCH₃ | —COCOOC₂H₅ | —COCOSC₂H₅ |
|---|---|---|---|
| —COOC₂H₅ | 6-6-1 | 6-7-1 | 6-8-1 |
| —COCOOC₂H₅ | 6-6-2 | 6-7-2 | 6-8-2 |
| —COCH₃ | 6-6-3 | — | 6-8-3 |
| —COCF₃ | 6-6-4 | — | 6-8-4 |
| —SO₂CH₃ | 6-6-5 | 6-7-3 | 6-8-5 |
| —SO₂CF₃ | 6-6-6 | 6-7-4 | 6-8-6 |
| —CHO | 6-6-7 | — | 6-8-7 |
| —COCH₂SCH₃ | 6-6-8 | — | 6-8-8 |
| 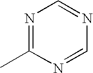 | 6-6-9 | 6-7-5 | 6-8-9 |
| —COOC₂H₄SCH₃ | 6-6-10 | 6-7-6 | 6-8-10 |
| —COCOOC₂H₄SCH₃ | 6-6-11 | 6-7-7 | 6-8-11 |
| —COCONHC₂H₄SCH₃ | 6-6-12 | 6-7-8 | 6-8-12 |
| 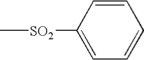 | 6-6-13 | 6-7-9 | — |

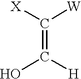

W

| X | —COCONHC₂H₄SCH₃ | 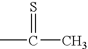 | —COOC₂H₅ | —COSC₂H₅ |
|---|---|---|---|---|
| —COOC₂H₅ | 6-9-1 | 6-10-1 | 6-11-1 | 6-12-1 |
| —COCOOC₂H₅ | 6-9-2 | 6-10-2 | — | 6-12-2 |
| —COCH₃ | — | 6-10-3 | — | 6-12-3 |
| —COCF₃ | — | 6-10-4 | — | 6-12-4 |
| —SO₂CH₃ | 6-9-3 | 6-10-5 | 6-11-2 | 6-12-5 |
| —SO₂CF₃ | 6-9-4 | 6-10-6 | 6-11-3 | 6-12-6 |
| —CHO | — | 6-10-7 | — | 6-12-7 |
| —COCH₂SCH₃ | — | 6-10-8 | — | 6-12-8 |
| 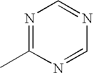 | 6-9-5 | 6-10-9 | 6-11-4 | 6-12-9 |
| —COOC₂H₄SCH₃ | 6-9-6 | 6-10-10 | 6-11-5 | 6-12-10 |
| —COCOOC₂H₄SCH₃ | 6-9-7 | 6-10-11 | 6-11-6 | 6-12-11 |
| —COCONHC₂H₄SCH₃ | 6-9-8 | 6-10-12 | — | 6-12-12 |
| 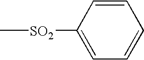 | — | — | 6-11-7 | — |

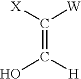

W

| X | 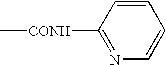 | 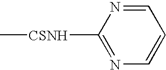 | —SO₂CH₃ |
|---|---|---|---|
| —COOC₂H₅ | 6-13-1 | 6-14-1 | 6-15-1 |
| —COCOOC₂H₅ | 6-13-2 | 6-14-2 | 6-15-2 |
| —COCH₃ | 6-13-3 | 6-14-3 | — |
| —COCF₃ | 6-13-4 | 6-14-4 | — |
| —SO₂CH₃ | 6-13-5 | 6-14-5 | 6-15-3 |
| —SO₂CF₃ | 6-13-6 | 6-14-6 | 6-15-4 |
| —CHO | 6-13-7 | 6-14-7 | — |
| —COCH₂SCH₃ | 6-13-8 | 6-14-8 | — |
| 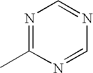 | 6-13-9 | 6-14-9 | 6-15-5 |
| —COOC₂H₄SCH₃ | 6-13-10 | 6-14-10 | 6-15-6 |
| —COCOOC₂H₄SCH₃ | 6-13-11 | 6-14-11 | 6-15-7 |
| —COCONHC₂H₄SCH₃ | 6-13-12 | 6-14-12 | 6-15-8 |

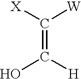

W

| X | —SO₂CF₃ | —SO₂CH₃ | —SO₂OCH₃ | —SO₂SCH₃ | —SO₂NH₂ |
|---|---|---|---|---|---|
| —COOC₂H₅ | — | 6-17-1 | 6-18-1 | 6-19-1 | 6-20-1 |
| —COCOOC₂H₅ | — | 6-17-2 | 6-18-2 | 6-19-2 | 6-20-2 |
| —COCH₃ | — | 6-17-3 | 6-18-3 | 6-19-3 | 6-20-3 |
| —COCF₃ | — | 6-17-4 | 6-18-4 | 6-19-4 | 6-20-4 |
| —SO₂CH₃ | — | 6-17-5 | 6-18-5 | 6-19-5 | 6-20-5 |
| —SO₂CF₃ | — | 6-17-6 | 6-18-6 | 6-19-6 | 6-20-6 |
| —CHO | — | 6-17-7 | 6-18-7 | 6-19-7 | 6-20-7 |
| —COCH₂SCH₃ | — | 6-17-8 | 6-18-8 | 6-19-8 | 6-20-8 |
| 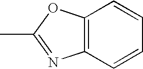 | 6-16-1 | 6-17-9 | 6-18-9 | 6-19-9 | 6-20-9 |
| —COOC₂H₄SCH₃ | — | 6-17-10 | 6-18-10 | 6-19-10 | 6-20-10 |
| —COCOOC₂H₄SCH₃ | — | 6-17-11 | 6-18-11 | 6-19-11 | 6-20-11 |
| —COCONHC₂H₄SCH₃ | 6-16-2 | 6-17-12 | 6-18-12 | 6-19-12 | 6-20-12 |

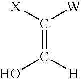

| | W | | | | |
|---|---|---|---|---|---|
| X | 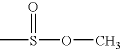 | 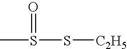 | 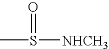 | 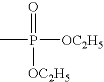 | —NO₂ |
| —COOC₂F₄H | 6-21-1 | 6-22-1 | 6-23-1 | 6-24-1 | 6-25-1 |
| —COCOOCH₂C₂F₄H | 6-21-2 | 6-22-2 | 6-23-2 | 6-24-2 | 6-25-2 |
| —COCH₃ | 6-21-3 | 6-22-3 | 6-23-3 | 6-24-3 | 6-25-3 |
| —COCF₃ | 6-21-4 | 6-22-4 | 6-23-4 | 6-24-4 | 6-25-4 |
| —SO₂CH₃ | 6-21-5 | 6-22-5 | 6-23-5 | 6-24-5 | 6-25-5 |
| —SO₂CF₃ | 6-21-6 | 6-22-6 | 6-23-6 | 6-24-6 | 6-25-6 |
| —CHO | 6-21-7 | 6-22-7 | 6-23-7 | 6-24-7 | 6-25-7 |
| —COCH₂SCH₃ | 6-21-8 | 6-22-8 | 6-23-8 | 6-24-8 | 6-25-8 |
| 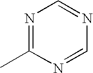 | 6-21-9 | 6-22-9 | 6-23-9 | 6-24-9 | 6-25-9 |
| —COOC₂H₄SCH₃ | 6-21-10 | 6-22-10 | 6-23-10 | 6-24-10 | 6-25-10 |
| —COCOOC₂H₄SCH₃ | 6-21-11 | 6-22-11 | 6-23-11 | 6-24-11 | 6-25-11 |
| —COCONHC₂H₄SCH₃ | 6-21-12 | 6-22-12 | 6-23-12 | 6-24-12 | 6-25-12 |

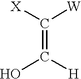

W

| X | 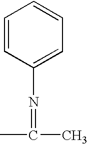 | 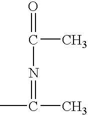 | 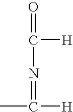 | 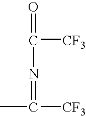 | 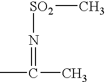 |
|---|---|---|---|---|---|
| —COOC₂H₅ | 6-26-1 | 6-27-1 | 6-28-1 | 6-29-1 | 6-30-1 |
| —COCOOC₂H₅ | 6-26-2 | 6-27-2 | 6-28-2 | 6-29-2 | 6-30-2 |
| —COCH₃ | 6-26-3 | 6-27-3 | 6-28-3 | 6-29-3 | 6-30-3 |
| —COCF₃ | 6-26-4 | 6-27-4 | 6-28-4 | 6-29-4 | 6-30-4 |
| —SO₂CH₃ | 6-26-5 | 6-27-5 | 6-28-5 | 6-29-5 | 6-30-5 |
| —SO₂CF₃ | 6-26-6 | 6-27-6 | 6-28-6 | 6-29-6 | 6-30-6 |
| —CHO | 6-26-7 | 6-27-7 | 6-28-7 | 6-29-7 | 6-30-7 |
| 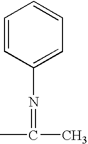 | 6-26-8 | 6-27-8 | 6-28-8 | 6-29-8 | 6-30-8 |
| 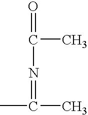 | — | 6-27-9 | 6-28-9 | 6-29-9 | 6-30-9 |
| 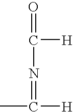 | — | — | 6-28-10 | 6-29-10 | 6-30-10 |
| 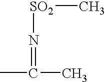 | — | — | — | 6-29-11 | 6-30-11 |

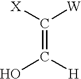

W

| X | 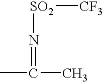 | 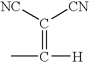 | 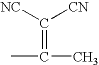 | 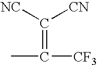 | 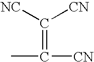 |
|---|---|---|---|---|---|
| —COOC₂H₅ | 6-31-1 | 6-32-1 | 6-33-1 | 6-34-1 | 6-35-1 |
| —COCOOC₂H₅ | 6-31-2 | 6-32-2 | 6-33-2 | 6-34-2 | 6-35-2 |
| —COCH₃ | 6-31-3 | 6-32-3 | 6-33-3 | 6-34-3 | 6-35-3 |
| —COCF₃ | 6-31-4 | 6-32-4 | 6-33-4 | 6-34-4 | 6-35-4 |
| —CHO | 6-31-5 | 6-32-5 | 6-33-5 | 6-34-5 | 6-35-5 |
| —SO₂CH₃ | 6-31-6 | 6-32-6 | 6-33-6 | 6-34-6 | 6-35-6 |
| —SO₂CF₃ | 6-31-7 | 6-32-7 | 6-33-7 | 6-34-7 | 6-35-7 |
| 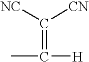 | 6-31-8 | 6-32-8 | 6-33-8 | 6-34-8 | 6-35-8 |
| 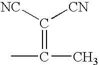 | 6-31-9 | — | 6-33-9 | 6-34-9 | 6-35-9 |
| 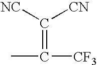 | 6-31-10 | — | — | 6-34-10 | 6-35-10 |
| 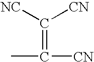 | 6-31-11 | — | — | — | 6-35-11 |

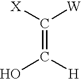

| | W | | | | |
|---|---|---|---|---|---|
| X | —CF₃ | —CH═CH—CN | —CH═CH—CHO | —C≡C—CF₃ | —C≡C—CN |
| —COOC₂H₅ | 6-36-1 | 6-37-1 | 6-38-1 | 6-39-1 | 6-40-1 |
| —COCOOC₂H₅ | 6-36-2 | 6-37-2 | 6-38-2 | 6-39-2 | 6-40-2 |
| —COCF₃ | 6-36-3 | 6-37-3 | 6-38-3 | 6-39-3 | 6-40-3 |
| —SO₂CH₃ | 6-36-4 | 6-37-4 | 6-38-4 | 6-39-4 | 6-40-4 |
| —COCH₃ | 6-36-5 | 6-37-5 | 6-38-5 | 6-39-5 | 6-40-5 |
| —SO₂CF₃ | 6-36-6 | 6-37-6 | 6-38-6 | 6-39-6 | 6-40-6 |
| —CHO | 6-36-7 | 6-37-7 | 6-38-7 | 6-39-7 | 6-40-7 |
| —COCH₂SCH₃ | 6-36-8 | 6-37-8 | 6-38-8 | 6-39-8 | 6-40-8 |
| 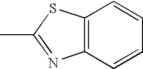 | 6-36-9 | 6-37-9 | 6-38-9 | 6-39-9 | 6-40-9 |
| —COOC₂H₄SCH₃ | 6-36-10 | 6-37-10 | 6-38-10 | 6-39-10 | 6-40-10 |
| —COCOOC₂H₄SCH₃ | 6-36-11 | 6-37-11 | 6-38-11 | 6-39-11 | 6-40-11 |
| —COCONHC₂H₄SCH₃ | 6-36-12 | 6-37-12 | 6-38-12 | 6-39-12 | 6-40-12 |

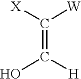

| | W | | | | |
|---|---|---|---|---|---|
| X | 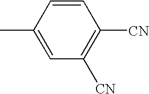 | 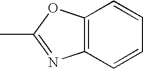 | 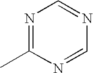 | Cl | H |
| —COOC₂H₅ | 6-41-1 | 6-42-1 | 6-43-1 | 6-44-1 | 6-45-1 |
| —COCOOC₂H₅ | 6-41-2 | 6-42-2 | 6-43-2 | 6-44-2 | 6-45-2 |
| —COCH₃ | 6-41-3 | 6-42-3 | — | 6-44-3 | 6-45-3 |
| —COCF₃ | 6-41-4 | 6-42-4 | — | 6-44-4 | 6-45-4 |
| —SO₂CH₃ | 6-41-5 | 6-42-5 | 6-43-3 | 6-44-5 | 6-45-5 |
| —SO₂CF₃ | 6-41-6 | — | 6-43-4 | 6-44-6 | 6-45-6 |
| —CHO | 6-41-7 | 6-42-6 | — | 6-44-7 | 6-45-7 |
| —COCH₂SCH₃ | 6-41-8 | 6-42-7 | — | 6-44-8 | 6-45-8 |
| 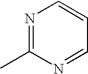 | 6-41-9 | 6-42-8 | 6-43-5 | 6-44-9 | 6-45-9 |
| —COOC₂H₄SCH₃ | 6-41-10 | 6-42-9 | 6-43-6 | 6-44-10 | 6-45-10 |
| —COCOOC₂H₄SCH₃ | 6-41-11 | 6-42-10 | 6-43-7 | 6-44-11 | 6-45-11 |
| —COCONHC₂H₄SCH₃ | 6-41-12 | 6-42-11 | 6-43-8 | 6-44-12 | 6-45-12 |

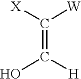

| | W | | | | |
|---|---|---|---|---|---|
| X | 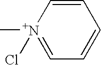 | 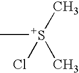 | 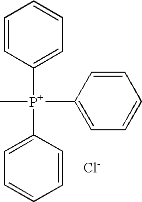 | 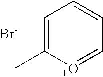 | 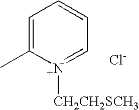 |
| —COOC₂H₅ | 6-46-1 | 6-47-1 | 6-48-1 | 6-49-1 | 6-50-1 |
| —COCOOC₂H₅ | 6-46-2 | 6-47-2 | 6-48-2 | 6-49-2 | 6-50-2 |
| —COCH₃ | 6-46-3 | 6-47-3 | 6-48-3 | 6-49-3 | 6-50-3 |
| —COCF₃ | 6-46-4 | 6-47-4 | 6-48-4 | 6-49-4 | 6-50-4 |
| —SO₂CH₃ | 6-46-5 | 6-47-5 | 6-48-5 | 6-49-5 | 6-50-5 |
| —SO₂CF₃ | 6-46-6 | 6-47-6 | 6-48-6 | 6-49-6 | 6-50-6 |
| —CHO | 6-46-7 | 6-47-7 | 6-48-7 | 6-49-7 | 6-50-7 |
| —COCH₂SCH₃ | 6-46-8 | 6-47-8 | 6-48-8 | 6-49-8 | 6-50-8 |
| 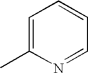 | 6-46-9 | 6-47-9 | 6-48-9 | 6-49-9 | 6-50-9 |
| —COOC₂H₄SCH₃ | 6-46-10 | 6-47-10 | 6-48-10 | 6-49-10 | 6-50-10 |
| —COCOOC₂H₄SCH₃ | 6-46-11 | 6-47-11 | 6-48-11 | 6-49-11 | 6-50-11 |
| —COCONHC₂H₄SCH₃ | 6-46-12 | 6-47-12 | 6-48-12 | 6-49-12 | 6-50-12 |

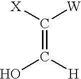

W

| X | 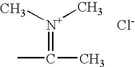 | 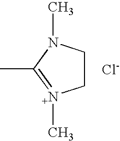 |
|---|---|---|
| —COOC₂H₅ | 6-51-1 | 6-52-1 |
| —COCOOC₂H₅ | 6-51-2 | 6-52-2 |
| —COCH₃ | 6-51-3 | 6-52-3 |
| —COCCl₃ | 6-51-4 | 6-52-4 |
| —SO₂CH₃ | 6-51-5 | 6-52-5 |
| —SO₂CF₃ | 6-51-6 | 6-52-6 |
| —CHO | 6-51-7 | 6-52-7 |
| 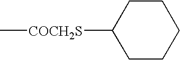 | 6-51-8 | 6-52-8 |
| 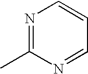 | 6-51-9 | 6-52-9 |
| —COOC₂H₄SC₂H₅ | 6-51-10 | 6-52-10 |
| —COCOOC₂H₄SC₂H₅ | 6-51-11 | 6-52-11 |
| 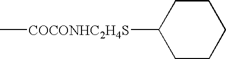 | 6-51 | 6-52-12 |

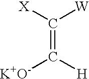

W

| X | —COCH₃ | —COCF₃ | —CHO | —COCH₂SCH₃ | —SO₂CH₃ |
|---|---|---|---|---|---|
| —COOC₂H₅ | 6-53-1 | 6-54-1 | 6-55-1 | 6-56-1 | 6-57-1 |
| —COCOOC₂H₅ | 6-53-2 | 6-54-2 | 6-55-2 | 6-56-2 | 6-57-2 |
| —COCH₃ | 6-53-3 | 6-54-3 | 6-55-3 | 6-56-3 | 6-57-3 |
| —COCF₃ | — | 6-54-4 | 6-55-4 | 6-56-4 | 6-57-4 |
| —CHO | — | — | 6-55-5 | 6-56-5 | 6-57-5 |
| —SO₂CH₃ | — | — | — | 6-56-6 | 6-57-6 |
| —SO₂CF₃ | 6-53-4 | 6-54-5 | 6-55-6 | 6-56-7 | 6-57-7 |
| —COCH₂SCH₃ | — | — | — | 6-56-8 | — |
| 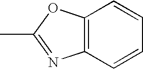 | 6-53-5 | 6-54-6 | 6-55-7 | 6-56-9 | 6-57-8 |
| —COOC₂H₄SCH₃ | 6-53-6 | 6-54-7 | 6-55-8 | 6-56-10 | 6-57-9 |
| —COCOOC₂H₄SCH₃ | 6-53-7 | 6-54-8 | 6-55-9 | 6-56-11 | 6-57-10 |
| —COCONHC₂H₄SCH₃ | 6-53-8 | 6-54-9 | 6-55-10 | 6-56-12 | 6-57-11 |

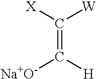

| | W | | | | |
|---|---|---|---|---|---|
| X | —SO₂CF₃ | 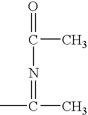 | 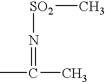 | 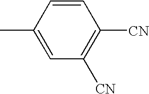 | 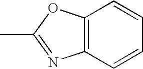 |
| —COOC₂H₅ | 6-58-1 | 6-59-1 | 6-60-1 | 6-61-1 | 6-62-1 |
| —COCOOC₂H₅ | 6-58-2 | 6-59-2 | 6-60-2 | 6-61-2 | 6-62-2 |
| —COCH₃ | — | 6-59-3 | 6-60-3 | 6-61-3 | — |
| —COCF₃ | — | 6-59-4 | 6-60-4 | 6-61-4 | — |
| —CHO | — | 6-59-5 | 6-60-5 | 6-61-5 | — |
| —SO₂CH₃ | — | 6-59-6 | 6-60-6 | 6-61-6 | — |
| —SO₂CF₃ | 6-58-3 | 6-59-7 | 6-60-7 | 6-61-7 | 6-62-3 |
| —COOH₂SCH₃ | 6-58-4 | 6-59-8 | 6-60-8 | 6-61-8 | — |
| 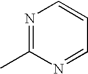 | 6-58-5 | 6-59-9 | 6-60-9 | 6-61-9 | 6-62-4 |
| —COOC₂H₄SCH₃ | 6-58-6 | 6-59-10 | 6-60-10 | 6-61-10 | 6-62-5 |
| —COCOOC₂H₄SCH₃ | 6-58-7 | 6-59-11 | 6-60-11 | 6-61-11 | 6-62-6 |
| —COCONHC₂H₄SCH₃ | 6-58-8 | 6-59-12 | 6-60-12 | 6-61-12 | 6-62-7 |

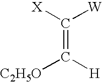

W

| X | —COCCl₃ | —COC₂F₄H | —CHO | —COCH₂SCH₃ |
|---|---|---|---|---|
| —COOC₂H₄SCH₃ | 6-63-1 | 6-64-1 | 6-65-1 | 6-66-1 |
| —COCOOC₂H₄SCH₃ | 6-63-2 | 6-64-2 | 6-65-2 | 6-66-2 |
| —COCF₃ | 6-63-3 | 6-64-3 | 6-65-3 | 6-66-3 |
| —CHO | 6-63-4 | 6-64-4 | 6-65-4 | 6-66-4 |
| —SO₂CH₃ | 6-63-5 | 6-64-5 | 6-65-5 | 6-66-5 |
| —SO₂CF₃ | 6-63-6 | 6-64-6 | 6-65-6 | 6-66-6 |
| —COCH₂SCH₃ | 6-63-7 | 6-64-7 | 6-65-7 | 6-66-7 |

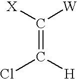

| | W | | | | | |
|---|---|---|---|---|---|---|
| X | —SO₂CF₃ | —CHO | —COCH₂SCH₃ | 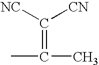 | 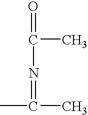 | 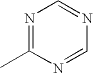 |
| —COOC₂H₅ | 6-67-1 | 6-67-2 | — | 6-67-4 | 6-67-6 | — |
| —COCOOC₂H₅ | —— | 6-67-3 | — | — | — | |
| —COCH₃ | — | — | — | — | — | 6-67-5 |

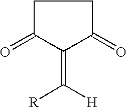

| | | |
|---|---|---|
| R: | —OH | 6-72-1 |
| | —OC₂H₅ | 6-72-4 |
| | —SCH₃ | 6-72-7 |

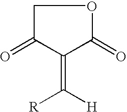

| | | |
|---|---|---|
| R: | —OH | 6-72-2 |
| | —O⁻Na⁺ | 6-72-3 |
| | —OCH₃ | 6-72-5 |
| | —O⁻Ag⁺ | 6-72-6 |
| | —SC₄H₉ | 6-72-8 |
| | —S⁻K⁺ | 6-72-9 |
| | 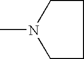 | 6-72-10 |
| | —Cl | 6-72-11 |

| | | | |
|---|---|---|---|
| 6-72-12 | 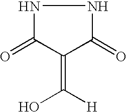 | 6-72-13 | 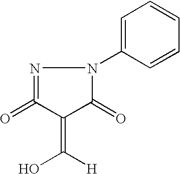 |
| 6-72-14 | 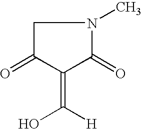 | 6-72-15 | 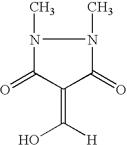 |

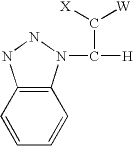

W

| X | —COCH₃ | —COCF₃ | —CHO | —COCH₂SCH₃ | —SO₂CH₃ |
|---|---|---|---|---|---|
| —COOC₂H₅ | 6-73-1 | 6-74-1 | 6-75-1 | 6-76-1 | 6-77-1 |
| —COCOOC₂H₅ | 6-73-2 | 6-74-2 | 6-75-2 | 6-76-2 | 6-77-2 |
| —COCH₃ | 6-73-3 | 6-74-3 | 6-75-3 | 6-76-3 | 6-77-3 |
| —COCF₃ | — | 6-74-4 | 6-75-4 | 6-76-4 | 6-77-4 |
| —CHO | — | — | 6-75-5 | 6-76-5 | 6-77-5 |
| —SO₂CH₃ | — | — | — | 6-76-6 | 6-77-6 |
| —SO₂CF₃ | 6-73-4 | 6-74-5 | 6-75-6 | 6-76-7 | 6-77-7 |
| —COCH₂SCH₃ | — | — | — | 6-76-8 | — |
| 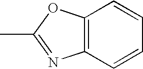 | 6-73-5 | 6-74-6 | 6-75-7 | 6-76-9 | 6-77-8 |
| 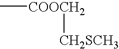 | 6-73-6 | 6-74-7 | 6-75-8 | 6-76-10 | 6-77-9 |
| 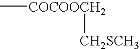 | 6-74-8 | 6-75-9 | 6-76-11 | 6-77-10 | 6-77-1- |
| 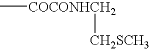 | 6-73-8 | 6-74-9 | 6-75-10 | 6-76-12 | 6-77-11 |

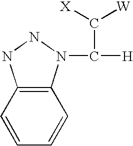

| | W | | | | |
|---|---|---|---|---|---|
| X | —SO₂CF₃ | 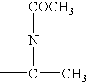 | 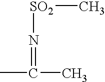 | 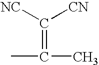 | 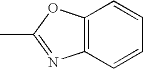 |
| —COOC₂H₅ | 6-78-1 | 6-79-1 | 6-80-1 | 6-81-1 | 6-82-1 |
| —COCOOC₂H₅ | 6-78-2 | 6-79-2 | 6-80-2 | 6-81-2 | 6-82-2 |
| —COCH₃ | — | 6-79-3 | 6-80-3 | 6-81-3 | — |
| —COCF₃ | — | 6-79-4 | 6-80-4 | 6-81-4 | — |
| —CHO | — | 6-79-5 | 6-80-5 | 6-81-5 | — |
| —SO₂CH₃ | — | 6-79-6 | 6-80-6 | 6-81-6 | — |
| —SO₂CF₃ | 6-78-3 | 6-79-7 | 6-80-7 | 6-81-7 | 6-82-3 |
| —COCH₂SCH₃ | 6-78-4 | 6-79-8 | 6-80-8 | 6-81-8 | — |
| 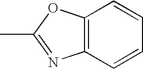 | 6-78-5 | 6-79-9 | 6-80-9 | 6-81-9 | 6-82-4 |
| 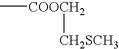 | 6-78-6 | 6-79-10 | 6-80-10 | 6-81-10 | 6-82-5 |
| 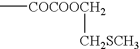 | 6-79-11 | 6-80-11 | 6-81-11 | 6-82-6 | 6-82-6 |
| 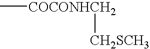 | 6-78-8 | 6-79-12 | 6-80-12 | 6-81-12 | 6-82-7 |

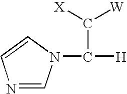

W

| X | —COCH₃ | —COCF₃ | —CHO | —COCH₂SCH₃ | —SO₂CH₃ |
|---|---|---|---|---|---|
| —COOC₂H₅ | 6-83-1 | 6-84-1 | 6-85-1 | 6-86-1 | 6-87-1 |
| —COCOOC₂H₅ | 6-83-2 | 6-84-2 | 6-85-2 | 6-86-2 | 6-87-2 |
| —COCH₃ | 6-83-3 | 6-84-3 | 6-85-3 | 6-86-3 | 6-87-3 |
| —COCF₃ | — | 6-84-4 | 6-85-4 | 6-86-4 | 6-87-4 |
| —CHO | — | — | 6-85-5 | 6-86-5 | 6-87-5 |
| —SO₂CH₃ | — | — | — | 6-86-6 | 6-87-6 |
| —SO₂CF₃ | 6-83-4 | 6-84-5 | 6-85-6 | 6-86-7 | 6-87-7 |
| —COCH₂SCH₃ | — | — | — | 6-86-8 | — |
| 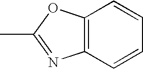 | 6-83-5 | 6-84-6 | 6-85-7 | 6-86-9 | 6-87-8 |
| 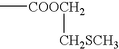 | 6-83-6 | 6-84-7 | 6-85-8 | 6-86-10 | 6-87-9 |
| 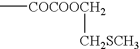 | 6-84-8 | 6-85-9 | 6-86-11 | 6-87-10 | 6-87-10 |
| 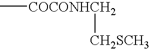 | 6-83-8 | 6-84-9 | 6-85-10 | 6-86-12 | 6-87-11 |

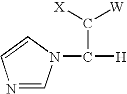

| | W | | | | |
|---|---|---|---|---|---|
| X | —SO₂CF₃ | 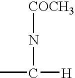 | 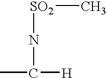 | 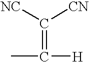 | 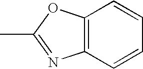 |
| —COOC₂H₅ | 6-88-1 | 6-89-1 | 6-90-1 | 6-91-1 | 6-92-1 |
| —COCOOC₂H₅ | 6-88-2 | 6-89-2 | 6-90-2 | 6-91-2 | 6-92-2 |
| —COCH₃ | — | 6-89-3 | 6-90-3 | 6-91-3 | — |
| —COCF₃ | — | 6-89-4 | 6-90-4 | 6-91-4 | — |
| —CHO | — | 6-89-5 | 6-90-5 | 6-91-5 | — |
| —SO₂CH₃ | — | 6-89-6 | 6-90-6 | 6-91-6 | — |
| —SO₂CF₃ | 6-88-3 | 6-89-7 | 6-90-7 | 6-91-7 | 6-92-3 |
| —COCH₂SCH₃ | 6-88-4 | 6-89-8 | 6-90-8 | 6-91-8 | — |
| 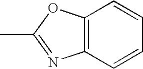 | 6-88-5 | 6-89-9 | 6-90-9 | 6-91-9 | 6-92-4 |
| 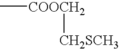 | 6-88-6 | 6-89-10 | 6-90-10 | 6-91-10 | 6-92-5 |
| 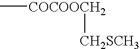 | 6-88-7 | 6-89-11 | 6-90-11 | 6-91-11 | 6-92-6 |
| 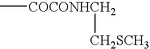 | 6-88-8 | 6-89-12 | 6-90-12 | 6-91-12 | 6-92-7 |

In formula (VII), Q represents a nitrogen atom or a phosphorus atom, R¹, R², R³, and R⁴ each independently represent a hydrogen atom or a substituent, and X⁻ represents an anion. Incidentally, R¹ to R⁴ may bond with each other to form a ring.

As the substituents represented by R¹ to R⁴, mention may be made of an alkyl group (such as a methyl group, an ethyl group, a propyl group, a butyl group, a hexyl group, or a cyclohexyl group), an alkenyl group (such as an allyl group or a butenyl group), an alkynyl group (such as a propargyl group or a butynyl group), an aryl group (such as a phenyl group or a naphthyl group), a heterocyclic groups (such as a piperidinyl group, a piperazinyl group, a morpholinyl group, a pyridyl group, a furyl group, a thienyl group, a tetrahydrofuryl group, a tetrahydrothienyl group, or a sulfolanyl group), an amino group, and the like.

As the rings which may be formed by mutual combination of R¹ to R⁴, mention may be made of a piperidine ring, a morpholine ring, a piperazine ring, a quinuclidine ring, a pyridine ring, a pyrrole ring, an imidazole ring, a triazole ring, and a tetrazole ring.

The groups represented by R¹ to R⁴ may have substituents such as a hydroxyl group, an alkoxy group, an aryloxy group, a carboxyl group, a sulfo group, an alkyl group, and an aryl group. R¹, R², R³, and R⁴ are each independently preferably a hydrogen atom or an alkyl group.

As anions represented by X⁻, mention may be made of inorganic and organic anions such as a halogen ion, a sulfate ion, a nitrate ion, an acetate ion, and a p-toluenesulfonate ion.

Further preferably, mention may be made of the compounds represented by the following formulae (VIIa), (VIIb), or (VIIc), and the compounds represented by formula [T].

Formula (VIIa)

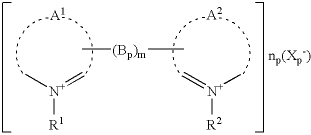

Formula (VIIb)

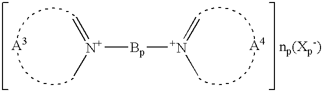

Formula (VIIc)

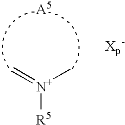

Formula [T]

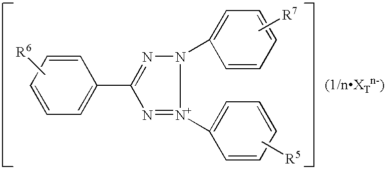

In the above formulae, A¹, A², A³, A⁴, and A⁵ each represent a non-metal atomic group for completing a nitrogen-containing heterocyclic ring, in which an oxygen atom, a nitrogen atom, or a sulfur atom may be contained, and benzene rings may be condensed. The heterocyclic rings formed by A¹, A², A³, A⁴, and A⁵ may have substituents, which may be the same or different. The substituents each represent an alkyl group, an aryl group, an aralkyl group, an alkenyl group, an alkynyl group, a halogen atom, an acyl group, an alkoxycarbonyl group, an aryloxycarbonyl group, a sulfo group, a carboxyl group, a hydroxyl group, an alkoxy group, an aryloxy group, an amido group, a sulfamoyl group, a carbamoyl group, a ureido group, an amino group, a sulfonamido group, a sulfonyl group, a cyano group, a nitro group, a mercapto group, an alkylthio group, or an arylthio group. Preferred examples of A¹, A², A³, A⁴, and A⁵ may include 5- or 6-membered rings (e.g., respective rings of pyridine, imidazole, thiozole, oxazole, pyrazine, and pyrimidine), and a more preferred example is a pyridine ring.

Bp represents a divalent linking group, and m denotes 0 or 1. The divalent linking group denotes a linking group consisting of an alkylene group, an arylene group, an alkenylene group, —SO₂—, —SO—, —O—, —S—, —CO—, or —N(R⁶)— (wherein R⁶ represents an alkyl group, an aryl group or a hydrogen atom), alone or in combination. As preferred Bp, mention may be made of an alkylene group or an alkenylene group.

R¹, R², and R⁵ each represent an alkyl group having 1 to 20 carbon atoms. Further, R¹ and R² may be the same or different. The alkyl group denotes a substituted or unsubstituted alkyl group, and examples of the substituent are the same as those exemplified as the substituents of A¹, A², A³, A⁴, and A⁵.

Preferred examples of R¹, R², and R⁵ include alkyl groups having 4 to 10 carbon atoms. Further preferred examples thereof may include substituted or unsubstituted aryl-substituted alkyl groups.

Xp-represents a counter ion necessary for balancing the electric charge of the whole molecule, and, for example, denotes a chlorine ion, a bromine ion, an iodine ion, a nitrate ion, a sulfate ion, a p-toluenesulfonate ion, or an oxalate ion. np represents the number of counter ions necessary for balancing the electric charge of the whole molecule, and np is 0 for an intramolecular salt.

The substituents R⁵, R⁶, and R⁷ of the phenyl group of the triphenyltetrazolium compound represented by formula [T] are each preferably a hydrogen atom or a group of which the Hammett's σ value (σp) indicative of the electron attracting property takes on a negative value.

The Hammett's σ values in the phenyl group are described in a large number of documents, for example, a report by C. Hansch in Journal of Medical Chemistry, vol. 20, on page 304, 1977. Particularly preferred examples of a group having a negative σ value, may include: a methyl group (σp=−0.17, hereinafter, all the values in the parentheses are in terms of σp value), an ethyl group (−0.15), a cyclopropyl group (−0.21), an n-propyl group (−0.13), an iso-propyl group (−0.15), a cyclobutyl group (0.15), an n-butyl group (−0.16), an iso-butyl group (−0.20), an n-pentyl group (−0.15), a cyclohexyl group (−0.22), an amino group (−0.66), an acetylamino group (−0.15), a hydroxyl group (−0.37), a methoxy group (−0.27), an ethoxy group (−0.24), a propoxy group (−0.25), a butoxy group (−0.32), and a pentoxy group (−0.34). All of these groups are useful as the substituent for the compound represented by formula [T].

n represents 1 or 2, and examples of the anion represented by XTn—may include: halogen ions such as chloride ion, bromide ion, and iodide ion; acid radicals of inorganic acids such as nitric acid, sulfuric acid, and perchloric acid; acid radicals of organic acids such as sulfonic acid and carboxylic acid; and anionic surfactants, specifically including lower alkyl benzenesulfonic acid anions such as p-toluenesulfonic acid anion, higher alkylbenzene sulfonic acid anions such as p-dodecyl benzenesulfonic acid anion, higher alkyl sulfate anions such as lauryl sulfate anion, boric acid-type anions such as tetraphenyl boron, dialkylsulfo succinate anions such as di-2-ethylhexylsulfo succinate anion, higher fatty acid anions such as cetyl polyethenoxysulfate anion, and those in which an acid radical is attached to a polymer, such as polyacrylic acid anion.

Hereinafter, as non-limiting specific examples of the quaternary onium salt compound, 7-1 to 7-55 and T-1 to T-18 will be shown below.

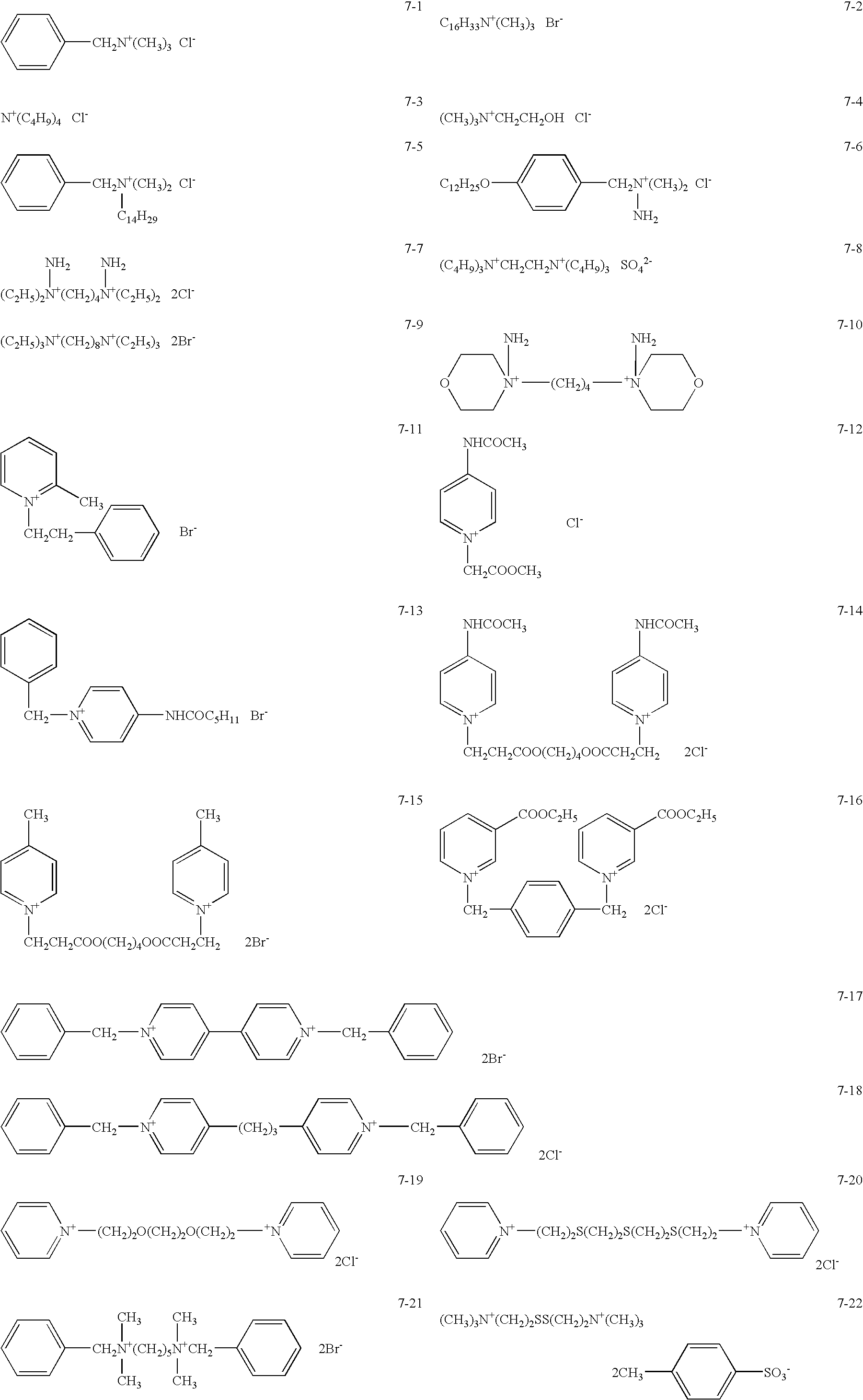

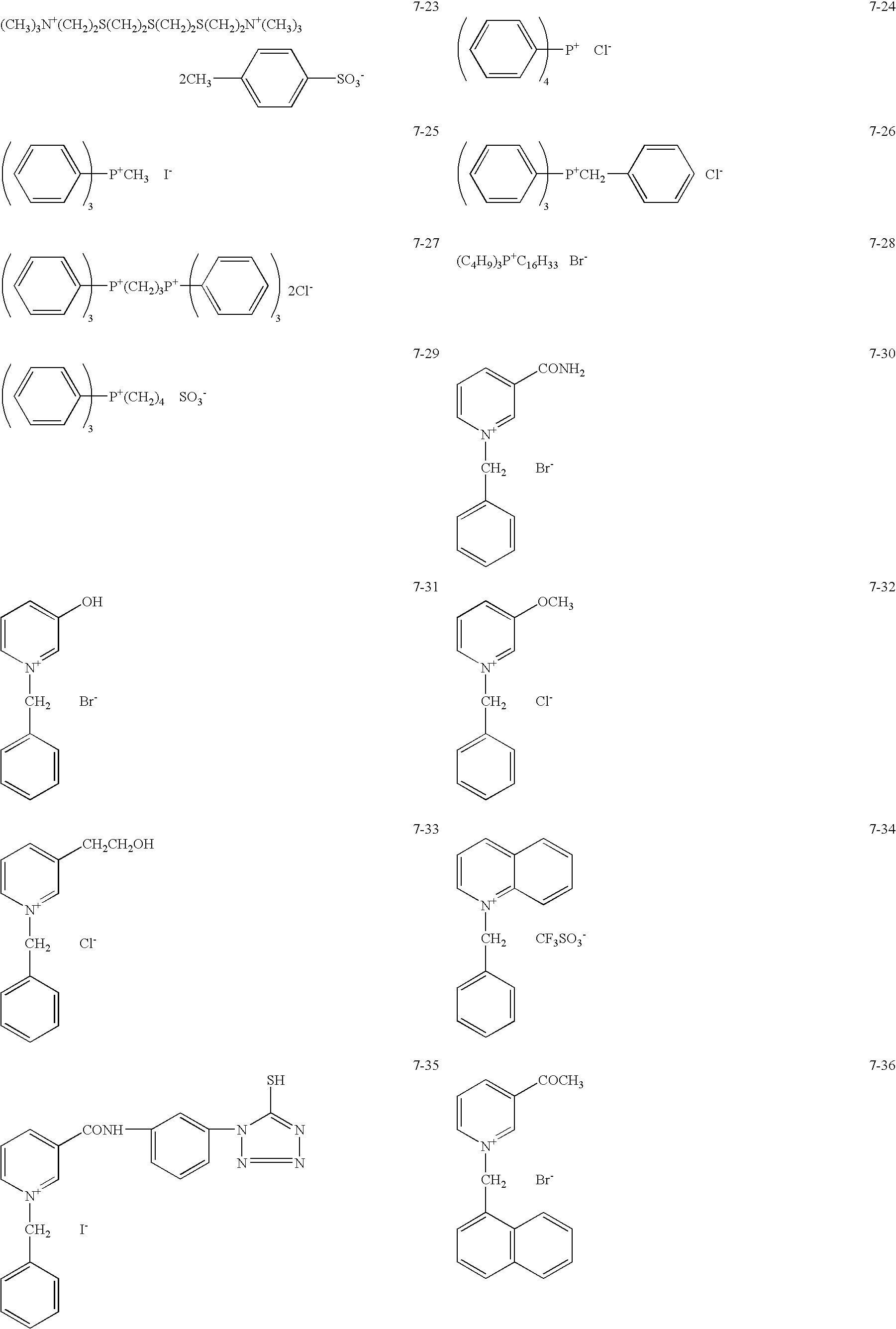

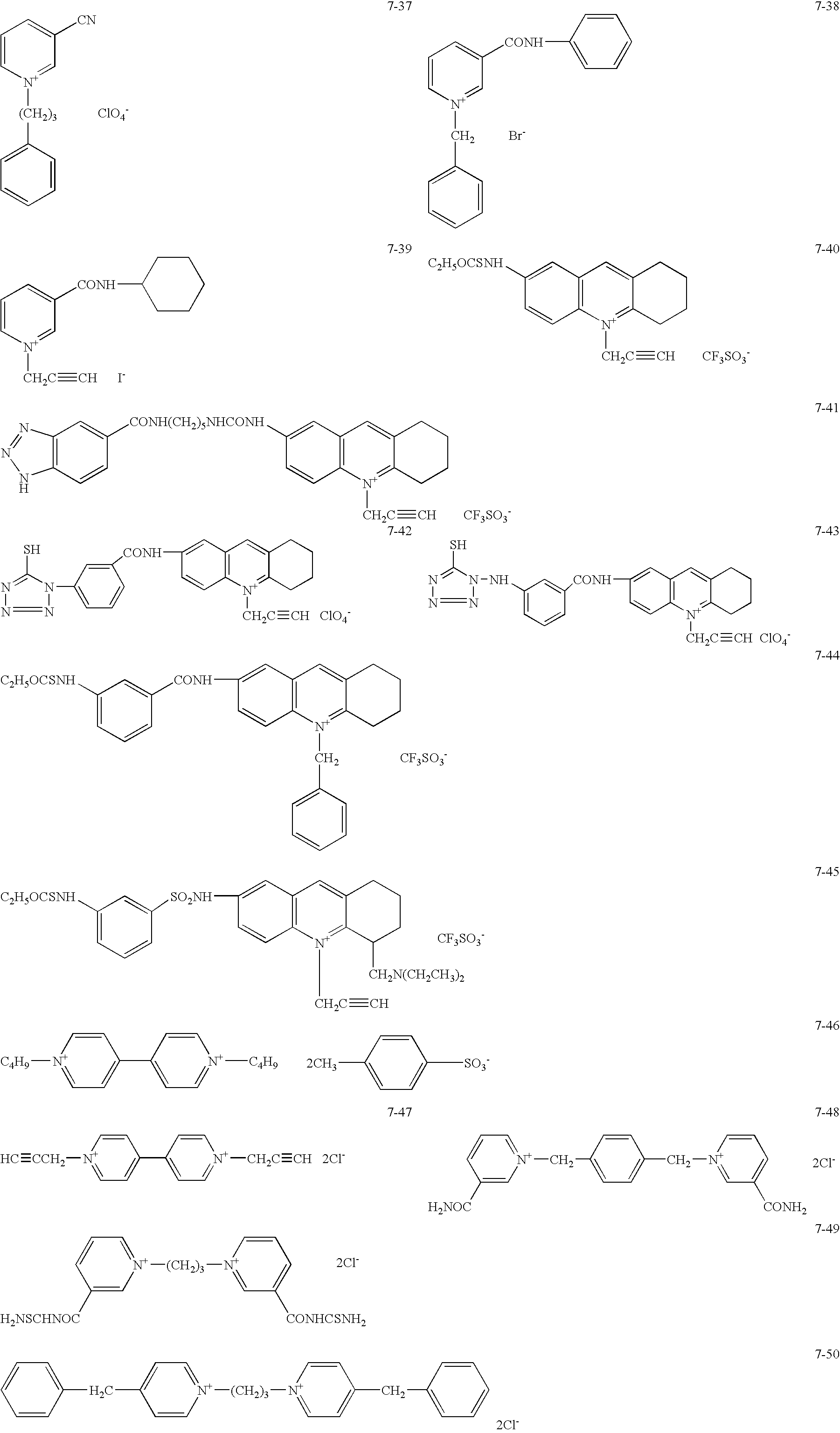

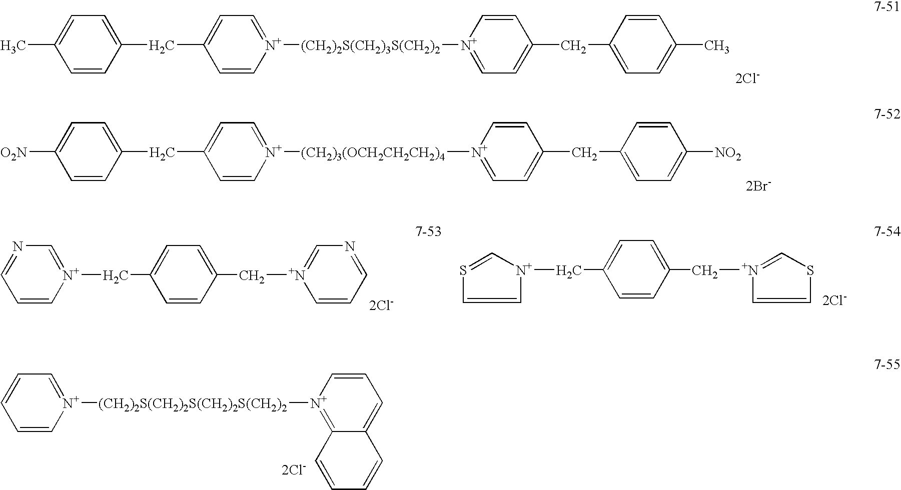

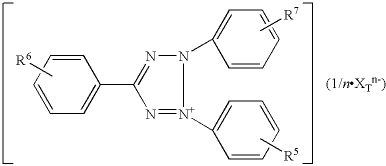

| [symbol] No. | R⁵ | R⁶ | R⁷ | X_{T}ⁿ^{⁻} |
|---|---|---|---|---|
| T-1 | H | H | p-CH₃ | — |
| T-2 | p-CH₃ | H | p-CH₃ | — |
| T-3 | p-CH₃ | p-CH₃ | p-CH₃ | — |
| T-4 | H | p-CH₃ | p-CH₃ | — |
| T-5 | p-OCH₃ | p-CH₃ | p-CH₃ | — |
| T-6 | p-OCH₃ | H | p-CH₃ | — |
| T-7 | p-OCH₃ | H | p-OCH₃ | — |
| T-8 | m-C₂H₅ | H | m-C₂H₅ | — |
| T-9 | p-C₂H₅ | p-C₂H₅ | p-C₂H₅ | — |
| T-10 | p-C₃H₇ | H | p-C₃H₇ | — |
| T-11 | p-isoC₃H₇ | H | p-isoC₃H₇ | — |
| T-12 | p-OC₂H₅ | H | p-OC₂H₅ | — |
| T-13 | p-OCH₃ | H | p-isoC₃H₇ | — |
| T-14 | H | H | p-nC₁₂H₂₅ | — |
| T-15 | p-nC₁₂H₂₅ | H | p-nC₁₂H₂₅ | — |
| T-16 | H | p-NH₂ | H | — |
| T-17 | p-NH₂ | H | H | — |
| T-18 | p-CH₃ | H | p-CH₃ | — |

The above-described quaternary onium compounds can be synthesized by reference to known methods. For example, for the above-described tetrazolium compound, the method described in CHEMICAL REVIEWS, vol. 55, p. 335 to 483 can serve as a reference.

The above-descrived silver-saving agents are added to an image forming layer or a layer adjacent to the image forming layer. When the image forming layer has a multilayered structure, for example, comprising a first image forming layer and a second image forming layer, the first image forming layer may contain the silver-saving agent, and the second image forming layer may not contain the silver-saving agent. The first image forming layer containing the silver-saving agent may be disposed closer to the support, and the second image forming layer not containing the silver-saving agent may be disposed more distant from the support. On the contrary, the first image forming layer containing the silver-saving agent may be disposed more distant from the support, and the second image forming layer not containing the silver-saving agent may be disposed closer to the support. A silver-saving agent is added in an amount in the range of 10⁻⁵ to 1 mol, and preferably 10⁻⁴ to 5×10⁻¹ mol per mole of the organic silver salt. The silver-saving agents may be added singly, or in combination of two or more.

(Explanation of Development Accelerator)

For the photothermographic material of the invention, there are preferably used, as development accelerators, the sulfonamidephenol type compounds represented by formula (A) described in JP-A Nos. 2000-267222 and 2000-330234, and the like, the hindered phenol type compounds represented by formula (II) described in JP-A No. 2001-92075, the hydrazine type compounds represented by formula (I) described in JP-A Nos. 10-62895 and 11-15116, and the like, formula (D) of JP-A No. 2002-156727, and formula (1) described in JP-A No. 2002-278017, and the phenol type or naphthol type compounds represented by formula (2) described in JP-A No. 2001-264929. Each of these development accelerators is used in an amount in the range of 0.1 to 20 mol %, preferably in the range of 0.5 to 10 mol %, and more preferably in the range of 1 to 5 mol % based on the amount of the reducing agent. As a process for introducing it into a sensitive material, mention may be made of the same process for the reducing agent. In particular, the development accelerator is preferably added in the form of a solid dispersion or an emulsified dispersion. When it is added in the form of an emulsified dispersion, it is preferably added in the form of an emulsified dispersion obtained by dispersing the compound using a high boiling solvent which is a solid at ordinary temperatures, and a low boiling co-solvent, or added in the form of a so-called oil-less emulsified dispersion not using a high boiling solvent.

In the invention, out of the development accelerators, particularly preferred are the hydrazine type compounds represented by formula (D) described in JP-A No. 2002-156727, and the phenol type or naphthol compounds represented by formula (2) described in JP-A No. 2001-264929.

Particularly preferred development accelerators of the invention are the compounds represented by formulae (A-1) and (A-2).

Q₁-NHNH-Q₂ Formula (A-1)

In formula (A-1), Q₁ represents an aromatic group or a heterocyclic group bonding with —NHNH-Q₂ at a carbon atom, and Q₂ represents a carbamoyl group, an acyl group, an alkoxycarbonyl group, an aryloxycarbonyl group, a sulfonyl group, or a sulfamoyl group.

In formula (A-1), the aromatic group or the heterocyclic group represented by Q₁ is preferably a 5- to 7-membered unsaturated ring. Preferred examples thereof may include: benzene ring, pyridine ring, pyrazine ring, pyrimidine ring, pyridazine ring, 1,2,4-triazine ring, 1,3,5-triazine ring, pyrrole ring, imidazole ring, pyrazole ring, 1,2,3-triazole ring, 1,2,4-triazole ring, tetrazole ring, 1,3,4-thiadiazole ring, 1,2,4-thiadiazole ring, 1,2,5-thiadiazole ring, 1,3,4-oxadia-zole ring, 1,2,4-oxadiazole ring, 1,2,5-oxadiazole ring, thiazole ring, oxazole ring, isothiazole ring, isoxazole ring, and thiophene ring. Condensed rings that are formed by condensing these rings are also preferred.

These rings may have a substituent, and when they have two or more substituents, those substituents may be the same or different. Examples of the substituents may include: a halogen atom, an alkyl group, an aryl group, a carbonamido group, an alkylsulfonamido group, an arylsulfonamido group, an alkoxy group, an aryloxy group, an alkylthio group, an arylthio group, a carbamoyl group, a sulfamoyl group, a cyano group, an alkylsulfonyl group, an arylsulfonyl group, an alkoxycarbonyl group, an aryloxycarbonyl group, and an acyl group. When these substituents are substitutable group, they may further have a substituent. Preferred examples of the substituent may include: a halogen atom, an alkyl group, an aryl group, a carbonamido group, an alkylsulfonamido group, an arylsulfonamido group, an alkoxy group, an aryloxy group, an alkylthio group, an arylthio group, an acyl group, an alkoxycarbonyl group, an aryloxycarbonyl group, a carbamoyl group, a cyano group, a sulfamoyl group, an alkylsulfonyl group, an arylsulfonyl group, and an acyloxy group.

The carbamoyl group represented by Q₂ is a carbamoyl group having preferably 1 to 50 carbon atoms, and more preferably 6 to 40 carbon atoms. Examples thereof may include: unsubstituted carbamoyl, methylcarbamoyl, N-ethylcarbamoyl, N-propylcarbamoyl, N-sec-butylcarbamoyl, N-octylcarbamoyl, N-cyclohexylcarbamoyl, N-tertbutylcarbamoyl, N-dodecylcarbamoyl, N-(3-dodecyloxypropyl)carbamoyl, N-octadecylcarbamoyl, N-{3-(2,4-tert-pentylphenoxy)propyl}carbamoyl, N-(2-hexyldecyl)carbamoyl, N-phenylcarbamoyl, N-(4-dodecyloxyphenyl)carbamoyl, N-(2-chloro-5-dodecyloxycarbonylphenyl)carbamoyl, N-naphthyl-carbamoyl, N-3-pyridylcarbamoyl and N-benzylcarbamoyl.

The acyl group represented by Q₂ is an acyl group having preferably 1 to 50 carbon atoms, and more preferably 6 to 40 carbon atoms. Examples thereof may include: formyl, acetyl, 2-methylpropanoyl, cyclohexylcarbonyl, octanoyl, 2-hexyl-decanoyl, dodecanoyl, chloroacetyl, trifluoroacetyl, benzoyl, 4-dodecyloxybenzoyl, and 2-hydroxymethylbenzoyl. The alkoxycarbonyl group represented by Q₂ is an alkoxycarbonyl group having preferably 2 to 50 carbon atoms, more preferably 6 to 40 carbon atoms. Examples thereof may include: methoxycarbonyl, ethoxycarbonyl, isobutyloxycarbonyl, cyclohexyloxycarbonyl, dodecyloxycarbonyl, and benzyloxycarbonyl.

The aryloxycarbonyl group represented by Q₂ is an aryloxycarbonyl group having preferably 7 to 50 carbon atoms, and more preferably 7 to 40 carbon atoms. Examples thereof may include phenoxycarbonyl, 4-octyloxyphenoxycarbonyl, 2-hydroxymethylphenoxycarbonyl, and 4-dodecyloxyphenoxycarbonyl.

The sulfonyl group represented by Q₂ is a sulfonyl group having preferably 1 to 50 carbon atoms, and more preferably 6 to 40 carbon atoms. Examples thereof may include: methylsulfonyl, butylsulfonyl, octylsulfonyl, 2-hexadecylsulfonyl, 3-dodecyloxypropylsulfonyl, 2-octyloxy-5-tert-octylphenylsulfonyl, and 4-dodecyloxyphenylsulfonyl.

The sulfamoyl group represented by Q₂ is a sulfamoyl group having preferably 0 to 50 carbon atoms, and more preferably 6 to 40 carbon atoms. Examples thereof may include: unsubstituted sulfamoyl, N-ethylsulfamoyl, N-(2-ethylhexyl)sulfamoyl, N-decylsulfamoyl, N-hexadecylsulfamoyl, N-{3-(2-ethylhexyloxy)propyl}-sulfamoyl, N-(2-chloro-5-dodecyloxycarbonylphenyl)sulfamoyl, and N-(2-tetradecyloxyphenyl) sulfamoyl.

The groups represented by Q₂ may further have the groups mentioned above as the examples of substituents of the 5- to 7-membered unsaturated ring represented by Q₁ at substitutable positions. When they have two or more substituents, the substituents may be the same or different.

Then, a description will be given to the preferred range of the compounds represented by formula (A-1). Q₁ is preferably a 5- or 6-membered ring, and further preferably, benzene ring, pyrimidine ring, 1,2,3-triazole ring, 1,2,4-triazole ring, tetrazole ring, 1,3,4-thiadiazole ring, 1,2,4-thiadiazole ring, 1,3,4-oxadiazole ring, 1,2,4-oxadiazole ring, thiazole ring, oxazole ring, isothiazole ring, or isoxazole ring, or a ring consisting of any of these rings condensed with a benzene ring or an unsaturated heterocyclic ring. Q₂ is preferably a carbamoyl group, and in particular preferably, a carbamoyl group having a hydrogen atom on a nitrogen atom.

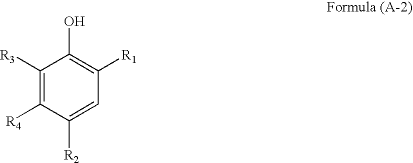

In formula (A-2), R₁ represents an alkyl group, an acyl group, an acylamino group, a sulfonamido group, an alkoxycarbonyl group, or a carbamoyl group. R₂ represents a hydrogen atom, a halogen atom, an alkyl group, an alkoxy group, an aryloxy group, an alkylthio group, an arylthio group, an acyloxy group, or a carbonic acid ester group. R₃ and R₄ each represent a group capable of being substituted on the benzene ring mentioned above as the examples of substituent of formula (A-1). R₃ and R₄ may bond with each other to form a condensed ring.

R₁ is preferably an alkyl group having 1 to 20 carbon atoms (e.g., a methyl group, an ethyl group, an isopropyl group, a butyl group, a tertoctyl group, or a cyclohexyl group), an acylamino group (e.g., an acetylamino group, a benzoylamino group, a methylureido group, or a 4-cyanopheylureido group), a carbamoyl group (an n-butylcarbamoyl group, an N,N-diethylcarbamoyl group, a phenylcarbamoyl group, a 2-chlorophenylcarbamoyl group, or a 2,4-dichlorophenylcarbamoyl group), and more preferably an acylamino group (including a ureido group or an urethane group). R₂ is preferably a halogen atom (more preferably a chlorine atom or a bromine atom), an alkoxy group (e.g., a methoxy group, a butoxy group, an n-hexyloxy group, an n-decyloxy group, a cyclohexyloxyl group, or a benzyloxy group), or an aryloxy group (such as a phenoxy group or a naphthoxy group).

R₃ is preferably a hydrogen atom, a halogen atom, or an alkyl group having 1 to 20 carbon atoms, and most preferably a halogen atom. R₄ is preferably a hydrogen atom, an alkyl group, or an acylamino group, and more preferably an alkyl group or an acylamino group. Preferred examples of the substituents are the same as those for R₁. When R₄ is an acylamino group, R₄ may also preferably bond with R₃ to form a carbostyryl ring.

In formula (A-2), when R₃ and R₄ bond with each other to form a condensed ring, the condensed ring is in particular preferably a naphthalene ring. To the naphthalene ring, the same substituents as those exemplified as the substituents for formula (A-1) may also be bonded. When formula (A-2) represents a naphthol type compound, R₁ is preferably a carbamoyl group. Especially, it is in particular preferably a benzoyl group. R₂ is preferably an alkoxy group or an aryloxy group, and in particular preferably an alkoxy group.

Below, non-limiting preferred specific examples of a development accelerator of the invention will be shown.

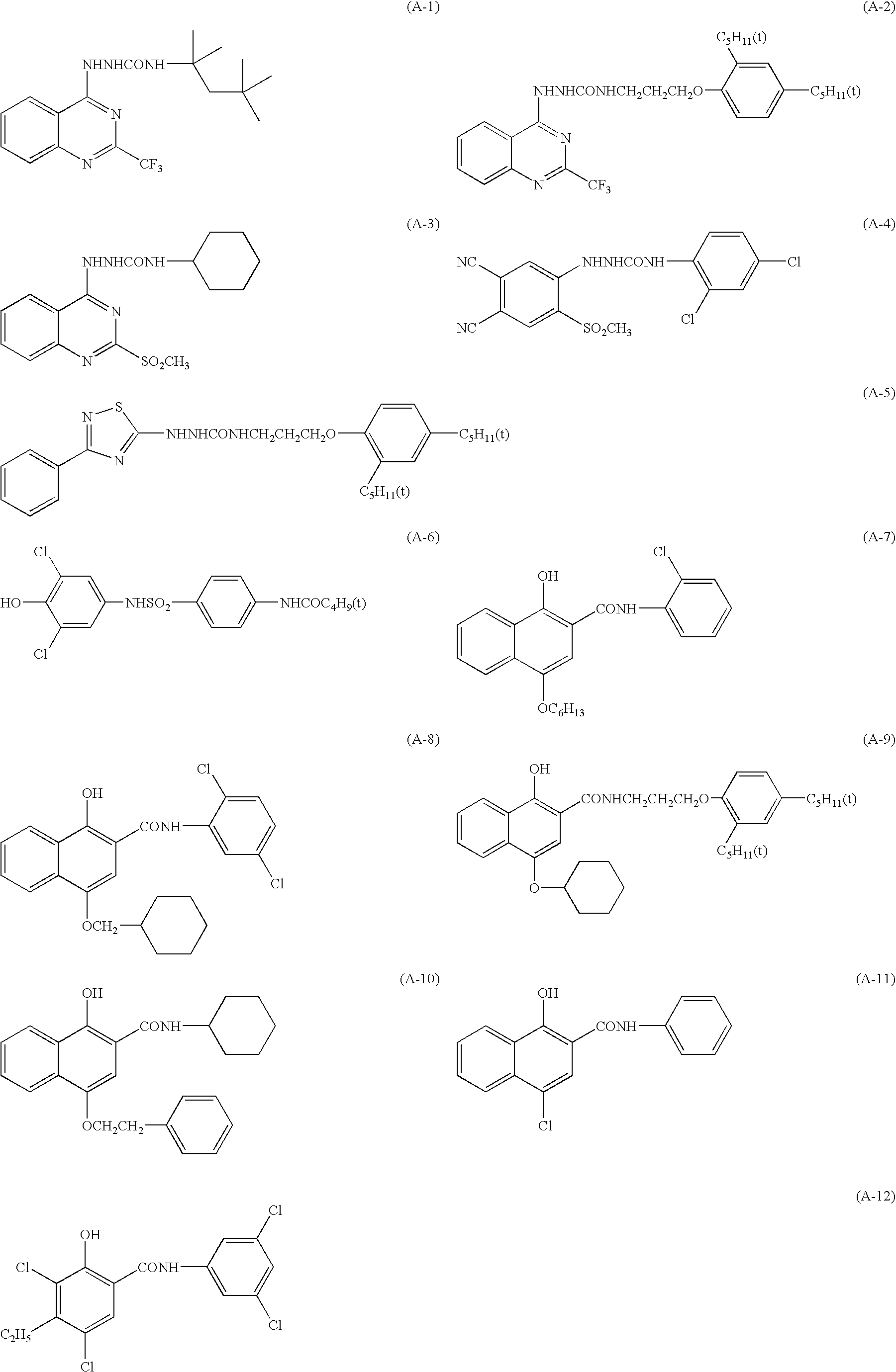

(Explanation of Hydrogen Bonding Compound)

When the reducing agent in the invention has an aromatic hydroxyl group (—OH) or an amino group, particularly in the case of the above-described bisphenols, a non-reducible compound having a group capable of forming a hydrogen bond with each of these groups is preferably used in combination. As the groups forming a hydrogen bond with a hydroxyl group or an amino group, mention may be made of a phosphoryl group, a sulfoxide group, a sulfonyl group, a carbonyl group, an amido group, an ester group, an urethane group, a ureido group, a tertiary amino group, a nitrogen-containing aromatic group, and the like. Out of these, preferred are a phosphoryl group, a sulfoxide group, an amido group (provided that it does not have an >N—H group, but is blocked like an >N—Ra (Ra is a substituent other than H)), an urethane group (provided that it does not have an >N—H group, but is blocked like an >N—Ra (Ra is a substituent other than H)), and a ureido group (provided that it has not an >N—H group, but is blocked like an >N—Ra (Ra is a substituent other than H)).

Particularly preferred hydrogen bonding compounds in the invention are the compounds represented by the following formula (D):

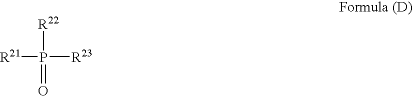

In formula (D), R²¹ to R²³ each independently represent an alkyl group, an aryl group, an alkoxy group, an aryloxy group, an amino group, or a heterocyclic group. These groups may be unsubstituted, or have a substituent. When R²¹ to R²³ have substituents, as the substituents, mention may be made of a halogen atom, an alkyl group, an aryl group, an alkoxy group, an amino group, an acyl group, an acylamino group, an alkylthio group, an arylthio group, a sulfonamido group, an acyloxy group, an oxycarbonyl group, a carbamoyl group, a sulfamoyl group, a sulfonyl group, a phosphoryl group, and the like. A preferred substituent is an alkyl group or an aryl group, examples of which may include: a methyl group, an ethyl group, an isopropyl group, a t-butyl group, a t-octyl group, a phenyl group, a 4-alkoxyphenyl group, and a 4-acyloxyphenyl group.

Specific examples of the alkyl group of R²¹ to R²³ may include: a methyl group, an ethyl group, a butyl group, an octyl group, a dodecyl group, an isopropyl group, a t-butyl group, a t-amyl group, a t-octyl group, a cyclohexyl group, a 1-methylcyclohexyl group, a benzyl group, a phenethyl group, and a 2-phenoxypropyl group. Examples of an aryl group may include: a phenyl group, a cresyl group, a xylyl group, a naphthyl group, a 4-t-butylphenyl group, a 4-t-octylphenyl group, a 4-anisidyl group, and a 3,5-dichlorophenyl group. Examples of an alkoxy group may include: a methoxy group, an ethoxy group, a butoxy group, an octyloxy group, a 2-ethylhexyloxy group, a 3,5,5-trimethylhexyloxy group, a dodecyloxy group, a cyclohexyloxy group, a 4-methylcyclohexyloxy group, and a benzyloxy group. Examples of an aryloxy group may include: a phenoxy group, a cresyloxy group, an isopropylphenoxy group, a 4-t-butylphenoxy group, a naphthoxy group, and a biphenyloxy group. Examples of an amino group may include: a dimethylamino group, a diethylamino group, a dibutylamino group, a dioctylamino group, an N-methyl-N-hexylamino group, a dicyclohexylamino group, a diphenylamino group, and an N-methyl-N-phenylamino group.

Each of R²¹ to R²³ is preferably an alkyl group, an aryl group, an alkoxy group, or an aryloxy group. From the viewpoint of the effects of the invention, at least one of R²¹ to R²³ is preferably an alkyl group or an aryl group, and two or more thereof are preferably alkyl groups or aryl groups. R²¹ to R²³ are preferably the same groups from the viewpoint of the availability at a low cost.

Non-limiting specific examples of the hydrogen bonding compounds including the compound of formula (D) in the invention will be shown.

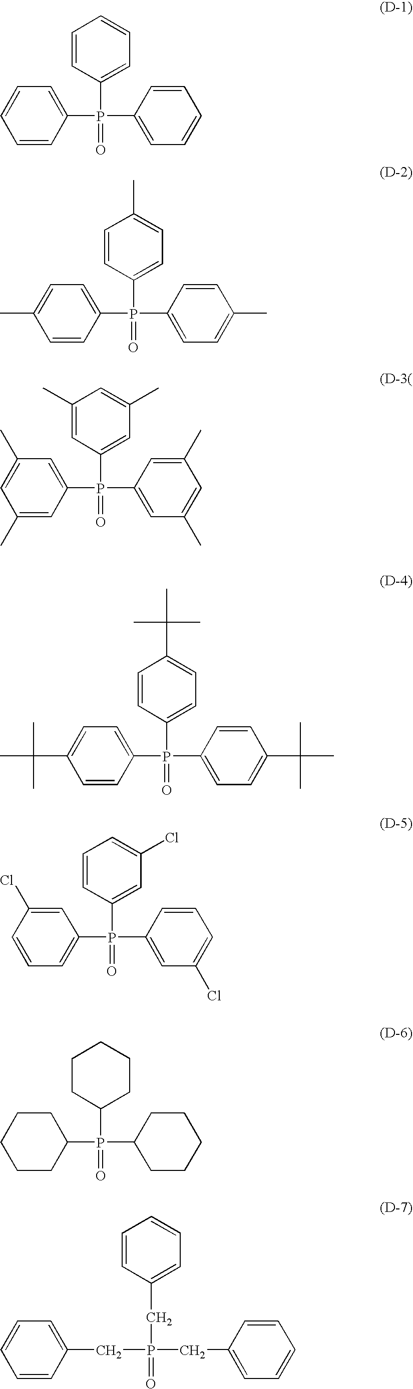

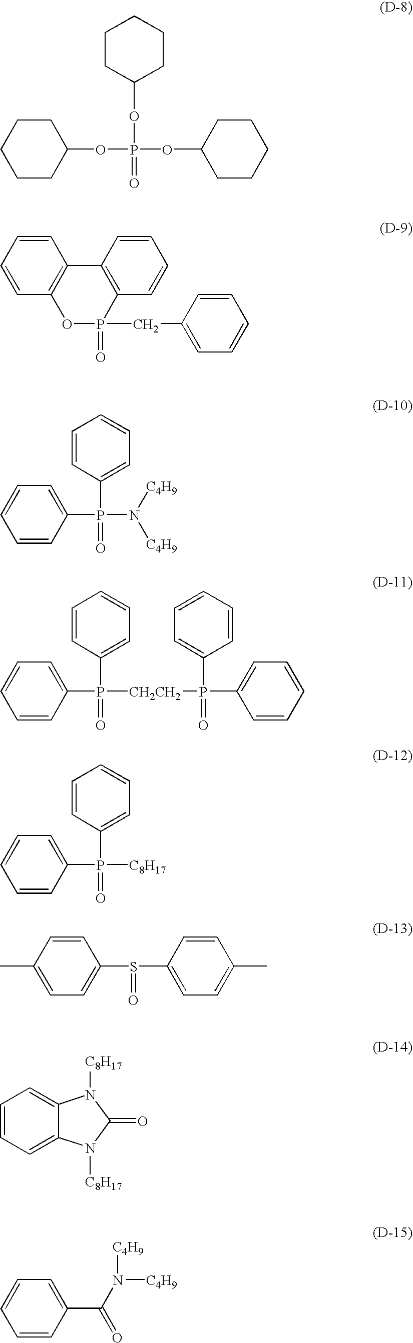

As the specific examples of the hydrogen bonding compound, other than the above-described ones, mention may be made of those described in EP-A No. 1096310, JP-A No. 2002-156727, and JP-A No. 2002-318431.

The compound of formula (D) in the invention can be used in the photosensitive material by being incorporated into the coating solution in solution form, in emulsified dispersion form, or in solid dispersed fine particle dispersion form in the same manner as with the reducing agent. However, it is preferably used in solid dispersion form. The compound of the invention forms a hydrogen bonding complex with a compound having a phenolic hydroxyl group or an amino group in a solution state, so that it can be separated as a complex in a crystalline state, depending on the combination between the reducing agent and the compound of formula (D) of the invention. It is particularly preferable for obtaining stable performances to use the crystal powder thus separated in the form of a solid dispersed fine particle dispersion. Further, methods of mixing the reducing agent with the compound of formula (D) of the invention in a powder state, and then causing the formation of a complex during dispersing by means of a sand grinder mill, or the like with an appropriate dispersing agent can also preferably be used.

It is preferable that the compound of formula (D) of the invention is used in an amount of preferably in the range of 1 to 200 mol %, more preferably in the range of 10 to 150 mol %, and further preferably in the range of 20 to 100 mol % based on the amount of the reducing agent.

(Explanation of Silver Halide)

1) Halogen Composition

The photosensitive silver halides usable in the invention are silver iodobromide or silver iodochlorobromide having a silver iodide content of 40% or more, and silver iodide. The silver iodide content is preferably 80 mol % or more and 100 mol % or less, and more preferably 90 mol % or more and 100 mol % or less. There is no particular restriction on the components other than silver iodide. The silver halides can be selected from silver chloride, silver bromide, silver thiocyanate, silver phosphate, and the like, but the silver halide is in particular preferably silver bromide or silver chloride.

The distribution of halogen composition in a grain may be uniform, or it may be such that the halogen composition is stepwise changed or continuously changed. Further, silver halide grains having a core/shell structure can preferably be used. For the structure, a twofold to fivefold structure is preferable. Core/shell grains having a twofold to fourfold structure are more preferably used. Techniques of localizing silver bromide or silver iodide on the surface of silver chloride, silver bromide, or silver chlorobromide grain can also preferably be used.

2) Grain Formation Method

The methods for forming the photosensitive silver halide are well known in the art. For example, methods described in Research Disclosure No. 17029, June, 1978, and U.S. Pat. No. 3,700,458 can be used. Specifically, the following method is used. Namely, a silver-supplying compound and a halogen-supplying compound are added into a solution of gelatin or other polymers, thereby to prepare a photosensitive silver halide. Then, the resulting photosensitive silver halide is mixed with an organic silver salt. Further, the methods described in paragraph Nos. 0217 to 0224 of JP-A No. 11-119374, and the methods described in JP-A Nos. 11-352627 and 2000-347335 are also preferred.

3) Average Grain Size

The grain size of the photosensitive silver halide has no particular restriction. Various sizes can be utilized according to the intended purpose. In particular, in this application, the light absorption caused by silver halide is reduced after heat development, and hence grains with a grain size in the region larger than in the related art are available.

Specifically, it is possible to use grains with a size of 5.0 μm or less, preferably 0.001 μm or more and 5.0 μm or less, more preferably 0.01 μm or more and 0.3 μm or less, and still more preferably 0.01 μm or more and 0.8 μm or less. The grain size herein mentioned denotes the diameter of the converted circular image having an area equivalent to the projection area of a silver halide grain (the projection area of the main plane for a tabular grain).

4) Grain Shape

The silver halide grain may be in the shape of a cube, an octahedron, a tablet, a sphere, a rod, a potato, or the like. In the invention, cubic grains are particularly preferred. Silver halide grains with rounded corners can also preferably be used. The plane indices (Miller indices) of outer surface planes of photosensitive silver halide grains have no particular restriction. However, [100] plane showing a high spectral sensitization efficiency upon adsorption of spectral sensitizing dyes thereon preferably occupies a large proportion. The proportion is preferably 50% or more, more preferably 65% or more, and furthermore preferably 80% or more. The proportion of Miller index [100] plane can be determined by the method described in T. Tani; J. Imaging Sci., 29, 165, (1985), which utilizes the adsorption dependency between [111] plane and [100] plane in the sensitizing dye adsorption.

5) Heavy Metal

The photosensitive silver halide grains of the invention can contain a metal of the Groups 8 to 10 in the Periodic Table (showing the Groups 1 to 18), or a metal complex thereof. The metals of the Groups 8 to 10 in the Periodic Table or the central metals of the metal complexes are preferably rhodium, ruthenium, and iridium. These metal complexes may be used alone, or in combination of two or more complexes of the same kind of metals and different kinds of metals. The preferred content is preferably in the range of 1×10⁻⁹ mol to 1×10⁻³ mol per mole of silver. These heavy metals, metal complexes, and addition processes thereof are described in JP-A No. 7-225449, JP-A No. 11-65021, paragraph Nos. 0018 to 0024, and JP-A No. 11-119374, paragraph Nos. 0227 to 0240.

In the invention, a silver halide grain having a hexacyano metal complex in the grain outermost surface is preferred. As the hexacyano metal complexes, mention may be made of [Fe(CN)₆]⁴⁻, [Fe(CN)₆]³⁻, [Ru(CN)₆]⁴⁻, [Os(CN)₆]⁴⁻, [Co(CN)₆]³⁻, [Rh(CN)₆]³⁻, [Ir(CN)₆]³⁻, [Cr(CN)₆]³⁻, [RE(CN)₆]³⁻, and the like. In the invention, a hexacyano Fe complex is preferred.

The hexacyano metal complex exists in the form of an ion in an aqueous solution, and hence its counter cation is not important. However, the counter cations to be preferably used are alkali metal ions such as sodium ion, potassium ion, rubidium ion, cesium ion, and lithium ion, ammonium ion, and alkylammonium ion (e.g., tetramethylammonium ion, tetraethylammonium ion, tetrapropylammonium ion, or tetra(n-butyl)ammonium ion), which are readily miscible with water, and are suitable for the operation of precipitating silver halide emulsions.

The hexacyano-metal complex may be added by being incorporated in a mixed solvent of water, and in addition, an organic solvent miscible with water (e.g., alcohols, ethers, glycols, ketones, esters, or amides), or gelatin.

The amount of hexacyano-metal complex to be added is preferably 1×10⁻⁵ mol or more to 1×10⁻² mol or less, and more preferably 1×10⁻⁴ mol or more to 1×10⁻³ mol or less per mole of silver.

In order for the hexacyano-metal complex to exist in the outermost surfaces of silver halide grains, the hexacyano-metal complex is directly added after the completion of addition of an aqueous silver nitrate solution for use in grain formation, and before the completion of the charging step until prior to the chemical sensitization step of performing chalcogen sensitization such as sulfur sensitization, selenium sensitization or tellurium sensitization, or noble metal sensitization such as gold sensitization, during the water washing step, during the dispersing step, or before the chemical sensitization step. In order to prevent the growth of silver halide grains, the hexacyano-metal complex is preferably added immediately after grain formation, and preferably added before the completion of the charging step.

Incidentally, the addition of the hexacyano-metal complex may be started after adding 96 mass % of the total amount of silver nitrate to be added for grain formation. It is more preferably started after adding 98 mass % thereof, and in particular preferably after adding 99 mass % thereof.

When the hexacyano-metal complex is added just before the completion of the grain formation, and after the addition of an aqueous solution of silver nitrate, it can adsorbs onto the outermost surfaces of the silver halide grains. Most of them forms a slightly-soluble salt with the silver ions in the grain surfaces. The silver salt of hexacyano-iron (II) is more slightly soluble than AgI, which can prevent re-dissolving in the form of fine grains. This enables manufacturing of silver halide fine grains with a small grain size.

Further, the metal atoms (e.g., [Fe(CN)₆]⁴⁻) which can be incorporated in the silver halide grains usable in the invention, and a desalting processes or a chemical sensitizing process of a silver halide emulsion are described in JP-A No. 11-84574, paragraph Nos. 0046 to 0050, JP-A No. 11-65021, paragraph Nos. 0025 to 0031, and JP-A No. 11-119374, paragraph Nos. 0242 to 0250.

6) Gelatin

As the gelatins to be incorporated in the photosensitive silver halide emulsion for use in the invention, various gelatins may be used. The dispersion state in an organic silver salt-containing coating solution of the photosensitive silver halide emulsion is required to be kept favorable, so that gelatin having a molecular weight of 10,000 to 1,000,000 is preferably used. It is also preferable to subject the substituent of gelatin to phthalation treatment. The gelatin may be used for grain formation or for dispersing after desalting treatment, but it is preferably used for grain formation.

7) Sensitizing Dye

As sensitizing dyes applicable to the invention, the sensitizing dyes can be advantageously selected which are capable of spectrally sensitizing silver halide grains in a desirable wavelength region upon adsorbing on the silver halide grains, and have the spectral sensitivities suitable for the spectral characteristics of an exposure light source. The sensitizing dyes and the addition processes thereof are described in the following references, or as the following substances: paragraph Nos. 0103 to 0109 of JP-A No. 11-65021, the compounds represented by formula (II) in JP-A No. 10-186572, the dyes represented by formula (I) and the paragraph No. 0106 of JP-A No. 11-119374, U.S. Pat. No. 5,510,236, the dyes described in Example 5 of U.S. Pat. No. 3,871,887, JP-A No. 2-96131, the dyes disclosed in JP-A No. 59-48753, on page 19, line 38 to page 20, line 35 of EP-A No. 0803764, JP-A Nos. 2001-272747, 2001-290238, and 2002-23306, and the like. These sensitizing dyes may be used alone, or may also be used in combination of two or more thereof. In the invention, the timing of adding a sensitizing dye to a silver halide emulsion is preferably during the period after the desalting step until, coating, and more preferably during the period after desalting until prior to the completion of chemical aging.

The amount of the sensitizing dye to be added in the invention can be set at a desirable amount according to the sensitivity and the fog performance. It is preferably 10⁻⁶ to 1 mol, and more preferably 10⁻⁴ to 10⁻¹ mol per mole of silver halide of the photosensitive layer.

In the invention, it is possible to use a super-sensitizer in order to improve the spectral sensitization efficiency. As the super-sensitizers for use in the invention, mention may be made of the compounds described in EP-A No. 587,338, U.S. Pat. Nos. 3,877,943 and 4,873,184, JP-A Nos. 5-341432, 11-109547, and 10-111543, and the like.

8) Chemical Sensitization

The photosensitive silver halide grains in the invention are preferably subjected to chemical sensitization with a sulfur sensitization process, a selenium sensitization process, or a tellurium sensitization process. The compounds preferably usable for a sulfur sensitization process, a selenium sensitization process, or a tellurium sensitization process are known compounds. For example, the compounds described in JP-A No. 7-128768 and the like may be used. In particular, tellurium sensitization is preferred in the invention. The compounds described in the reference described in paragraph No. 0030 of JP-A No. 11-65021, and the compounds represented by formulae (II), (III), and (IV) in JP-A No. 5-313284 are more preferred.

The photosensitive silver halide grains in the invention has been preferably chemically sensitized by a gold sensitization process, in combination with the chalcogen sensitization, or alone. The gold sensitizer preferably has a valence of gold of +1 or +3. Preferred gold sensitizers are normally used gold compounds. Typical preferred examples thereof include: chloroauric acid, bromoauric acid, potassium chloroaurate, potassium bromoaurate, auric trichloride, potassium auric trithiocyanate, potassium iodoaurate, tetracyanoauric acid, ammonium aurothiocyanate, and pyridyltrichlorogold. Further, the gold sensitizers described in U.S. Pat. No. 5,858,637 and JP-A No. 2002-278016 are also preferably used.

In the invention, any timing is acceptable for the chemical sensitization so long as the timing is after grain formation and before coating. The timing may be after desalting, and (1) before spectral sensitization, (2) simultaneously with spectral sensitization, (3) after spectral sensitization, (4) immediately before coating, or the like.

Each amount of the sulfur, selenium, and tellurium sensitizers for use in the invention varies according to the silver halide grains to be used, the chemical aging conditions, and the like. Each sensitizer is used in an amount of about 10⁻⁸ to 10⁻² mol, and preferably 10⁻⁷ to 10⁻³ mol per mole of silver halide.

The amount of gold sensitizer to be added varies according to various conditions. It is, as a guideline, 10⁻⁷ mol to 10⁻³ mol, and more preferably 10⁻⁶ to 5×10⁻⁴ mol per mole of silver halide.

The conditions for the chemical sensitization in the invention has no particular restriction. The pH is 5 to 8, the pAg is 6 to 11, and the temperature is about 40 to 95° C.

To the silver halide emulsion for use in the invention, a thiosulfonic acid compound may also be added with the method described in EP-A No. 293,917.

For the photosensitive silver halide grains in the invention, a reducing agent is preferably used. As the specific compounds for a reduction sensitization process, ascorbic acid and thiourea dioxide are preferred. In addition, stannous chloride, aminoiminomethane sulfinic acid, hydrazine derivatives, borane compounds, silane compounds, polyamine compounds, and the like are preferably used. The reduction sensitizer may be added in the any process of the photosensitive emulsion manufacturing steps of from the crystal growth until the preparation step immediately before coating. The emulsion is preferably aged with the pH held at 7 or more, or with the pAg held at 8.3 or less, so that reduction sensitization is performed. The reduction sensitization is also preferably performed by introducing the single addition part of silver ion during grain formation.

9) Compound Capable of Being One-Electron Oxidized To Become a One-Electron Oxidation Product, and Releasing One or More Electrons

The photothermographic material in the invention preferably contains a compound capable of being one-electron oxidized to become a one-electron oxidation product, and releasing one or more electrons. The compound can be used alone, or in combination with the above-described various chemical sensitizers, which brings about an increase in sensitivity of silver halide.

The compound capable of being one-electron oxidized to become a one-electron oxidation product, and releasing one or more electrons to be contained in the photothermographic material of the invention is a compound selected from the following compounds of types 1 to 5.

(Type 1)

Compound capable of being one-electron oxidized to become a one-electron oxidation product, and subsequently undergoing a bond cleavage reaction to further release two or more electrons;

(Type 2)

Compound capable of being one-electron oxidized to become a one-electron oxidation product, and subsequently undergoing a bond cleavage reaction to further release another electron, and having two or more silver halide adsorbing groups in the same molecule;

(Type 3)

Compound capable of being one-electron oxidized to become a one-electron oxidation product, subsequently undergoing a bond formation process, and then, further releasing one or more electrons;

(Type 4)

Compound capable of being one-electron oxidized to become a one-electron oxidation product, subsequently undergoing a ring cleavage reaction in the molecule, and then, further releasing one or more electrons;

(Type 5)

Compound represented by X—Y, wherein X represents a reducing group and Y represents a leaving group, capable of being one-electron oxidized at the reducing group represented by X to become a one-electron oxidation product, subsequently undergoing the cleavage reaction of the X—Y bond to release Y, thereby producing an X radical, and further releasing another electron therefrom.

Out of the compounds of the type 1, and types 3 to 5, a “compound having a silver halide adsorbing group in the molecule” or a “compound having a partial structure of a spectral sensitizing dye in the molecule” is preferred. It is more preferably the “compound having a silver halide adsorbing group in the molecule”. Each compound of type 1 to 4 is more preferably a “compound having two or more mercapto group-substituted nitrogen-containing heterocyclic groups as adsorbing groups”.

The compounds of types 1 to 5 will be described in details.

For the compound of type 1, the “bond cleavage reaction” specifically denotes the cleavage of the bond between respective elements of carbon-carbon, carbon-silicon, carbon-hydrogen, carbon-boron, carbon-tin, or carbon-germanium, and may also further be accompanied by the cleavage of a carbon-hydrogen bond. The compound of type 1 is a compound not capable of undergoing a bond cleavage reaction to further release two or more electrons (preferably 3 or more electrons) until being one-electron oxidized to become a one-electron oxidation product.

Out of the compounds of type 1, the preferred compounds are represented by formulae (A), (B), (1), (2), and (3):

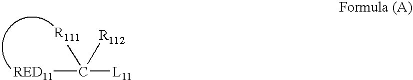

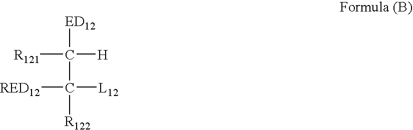

In formula (A), RED₁₁ represents a reducing group capable of being one-electron oxidized, and L₁₁ represents a leaving group; R₁₁₂ represents a hydrogen atom or a substituent; and R₁₁₁ represents a non-metal atomic group capable of forming a ring structure corresponding to a tetrahydro form, a hexahydro form, or an octahydro form of a 5-membered or 6-membered aromatic ring (including an aromatic heterocyclic ring) with the carbon atom and RED₁₁.

In formula (B), RED₁₂ represents a reducing group capable of being one-electron oxidized, and L₁₂ represents a leaving group; R₁₂₁, and R₁₂₂ each independently represent a hydrogen atom or a substituent; and ED₁₂ represents an electron donating group. In formula (B), R₁₂₁ and RED₁₂, R₁₂₁ and R₁₂₂, or ED₁₂ and RED₁₂ may bond with each other to form a ring.

The compound represented by formula (A) or formula (B) is a compound capable of being one-electron oxidized at the reducing group represented by RED₁₁ or RED₁₂, and then, spontaneously releasing L₁₁ or L₁₂ by the bond cleavage reaction, thereby to further release two or more electrons, and preferably 3 or more electrons.

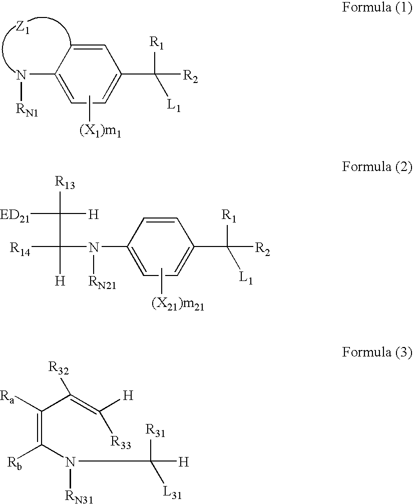

In formula (1), Z₁ represents an atomic group capable of forming a 6-membered ring with the nitrogen atom and two carbon atoms of the benzene ring; R₁, R₂, and R_{N1} each independently represent a hydrogen atom or a substituent; X₁ represents a group capable of being substituted on the benzene ring; m₁ denotes an integer from 0 to 3; and L₁ represents a leaving group. In formula (2), ED₂₁ represents an electron donating group; R₁₁, R₁₂, R_{N21}, R₁₃, and R₁₄ each independently represent a hydrogen atom or a substituent; X₂₁ represents a group capable of being substituted on the benzene ring; m₂₁ denotes an integer from 0 to 3; and L₂₁ represents a leaving group. R_{N21}, R₁₃, R₁₄, X₂₁, and ED₂₁ may bond with each other to form a ring. In formula (3), R₃₂, R₃₃, R₃₁, R_{N31}, Rₐ, and R_{b} each independently represent a hydrogen atom or a substituent; and L₃₁ represents a leaving group, provided that Rₐ and R_{b} bond with each other to form an aromatic ring when R_{N31} represents a group other than an aryl group.

These compounds are the compounds each capable of being one-electron oxidized, and then, spontaneously releasing L₁, L₂₁, or L₃₁ by the bond cleavage reaction, thereby to further release two or more electrons, and preferably 3 or more electrons.

Below, first, the compounds represented by formula (A) will be described in details.

The reducing group capable of being one-electron oxidized, represented by RED₁₁ in formula (A) is a group capable of bonding R₁₁₁ described later to form a specific ring. Specific examples thereof may include divalent groups each formed by removing one hydrogen atom at a proper site for forming a ring from each of the following monovalent groups. Examples thereof may include: an alkylamino group, arylamino group (e.g., an anilino group or a naphthylamino group), a heterocyclic amino group (e.g., a benzthiazolylamino group or a pyrrolylamino group), an alkylthio group, an arylthio group (e.g., a phenylthio group), a heterocyclic thio group, an alkoxy group, an aryloxy group (e.g., a phenoxy group), a heterocyclic oxy group, an aryl group (e.g., a phenyl group, a naphthyl group, or an anthranyl group), and aromatic or nonaromatic heterocyclic groups (5-membered to 7-membered monocyclic or condensed heterocyclic ring containing at least one hetero atom of a nitrogen atom, a sulfur atom, an oxygen atom, and a selenium atom, specific examples of which may include a tetrahydroquinoline ring, a tetrahydroisoquinoline ring, a tetrahydroquinoxaline ring, a tetrahydroquinazoline ring, an indoline ring, an indole ring, an indazole ring, a carbazole ring, a phenoxazine ring, a phenothiazine ring, a benzothiazoline ring, a pyrrole ring, an imidazole ring, a thiazoline ring, a piperidine ring, a pyrrolidine ring, a morpholine ring, a benzimidazole ring, a benzimidazoline ring, a benzoxazoline ring, and a methylenedioxyphenyl ring (hereinafter, for the sake of convenience, RED₁₁ is referred to as the designation of a monovalent group). RED₁₁ may have a substituent.

In the invention, unless otherwise specified, the substituent denotes a substituent selected from the following groups. Examples thereof may include: a halogen atom, alkyl groups (including, an aralkyl group, a cycloalkyl group, and an active methine group), an alkenyl group, an alkynyl group, an aryl group, a heterocyclic group (any substitution position is acceptable), a heterocyclic group containing a quaternized nitrogen atom (e.g., a pyridinio group, an imidazolio group, a quinolinio group, or an isoquinolinio group), an acyl group, an alkoxycarbonyl group, an aryloxycarbonyl group, a carbamoyl group, a carboxyl group or a salt thereof, a sulfonylcarbamoyl group, an acylcarbamoyl group, a sulfamoylcarbamoyl group, a carbazoyl group, an oxalyl group, an oxamoyl group, a cyano group, a carbonimidoyl group, a thiocarbamoyl group, a hydroxyl group, an alkoxy group (including a group repeatedly containing ethyleneoxy group or propyleneoxy units), an aryloxy group, a heterocyclic oxy group, an acyloxy group, an (alkoxy or aryloxy)carbonyloxy group, a carbamoyloxy group, a sulfonyloxy group, an amino group, an (alkyl, aryl, or heterocyclic)amino group, an acylamino group, a sulfonamido group, a ureido group, a thioureido group, an imido group, an (alkoxy or aryloxy)carbonylamino group, a sulfamoylamino group, a semicarbazido group, a thiosemicarbazido group, a hydrazino group, an ammonio group, an oxamoylamino group, (alkyl or aryl)sulfonylureido group, an acylureido group, an acylsulfamoylamino group, a nitro group, a mercapto group, (alkyl, aryl, or heterocyclic)thio group, an (alkyl or aryl)sulfonyl group, an (alkyl or aryl)sulfinyl group, a sulfo group or a salt thereof, a sulfamoyl group, an acylsulfamoyl group, a sulfonylsulfamoyl group or a salt thereof, and a group containing a phosphoric acid amide or phosphoric acid ester structure. These substituents may also be further substituted with these substituents.

RED₁₁ is preferably an alkylamino group, an arylamino group, a heterocyclic amino group, an aryl group, or an aromatic or non-aromatic heterocyclic group, and more preferably an arylamino group (in particular, an anilino group), or an aryl group (in particular, a phenyl group). When it has a substituent, the substituent is preferably a halogen atom, an alkyl group, an alkoxy group, a carbamoyl group, a sulfamoyl group, an acylamino group, or a sulfonamido group.

However, when RED₁₁ represents an aryl group, the aryl group preferably has at least one “electron donating group”. Herein, the “electron donating group” is a hydroxy group, an alkoxy group, a mercapto group, a sulfonamido group, an acylamino group, an alkylamino group, an arylamino group, a heterocyclic amino group, an active methine group, a 5-membered monocyclic or condensed electron-excessive aromatic heterocyclic group containing at least one nitrogen atom in the ring (e.g., an indolyl group, a pyrrolyl group, an imidazolyl group, a benzimidazolyl group, a thiazolyl group, a benzothiazolyl group, or an indazolyl group), or a non-aromatic nitrogen-containing heterocyclic group to be substituted at the nitrogen atom (a group which may also be referred to as a cyclic amino group such as a pyrrolidinyl group, an indolinyl group, a piperidinyl group, a piperazinyl group, or a morpholino group). Herein, the active methine group denotes a methine group substituted with two electron attracting groups, and the “electron attracting group” herein denotes an acyl group, an alkoxycarbonyl group, an aryloxycarbonyl group, a carbamoyl group, an alkylsulfonyl group, an arylsulfonyl group, a sulfamoyl group, a trifluoromethyl group, a cyano group, a nitro group or a carbonimidoyl group. Herein, the two electron attracting groups may bond with each other to form a ring.

In formula (A), L₁₁ represents a carboxy group or a salt thereof, a silyl group, a hydrogen atom, triaryl boron anion, a trialkyl stanyl group, a trialkyl germyl group, or a —CR_{C1}R_{C2}R_{C3} group. Herein the silyl group specifically denotes a trialkylsilyl group, an aryldialkylsilyl group, a triarylsilyl group, or the like, and may have any given substituent.

When L₁₁ represents a salt of a carboxy group, as a counter ion for forming a salt, mention may be made of an alkali metal ion, an alkaline earth metal ion, a heavy metal ion, an ammonium ion, a phosphonium ion, or the like, preferably an alkali metal ion or an ammonium ion, and most preferably an alkali metal ion (in particular, Li⁺, Na⁺, or K⁺ ion).

L₁₁ represents a —CR_{C1}R_{C2}R_{C3}, where R_{C1}, R_{C2}, and R_{C3} each independently represent a hydrogen atom, an alkyl group, an aryl group, a heterocyclic group, an alkylthio group, an arylthio group, an alkylamino group, an arylamino group, a heterocyclic amino group, an alkoxy group, an aryloxy group, or a hydroxy group, and these may bond with each other to form a ring, and may also further have any given substituent, provided that when one of R_{C1}, R_{C2}, and R_{C3} represents a hydrogen atom or an alkyl group, the remaining two do not represent a hydrogen atom or an alkyl group. R_{C1}, R_{C2}, and R_{C3} are preferably, each independently, an alkyl group, aryl group (particularly, a phenyl group), an alkylthio group, an arylthio group, an alkylamino group, an arylamino group, a heterocyclic group, an alkoxy group, or a hydroxy group. Specific examples thereof may include a phenyl group, a p-dimethylaminophenyl group, a p-methoxyphenyl group, a 2,4-dimethoxyphenyl group, a p-hydroxyphenyl group, a methylthio group, a phenylthio group, a phenoxy group, a methoxy group, an ethoxy group, a dimethylamino group, an N-methylanilino group, a diphenylamino group, a morpholino group, a thiomorpholino group, and a hydroxy group. When these bond with each other to form a ring, examples thereof may include a 1,3-dithiolan-2-yl group, a 1,3-dithian-2-yl group, an N-methyl-1,3-thiazolidin-2-yl group, and an N-benzyl-benzothiazolidin-2-yl group.

It is also preferable that, the —CR_{C1}R_{C2}R_{C3} group, where R_{C1}, R_{C2}, and R_{C3} have been selected from the groups within the above-described range, represents the same group as the residue formed by removing L₁₁ from the compound of formula (A).

In formula (A), L₁₁ preferably represents a carboxyl group or a salt thereof, or a hydrogen atom, and more preferably a carboxy group or a salt thereof.

When L₁₁ represents a hydrogen atom, the compound represented by formula (A) preferably has an intramolecular base moiety. By the action of the base moiety, after the oxidation of the compound represented by formula (A), the hydrogen atom represented by L₁₁ is deprotonated, so that electrons are further released therefrom.

The base herein is specifically a conjugate base of an acid exhibiting about 1 to about 10 pKa. Examples thereof may include nitrogen-containing hetero cyclic rings (pyridines, imidazoles, benzimidazoles, and thiazoles), anilines, trialkylamines, amino group, carbon acids (such as active methylene anions), thioacetic acid anion, carboxylate (—COO⁻), sulfate (—SO₃⁻), and amine oxide (>N⁺(O⁻)—). A conjugate base of an acid exhibiting about 1 to about 8 pKa is preferred, carboxylate, sulfate, or amine oxide is more preferred, and carboxylate is particularly preferred. When these bases contain an anion, they may also have a counter cation, examples of which may include alkali metal ions, alkaline-earth metal ions, heavy metal ions, ammonium ions, and phosphonium ions. These bases are linked to the compound represented by formula (A) at an arbitrary position. The position at which any of these base moieties is linked may be any of RED₁₁₁, R₁₁₁, and R₁₁₂ in formula (A). Alternatively, the base moiety may also be linked to the substituent of each of these groups.

In formula (A), R₁₁₂ represents a hydrogen atom or a group capable of being substituted on the carbon atom, provided that R₁₁₂ does not represent the same group as L₁₁.

R₁₁₂ is preferably a hydrogen atom, an alkyl group, an aryl group (such as a phenyl group), an alkoxy group (such as a methoxy group, an ethoxy group, or a benzyloxy group), a hydroxy group, an alkylthio group (such as a methylthio group or a butylthio group), an amino group, an alkylamino group, an arylamino group, or a heterocyclic amino group, and more preferably a hydrogen atom, an alkyl group, an alkoxy group, a hydroxy group, a phenyl group, or an alkylamino group.

In formula (A), the ring structure formed by R₁₁₂ is the ring structure corresponding to a tetrahydro form, a hexahydro form, or an octahydro form of a 5-membered or 6-membered aromatic ring (including an aromatic heterocyclic ring). Herein, the hydro form denotes a ring structure resulting from partial hydrogenation of internal carbon to carbon double bonds or (carbon to nitrogen double bonds) of an aromatic ring (including an aromatic heterocyclic ring). The tetrahydro form, the hexahydro form, and the octahydro form refer to the structures resulting from hydrogenation of two, three, and four carbon to carbon double bonds (or carbon to nitrogen double bonds), respectively. The aromatic ring is hydrogenated, and as a result, takes on a partially hydrogenated nonaromatic ring structure.

Specific examples thereof may include a pyrrolidine ring, an imidazolidine ring, a thiazolidine ring, a pyrazolidine ring and an oxazolidine ring, a piperidine ring, a tetrahydropyridine ring, a tetrahydropyrimidine ring, a piperazine ring, a tetralin ring, a tetrahydroquinoline ring, a tetrahydroisoquinoline ring, tetrahydroquinazoline ring, tetrahydroquinoxaline ring, a tetrahydrocarbazole ring, and an octahydrophenanthridine ring. These ring structures may have any given substituents.

The ring structure formed by R₁₁₁ is preferably a pyrrolidine ring, an imidazolidine ring, a piperidine ring, a tetrahydropyridine ring, a tetrahydropyrimidine ring, a piperazine ring, a tetrahydroquinoline ring, a tetrahydroisoquinoline ring, a tetrahydroquinazoline ring, a tetrahydroquinoxaline ring, or a tetrahydrocarbazole ring, in particular preferably, a pyrrolidine ring, a piperidine ring, a piperazine ring, a tetrahydropyridine ring, a tetrahydroquinoline ring, a tetrahydroisoquinoline ring, a tetrahydroquinazoline ring, or a tetrahydroquinoxaline ring, and most preferably a pyrrolidine ring, a piperidine ring, a tetrahydropyridine ring, a tetrahydroquinoline ring or a tetrahydroisoquinoline ring.

In formula (B), RED₁₂ and L₁₂ each represent the group synonymous with the groups represented by RED₁₁ and L₁₁ in formula (A), and the preferred range thereof is also the same. However, RED₁₂ is a monovalent group, except when it forms the following ring structure, and specifically, mention may be made of the groups of the designations of the monovalent groups described for RED₁₁. R₁₂₁ and R₁₂₂ each represent the group synonymous with the groups represented by R₁₁₂ of formula (A), and the preferred range thereof is also the same. ED₁₂ represents an electron donating group. R₁₂₁ and RED₁₂, R₁₂₁ and R₁₂₂, or ED₁₂ and RED₁₂ may bond with each other to form a ring.

In formula (B), the electron donating group represented by ED₁₂ is the same as the electron donating group explained as the substituent when RED₁₁ represents an aryl group. ED₁₂ is preferably a hydroxy group, an alkoxy group, a mercapto group, a sulfonamido group, an alkylamino group, an arylamino group, an active methine group, a 5-membered monocyclic or condensed electron-excessive aromatic heterocyclic group containing at least one nitrogen atom in the ring, a non-aromatic nitrogen-containing heterocyclic group to be substituted at the nitrogen atom, or a phenyl group substituted with any of these electron donating groups. It is more preferably a hydroxy group, a mercapto group, a sulfonamido group, an alkylamino group, an arylamino group, an active methine group, a nonaromatic nitrogen-containing heterocyclic group to be substituted at the nitrogen atom, or a phenyl group substituted with any of these electron donating groups (e.g., a p-hydroxyphenyl group, a p-dialkylaminophenyl group, or an o,p-dialkoxyphenyl group).

In formula (B), R₁₂₁ and RED₁₂, R₁₂₂ and R₁₂₁, or ED₁₂ and RED₁₂ may bond with each other to form a ring. The ring structure herein formed is a nonaromatic carbon ring or heterocyclic ring, which is a 5-membered to 7-membered monocyclic or condensed ring, and has a substituted or unsubstituted ring structure. When R₁₂, and RED₁₂ form a ring structure, specific examples thereof may include a pyrroline ring, an imidazoline ring, a thiazoline ring, a pyrazoline ring, an oxazoline ring, an indan ring, a morpholine ring, an indoline ring, a tetrahydro-1,4-oxazine ring, a 2,3-dihydrobenzo-1,4-oxazine ring, a tetrahydro-1,4-thiazine ring, a 2,3-dihydrobenzo-1,4-thiazine ring, a 2,3-dihydrobenzofuran ring, and a 2,3-dihydrobenzothiophene ring, in addition to those mentioned as the examples of the ring structures formed by R₁₁₁ in formula (A). When ED₁₂ and RED₁₂ form a ring structure, ED₁₂ preferably represents an amino group, an alkyl amino group, or an arylamino group, and specific examples of the ring structure formed may include a tetrahydropyrazine ring, a piperazine ring, a tetrahydroquinoxaline ring, and a tetrahydroisoquinoline ring. When R₁₂₂ and R₁₂₁ form a ring structure, specific examples thereof may include a cyclohexane ring and a cyclopentane ring.

Then, formulae (1) to (3) will be described.

In formulae (1) to (3), R₁, R₂, R₁₁, R₁₂, and R₃₁ are the groups synonymous with the groups represented by R₁₁₂ of formula (A), and the preferred range thereof is also the same. L₁, L₂₁, and L₃₁ represent the same leaving groups as the groups mentioned as the specific examples in the description on L₁₁ of formula (A), and the preferred range thereof is also the same. The substituents represented by X₁ and X₂₁ are the same as the examples of the substituent which may be possessed by RED₁₁ of formula (A), and the preferred range thereof is also the same. m₁ and m₂₁ are each independently an integer from 0 to 2, and more preferably 0 or 1.

When R_{N1}, R_{N21}, and R_{N31} each represent a substituent, the substituent is preferably an alkyl group, an aryl group, or a heterocyclic group, and it may further have any given substituents. R_{N1}, R_{N21}, and R_{N31} each independently represent preferably a hydrogen atom, an alkyl group, or an aryl group, and more preferably a hydrogen atom or an alkyl group.

When R₁₃, R₁₄, R₃₃, Rₐ, and R_{b} each represent a substituent, the substituent is preferably an alkyl group, an aryl group, an acyl group, an alkoxycarbonyl group, a carbamoyl group, a cyano group, an alkoxy group, an acylamino group, a sulfonamido group, a ureido group, a thioureido group, an alkylthio group, an arylthio group, an alkylsulfonyl group, an arylsulfonyl group, a sulfamoyl group, or the like.

In formula (1), the 6-membered ring formed by Z₁ in formula (1) is a nonaromatic heterocyclic ring condensed with the benzene ring of formula (1). Specifically, the ring structure including the benzene ring condensed thereon is a tetrahydroquinoline ring, a tetrahydroquinoxaline ring, or a tetrahydroquinazoline ring, and preferably a tetrahydroquinoline ring or a tetrahydroquinoxaline ring. It may have a substituent.

In formula (2), ED₂₁ represents the group synonymous with the group represented by ED₁₂ in formula (B), and the preferred range thereof is also the same.

In formula (2), any two of R_{N21}, R₁₃, R₁₄, X₂₁, and ED₂₁ may also bond with each other to form a ring. The ring structure herein formed by combination of R_{N21} and X₂₁ is preferably a benzene ring-condensed 5-membered to 7-membered nonaromatic carbon ring or heterocyclic ring. Specific examples thereof may include a tetrahydroquinoline ring, a tetrahydroquinoxaline ring, an indoline ring, and a 2,3-dihydro-5,6-benzo-1,4-thiazine ring. A tetrahydroquinoline ring, a tetrahydroquinoxaline ring, and an indoline ring are preferred.

In formula (3), when R_{N31} represents a group other than an aryl group, Rₐ and R_{b} bond with each other to form an aromatic ring. The aromatic ring herein is an aryl group (e.g., a phenyl group or a naphthyl group) or an aromatic heterocyclic group (e.g., a pyridine ring group, a pyrrole ring group, a quinoline ring group, or an indole ring group), and preferably an aryl group. The aromatic ring group may have any given substituent.

In formula (3), It is preferable that Rₐ and R_{b} bond with each other to form an aromatic ring (particularly a phenyl group).

In formula (3), R₃₂ is preferably a hydrogen atom, an alkyl group, an aryl group, a hydroxy group, an alkoxy group, a mercapto group, an amino group, or the like. When R₃₂ represents a hydroxy group, it is also preferable that R₃₃ represents an “electron donating group” at the same time. “The electron donating group” herein is the same as that explained previously, and is preferably an acyl group, an alkoxycarbonyl group, a carbamoyl group, or a cyano group.

Then, the compound of type 2 will be described.

For the compound of type 2, the “bond cleavage reaction” denotes the cleavage of the bond between respective elements of carbon-carbon, carbon-silicon, carbon-hydrogen, carbon-boron, carbon-tin, or carbon-germanium, and it may also further be accompanied by the cleavage of a carbon-hydrogen bond.

The compound of type 2 is a compound having two or more (preferably 2 to 6, and more preferably 2 to 4) silver halide adsorbing groups in the molecule. It is more preferably a compound including two or more mercapto group-substituted nitrogen-containing heterocyclic groups as adsorbing groups. The number of the adsorbing groups is preferably 2 to 6, and more preferably 2 to 4. The adsorbing groups will be described later.

Out of the compounds of type 2, preferred compounds are represented by formula (C).

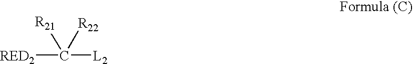

The compound herein represented by formula (C) is a compound capable of being one-electron oxidized at the reducing group represented by RED₂, and then spontaneously releasing L₂ by the bond cleavage reaction, thereby to further release another electron.

In formula (C), RED₂ represents a group synonymous with the group represented by RED₁₂ in formula (B), and the preferred range thereof is also the same. L₂ represents a group synonymous with the group mentioned in the description on L₁₁ of formula (A), and the preferred range thereof is also the same. Incidentally, when L₂ represents a silyl group, the compound is a compound having two or more mercapto group-substituted nitrogen-containing heterocyclic groups as adsorbing groups in the molecule. R₂₁ and R₂₂ each independently represent a hydrogen atom or a substituent, and each represent the group synonymous with the group represented by R₁₁₂ of formula (A), and the preferred range thereof is also the same. RED₂ and R₂₁ may also bond with each other to form a ring.

The ring structure herein formed is a 5-membered to 7-membered, monocyclic or condensed, nonaromatic carbon ring or heterocyclic ring, and may also have a substitute. However, the ring structure will not be the ring structure corresponding to a tetrahydro form, a hexahydro form, or an octahydro form of an aromatic ring or an aromatic heterocyclic ring. The ring structure is preferably the ring structure corresponding to a dihydro form of an aromatic ring or an aromatic heterocyclic ring. Specific examples thereof may include a 2-pyrroline ring, a 2-imidazoline ring, a 2-thiazoline ring, a 1,2-dihydropyridine ring, a 1,4-dihydropyridine ring, an indoline ring, a benzimidazoline ring, a benzothiazoline ring, a benzoxazoline ring, a 2,3-dihydrobenzothiophene ring, a 2-3-dihydrobenzofuran ring, a benzo-α-pyrane ring, a 1,2-dihydroquinoline ring, a 1,2-dihydroquinazoline ring, and a 1,2-dihydroquinoxaline ring, and preferably may include a 2-imidazoline ring, a 2-thiazoline ring, an indoline ring, a benzimidazoline ring, a benzothiazoline ring, a benzoxazoline ring, a 1,2-dihydropridine ring, a 1,2-dihydroquinoline ring, a 1,2-tetrahydroquinazoline ring, and a 1,2-dihydroquinoxaline ring, and more preferably may include an indoline ring, a benzimidazoline ring, a benzothiazoline ring, and a 1,2-dihydroquinoline ring, and in particular preferably may include an indoline ring.

Next, the compounds of type 3 will be described.

For the compounds of type 3, the “bond formation process” represents the formation of the bond between atoms of carbon-carbon, carbon-nitrogen, carbon-sulfur, carbon-oxygen, or the like.

The compound of type 3 is a compound characterized by being capable of being one-electron oxidized to become a one-electron oxidation product, subsequently undergoing a reaction with a reactive group moiety (carbon-carbon double bond moiety, carbon-carbon triple bond moiety, aromatic group moiety, or nonaromatic heterocyclic group moiety of a benzo-condensed ring) present in the molecule to form a bond, and then further releasing one or more electrons.

More specifically, the compound of type 3 has the following feature: the one-electron oxidation product (a cation radical species or a neutral radical species resulting from the release of a proton therefrom) generated by one-electron oxidation reacts with the reactive group present in the molecule to form a bond, thereby forming another radical species having a ring structure in the molecule; and second electron is released directly or with the release of a proton from the radical species.

As for some of the compounds of type 3, the two-electron oxidation product thus generated may, in some cases, subsequently undergo a hydrolysis reaction, followed by: or in other cases, may effect a tautomerization reaction directly involving proton transfer, thereby causing: the further release of one or more electrons, and generally two or more electrons. Alternatively, other compounds have the ability to become a two-electron oxidation product, and to further release one or more electrons, and generally two or more electrons directly from itself without undergoing the tautomerization reaction.

The compounds of type 3 are represented by formula (D).

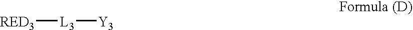

In formula (D), RED₃ represents a reducing group capable of being one-electron oxidized; Y₃ represents a reactive group moiety with which RED₃ reacts after being one-electron oxidized, and specifically represents an organic group including a carbon-carbon double bond moiety, a carbon-carbon triple bond moiety, an aromatic group moiety, or a nonaromatic heterocyclic group moiety of a benzo-condensed ring; and L₃ represents a linking group for linking RED₃ with Y₃.

RED₃ represents a group synonymous with the group represented by RED₁₂ in formula (B), and preferably, an arylamino group, a heterocyclic amino group, an aryloxy group, an arylthio group, an aryl group, or an aromatic or nonaromatic heterocyclic group (in particular preferably, a nitrogen-containing heterocyclic group), and more preferably an arylamino group, a heterocyclic amino group, an aryl group, or an aromatic or nonaromatic heterocyclic group. The heterocyclic group out of these groups is preferably a tetrahydroquinoline ring group, a tetrahydroquinoxaline ring group, a tetrahydroquinazoline ring group, an indoline ring group, an indole ring group, a carbazole ring group, a phenoxazine ring group, a phenothiazine ring group, a benzothiazoline ring group, a pyrrole ring group, an imidazole ring group, a thiazole ring group, a benzimidazole ring group, a benzimidazoline ring group, a benzothiazoline ring group, a 3,4-methylenedioxyphenyl-1-yl group, or the like.

RED₃ is in particular preferably an arylamino group (in particular, an anilino group), an aryl group (in particular, a phenyl group), or an aromatic or nonaromatic heterocyclic group.

Herein, when RED₃ represents an aryl group, the aryl group preferably has at least one “electron donating group”. The “electron donating groups” are the same as those described previously.

When RED₃ represents an aryl group, the substituent of the aryl group is more preferably an alkylamino group, a hydroxy group, an alkoxy group, a mercapto group, a sulfonamido group, an active methine group, or a nonaromatic nitrogen-containing heterocyclic group to be substituted at the nitrogen atom, more preferably, an alkylamino group, a hydroxy group, an active methine group, or a nonaromatic nitrogen-containing heterocyclic group to be substituted at the nitrogen atom, and most preferably an alkylamino group, or a nonaromatic nitrogen-containing heterocyclic group to be substituted at the nitrogen atom.

When the organic group containing a carbon-carbon double bond moiety (e.g., a vinyl group) represented by Y₃ has a substituent, the substituent is preferably an alkyl group, a phenyl group, an acyl group, a cyano group, an alkoxycarbonyl group, a carbamoyl group, an electron donating group, or the like. The electron donating group is preferably an alkoxy group, a hydroxy group (which may also be protected with a silyl group, and examples of which may include a trimethylsilyloxy group, a t-butyldimethylsilyloxy group, a triphenysilyloxy group, a triethylsilyloxy group, and a phenyldimethylsilyloxy group), an amino group, an alkylamino group, an arylamino group, a sulfonamido group, an active methine group, a mercapto group, or an alkylthio group, or a phenyl group having any of these electron donating groups as a substituent.

Incidentally, herein, when the organic group containing a carbon-carbon double bond moiety has a hydroxy group as a substituent, Y₃ contains the following partial structure: >C₁═C₂ (—OH)—, which may also undergo tautomerization, resulting in the following partial structure: >C₁H—C₂(═O)—. Further, in this case, it is also preferable that the substituent to be substituted for the C₁ carbon is an electron attracting group. In this instance, Y₃ has the partial structure of an “active methylene group” or an “active methine group.” The electron attracting groups capable of imparting the partial structure of an active methylene group or an active methine group are the same as those explained in the previous description on the “active methine group.”

When the organic group containing a carbon-carbon triple bond moiety (e.g., an ethynyl group) represented by Y₃ has a substituent, the substituent is preferably an alkyl group, a phenyl group, an alkoxycarbonyl group, a carbamoyl group, an electron donating group, or the like.

When Y₃ represents an organic group containing an aromatic group moiety, the aromatic group is preferably an aryl group (in particular preferably, a phenyl group) or an indole ring group having an electron donating group as a substituent, wherein the electron donating group is preferably a hydroxy group (which may also be protected with a silyl group), an alkoxy group, an amino group, an alkylamino group, an active methine group, a sulfonamido group, or a mercapto group.

When Y₃ represents an organic group containing a benzo-condensed nonaromatic heterocyclic group moiety, the benzo-condensed non-aromatic heterocyclic group is preferably the one including therein the aniline structure as a partial structure. Examples thereof may include an indoline ring group, a 1,2,3,4-tetrahydroquinoline ring group, a 1,2,3,4-tetrahydroquinoxaline ring group, and a 4-quinolone ring group.

The reactive group represented by Y₃ is more preferably a carbon-carbon double bond moiety, an aromatic group moiety, or an organic group containing a benzo-condensed nonaromatic heterocyclic group. Further preferably, it is a carbon-carbon double bond moiety, a phenyl group having an electron donating group as a substituent, an indole ring group, or a benzo-condensed nonaromatic heterocyclic group including therein the aniline structure as a partial structure. The carbon-carbon double bond moiety herein more preferably has at least one electron donating group as a substituent.

The compound represented by formula (D) wherein the reactive group represented by Y₃ has been selected from the range described up to this point, and as a result, has the same partial structure as that of the reducing group represented by RED₃, is also another preferred example of the compound represented by formula (D).

L₃ represents a linking group for linking RED₃ with Y₃, and specifically represents a single bond, an alkylene group, an arylene group, a heterocyclic group, or a group comprising a single or any combination of respective groups of —O—, —S—, —NR_{N}—, —C(═O)—, —SO₂—, —SO—, and —P(═O)—, wherein, R_{N} represents a hydrogen atom, an alkyl group, an aryl group, or a heterocyclic group. The linking group represented by L₃ may also have any given substituent. The linking group represented by L₃ can be linked at an arbitrary position of the respective groups represented by RED₃ and Y₃ in such a manner as to be substituted with respective any one hydrogen atom thereof.

Preferred examples of L₃ may include a single bond, an alkylene group (particularly, a methylene group, an ethylene group, or a propylene group), an arylene group (particularly a phenylene group), —C(═O)—, —O—, —NH—, and —N(alkyl group)-, and divalent linking groups comprising combinations of these groups.

For the group represented by L₃, when a cation radical species (X⁺.) produced through oxidation of RED₃ or a radical species (X.) produced therefrom with release of a proton reacts with the reactive group represented by Y₃ to form a bond, the atomic group involved therein is preferably capable of forming a 3- to 7-membered ring structure including L₃. To this end, it is preferable that the radical species (X⁺.or X.), the reactive group represented by Y, and L are coupled with 3 to 7 atomic groups.

Then, the compounds of type 4 will be described.

The compound of type 4 is a compound having a reducing group-substituted ring structure. It is a compound capable of being one-electron oxidized at the reducing group, and subsequently undergoing a cleavage reaction of the ring structure, thereby to further release one or more electrons. The cleavage reaction of the ring structure herein mentioned denotes the process of the type illustrated below.

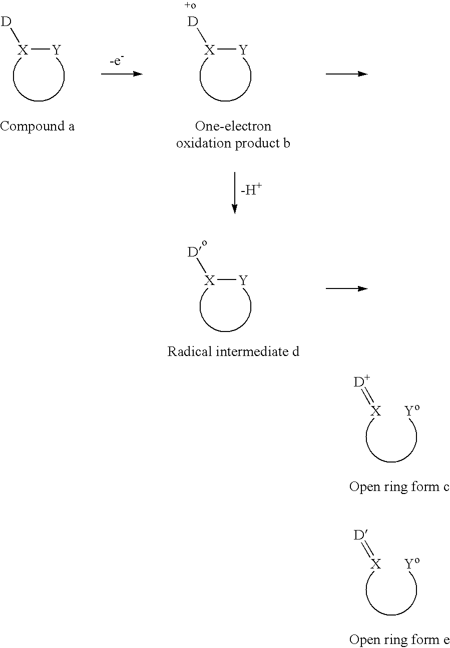

wherein the compound a denotes a compound of type 4; in the compound a, D denotes a reducing group; and X and Y represent groups forming a bond to be cleaved after one-electron oxidation in the ring structure. First, the compound a is one-electron oxidized to form a one-electron oxidation product b. Hence, the single bond of D-X becomes a double bond, and at the same time, the bond of X—Y is cut to form an open ring form c. Alternatively, another path may also be taken in which the one-electron oxidation product b undergoes the release of a proton, thereby to form a radical intermediate d, from which another open ring form e is formed similarly. The compound of the invention is characterized in that, subsequently, one or more electrons are further released from the open ring form c or e thus formed.

The ring structures possessed by the compounds of type 4 are 3- to 7-membered carbon rings or heterocyclic rings, and denote monocyclic or condensed, saturated or unsaturated nonaromatic rings. They are preferably saturated ring structures, and more preferably 3-membered or 4-membered rings. The ring structure is preferably a cyclopropane ring, a cyclobutane ring, an oxirane ring, an oxetane ring, an aziridine ring, an azetidine ring, an episulfide ring, or a thietane ring, more preferably a cyclopropane ring, a cyclobutane ring, an oxirane ring, an oxetane ring, or an azetidine ring, and in particular preferably a cyclopropane ring, a cyclobutane ring, or an azetidine ring. The ring structures may have any given substituents.

The compounds of type 4 are preferably represented by the following formula (E) or (F)

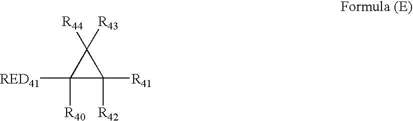

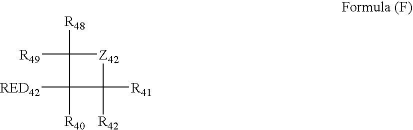

In formulae (E) and (F), RED₄₁ and RED₄₂ each represent a group synonymous with the group represented by RED₁₂ of formula (B), and the preferred range thereof is also the same; and R₄₁ to R₄₄ and R₄₅ to R₄₉ each independently represent a hydrogen atom or a substituent. In formula (F), Z₄₂ represents —CR₄₂₀R₄₂₁—, —NR₄₂₃—, or —O—, where R₄₂₀ and R₄₂₁ each independently represent a hydrogen atom or a substituent; and R₄₂₃ represents a hydrogen atom, an alkyl group, an aryl group, or a heterocyclic group.

In formulae (E) and (F), R₄₀ and R₄₅ each independently represents preferably a hydrogen atom, an alkyl group, an aryl group, or a heterocyclic group, and more preferably a hydrogen atom, an alkyl group, or an aryl group. R₄₁ to R₄₄ and R₄₆ to R₄₉ are each independently preferably a hydrogen atom, an alkyl group, an alkenyl group, an aryl group, a heterocyclic group, an arylthio group, an alkylthio group, an acylamino group, or a sulfonamido group, and more preferably a hydrogen atom, an alkyl group, an aryl group, or a heterocyclic group.

As for R₄₁ to R₄₄, the case where at least one of them is a donor group, or the case where both of R₄₁ and R₄₂ or both of R₄₃ and R₄₄ are electron attracting groups is preferred. The case where at least one of R₄₁ to R₄₄ is a donor group is more preferred. It is further preferable that at least one of R₄₁ to R₄₄ is a donor group, and the groups which are not donor groups among R₄₁ to R₄₄ are each independently a hydrogen atom or an alkyl group.

The donor group herein mentioned is an “electron donating group” or aryl group that is substituted with at least one “electron donating group.” Preferably usable donor groups are an alkylamino group, an arylamino group, a heterocyclic amino group, a 5-membered, mono-cyclic or condensed electron-excessive aromatic heterocyclic group containing at least one nitrogen atom in the ring, nonaromatic nitrogen-containing heterocyclic group to be substituted at the nitrogen atom, and a phenyl group substituted with at least one electron donating group. More preferably usable ones are an alkylamino group, an arylamino group, a 5-membered monocyclic or condensed electron-excessive aromatic heterocyclic group containing at least one nitrogen atom in the ring (such as an indole ring, a pyrrole ring or a carbazole ring), and a phenyl group substituted with an electron donating group (such as a phenyl group substituted with 3 or more alkoxy groups or a phenyl group substituted with a hydroxy group, an alkylamino group, or an arylamino group). Particularly preferably usable ones are an arylamino group, a 5-membered, monocyclic or condensed electron-excessive aromatic heterocyclic group containing at least one nitrogen atom in the ring (in particular, a 3-indolyl group), and a phenyl group substituted with an electron donating group (in particular, a trialkoxyphenyl group, or a phenyl group substituted with an alkylamino group or an arylamino group).

Z₄₂ is preferably —CR₄₂₀R₄₂₁— or —NR₄₂₃—, and more preferably —NR₄₂₃—. R₄₂₀ and R₄₂₁ are each independently preferably a hydrogen atom, an alkyl group, an aryl group, a heterocyclic group, an acylamino group, or a sulfonamide, and more preferably a hydrogen atom, an alkyl group, an aryl group, a heterocyclic group. R₄₂₃ is preferably a hydrogen atom, an alkyl group, an aryl group, or an aromatic heterocyclic group, and more preferably a hydrogen atom, an alkyl group, or an aryl group.

When each group of R₄₀ to R₄₉ and R₄₂₀, R₄₂₁ and R₄₂₃ is a substituent, it has preferably a total of 40 or less carbon atoms, more preferably a total of 30 or less carbon atoms, and in particular preferably a total of 15 or less carbon atoms. Further, these substituents may bond with each other or bond another moiety (RED₄₁, RED₄₂, or Z₄₂) in the molecule to form a ring.

In the compounds of types 1 to 4 of the invention, the silver halide adsorbing group is a group directly adsorbing to a silver halide or a group promoting adsorption to a silver halide. Specifically, it is a mercapto group (or a salt thereof), a thione group (—C(═S)—), a heterocyclic group containing at least one atom selected from a nitrogen atom, a sulfur atom, a selenium atom, and a tellurium atom, a sulfide group, a cationic group, or an ethynyl group. However, the compounds of type 2 of the invention do not include a sulfide group as an adsorbing group.

A mercapto group (or a salt thereof) as an adsorbing group denotes a mercapto group (or a salt thereof) itself, and at the same time, more preferably, denotes a heterocyclic group, an aryl group, or an alkyl group substituted with at least one mercapto group (or salt thereof). The heterocyclic group herein denotes a 5-membered to 7-membered, monocyclic or condensed, aromatic or nonaromatic heterocyclic group. Examples thereof may include an imidazole ring group, a thiazole ring group, an oxazole ring group, a benzimidazole ring group, a benzothiazole ring group, a benzoxazole ring group, a triazole ring group, a thiadiazole ring group, an oxadiazole ring group, a tetrazole ring group, a purine ring group, a pyridine ring group, a quinoline ring group, an isoquinoline ring group, a pyrimidine ring group, and a triazine ring group. A heterocyclic group containing a quaternized nitrogen atom may also be acceptable, and in this case, it is also acceptable that a substituted mercapto group undergoes dissociation to give mesoion. Examples of such a heterocyclic group may include an imidazolium ring group, a pyrazolium ring group, a thiazolium ring group, a triazolium ring group, a tetrazolium ring group, a thiadiazolium ring group, a pyridinium ring group, a pyrimidinum ring group, and a triazonium ring group. Out of these groups, a triazolium ring group (e.g., 1,2,4-triazolium-3-thiolate ring group) is preferable. As an aryl group, mention may be made of a phenyl group or a naphthyl group. As an alkyl group, mention may be made of straight-chain, branched, or cyclic alkyl groups having 1 to 30 carbon atoms. When a mercapto group forms a salt, as counter ions, mention may be made of cations of alkali metals, alkaline earth metals, and heavy metals (Li⁺, Na⁺, K⁺, Mg²⁺, Ag⁺, Zn²⁺, and the like), ammonium ions, heterocyclic groups containing a quaternized nitrogen atom, phosphonium ions, and the like.

The mercapto group as an adsorbing group may further undergo tautomerization, thereby to become a thione group. Specific examples thereof may include a thioamido group (in this case, —C(═S)—NH— group) and a group including the partial structure of the thioamido group, i.e., a chain or cyclic thioamido group, thioureido group, thiourethane group, or dithiocarbamic acid ester group. In this case, examples of the cyclic group may include a thiazolidine-2-thione group, an oxazolidine-2-thione group, a 2-thiohydantoin group, a rhodanine group, an isorhodanine group, a thiobarbituric acid group, and a 2-thioxo-oxazolidin-4-one group.

Thione groups as adsorbing groups also include a chain or cyclic thioamido group, thioureido group, thiourethane group, and dithiocarbamic acid ester group, which can not undergo tautomerization to yield mercapto groups (no hydrogen atom at a site of thione group), including the thione group produced by tautomerization of the mercapto group.

The heterocyclic group which contains at least one atom selected from a nitrogen atom, a sulfur atom, a selenium atom, and a tellurium atom as an adsorbing group is a nitrogen-containing heterocyclic group having an —NH— group capable of forming imino silver (>NAg) as a partial structure of the heterocyclic ring, or a heterocyclic group having an “—S—” group, an “—Se—” group, a “—Te—” group or an “═N—” group capable of coordinating with silver ion through a coordinate bond as a partial structure of the heterocyclic ring. Examples of the former group may include a benzotriazole group, a triazole group, an indazole group, a pyrazole group, a tetrazole group, a benzimidazole group, an imidazole group, and a purine group. Examples of the latter group may include a thiophene group, a thiazole group, an oxazole group, a benzothiazole group, a benzoxazole group, a thiadiazole group, an oxadiazole group, a triazine group, a selenazole group, a benzoselenazole group, a tellurazole group, and a benzotellurazole group. The former groups are preferred.

The sulfide groups as adsorbing groups include all the groups having a partial structure of “—S—”, and preferably the groups having partial structures of alkyl (or alkylene)-S-alkyl (or alkylene), aryl (or arylene)-S-alkyl (or alkylene), and aryl (or arylene)-S-aryl (or arylene). Further, these sulfide groups may also form ring structures or become an “—S—S—” group. Specific examples of the ring structure which may be formed may include groups comprising a thiolane ring, a 1,3-dithiolane ring or a 1,2-dithiolane ring, a thiane ring, a dithiane ring, and a tetrahydro-1,4-thiadine ring (thiomorpholine ring). The sulfide groups are in particular preferably the groups having a partial structure of alkyl (or alkylene)-S-alkyl (or alkylene).

Cationic group as an adsorbing group denotes a group containing a quaternized nitrogen atom, and specifically, a group including an ammonio group or a nitrogen-containing heterocyclic group containing a quaternized nitrogen atom. However, the cationic group will not become a part of the atomic group forming a dye structure (e.g., cyanine chromophore). The ammonio group herein is a trialkylammonio group, a dialkylarylammonio group, an alkyldiarylammonio group, or the like. Examples thereof may include a benzyldimethylammonio group, a trihexylammonio group, and a phenyldiethylammonio group. Examples of the nitrogen-containing heterocyclic group containing a quaternized nitrogen atom may include a pyridinio group, a quinolinio group, an isoquinolinio group, and an imidazolio group, preferably, a pyridinio group and an imidazolio group, and, particularly preferably, a pyridinio group. The nitrogen-containing heterocyclic groups containing a quaternized nitrogen atom may also have any given substituents. Preferred examples of the substituents for a pyridinio group and an imidazolio group may include an alkyl group, an aryl group, an acylamino group, a chloro atom, an alkoxycarbonyl group, and a carbamoyl group. As for a pyridinio group, the substituent is in particular preferably a phenyl group.

The ethynyl group as an adsorbing group denotes a —C≡CH group, where a hydrogen atom may also be substituted.

The adsorbing group may have any given substituent.

Incidentally, specific examples of the adsorbing group may include the ones described on pages 4 through 7 in the specification of JP-A No. 11-95355.

The adsorbing group in the invention is preferably a mercapto-substituted nitrogen-containing heterocyclic group (e.g., a 2-mercaptothiadiazole group, a 3-mercapto-1,2,4-triazole group, a 5-mercaptotetrazole group, a 2-mercapto-1,3,4-oxadiazole group, a 2-mercaptobenzoxazole group, a 2-mercaptobenzothiazole group, or a 1,5-dimethyl-1,2,4-triazolium-3-thiolate group), or a nitrogen-containing heterocyclic group having an —NH— group capable of forming imino silver (>NAg) as a partial structure of the heterocyclic ring (e.g., a benzotriazole group, a benzimidazole group, or an indazole group). It is in particular preferably a 5-mercaptotetrazole group, a 3-mercapto-1,2,4-triazole group, or a benzotriazole group, and most preferably a 3-mercapto-1,2,4-triazole group and 5-mercaptotetrazole group.

Out of the compounds of the invention, the compounds having two or more mercapto groups in the molecule as a partial structure are also particularly preferred compounds. The mercapto group (—SH) herein may be a thione group when it can undergo tautomerization. Examples of such compounds may include the compounds each having 2 or more adsorbing groups (e.g., ring-forming thioamido group, alkylmercapto group, arylmercapto group, or heterocyclic mercapto group) in the molecule and having the so far mentioned mercapto groups or thione groups as a partial structure; and the compounds each having one or more adsorbing groups (e.g., a dimercapto-substituted nitrogen-containing heterocyclic group) having, as a partial structure, two or more mercapto groups or thione groups out of the adsorbing groups.

Examples of adsorbing groups (such as a dimercapto-substituted nitrogen-containing heterocyclic group) having two or more mercapto groups as a partial structure may include a 2,4-dimercaptopyrimidine group, a 2,4-dimercaptotriazine group, a 3,5-dimercapto-1,2,4-triazole group, a 2,5-dimercapto-1,3-thiazole group, a 2,5-dimercapto-1,3-oxazole group, 2,7-dimercapto-5-methyl-s-triazolo(1,5-A)-pyrimidine, 2,6,8-trimercaptopurine, 6,8-dimercaptopurine, 3,5,7-trimercapto-s-triazolotriazine, 4,6-dimercaptopyrazolopyrimidine, and 2,5-dimercaptoimidazole. A 2,4-dimercaptopyrimidine group, a 2,4-dimercaptotriazine group, and a 3,5-dimercapto-1,2,4-triazole group are in particular preferred.

The adsorbing groups may be substituted at any position in formulae (A) to (F) and formulae (1) to (3). It is, however, preferable that the adsorbing groups are substituted at RED₁₁, RED₁₂, RED₂, and RED₃ in formulae (A) to (D) and at RED₄₁, R₄₁, RED₄₂, and R₄₆ to R₄₈ in formulae (E) and (F), and at any position except for R₁, R₂, R₁₁, R₁₂, R₃₁, L₁, L₂₁, and L₃₁ in formulae (1) to (3). It is more preferable that the adsorbing groups are substituted at RED₁₁ to RED₄₂ in all formulae (A) to (F).

The partial structure of a spectral sensitizing dye is a group containing chromophore of a spectral sensitizing dye, i.e., a residue formed by removing any hydrogen atoms or substituents from the spectral sensitizing dye compound. The partial structure of a spectral sensitizing dye may be substituted at any position in formulae (A) to (F) and formulae (1) to (3). It is, however, preferable that the partial structures are substituted at RED₁₁, RED₁₂, RED₂, and RED₃ in formulae (A) to (D) and at RED₄₁, R₄₁, RED₄₂, and R₄₆ to R₄₈ in formulae (E) and (F), and at any position except for R₁, R₂, R₁₁, R₁₂, R₃₁, L₁, L₂₁, and L₃₁ in formulae (1) to (3). It is more preferable that the partial structures are substituted at RED₁₁ to RED₄₂ in all formulae (A) to (F). Preferable spectral sensitizing dyes are those typically used in a color sensitization technique, and examples thereof may include cyanine dyes, composite cyanine dyes, merocyanine dyes, composite merocyanine dyes, homopolar cyanine dyes, styryl dyes and hemicyanine dyes. Typical spectral sensitizing dyes are disclosed in Research Disclosure, Item 36544, September 1994. Those skilled in the art are able to synthesize these dyes according to the procedures described in the Research Disclosure or The Cyanine Dyes and Related Compounds (Interscience Publsihers, New York, 1964) authored by F. M. Hamer. Further, all the dyes described on pages 7 through 14 in the specification of JP-A No. 11-95355 (U.S. Pat. No. 6,054,260) are applicable.

The compounds of types 1 to 4 of the invention have a total of preferably 10 to 60, more preferably 15 to 50, further preferably 18 to 40, and in particular preferably 18 to 30 carbon atoms.

Each compound of types 1 to 4 of the invention is one-electron oxidized through exposure of a silver halide photosensitive material using it, subsequently undergoes a reaction, and then further releases another electron, or two or more electrons according to the type of the compound, and is oxidized. The oxidation potential of the first electron is preferably about 1.4 V or less, and more preferably 1.0 V or less. The oxidation potential is preferably higher than 0 V, and more preferably higher than 0.3 V. Therefore, the oxidation potential is in a range of preferably about 0 to about 1.4 V, and more preferably about 0.3 V to about 1.0 V.

The oxidation potential herein can be measured by a technique of cyclic voltammetry. Specifically, a sample is dissolved in a solution of acetonitrile: water (including 0.1M lithium perchlorate)=80%:20% (% by volume), and a nitrogen gas is passed through the solution for 10 minutes. Then, a glassy carbon disk is used as a working electrode, a platinum wire is used as a counter electrode, and a calomel electrode (SCE) is used as a reference electrode. Thus, a measurement is carried out at a potential scanning rate of 0.1 V/sec at 25° C. Oxidation potential versus SCE is determined at the peak potential of a cyclic voltammetry wave.

When each compound of types 1 to 4 of the invention is a compound which is one-electron oxidized, subsequently undergoing a reaction, and then further releasing another electron, the oxidation potential at the subsequent stage is preferably −0.5 V to −2 V, more preferably −0.7 V to −2 V, and still more preferably −0.9 V to −1.6 V.

When each compound of types 1 to 4 of the invention is a compound which is one-electron oxidized, subsequently undergoing a reaction, and then further releasing two or more electrons, the oxidation potential at the subsequent stage has no particular restriction. This is for the following reason. It is not possible to distinctly discriminate between the oxidation potential of the second electron and the oxidation potential of the third electron, and hence it is often difficult to actually determine these potentials with precision for discrimination.

Then, the compound of type 5 will be described.

The compound of type 5 is represented by X—Y, wherein X represents a reducing group, and Y represents a leaving group. It is a compound capable of being one-electron oxidized at the reducing group represented by X to become a one-electron oxidation product, subsequently undergoing the cleavage reaction of the X—Y bond, thereby to release Y and form an X radical, and further releasing another electron therefrom. The reaction upon oxidation of the compound of type 5 can be expressed by the following formula.

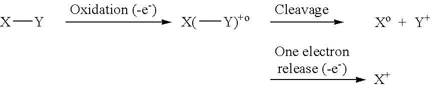

As for the compound of type 5, the oxidation potential is preferably 0 to 1.4 V, and more preferably 0.3 V to 1.0 V. In the above reaction formula, the oxidation potential of the radical X is preferably −0.7 V to −2.0 V, and more preferably −0.9 V to −1.6 V.

The compounds of type 5 are preferably represented by the following formula (G).

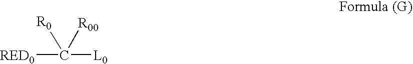

In formula (G), RED₀ represents a reducing group, and L₀ represents a leaving group; R₀ and R₀₀ each independently represent a hydrogen atom or a substituent; and RED₀ and R₀, and R₀ and R₀₀ may bond with each other to form a ring. RED₀ represents a group synonymous with the group represented by RED₂ of formula (C), and the preferred range thereof is also the same. R₀ and R₀₀ represent groups synonymous with the groups represented by R₂₁ and R₂₂ of formula (C), and the preferred range is also the same. However, R₀ and R₀₀ each do not represent a group synonymous with the group represented by L₀ except for a hydrogen atom. RED₀ and R₀ may also bond with each other to form a ring. Examples of the ring structure may include the same examples of the ring structure formed by mutual combination of RED₂ and R₂₁ of formula (C), and the preferred range thereof is also the same. Examples of the ring structure formed by mutual combination of R₀ and R₀₀ may include a cyclopentane ring and a tetrahydrofuran ring. L₀ in formula (G) is a group synonymous with the group represented by L₂ of formula (C), and the preferred range thereof is also the same.

The compound represented by formula (G) preferably has a silver halide adsorbing group or a partial structure of a spectral sensitizing dye in the molecule. However, when L₀ represents a group other than a silyl group, the compound will not have two or more adsorbing groups in the molecule at the same time, provided that the compound may have two or more sulfide groups as adsorbing groups regardless of L₀.

Examples of the silver halide adsorbing group contained in the compound represented by formula (G) may include the same adsorbing groups which the compounds of types 1 to 4 of the invention may contain. Further, in addition, they include all the ones described as “silver halide adsorbing groups” on pages 4 through 7 of the specification of JP-A No. 11-95355, and the preferred range thereof is also the same.

The partial structure of the spectral sensitization dye which may also be contained in the compound represented by the general formula (G) is the same as the partial structure of the spectral sensitizing dye which may be contained in each compound of types 1 to 4 of the invention. At the same time, examples thereof may include all the ones described as “light absorbing groups” on pages 7 through 14 in JP-A No. 11-95355, and the preferred range is also the same.

Below, non-limiting specific examples of the compounds of types 1 to 5 of the invention will be shown.

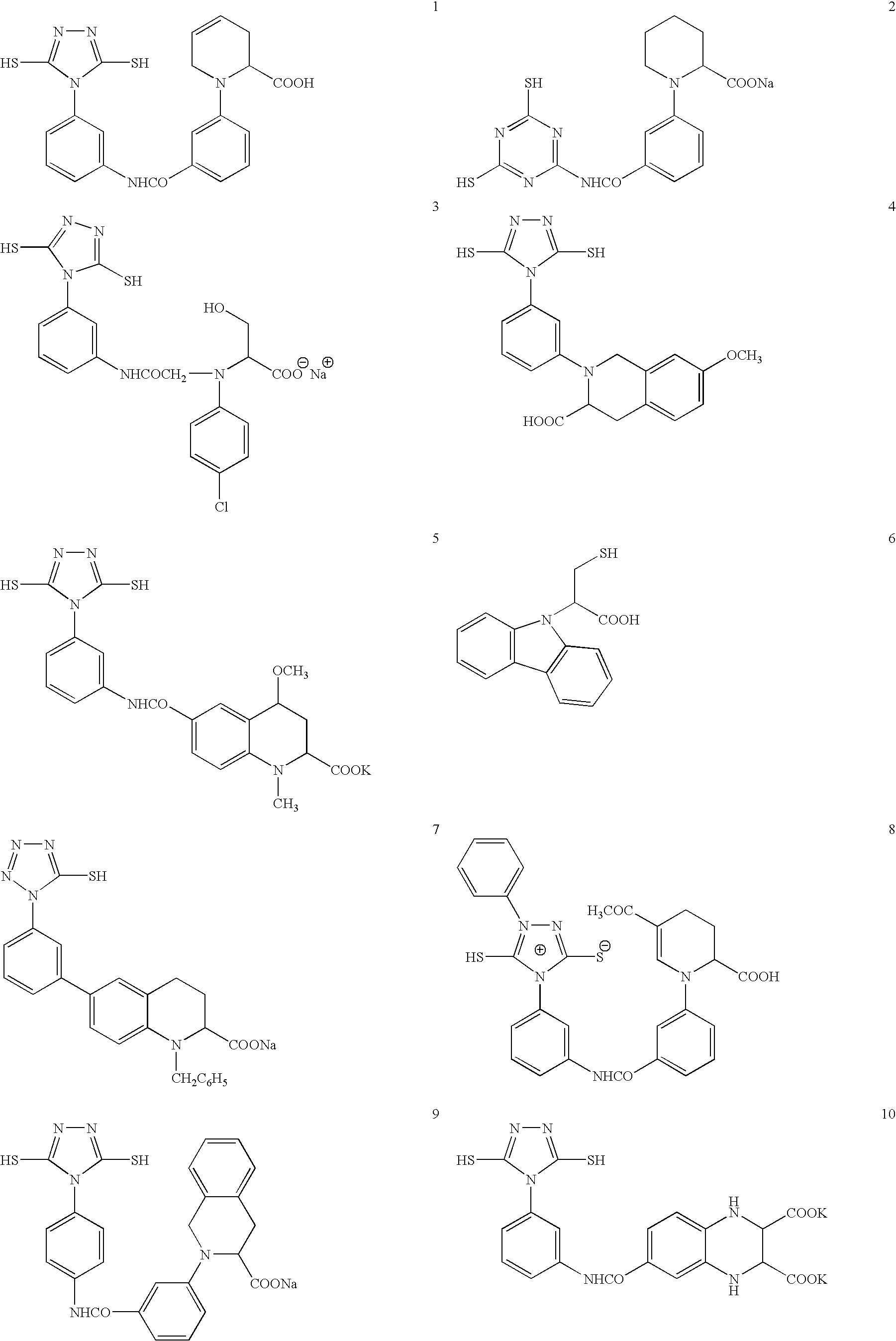

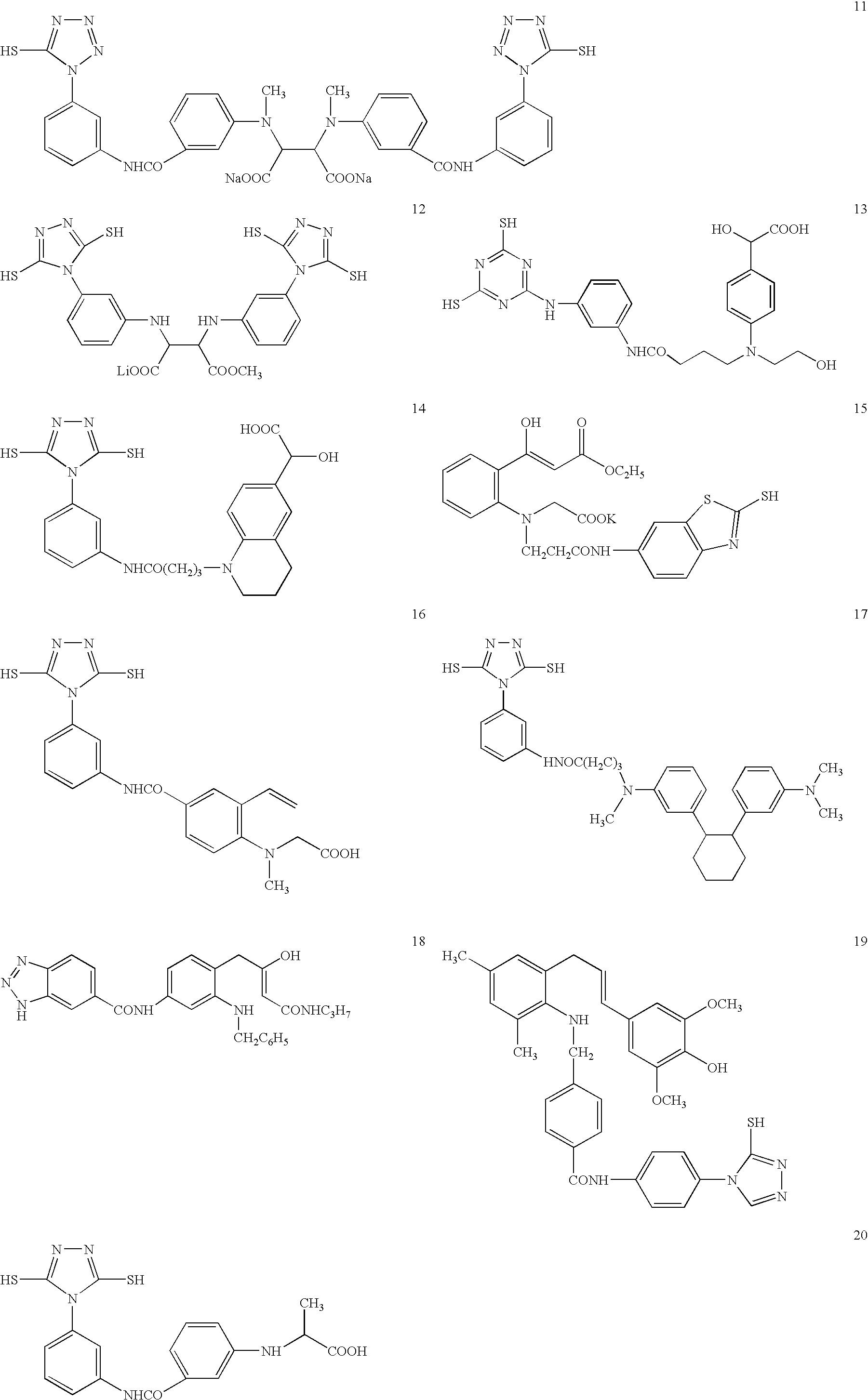

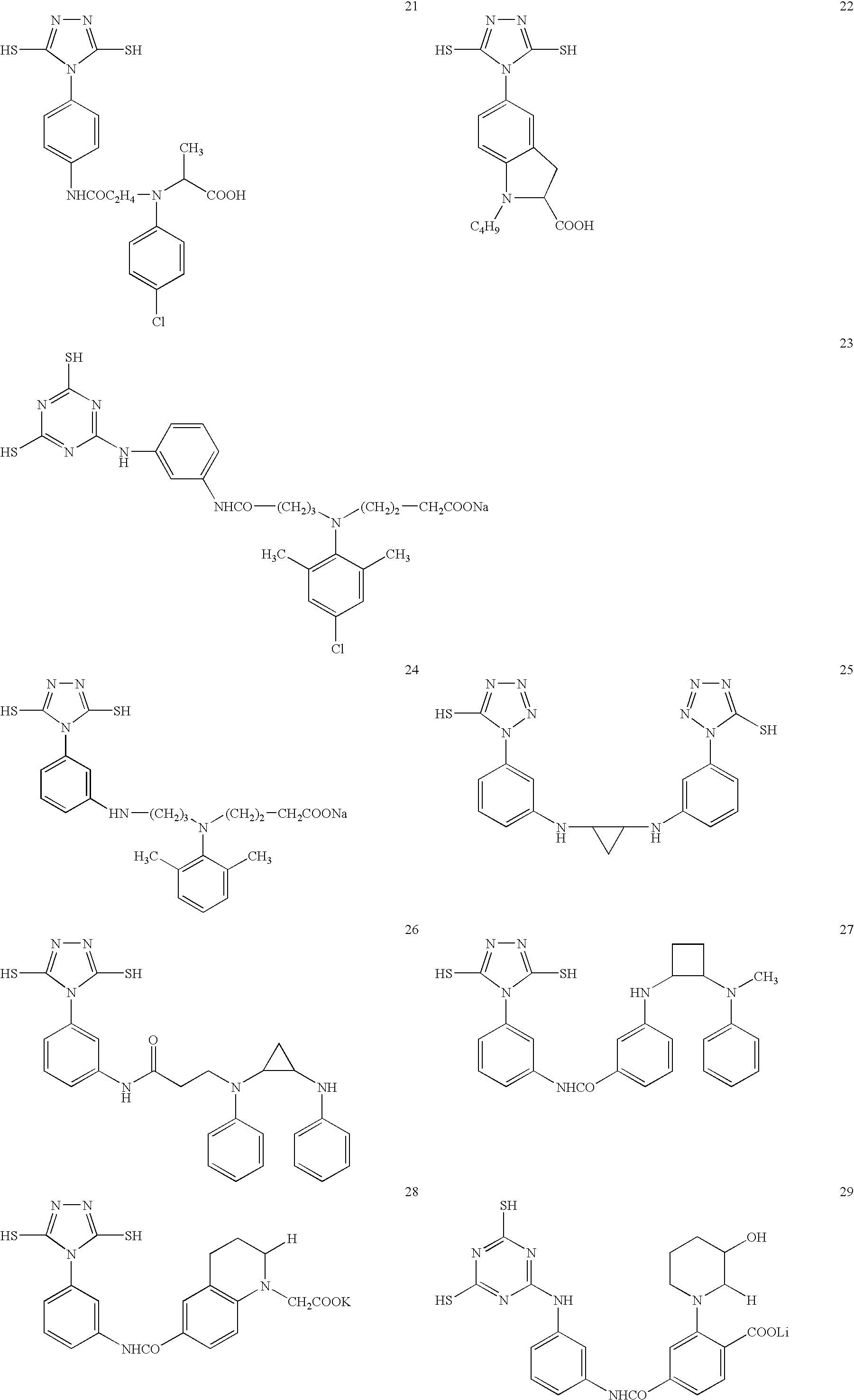

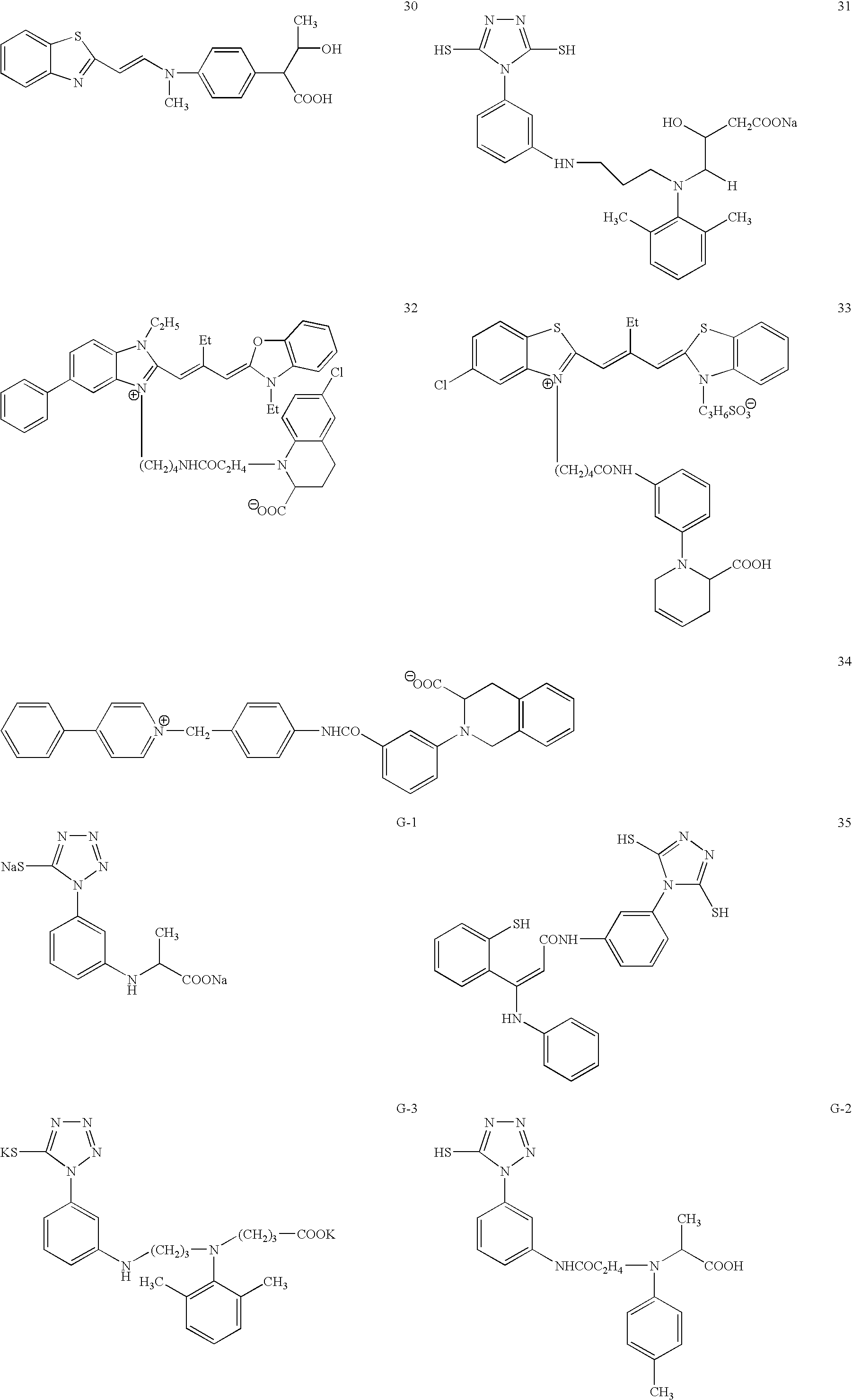

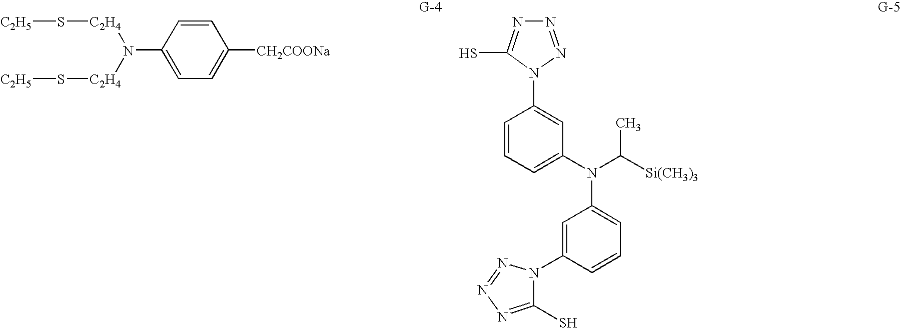

The compounds of types 1 to 4 of the invention are the same as the compounds explained in details respectively in JP-A Nos. 2003-114487, 2003-114486, 2003-140287, 2003-075950 and 2003-114488. The specific examples of the compounds described in the specifications of these patent publication documents can also be mentioned as examples of the compounds of types 1 to 4 of the invention. The synthetic examples of the compounds of types 1 to 4 of the invention are also the same as those described in these patents.

Specific examples of the compound of type 5 of the invention may include the compounds, as they are, referred to as “one-photon two-electron sensitizers” or “deprotonating electron donating sensitizers” described in the patent publication of JP-A No. 9-211769 (compounds PMT-1 to S-37 described in tables E and F on pages 28 through 32), JP-A Nos. 9-211774 and 11-95355 (compounds INV1 to 36), JP-W No. 2001-500996 (compounds 1 to 74, 80 to 87, and 92 to 122), U.S. Pat. Nos. 5,747,235 and 5,747,236, EP-A Nos. 786692 (compounds INNV1 to 35), and 893732, U.S. Pat. Nos. 6,054,260 and 5,994,051, and the like.

Each compound of types 1 to 5 of the invention may be used at any time during the preparation of a photosensitive silver halide emulsion and during a photothermographic material manufacturing step. It may be used, for example, at the time of photosensitive silver halide grain formation, during a desalting step, during a chemical sensitization step, prior to coating, or during other period. Alternatively, the compounds may also be added over a plurality of times during these steps. They are preferably added during the period from completion of the photosensitive silver halide grain formation until prior to the desalting step, at the time of chemical sensitization (during the period from immediately before the start of chemical sensitization to immediately after the completion thereof), or before coating, and more preferably during the period from the time of chemical sensitization until prior to mixing with non-photosensitive organic silver salts.

Each compound of types 1 to 5 of the invention is preferably dissolved in water or in a water-soluble solvent such as methanol or ethanol, or a mixture thereof, and added. For being dissolved in water, the compound whose solubility increases with an increase or a decrease in pH, may be increased or decreased in pH to be dissolved in water, to be added.

Each compound of types 1 to 5 of the invention is preferably used in an emulsion layer containing a photosensitive silver halide and a non-photosensitive organic silver salt. It is also acceptable that the compound is added to a protective layer or an intermediate layer, in addition to the emulsion layer containing a photosensitive silver halide and a non-photosensitive organic silver salt, and allowed to disperse therein at the time of coating. Each compound of the invention may be added either before or after addition of the sensitizing dye, and is incorporated into the silver halide emulsion layer preferably in a proportion of 1×10⁻⁹ to 5×10⁻¹ mol, and more preferably 1×10⁻⁸ to 5×10⁻² mol per mole of silver halide.

10) Adsorptive Redox Compound

In the invention, an adsorptive redox compound having a silver adsorbing group and a reducing group in the molecule is preferably contained.

The adsorptive redox compound for use in the invention is preferably a compound represented by the following formula (I).

A-(W)n-B Formula (I)

In formula (I), A represents a silver halide adsorbable group (hereinafter, referred to as an adsorbing group); W represents a divalent linking group; n denotes 0 or 1; and B represents a reducing group.

Then, formula (I) will be described in details.

In formula (I), the adsorbing group represented by A is a group directly adsorbing to a silver halide or a group promoting adsorption to a silver halide. Specifically, it is a mercapto group (or a salt thereof, a thione group (—C(═S)—), a heterocyclic group containing at least one atom selected from a nitrogen atom, a sulfur atom, a selenium atom, or a tellurium atom, a sulfide group, a disulfide group, a cationic group, or an ethynyl group.

A mercapto group (or a salt thereof) as an adsorbing group denotes a mercapto group (or a salt thereof) itself, and at the same time, more preferably, denotes a heterocyclic group, an aryl group, or an alkyl group substituted with at least one mercapto group (or salt thereof). The heterocyclic group herein denotes at least a 5-membered to 7-membered, monocyclic or condensed, aromatic or nonaromatic heterocyclic group. Examples thereof may include an imidazole ring group, a thiazole ring group, an oxazole ring group, a benzimidazole ring group, a benzothiazole ring group, a benzoxazole ring group, a triazole ring group, a thiadiazole ring group, an oxadiazole ring group, a tetrazole ring group, a purine ring group, a pyridine ring group, a quinoline ring group, an isoquinoline ring group, a pyrimidine ring group, and a triazine ring group. A heterocyclic group containing a quaternized nitrogen atom may also be acceptable, and in this case, it is also acceptable that a substituted mercapto group undergoes dissociation to give mesoion. Preferred examples of such a heterocyclic group may include an imidazolium ring group, a pyrazolium ring group, a thiazolium ring group, a triazolium ring group, a tetrazolium ring group, a thiadiazolium ring group, a pyridinium ring group, a pyrimidinium ring group, and triazinium ring group. Out of these groups, a triazolium ring group (e.g., 1,2,4-triazolium-3-thiolate ring group) is preferable. As an aryl group, mention may be made of a phenyl group or a naphthyl group. As an alkyl group, mention may be made of straight-chain, branched, or cyclic alkyl groups having 1 to 30 carbon atoms. When a mercapto group forms a salt, as counter ions, mention may be made of cations of alkali metals, alkaline earth metals, and heavy metals (Li⁺, Na⁺, K⁺, Mg²⁺, Ag⁺, Zn²⁺, and the like), ammonium ions, heterocyclic groups containing a quaternized nitrogen atom, phosphonium ions, and the like.

The mercapto group as an adsorbing group may further undergo tautomerization, thereby to become a thione group. Specific examples thereof may include a thioamido group (in this case, —C(═S)—NH— group) and a group including the partial structure of the thioamido group, i.e., a chain or cyclic thioamido group, thioureido group, thiourethane group, or dithiocarbamic acid ester group. In this case, examples of the cyclic group may include a thiazolidine-2-thione group, an oxazolidine-2-thione group, a 2-thiohydantoin group, a rhodanine group, an isorhodanine group, a thiobarbituric acid group, and a 2-thioxo-oxazolidin-4-on group.

Thione groups as adsorbing groups include a chain or cyclic thioamido group, thioureido group, thiourethane group, and dithiocarbamic acid ester group, which can not undergo tautomerization to yield mercapto groups (no hydrogen atom at a site of thione group), including the thione group produced by tautomerization of the mercapto group.

The heterocyclic group which contains at least one atom selected from a nitrogen atom, a sulfur atom, a selenium atom, and a tellurium atom as an adsorbing group is a nitrogen-containing heterocyclic group having an —NH— group capable of forming imino silver (>NAg) as a partial structure of the heterocyclic ring, or a heterocyclic group having an “—S—” group, an “—Se—” group, a “—Te—” group or an “═N—” group capable of coordinating with silver ion through a coordinate bond as the partial structure of the heterocyclic ring. Examples of the former group may include a benzotriazole group, a triazole group, an indazole group, a pyrazole group, a tetrazole group, a benzimidazole group, an imidazole group, a purine group. Examples of the latter group may include a thiophene group, a thiazole group, an oxazole group, a benzothiophene group, a benzothiazole group, a benzoxazole group, a thiadiazole group, an oxadiazole group, a triazine group, a selenazole group, a benzoselenazole group, a tellurazole group, and a benzotellurazole group. The former groups are preferred.

The sulfide groups as adsorbing groups include all the groups having a partial structure of “—S—” or “—S—S—”, and preferably the groups having partial structures of alkyl (or alkylene)-X-alkyl (or alkylene), aryl (or arylene)-X-alkyl (or alkylene), and aryl (or arylene)-X-aryl (or arylene), where X represents —S— or —S—S—. Further, these sulfide groups or the disulfide groups may also form ring structures. Specific examples of the ring structure which may be formed may include groups comprising a thiolane ring, a 1,3-dithiolane ring, a 1,2-dithiolane ring, a thiane ring, a dithiane ring, and a thiomorpholine ring. The sulfide groups are in particular preferably the groups having a partial structure of alkyl (or alkylene)-S-alkyl (or alkylene), and the disulfide groups are in particular preferably a 1,2-dithiolane ring group.

Cationic group as an adsorbing group denotes a group containing a quaternized nitrogen atom, and specifically, a group including an ammonio group or a nitrogen-containing heterocyclic group containing a quaternized nitrogen atom. The ammonio group herein is a trialkylammonio group, a dialkyldiarylammonio group, an alkylarylammonio group, or the like. Examples thereof may include a benzyldimethylammonio group, a trihexylammonio group, and a phenyldiethylammonio group. Examples of the nitrogen-containing heterocyclic group containing a quaternized nitrogen atom may include a pyridinio group, a quinolinio group, an isoquinolinio group, and an imidazolio group. A pyridinio group and an imidazolio group are preferred, and, a pyridinio group is particularly preferred. The nitrogen-containing heterocyclic groups containing a quaternized nitrogen atom may also have any given substituents. Preferred examples of the substituents for a pyridinio group and an imidazolio group may include an alkyl group, an aryl group, an acylamino group, a chloro atom, an alkoxycarbonyl group, and a carbamoyl group. As for a pyridinio group, the substituent is in particular preferably a phenyl group.

The ethynyl group as an adsorbing group denotes a —C≡CH group, where a hydrogen atom may also be substituted.

The adsorbing group may have any given substituent. Examples of the substituent may include: a halogen atom (fluorine atom, chloro atom, bromine atom, or iodine atom), an alkyl group (straight-chain, branched, or cyclic alkyl group, including a bicycloalkyl group or an active methine group), an alkenyl group, an alkynyl group, an aryl group, a heterocyclic group (any substitution position is acceptable), an acyl group, an alkoxycarbonyl group, an aryloxycarbonyl group, a heterocyclic oxycarbonyl group, a carbamoyl group, an N-hydroxycarbamoyl group, an N-acylcarbamoyl group, an N-sulfonylcarbamoyl group, an N-carbamoylcarbamoyl group, a thiocarbamoyl group, an N-sulfamoylcarbamoyl group, a carbazoyl group, a carboxy group or a salt thereof, an oxalyl group, an oxamoyl group, a cyano group, a carbonimidoyl group, a formyl group, a hydroxy group, an alkoxy group (including a group repeatedly containing ethyleneoxy group or propyleneoxy units), an aryloxy group, a heterocyclic oxy group, an acyloxy group, an (alkoxy or aryloxy)carbonyloxy group, a carbamoyloxy group, a sulfonyloxy group, an amino group, an (alkyl, aryl, or heterocyclic)amino group, an acylamino group, a sulfonamido group, a ureido group, a thioureido group, an N-hydroxyureido group, an imido group, an (alkoxy or aryloxy)carbonylamino group, a sulfamoylamino group, a semicarbazido group, a thiosemicarbazido group, a hydrazino group, an ammonio group, an oxamoylamino group, an N-(alkyl or aryl)sulfonylureido group, an N-acylureido group, an N-acylsulfamoylamino group, a hydroxyamino group, a nitro group, a heterocyclic group containing a quaternized nitrogen atom (e.g., a pyridinio group, an imidazolio group, a quinolinio group, or an isoquinolinio group), an isocyano group, an imino group, a mercapto group, an (alkyl, aryl, or heterocyclic)thio group, an (alkyl, aryl, or heterocyclic)dithio group, an (alkyl or aryl)sulfonyl group, an (alkyl or aryl)sulfinyl group, a sulfo group or a salt thereof, a sulfamoyl group, an N-acylsulfamoyl group, an N-sulfonylsulfamoyl group or a salt thereof, a phosphino group, a phosphinyl group, a phosphinyloxy group, a phosphinylamino group, and a silyl group. Incidentally, herein, the active methine group denotes a methine group substituted with two electron attracting groups, and the “electron attracting group” herein denotes an acyl group, an alkoxycarbonyl group, an aryloxycarbonyl group, a carbamoyl group, an alkylsulfonyl group, an arylsulfonyl group, a sulfamoyl group, a trifluoromethyl group, a cyano group, a nitro group, or a carbonimidoyl group. Herein, the two electron attracting groups may bond with each other to form a ring. The salt denotes a salt with a cation of an alkali metal, an alkaline earth metal, or a heavy metal, or an organic cation such as an ammonium ion or a phosphonium ion.

Incidentally, specific examples of the adsorbing group may include the ones described on pages 4 through 7 in the specification of JP-A No. 11-95355.

The adsorbing group represented by A in formula (I) is more preferably a mercapto-substituted heterocyclic group (e.g., a 2-mercaptothiadiazole group, a 3-mercapto-1,2,4-triazole group, a 5-mercaptotetrazole group, a 2-mercapto-1,3,4-oxadiazole group, a 2-mercaptobenzothiazole group, a 2-mercaptobenzimidazole group, or a 1,5-dimethyl-1,2,4-triazolium-3-thiolate group), a dimercapto-substituted heterocyclic group (e.g., a 2,4-dimercaptopyrymidine group, a 2,4-dimercaptotriazine group, a 3,5-dimercapto-1,2,4-triazole group, or a 2,5-dimercapto-1,3-thiazole group), or a nitrogen-containing heterocyclic group having an —NH— group capable of forming imino silver (>NAg) as a partial structure of the heterocyclic ring (e.g., a benzotriazole group, a benzimidazole group, or an indazole group). It is in particular preferably a dimercapto-substituted heterocyclic group.

In formula (I), W represents a divalent linking group. Any linking groups are acceptable so long as they do not adversely affect the photographic properties. For example, divalent linking groups comprising a carbon atom, a hydrogen atom, an oxygen atom, a nitrogen atom, and a sulfur atom are available. Specifically, mention may be made of an alkylene group having 1 to 20 carbon atoms (e.g., a methylene group, an ethylene group, a trimethylene group, a tetramethylene group, or a hexamethylene group), an alkenylene group having 2 to 20 carbon atoms, an alkynylene group having 2 to 20 carbon atoms, an arylene group having 6 to 20 carbon atoms (e.g., a phenylene group or a naphthylene group), —CO—, —SO₂—, —O—, —S—, or —NR₁—, or a combination of these linking groups, or the like. Herein, R₁ represents a hydrogen atom, an aliphatic group, or an aryl group. The aliphatic group represented by R₁ is preferably the one having 1 to 30 carbon atoms, and in particular, straight-chain, branched, or cyclic alkyl group, alkenyl group, alkynyl group, or aralkyl group, each having 1 to 20 carbon atoms (e.g., methyl group, ethyl group, isopropyl group, t-butyl group, n-octyl group, n-decyl group, n-hexadecyl group, cyclopropyl group, cyclopentyl group, cyclohexyl group, aryl group, 2-butenyl group, 3-pentenyl group, propargyl group, 3-pentinyl group, or a benzyl group). The aryl group represented by R₁ is preferably a monocyclic or condensed-ring aryl group having preferably 6 to 30 carbon atoms, and further preferably 6 to 20 carbon atoms. Examples thereof may include a phenyl group and a naphthyl group. The linking group represented by W may have any given substituent, and the any given substituent is synonymous with the group described as the substituent of the adsorbing group.

In formula (I), the reducing group represented by B represents a group capable of reducing a silver ion. Examples thereof may include: a formyl group, an amino group, a triple bond group such as an acetylene group or a propargyl group, a mercapto group, and residues derived from a compound selected from hydroxylamines, hydroxamic acids, hydroxyureas, hydroxyurethanes, hydroxycarbazides, reductons (including reducton derivatives), anilines, phenols (including chroman-6-ols, 2,3-dihydrobenzofuran-5-ols, aminophenols, sulfonamindophenols, and polyphenols such as hydroquinones, catechols, resorcinols, benzenetriols, and bisphenol), hydrazines, hydrazides, and phenidones.

In formula (I), the reducing group represented by B is a residue derived from any of the compounds represented by the following formulae B₁ through B₁₃.

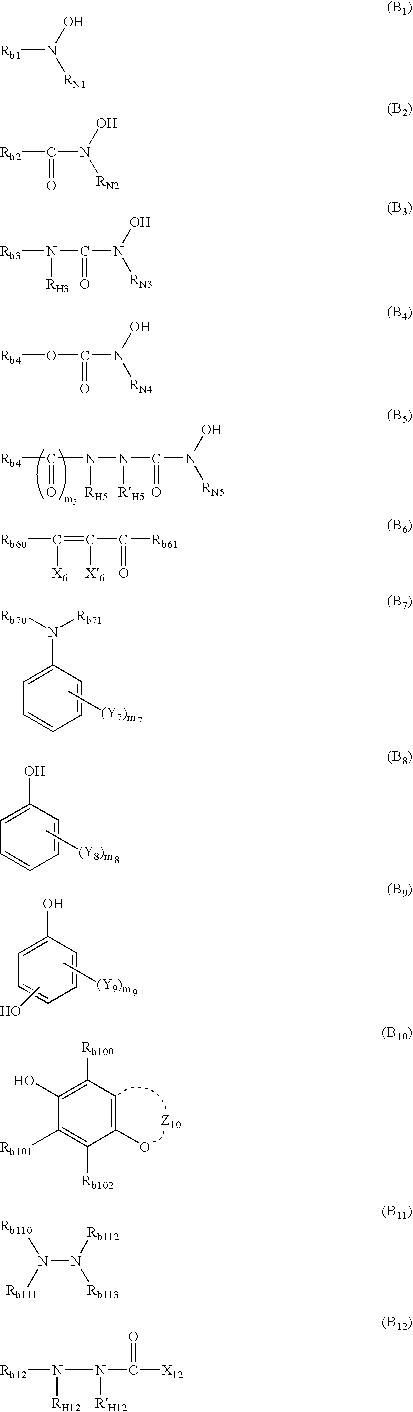

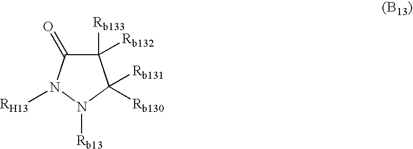

In formulae (B₁) to (B₁₃), R_{b1}, R_{b2}, R_{b3}, R_{b4}, R_{b5}, R_{b70}, R_{b71}, R_{b110}, R_{b111}, R_{b112}, R_{b113}, R_{b12}, R_{b13}, R_{N1}, R_{N2}, R_{N3}, R_{N4}, and R_{N5} each independently represent a hydrogen atom, an alkyl group, an aryl group, or a heterocyclic group; R_{H3}, R_{H5}, R′_{H5}, R_{H12}, R′_{H12}, and R_{H13} each independently represent a hydrogen atom, an alkyl group, an aryl group, an acyl group, an alkylsulfonyl group, or an arylsulfonyl group, and out of these, R_{H13} may further be a hydroxy group; R_{b100}, R_{b101}, R_{b102}, and R_{b130} to R_{b133} each independently represent a hydrogen atom or a substituent; Y₇ and Y₈ each independently represent a substituent except for a hydroxy group; Y₉ represents a substituent; m₅ is 0 or 1; m₇ represents an integer from 0 to 5; m₈ is an integer from 1 to 5; m₉ represents an integer from 0 to 4; Y₇, Y₈, and Y₉ may also further be an aryl group condensed with a benzene ring (e.g., a benzene condensed ring), which may further have a substituent; Z₁₀ represents a non-metal atomic group capable of forming a ring; and X₁₂ represents a hydrogen atom, an alkyl group, an aryl group, a heterocyclic group, an alkoxy group, an amino group (including an alkylamino group, an arylamino group, a heterocyclic amino group, or a cyclic amino group), or a carbamoyl group.

In formula (B₆), X₆ and X′₆ each independently represent a hydroxy group, an alkoxy group, a mercapto group, an alkylthio group, an amino group (including an alkylamino group, an arylamino group, a heterocyclic amino group, or a cyclic amino group), an acylamino group, a sulfonamido group, an alkoxycarbonylamino group, a ureido group, an acyloxy group, an acylthio group, an alkylaminocarbonyloxy group, or an arylaminocarbonyloxy group; R_{b60} and R_{b61} each independently represent an alkyl group, an aryl group, an amino group, an alkoxy group, or an aryloxy group; and R_{b60} and R_{b61} may bond with each other to form a ring.

In the description of respective groups in formulae (B₁) to (B₁₃), the alkyl group denotes a straight-chain, branched, or cyclic, substituted or unsubstituted alkyl group having 1 to 30 carbon atoms; the aryl group denotes a monocyclic or condensed, substituted or unsubstituted aromatic hydrocarbon ring such as a phenyl group or a naphthyl group; and the heterocyclic group denotes an aromatic or non-aromatic, monocyclic or condensed, substituted or unsubstituted heterocyclic group containing at least one hetero atom.

The substituents mentioned in the description on respective groups in formulae (B₁) to (B₁₃) are synonymous with the substituents of the above-described adsorbing groups. These substituents may also further be substituted with these substituents.

In formulae (B₁) to (B₅), R_{N1}, R_{N2}, R_{N3}, R_{N4}, and R_{N5} each independently preferably denote a hydrogen atom or an alkyl group. Herein, the alkyl group is preferably a straight-chain, branched, or cyclic, substituted or unsubstituted alkyl group having preferably 1 to 12 carbon atoms, and more preferably a straight-chain or branched, substituted or unsubstituted alkyl group having 1 to 6 carbon atoms. Examples thereof may include a methyl group, an ethyl group, a propyl group, and a benzyl group.

In formula, (B₁), R_{b1} is preferably an alkyl group or a heterocyclic group. Herein, the alkyl group is a straight-chain, branched, or cyclic, substituted or unsubstituted alkyl group having preferably 1 to 30 carbon atoms, and more preferably 1 to 18 carbon atoms. The heterocyclic group is a 5-membered or 6-membered, monocyclic or condensed, aromatic or nonaromatic heterocyclic group, and may also have a substituent. The heterocyclic group is preferably an aromatic heterocyclic group, examples of which may include a pyridine ring group, a pyrimidine ring group, a triazine ring group, a thiazole ring group, a benzothiazole ring group, an oxazole ring group, a benzoxazole ring group, an imidazole ring group, a benzimidazole ring group, a pyrazole ring group, an indazole ring group, an indole ring group, a purine ring group, a quinoline ring group, an isoquinoline ring group, and a quinazoline ring group. In particular, a triazine ring group and a benzothiazole ring group are preferred. The compound represented by formula (B₁), wherein the alkyl group or the heterocyclic group represented by R_{b1} further has another, or two or more —N(R_{N1})OH groups as substituents thereof is also one of the preferred examples of the compound represented by formula (B₁).

In formula (B₂), R_{b2} is preferably an alkyl group, an aryl group, or a heterocyclic group, and more preferably an alkyl group or an aryl group. The preferred range of the alkyl group is the same as in the description on R_{b1}. The aryl group is preferably a phenyl group or a naphthyl group, and in particular preferably a phenyl group, and may also have a substituent. The compound represented by formula (B₂), wherein the group represented by R_{b2} further has another, or two or more —CON(R_{N2})OH groups as substituents thereof is also one of the preferred examples of the compound represented by formula (B₂).

In formula (B₃), R_{b3} is preferably an alkyl group or an aryl group, and the preferred range thereof is the same as in the description on R_{b1} and R_{b2}. R_{H3} is preferably a hydrogen atom, an alkyl group, or a hydroxy group, and more preferably a hydrogen atom. The compound represented by formula (B₃), wherein the a group represented by R_{b3} further has another or two or more —N(R_{H3})CON(R_{N3}) groups as substituents thereof is also one of the preferred examples of the compound represented by formula (B₃). Further, R_{b3} and R_{N3} may bond with each other to form a ring (preferably, a 5-membered or 6-membered saturated heterocyclic ring).

In formula (B₄), R_{b4} is preferably an alkyl group, and the preferred range thereof is the same as in the description on R_{b1}. The compound represented by formula (B₄), wherein the group represented by R_{b4} further has another or two or more —OCON(R_{N4})OH groups as substituents thereof is also one of the preferred examples of the compound represented by formula (B₄).

In formula (B₅), R_{b5} is preferably an alkyl group or an aryl group, and more preferably an aryl group, and the preferred range thereof is the same as in the description on R_{b1} and R_{b2}. R_{H5} and R′_{H5} are each independently preferably a hydrogen atom or an alkyl group, and more preferably a hydrogen atom.

In formula (B₆), R_{b60} and R_{b61} preferably bond with each other to form a ring. The ring structure herein formed may be a 5-membered to 7-membered nonaromatic carbon ring or heterocyclic ring, which may be a monocyclic ring or a condensed ring. Specific preferred examples of the ring structure may include: a 2-cyclopenten-1-one ring, a 2,5-dihydrofuran-2-one ring, a 3-pyrolin-2-one ring, 4-pyrazolin-3-one ring, a 2-cyclohecen-1-one ring, a 5,6-dihydro-2H-pyran-2-one ring, a 5,6-dihydro-2-pyridone ring, a 1,2-dihydronaphthalen-2-on ring, a coumarin ring (benzo-α-pyran-2-one ring), a 2-quinolone ring, a 1,4-dihydronaphthalen-1-one ring, a chromone ring (benzo-γ-pyran-4-one ring), a 4-quinolone ring, an inden-1-one ring, a 3-pyrolin-2,4-dione ring, an uracil ring, a thiouracil ring, and a dithiouracil ring. The more preferred examples include a 2-cyclopenten-1-one ring, a 2,5-dihydrofuran-2-one ring, a 3-pyrolin-2-one ring, a 4-pyrazolin-3-one ring, a 1,2-dihydronaphthalen-2-one ring, a coumarin ring (benzo-α-pyran-2-one ring), a 2-quinolone ring, a 1,4-dihydronaphthalen-1-one ring, a chromone ring (benzo-γ-pyran-4-one ring), a 4-quinolone ring, an inden-1-one ring, and a dithiouracil ring. Still more preferred ring structures are a 2-cyclopenten-1-one ring, a 2,5-dihydrofuran-2-one ring, a 3-pyrolin-2-one ring, an inden-1-one ring, and a 4-pyrazolin-3-one ring.

When X₆ and X′₆ each represent a cyclic amino group, the cyclic amino group is a nonaromatic nitrogen-containing heterocyclic group bonding at the nitrogen atom. Examples thereof include a pyrrolidino group, a pepridino group, a peperazino group, a morpholino group, a 1,4-thiazin-4-yl group, a 2,3,5,6-tetrahydro-1,4-thiazin-4-yl group, and an indolyl group.

X₆ and X′₆ are each independently preferably a hydroxy group, a mercapto group, an amino group (including an alkylamino group, an arylamino group, or a cyclic amino group), an acylamino group, a sulfonamido group, an acyloxy group, or an acylthio group, more preferably a hydroxy group, a mercapto group, an amino group, an alkylamino group, a cyclic amino group, a sulfonamido group, an acylamino group, or an acyloxy group, and in particular preferably a hydroxy group, an amino group, an alkylamino group, or a cyclic amino group. Further, at least one of X₆ and X′₆ is preferably a hydroxy group.

In formula (B₇), R_{b70} and R_{b71} are each independently preferably a hydrogen atom, an alkyl group, or an aryl group, and more preferably an alkyl group, and the preferred range of an alkyl group is the same as in the description on R_{b1}. R_{b70} and R_{b71} may also bond with each other to form a ring (e.g., a pyrroline ring, a piperidine ring, a morpholino ring, or a thiomorpholino ring). The substituent represented by Y₇ is preferably an alkyl group (of which the preferred range is the same as in the description on R_{b1}), an alkoxy group, an amino group, an acylamino group, a sulfonamido group, a ureido group, an acyl group, an alkoxycarbonyl group, a carbamoyl group, a sulfamoyl group, a chloro atom, a sulfo group or a salt thereof, a carboxy group or a salt thereof, or the like. m₇ preferably denotes 0 to 2.

In formula (B₈), m₈ is preferably 1 to 4, and a plurality of Y₈'S may be the same or different. Y₈ when m₈ is 1, or at least one of a plurality of Y₈′S when m₈ is 2 or more is preferably an amino group (including an alkylamino group or an arylamino group), a sulfonamido group, or an acylamino group. When m₈ is 2 or more, the residual Y₈s are each preferably a sulfonamido group, an acylamino group, a ureido group, an alkyl group, an alkylthio group, an acyl group, an alkoxycarbonyl group, a carbamoyl group, a sulfo group or a salt thereof, a carboxy group or a salt thereof, a chloro atom, or the like. The compounds each substituted with an o′-(or p′-)hydroxymethyl group (which may further have a substituent) as the substituent represented by Y₈ at the ortho position or the para position with respect to the hydroxyl group represent the compound group are generally referred to as bisphenols. Each of these compounds is also one of the preferred examples of the compounds represented by formula (B₈). Further, it is very preferable that the compounds represented by formula (B₈), wherein Y₈ represents a benzene condensed ring, represent naphthols.

In formula (B₉), the substitution positions of two hydroxy groups are the ortho positions (catechols), meta positions (resorcinols), or para positions (hydroquinones) to each other. m₉ is preferably 1 to 2, and a plurality of Y₉'s may be the same or different. Preferred examples of the substituent represented by Y₉ may include a chloro atom, an acylamino group, a ureido group, a sulfonamido group, an alkyl group, an alkylthio group, an alkoxy group, an acyl group, an alkoxycarbonyl group, a carbamoyl group, a sulfo group or a salt thereof, a carboxy group or a salt thereof, a hydroxy group, an alkylsulfonyl group, and an arylsulfonyl group. It is also preferable that the compounds represented by formula (B₉), wherein Y₉ represents a benzene condensed ring, denote 1,4-naphthohydroquinones. When the compounds represented by formula (B₉) represent catechols, Y₉ is in particular preferably a sulfo group or a salt thereof, or a hydroxy group.

In formula (B₁₀), when R_{b100}, R_{b101}, and R_{b102} each represent a substituent, preferred examples of the substituent are the same as the preferred examples of Y₉. Out of these, an alkyl group (in particular, a methyl group) is preferred. The ring structure formed by Z₁₀ is preferably a chroman ring or a 2,3-difydrobenzofuran ring. The ring structure may have a substituent, and also may form a spiro ring.

In formula (B₁₁), R_{b110}, R_{b111}, R_{b112}, and R_{b113} each independently preferably represent an alkyl group, an aryl group, or a heterocyclic group. The preferred range thereof is the same as in the description on R_{b1} and R_{b2}. Out of these, the arkyl group is preferred, and two alkyl groups of R_{b110} to R_{b113} may also bond with each other to form a ring. The ring structure herein is a 5-membered or 6-membered nonaromatic heterocyclic ring. Examples thereof may include a pyrrolidine ring, a piperidine ring, a morpholino ring, a thiomorpholino ring, and a hexahydropyridazine ring.

In formula (B₁₂), R_{b12} is preferably an alkyl group, an aryl group, or a heterocyclic group, and the preferred range thereof is the same as in the description on R_{b1} and R_{b2}. X₁₂ is preferably an alkyl group, an aryl group (in particular, a phenyl group), a heterocyclic group, an alkoxy group, an amino group (including an alkylamino group, an arylamino group, a heterocyclic amino group, or a cyclic amino group), or a carbamoyl group. It is more preferably an alkyl group (in particular preferably an alkyl group having 1 to 8 carbon atoms), an aryl group (in particular preferably a phenyl group), or an amino group (including an alkylamino group, an arylamino group, or a cyclic amino group). R_{H12} and R′_{H12} are each independently preferably a hydrogen atom or an alkyl group, and more preferably a hydrogen atom.

In formula (B₁₃), R_{b13} is preferably an alkyl group or an aryl group, and the preferred range thereof is the same as in the description on R_{b1} and R_{b2}. R_{b130}, R_{b131}, R_{b132}, and R_{b133} are each independently preferably a hydrogen atom, an alkyl group (in particular preferably having 1 to 8 carbon atoms), or an aryl group (in particular preferably a phenyl group). R_{H13} is preferably a hydrogen atom or an acyl group, and more preferably a hydrogen atom.

In formula (I), the reducing group represented by B represents any of preferably hydroxylamines, hydroxamic acids, hydroxyureas, hydroxysemicarbazides, phenols, hydrazines, hydrazides, phenidones, and in particular preferably hydroxyureas, hydroxysemicarbazides, phenols, hydrazides, or phenidones.

The reducing group represented by B in formula (I) can be measured for the oxidation potential using the measurement method described in DENKI KAGAKU SOKUTEIHOU authored by Akira Fujishima (pages 150 to 208, published by GIHODO Publisher's Co.), or in JIKKEN KAGAKU KOZA (Courses in Experimental Chemistry) 4th ed., (vol. 9, pages 282 to 344, Maruzen) edited and authored by the Chemical Society of Japan. For example, with a technique of rotating disk voltammetry, specifically, a sample is dissolved in a solution of methanol: pH6.5 Britton-Robinson buffer=10%:90% (% by volume), and a nitrogen gas is passed through the solution for 10 minutes. Then, a rotating disk electrode (RDE) made of glassy carbon is used as a working electrode, a platinum wire is used as a counter electrode, and a saturated calomel electrode is used as a reference electrode. Thus, a measurement is carried out at 25° C., 1000 revolutions/min, and a sweep rate of 20 mV/sec. The half-wave potential (E1/2) can be determined from the voltammogram obtained.

When the reducing group represented by B of the invention is measured with the above-described measurement method, it has an oxidation potential of preferably in the range of about −0.3 V to about 1.0 V, more preferably in the range of about −0.1 V to about 0.8 V, and in particular preferably in the range of about 0 to about 0.7 V.

The reducing groups represented by B of the invention are often the compounds known in the photographic industry, and examples thereof are described in the following patent publications: e.g., JP-A Nos. 2001-42466, 8-114884, 8-314051, 8-333325, 9-133983, 11-282117, 10-246931, 10-90819, 9-54384, 10-171060, and 7-77783. As one example of the phenols, mention may be made of the compounds described in U.S. Pat. No. 6,054,260.

The compounds of formula (I) of the invention may also be the compounds each incorporating therein a ballast group or a polymer chain which is commonly used in an immobile photographic additive such as a coupler. As the polymers, mention may be made of the ones described in, for example, JP-A No. 1-100530.

The compounds of formula (I) of the invention may also each be a bis form or a tris form. The compounds of formula (I) of the invention have a molecular weight of preferably between 100 and 10000, more preferably between 120 and 1000, and in particular preferably 150 and 500.

Non-limiting examples of the compounds of formula (I) of the invention will be shown below. Further, the compounds exemplified in JP-A Nos. 2000-330247 and 2001-42446 are also preferred examples.

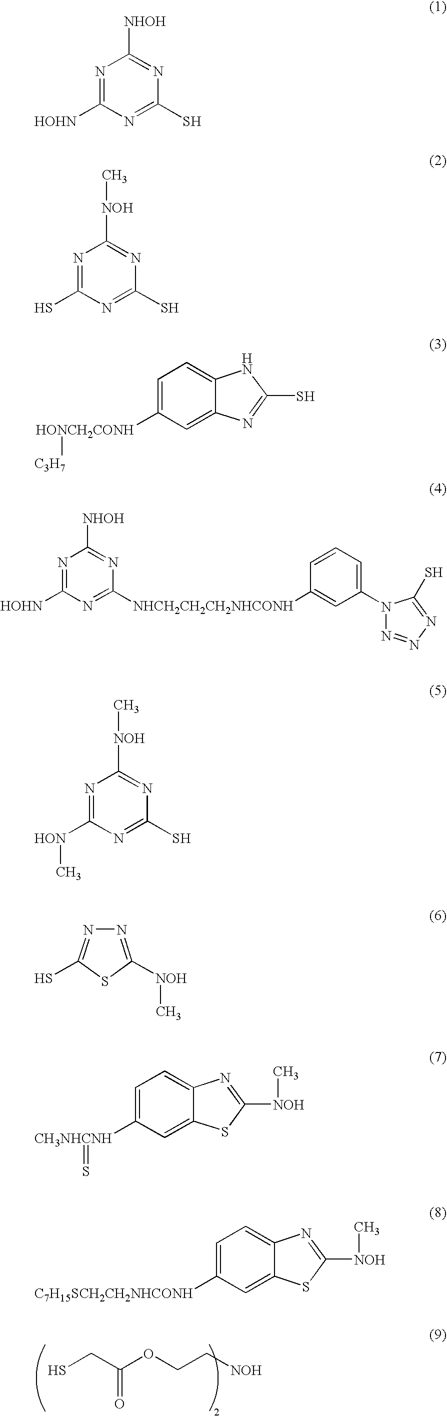

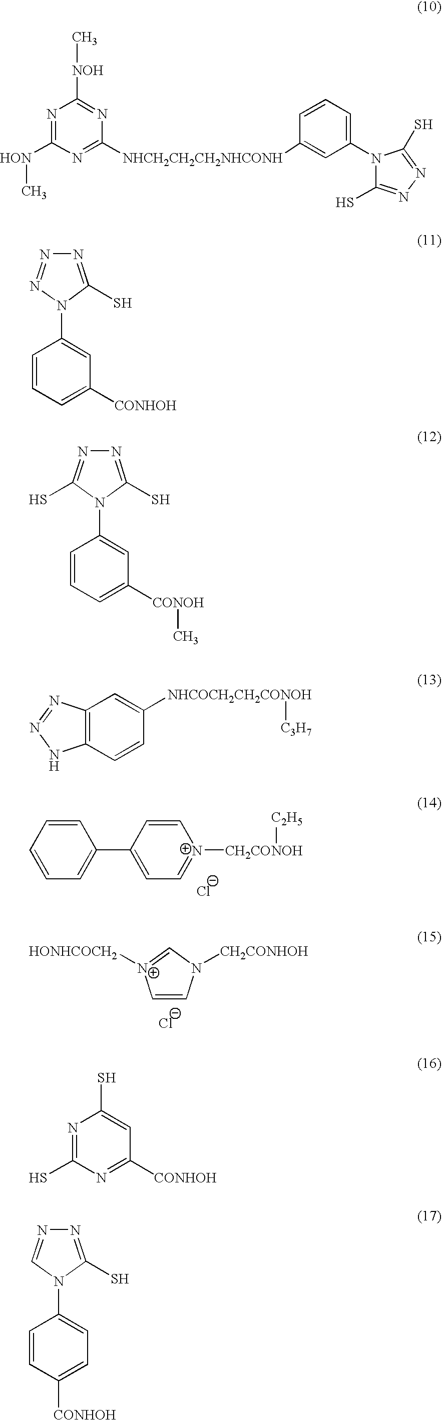

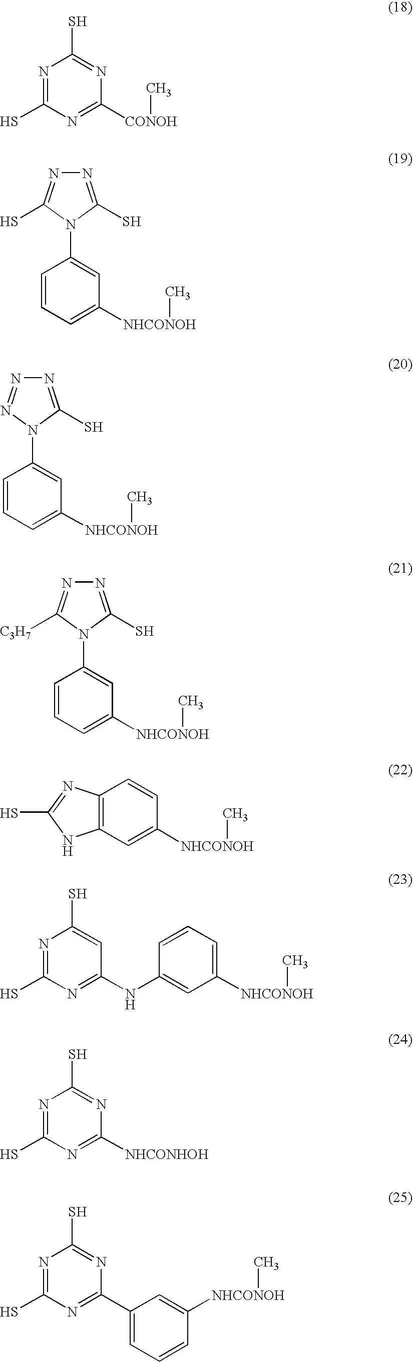

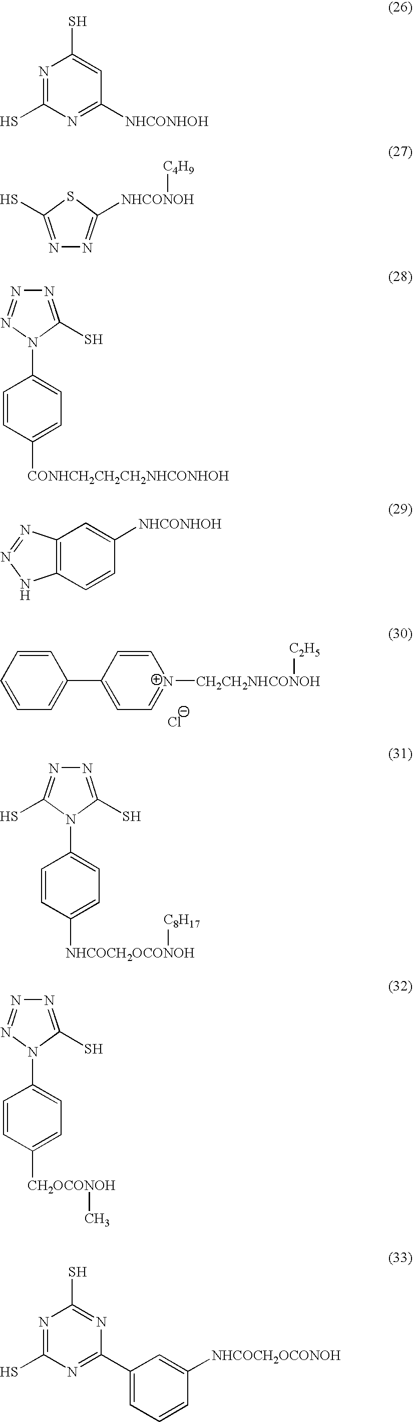

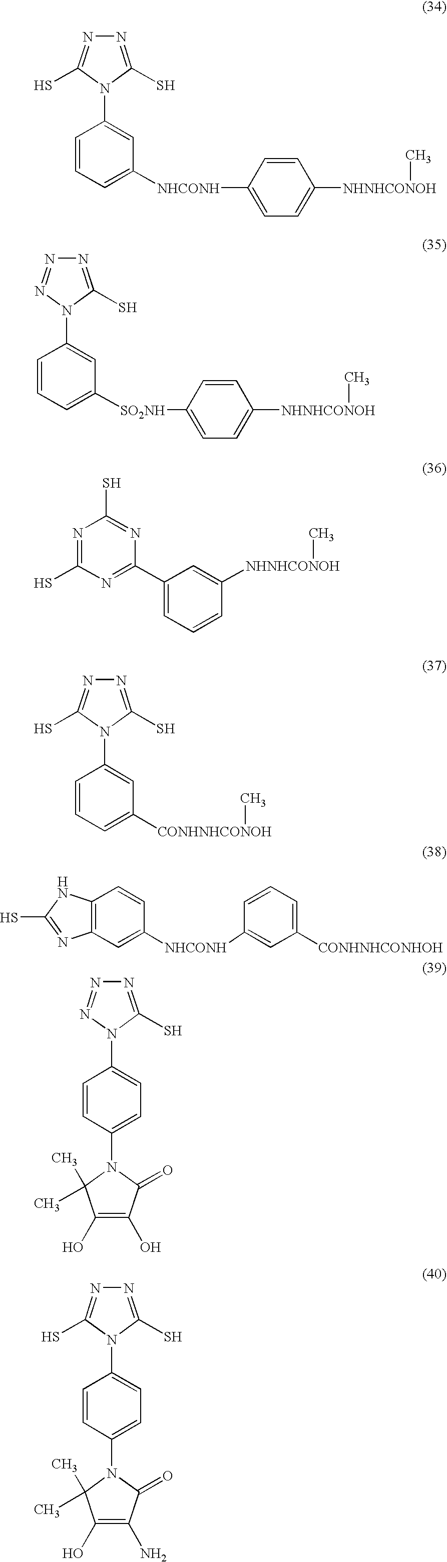

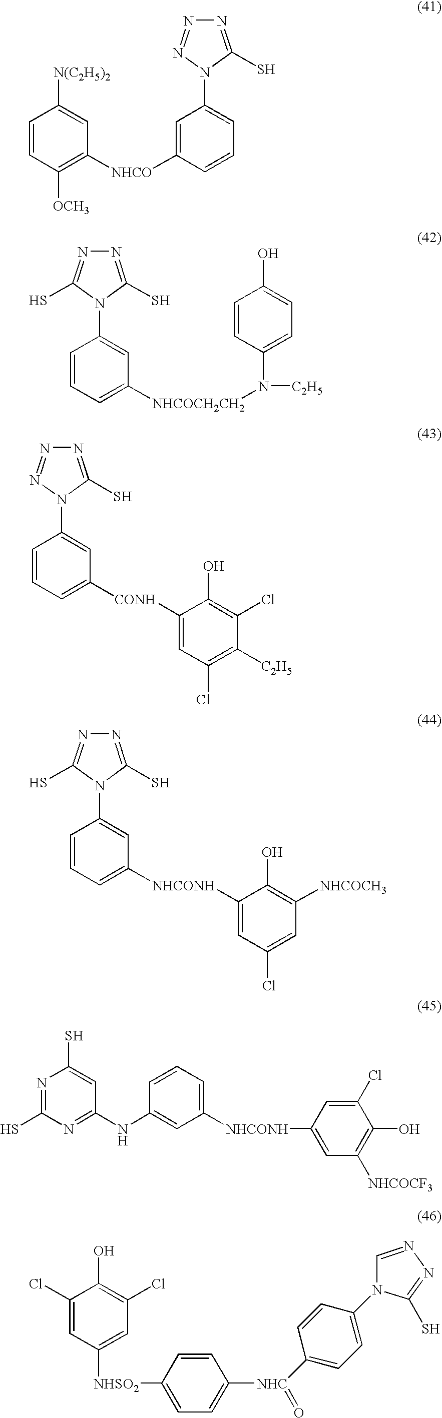

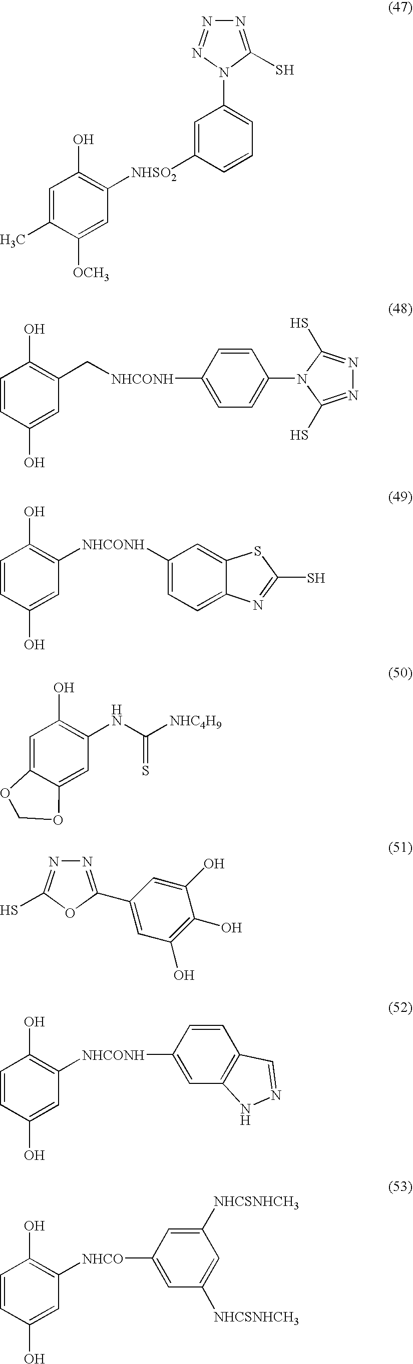

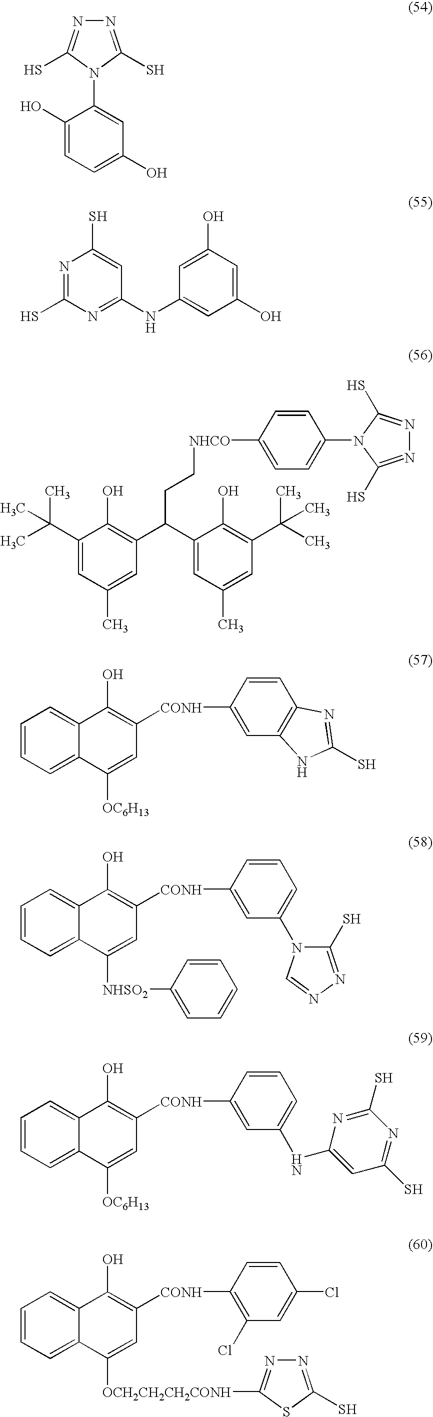

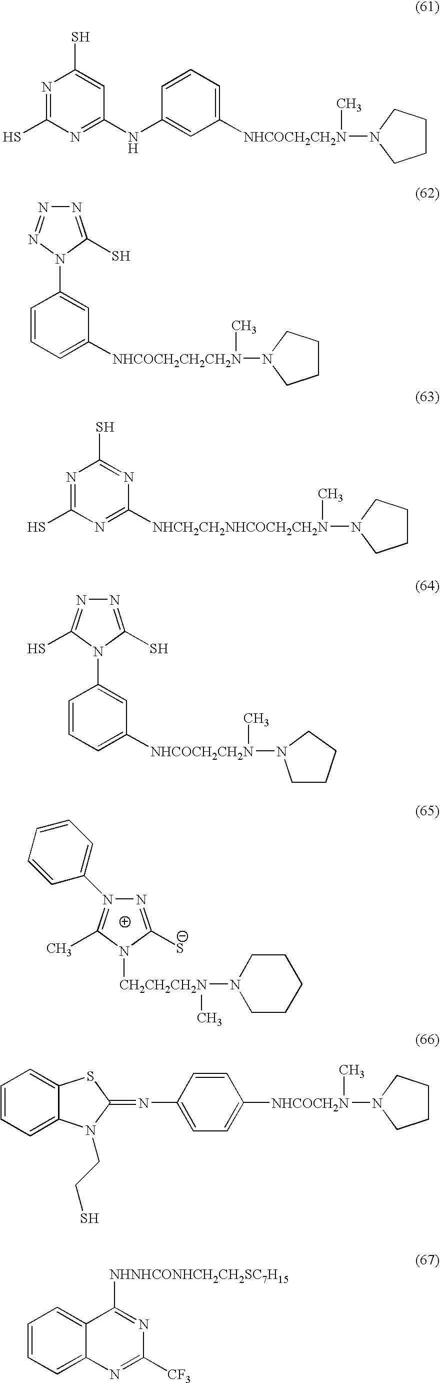

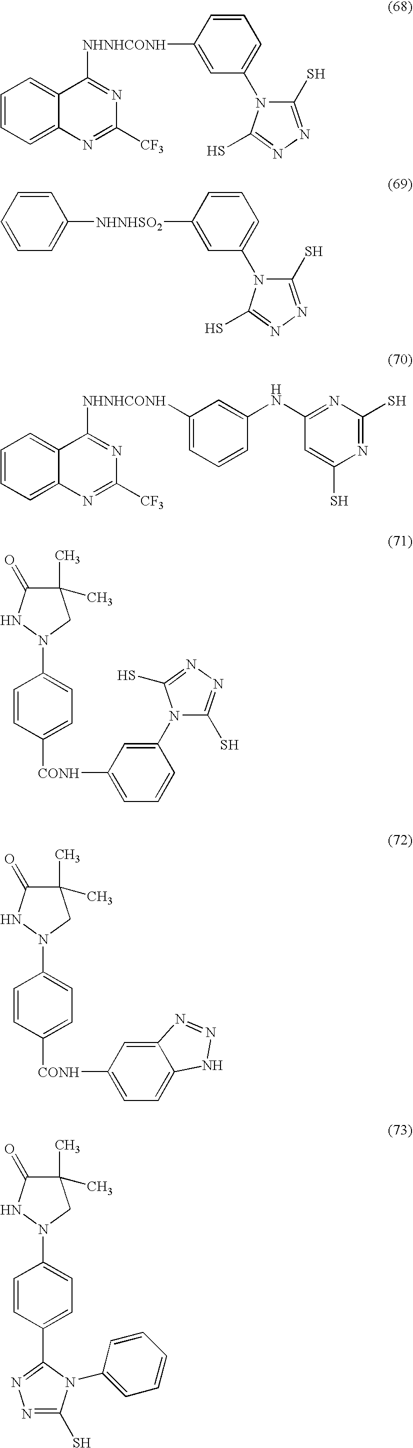

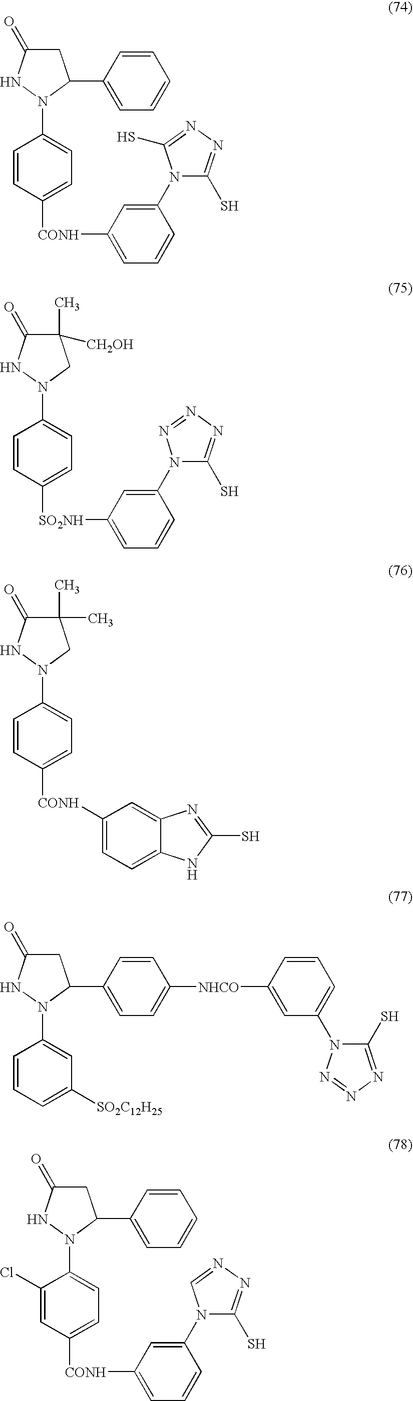

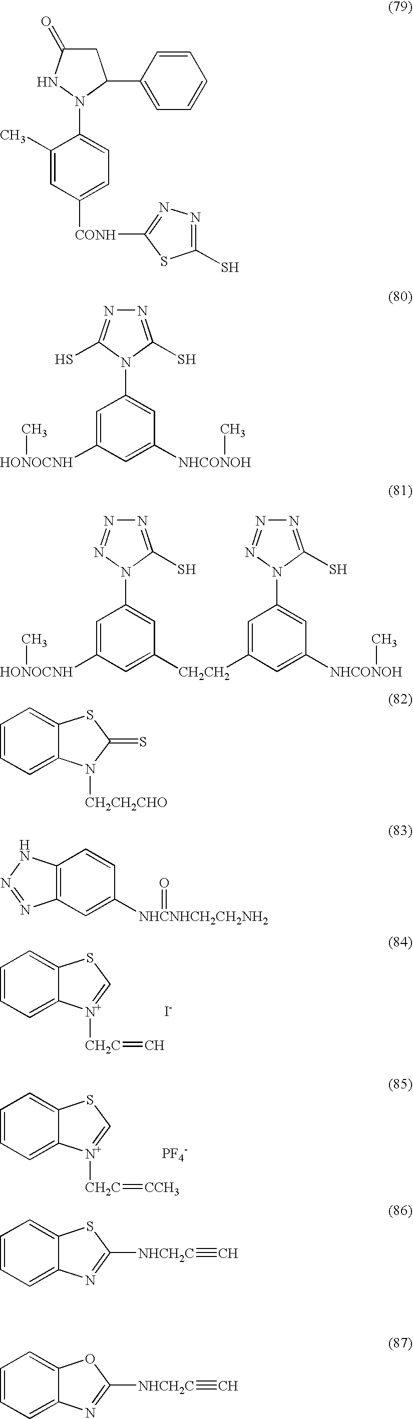

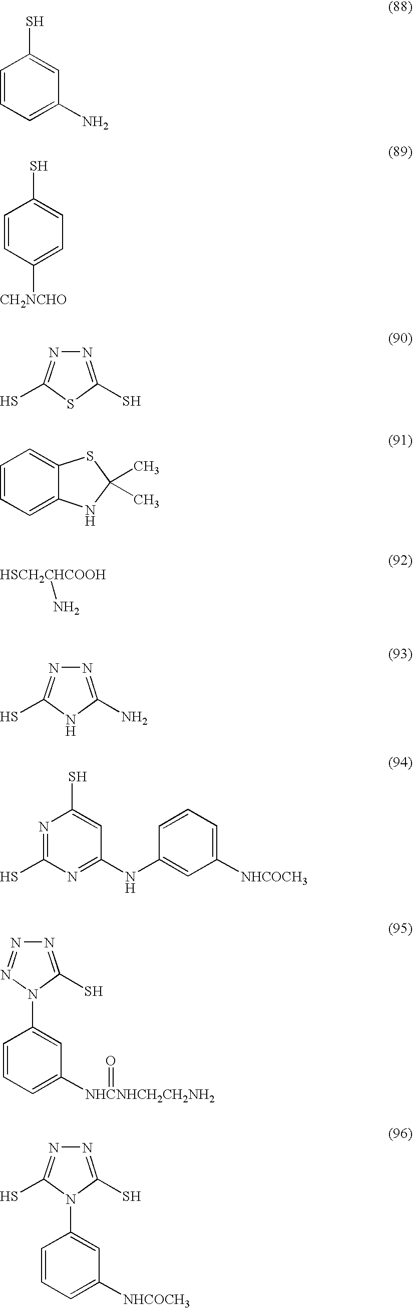

The compounds of the invention can be synthesized with ease according to known methods.

The compounds of formula (I) of the invention may be used alone, or may also preferably used in combination of two or more of the compounds simultaneously. When two or more of the compounds are used, these may be either added to the same layer, or added to different layers, and each may be added with a different method.

The compounds of formula (I) of the invention are preferably added to a silver halide emulsion layer, and more preferably added during the preparation of the emulsion. When they are added during the preparation of the emulsion, it is possible to add them at any timing during the step. Examples of the timing may include: during silver halide grain formation step, before the start of a desalting step, during the desalting step, before the start of chemical aging, during chemical aging step, and during a step prior to complete emulsion preparation. Alternatively, the compounds may also be added over a plurality of times during these steps. They are preferably used in the emulsion layer. However, they may also be added to the adjacent protective layer or intermediate layer as well as to the emulsion layer, whereby they are dispersed therein during coating.

The preferred amount of the compounds largely depends upon the above-described addition method or the compound species to be added. However, in general, it is 1×10⁻⁶ mol, preferably 1×10⁻⁵ to 5×10⁻¹ mol, and more preferably 1×10⁻⁴ to 1×10⁻¹ mol per mole of photosensitive silver halide.

The compound of formula (I) of the invention may be dissolved in water or a water-soluble solvent such as methanol or ethanol, or a mixed solvent thereof, and added. In this step, it may be properly adjusted in pH by an acid or a base, and a surfactant may also be allowed to be present therein. Further, it may also be dissolved in a high boiling organic solvent, and added in an emulsified dispersion form. Alternatively, it may also be added in a solid dispersion.

11) Use of a Plurality of Silver Halides in Combination

The photosensitive silver halide emulsions in the photosensitive material for use in the invention may be used alone, or in combination of two or more thereof (e.g., the ones having different average grain sizes, the ones having different halogen compositions, the ones having different crystal habits, and the ones requiring different conditions for chemical sensitization). By using a plurality of kinds of photosensitive silver halides mutually different in sensitivity, it is possible to adjust the gradation. As the techniques on these, mention may be made of JP-A Nos. 57-119341, 53-106125, 47-3929, 48-55730, 46-5187, 50-73627, and 57-150841, and the like. As for the sensitivity difference, a difference of 0.2 logE or more is preferably caused between respective emulsions.

12) Coating Amount

The amount of a photosensitive silver halide to be added is preferably 0.03 to 0.6 g/m², more preferably 0.05 to 0.4 g/m², and most preferably 0.07 to 0.3 g/m² in terms of the coating amount of silver per square meter of the sensitive material. The photosensitive silver halide is in an amount of preferably 0.01 mol or more and 0.5 mol or less, more preferably 0.02 mol or more and 0.3 mol or less, and further preferably 0.03 mol or more and 0.2 mol or less per mole of organic silver salt.

13) Mixing of Photosensitive Silver Halide and Organic Silver Salt

Regarding the mixing method and the mixing condition for separated prepared photosensitive silver halide and organic silver salt, there is a method of mixing the silver halide grains and organic silver salt, which have been respectively prepared, in a high-speed stirrer, a ball mill, a sand mill, a colloid mill, a shaking mill, a homogenizer, or the like; a method of mixing the photosensitive silver halide which has been prepared, in any timing during the preparation of an organic silver salt, and preparing organic silver salt; or other methods. However, there is no particular restriction thereon, so far as the effects of the invention are sufficiently produced. For mixing, it is a preferable method for adjusting the photographic characteristics that two or more kinds of aqueous dispersions of organic silver salts and two or more kinds of aqueous dispersions of photosensitive silver salts are mixed.

14) Mixing of Silver Halide into Coating Solution

The preferred timing of adding the silver halide of the invention into an image forming layer coating solution is in the period of from 180 minutes before to immediately before, and preferably 60 minutes before to 10 seconds before coating. However, the mixing process and the mixing conditions have no particular restriction so long as the effects of the invention satisfactorily occur. As specific mixing processes, there are a method in which the mixing is performed in a tank configured such that the mean residence time therein calculated from the addition flow rate and the feeding amount to a coater becomes a desirable time; a method using a static mixer described in Chapter 8 of Ekitai Kongo Gijutsu written by N. Harnby, M. F. Edwards, and A. W. Nienow, translated by Koji Takahashi, (published by Nikkan Kogyo Shinbunsha, 1989); and the like.

(Explanation of Binder)

The usable binder in the organic silver salt-containing layer of the invention may be any polymer. Preferred binders are transparent or semi-transparent, and generally colorless, and include natural resins, or polymers and copolymers, synthetic resins, or polymers and copolymers, and other media which form a film, such as gelatins, rubbers, poly(vinyl alcohol)s, hydroxyethyl celluloses, cellulose acetates, cellulose acetate butylates, poly(vinylpyrrolidone)s, casein, starch, poly(acrylic acid)s, poly(methylmethacrylic acid)s, poly(vinyl chloride)s, poly(methacrylic acid)s, styrene-maleic anhydride copolymers, styrene-acrylonitrile copolymers, styrene-butadiene copolymers, poly(vinyl acetal)s (e.g., poly(vinyl formal) and poly(vinyl butyral)), poly(ester)s, poly(urethane)s, phenoxy resins, poly(vinylidene chloride)s, poly(epoxide)s, poly(carbonate)s, poly(vinyl acetate)s, poly(olefin)s, cellulose esters, and poly(amide)s. The binders may be coated for formation from water or an organic solvent, or an emulsion.

In the invention, the glass transition temperature of the binder usable in combination in the organic silver salt-containing layer is preferably 0° C. or more and 80° C. or less (hereinafter, may be referred to as a high Tg binder), more preferably 10° C. to 70° C., and further preferably 15° C. or more and 60° C. or less.

Incidentally, in this specification, the Tg was calculated with the following equation.

1/Tg=Σ(Xi/Tgi)

In this case, it is assumed that the polymer is formed by copolymerization of n monomer components from i=1 to n. Xi represents the weight ratio of the i-th monomer (ΣXi=1), and Tgi denotes the glass transition temperature (an absolute temperature) of the homopolymer of the i-th monomer, provided that Σ is the sum for from i=1 to i=n. Incidentally, for the value (Tgi) of the glass transition temperature of the homopolymer of each monomer, the values described in Polymer Handbook, (3rd Edition) (written by J. Brandrup and E. H. Immergut, (Willey-interscience, 1989)), have been adopted.

The binders may be used, if required, in combination of two or more thereof. Alternatively, the one having a glass transition temperature of 20° C. or more and the one having a glass transition temperature of lower than 20° C. may also be used in combination. When two or more kinds of polymers having different Tg values are blended to be used, it is preferable that the weight average Tg thereof falls within the above-described range.

In the invention, an organic silver salt-containing layer is preferably formed as a coating film by way of a coating solution in which 30 mass % or more of the solvent is water for coating and drying.

In the invention, the performances are improved when coating is performed with a coating solution in which 30 mass % or more of the solvent is water, followed by drying to form the organic silver salt-containing layer, further when the binder in the organic silver salt-containing layer is soluble or dispersible in an aqueous solvent (a water solvent), and, in particular, when the binder comprises a latex of polymer having an equilibrium moisture content at 25° C. and 60% RH of 2 mass % or less. The most preferable form is such that preparation has been performed so as to obtain an ionic conductivity of 2.5 mS/cm or less. For such a preparation method, mention may be made of a purification treatment method using a functional membrane for separation after synthesizing a polymer.

The aqueous solvent mentioned here in which the polymer is soluble or dispersible means water or a mixture of water and a water-miscible organic solvent in an amount of 70 mass % or less. Examples of the water-miscible organic solvent may include: alcohol type solvents such as methyl alcohol, ethyl alcohol, and propyl alcohol, cellosolve type solvents such as methyl cellosolve, ethyl cellosolve, and butyl cellosolve, ethyl acetate, and dimethyl formamide.

Incidentally, the term “the aqueous solvent” is used also for a system where a polymer is not thermodynamically dissolved, but exists in a so-called dispersed state.

Here, “the equilibrium moisture content at 25° C. and 60% RH” can be expressed by using the weight W1 of a polymer in an equilibrium with moisture conditioning under an atmosphere of 25° C. and 60% RH, and the weight W0 of the polymer in an absolutely dry state, as the following equation.

Equilibrium moisture content at 25° C. and 60% RH=[(W1−W0)/W0]×100 (mass %)

As for the definition and the measurement method of moisture content, for example, Polymer Engineering Course 14, (Kobunshi Kougaku Kouza 14) Testing Methods of Polymer Materials, (compiled by the Society of Polymer Science of Japan, Chijin Shokan) can serve as a reference.

The equilibrium moisture content at 25° C. and 60% RH of the binder polymer of the invention is preferably 2 mass % or less, more preferably 0.01 mass % or more and 1.5 mass % or less, and furthermore preferably 0.02 mass % or more and 1 mass % or less.

In the invention, a polymer dispersible in an aqueous solvent is particularly preferred. Acceptable examples of the dispersion state, may include any of the dispersion state for a latex in which fine particles of a water-insoluble and hydrophobic polymer are dispersed, or the dispersion state for the one in which polymer molecules are dispersed in a molecular state or a micelle-forming state. However, dispersed particles in a latex are more preferred. The average particle diameter of dispersed particles is 1 to 50000 nm, preferably in the range of 5 to 1000 nm, more preferably in the range of 10 to 500 nm, and furthermore preferably in the range of 50 to 200 nm. The particle diameter distribution of the dispersed particles has no particular restriction. Both of dispersed particles having a broad particle diameter distribution or dispersed particles having a monodisperse particle diameter distribution are acceptable. It is also a preferred method in terms of controlling the physical properties of the coating solution to use the ones having a monodisperse particle diameter distribution in mixture of two or more kinds thereof.

In the invention, as the preferred embodiments of the polymer dispersible in an aqueous solvent, hydrophobic polymers such as acrylic polymers, poly(ester)s, rubbers (e.g., SBR resins), poly(urethane)s, poly(vinyl chloride)s, poly(vinyl acetate)s, poly(vinylidene chloride)s, and poly(olefin)s can preferably be used. These polymers may be straight chain polymers or branched chain polymers, and may be cross-linked polymers, so-called homopolymers in which a single kind of monomers are polymerized, or copolymers in which two or more kinds of monomers are polymerized. For a copolymer, it may be either of a random copolymer or a block copolymer. Each molecular weight of these polymers is 5,000 to 1,000,000, and preferably 10,000 to 200,000 in terms of the number average molecular weight. When a polymer having a too small molecular weight is used, the mechanical strength of the resulting emulsion layer is insufficient. When a polymer having a too large molecular weight is used, the film forming properties are inferior. Both of these cases are not preferable. Cross-linkable polymer latexes are in particular preferably used.

(Specific Examples of Latex)

Specific examples of a preferred polymer latex may include the following ones. Below, they are expressed with the raw material monomers. Each numerical value parenthesized denotes the amount in terms of mass %, and the molecular weights are the number average molecular weights. When multi-functional monomers have been used, the concept of molecular weight can not be applied, because crosslinked structures are formed. Accordingly, such a case is described as “crosslinkable” to omit the description of molecular weight. Tg denotes the glass transition temperature.

P-1; Latex of -MMA(70)-EA(27)-MAA(3)-(molecular weight: 37000, Tg: 61° C.)

P-2; Latex of -MMA(70)-2EHA(20)-St(5)-AA(5)-(molecular weight: 40000, Tg: 59° C.)

P-3; Latex of -St(50)-Bu(47)-MAA(3)- (crosslinkable, Tg: −17° C.))

P-4; Latex of -St(68)-Bu(29)-AA(3)- (crosslinkable, Tg: 17° C.))

P-5; Latex of -St(71)-Bu(26)-AA(3)- (crosslinkable, Tg: 24° C.)

P-6; Latex of -St(70)-Bu(27)—IA(3)- (crosslinkable)

P-7; Latex of -St(75)-Bu(24)-AA(1)- (crosslinkable, Tg: 29° C.)

P-8; Latex of -St(60)-Bu(35)-DVB(3)-MAA(2)- (crosslinkable)

P-9; Latex of -St(70)-Bu(25)-DVB(2)-AA(3)- (crosslinkable)

P-10; Latex of -VC(50)-MMA(20)-EA(20)-AN(5)-AA(5)- (molecular weight: 80000)

P-11; Latex of -VDC(85)-MMA(5)-EA(5)-MAA(5)- (molecular weight: 67000)

P-12; Latex of -Et(90)-MAA(10)- (molecular weight: 12000)

P-13; Latex of -St(70)-2EHA(27)-AA(3)- (molecular weight: 130000, Tg: 43° C.))

P-14; Latex of -MMA(63)-EA(35)-AA(2)- (molecular weight: 33000, Tg: 47° C.)

P-15; Latex of -St(70.5)-Bu(26.5)-AA(3)- (crosslinkable, Tg: 23° C.)

P-16; Latex of -St(69.5)-Bu(27.5)-AA(3)- (crosslinkable, Tg: 20.5° C.)

The abbreviations of the above-described structures denote the following monomers. MMA; methyl methacrylate, EA; ethyl acrylate, MAA; methacrylic acid, 2EHA; 2-ethylhexyl acrylate, St; styrene, Bu; butadiene, AA; acrylic acid, DVB; divinylbenzene, VC; vinyl chloride, AN; acrylonitrile, VDC: vinylidene chloride, Et; ethylene, and IA; itaconic acid.

The above-described polymer latexes are also commercially available, and the following polymers are available. Examples thereof may include: acrylic polymers such as CEVIAN A-4635, 4718, and 4601 (all manufactured by DAICEL Chemical Industries, Ltd), and Nipol Lx811, 814, 821, 820, and 857 (all manufactured by Nippon Zeon Co., Ltd.); poly(ester)s such as FINETEX ES650, 611, 675, and 850 (all manufactured by Dai-Nippon Ink & Chemicals, Inc., Ltd.), WD-size, and WMS (both manufactured by Eastman Chemical); poly(urethane)s such as HYDRAN AP10, 20, 30, and 40 (all manufactured by Dai-Nippon Ink & Chemicals, Inc., Ltd.); rubbers such as LACSTAR 7310K, 3307B, 4700H, and 7132C (all manufactured by Dai-Nippon Ink & Chemicals, Inc., Ltd.), and Nipol Lx416, 410, 438, and 2507 (all manufactured by Nippon Zeon Co., Ltd.); poly(vinyl chloride)s such as G351 and G576 (both manufactured by Nippon Zeon Co., Ltd.); poly(vinylidene chloride)s such as L502 and L513 (both manufactured by Asahi Chemical Industry Co., Ltd); and poly(olefin)s such as CHEMIPEARL S120 and SA100 (both manufactured by Mitsui Photochemical Industries Ltd.).

These polymer latexes may be used alone, or if required, in a blend of two or more thereof.

(Preferred Latexes)

As the polymer latex for use in the invention, the latex of a styrene-butadiene copolymer is particularly preferred. The weight ratio of styrene monomer units to butadiene monomer units in the styrene-butadiene copolymer preferably falls within a range of 40:60 to 95:5 by weight. Also preferably, the proportion occupied by the styrene monomer units and the butadiene monomer units in the copolymer is 60 to 99 mass %. The polymer latex of the invention contains an acrylic acid or a methacrylic acid in an amount of preferably 1 to 6 mass %, and more preferably 2 to 5 mass % relative to the sum of the amounts of styrene and butadiene. The polymer latex of the invention preferably contains an acrylic acid.

As the styrene-butadiene-acid copolymer latexes to be preferably used in the invention, mention may be made of the above-mentioned P-3 to P-8, and -15, and commercially available products, LACSTAR-3307B and -7132C, Nipol Lx416, and the like.

To an organic silver salt-containing layer of the photosensitive material of the invention, if required, a hydrophilic polymer such as gelatin, polyvinyl alcohol, methyl cellulose, hydroxypropyl cellulose, or carboxymethyl cellulose may also be added. The amount of the hydrophilic polymer to be added is 30 mass % or less, and more preferably 20 mass % or less based on the total amount of the binder in the organic silver salt-containing layer.

The organic silver salt-containing layer (i.e., image-forming layer) of the invention is preferably the one formed using a polymer latex. The amount of binder in the organic silver salt-containing layer is such that the weight ratio of total binder/organic silver salt falls within a range of 1/10 to 10/1, more preferably in the range of 1/3 to 5/1, and furthermore preferably in the range of 1/1 to 3/1.

Further, such an organic silver salt-containing layer is also, in general, the photosensitive layer (emulsion layer) containing photosensitive silver halide which is a photosensitive silver salt. The weight ratio of total binder/silver halide in such a case is in the range of 400 to 5, and more preferably 200 to 10.

The total amount of binder in the image-forming layer of the invention is in the range of preferably 0.2 to 30 g/m², more preferably 1 to 15 g/m², and furthermore preferably 2 to 10 g/m². To the image-forming layer of the invention, a crosslinking agent for crosslinking, a surfactant for improving the coatability, and the like may also be added.

(Preferred Solvent of Coating Solution)

In the invention, the solvent of the coating solution of an organic silver salt-containing layer of the photosensitive material (herein, for simplification, both solvents and dispersion media are referred to as solvents) is preferably an aqueous solvent containing water in an amount of 30 mass % or more. As a component except for water, a given water-miscible organic solvent such as methyl alcohol, ethyl alcohol, isopropyl alcohol, methyl cellosolve, ethyl cellosolve, dimethylformamide, or ethyl acetate may also be used. The water content of the solvent of the coating solution is preferably 50 mass % or more, and more preferably 70 mass % or more. Preferred examples of the solvent composition include, other than water, water/methyl alcohol=90/10, water/methyl alcohol=70/30, water/methyl alcohol/dimethylformamide=80/15/5, water/methyl alcohol/ethyl cellosolve=80/10/5, and water/methyl alcohol/isopropyl alcohol=85/10/5, (each numerical value is expressed in terms of mass %).

(Explanation of Anti-Fogging Agent)

As anti-fogging agents, stabilizers, and stabilizer precursors usable in the invention, mention may be made of the ones of patent described in paragraph No. 0070 of JP-A NO. 10-62899, and from page 20, line 57 to page 21, line 7 of EP-A No. 0803764, the compounds of JP-A Nos. 9-281637 and 9-329864, and the compounds described in U.S. Pat. No. 6,083,681, and EP-A No. 1048975. The anti-fogging agents to be preferably used in the invention are organic halides. As for these, mention may be made of the ones disclosed in patent described in paragraph Nos. 01110 to 0112 of JP-A No. 11-65021. Particularly preferred are the organic halogen compounds represented by formula (P) in JP-A No. 2000-284399, the organic polyhalogen compounds represented by formula (II) in JP-A No. 10-339934, and the organic polyhalogen compounds described in JP-A Nos. 2001-31644 and 2001-33911.

(Explanation of Polyhalogen Compound)

Below, preferred organic polyhalogen compounds in the invention will be described specifically. The preferred organic polyhalogen compounds in the invention are the compounds represented by the following formula (H):

Q-(Y)n-C(Z₁)(Z₂)X Formula (H)

In formula (H), Q represents an alkyl group, an aryl group, or a heterocyclic group, Y represents a bivalent linking group, n denotes 0 or 1, Z₁ and Z₂ represent halogen atoms, and X represents a hydrogen atom or an electron attracting group.

In formula (H), Q is preferably an aryl group or a heterocyclic group.

In formula (H), when Q is a heterocyclic group, a nitrogen-containing heterocyclic group having one or two nitrogen atoms is preferred, and a 2-pyridyl group and a 2-quinolyl group are particularly preferred.

In formula (H), when Q is an aryl group, Q represents a phenyl group substituted by an electron attracting group in which preferably the Hammet's substituent constant σp takes on a positive value. With regard to Hammett's substituent constant, Journal of Medicinal Chemistry, 1973, Vol. 16, No. 11, pp. 1207 to 1216, or the like can serve as a reference. Examples of such an electron attracting group may include: a halogen atom (fluorine atom (σp value: 0.06), chlorine atom (σp value: 0.23), bromine atom (σp value: 0.23), iodine atom (σp value: 0.18), trihalomethyl groups (tribromomethyl (σp value: 0.29), trichloromethyl (σp value: 0.33), and trifluoromethyl (σp value: 0.54)), a cyano group (σp value: 0.66), a nitro group (σp value: 0.78), an aliphatic-aryl or heterocyclic sulfonyl group (e.g., methanesulfonyl (σp value: 0.72)), an aliphatic-aryl or heterocyclic acyl group (e.g., acetyl (σp value: 0.50), benzoyl (σp value: 0.43), an alkynyl group (e.g., C≡CH (σp value: 0.23)), aliphatic-aryl or heterocyclic oxycarbonyl groups (e.g., methoxycarbonyl (σp value: 0.45) and phenoxycarbonyl (σp value: 0.44)), a carbamoyl group (σp value: 0.36), a sulfamoyl group (σp value: 0.57), a sulfoxide group, a heterocyclic group, and a phosphoryl group. The σp value is preferably in the range from 0.2 to 2.0, and more preferably in the range from 0.4 to 1.0. Particularly preferred electron attracting groups are a carbamoyl group, an alkoxycarbonyl group, an alkylsulfonyl group, and an alkylphosphoryl group. Out of these, a carbamoyl group is most preferred.

X is preferably an electron attracting group, and more preferably a halogen atom, an aliphatic-aryl or heterocyclic sulfonyl group, an aliphatic-aryl or heterocyclic acyl group, an aliphatic-aryl or heterocyclic oxycarbonyl group, a carbamoyl group, or a sulfamoyl group. In particular, a halogen atom is preferred. Out of the halogen atoms, a chlorine atom, a bromine atom, and an iodine atom are preferred, a chlorine atom and a bromine atom are more preferred, and a bromine atom is particularly preferred.

Y preferably represents —C(═O)—, —SO—, or —SO₂—, more preferably C(═O)— or —SO₂—, and in particular preferably —SO₂—. n denotes 0 or 1, and preferably 1.

Below, specific examples of the compound of formula (H) of the invention will be shown.

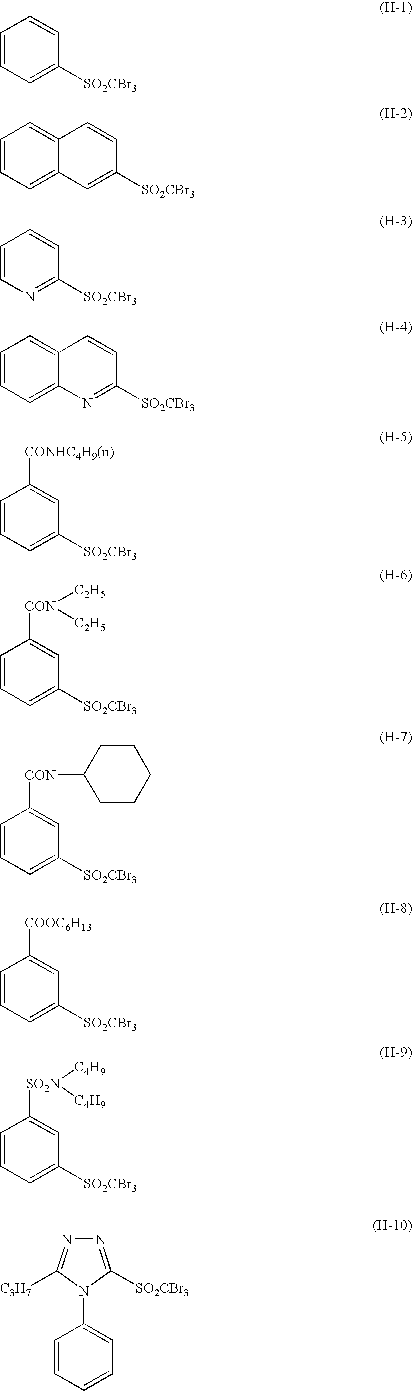

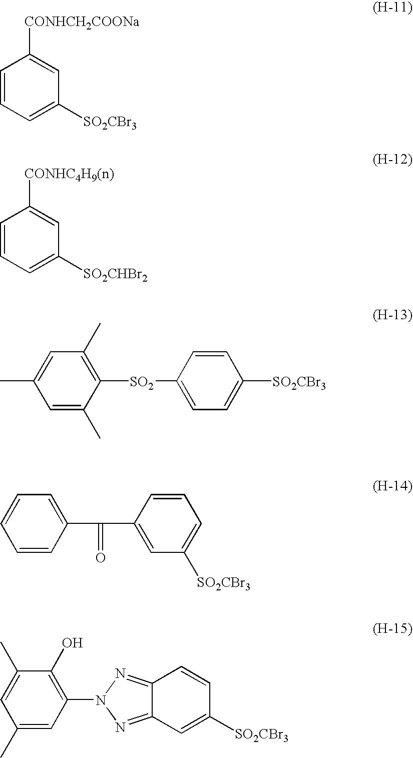

As the preferred polyhalogen compounds of the invention other than the above-described ones, mention may be made of the compounds described in JP-A Nos. 2001-31644, 2001-56526, and 2001-209145.

The compound represented by formula (H) of the invention is used in an amount of, preferably in the range of 10⁻⁴ to 1 mol, more preferably in the range of 10⁻³ to 0.5 mol, and furthermore preferably in the range of 1×10⁻² mol to 0.2 mol per mole of non-photosensitive silver salt in the image-forming layer.

In the invention, as a method for incorporating an anti-fogging agent into a photosensitive material, mention may be made of the method described in connection with the incorporation method of the reducing agent. Also for the organic polyhalogen compound, it is preferably added in the form of a solid fine particle dispersion.

(Other Anti-Fogging Agents)

As other anti-fogging agent, mention may be made of mercury (II) salt in paragraph No. 0113 of JP-A No. 11-65021, benzoic acids in paragraph No. 0114, ibid., salicylic acid derivatives in JP-A No. 2000-206642, formalin scavenger compounds represented by formula (S) in JP-A No. 2000-221634, triazine compounds according to claim 9 of JP-A No. 11-352624, the compounds represented by formula (III) in JP-A No. 6-11791, 4-hydroxy-6-methyl-1,3,3a,7-tetrazaindene, and the like.

The photothermographic material in the invention may contain an azolium salt for the purpose of inhibiting fogging. As the azolium salts, mention may be made of the compounds represented by formula (XI) described in JP-A No. 59-193447, the compounds described in JP-B No. 55-12581, and the compounds represented by formula (II) described in JP-A No. 60-153039. The azolium salt may be added to the photosensitive material at any site. As for the layer to which the salt is added, the azolium salt is preferably added to the layer on the side having a photosensitive layer, and more preferably added to an organic silver salt-containing layer. The timing of adding an azolium salt may be during any steps of the preparation of a coating solution. When the azolium salt is added in the organic silver salt-containing layer, the timing may be during any steps between the preparation of the organic silver salt and the preparation of the coating solution, and it is preferably from after the preparation of the organic silver salt until immediately before coating. The azolium salt may be added by any process in which it is added in the form of a powder, a solution, a fine particle dispersion, or the like. Alternatively, it may also be added in the form of a solution of mixture with other additives such as a sensitizing dye, a reducing agent, and a color toning agent. The amount of the azolium salt to be added in the invention may be any amount. However, it is preferably 1×10⁻⁶ mol or more and 2 mol or less, and more preferably 1×10⁻³ mol or more and 0.5 mol or less per mol of silver.

(Other Additives)

1) Mercapto, Disulfide, and Thiones

The photothermographic material of the invention may contain a mercapto compound, a disulfide compound, or a thione compound in order to inhibit or accelerate development, thereby controlling the development, to enhance the spectral sensitization efficiency, to improve the storage stability before and after development, or for other purposes. Examples thereof include the compounds disclosed in paragraph Nos. 0067 to 0069 of JP-A No. 10-62899, the compounds represented by formula (I), and the specific examples thereof described in paragraph Nos. 0033 to 0052 of JP-A No. 10-186572, and those described on page 20, lines 36 to 56 of EP-A No. 0803764. Out of these, the mercapto-substituted heterocyclic aromatic compounds described in JP-A Nos. 9-297363, 9-304875, 2001-100358, 2002-303954 and 2002-303951 are preferred.

2) Color Toning Agent

In the photothermographic material of the invention, it is preferable to add a color toning agent. The color toning agent is described in paragraph Nos. 0054 to 0055 of JP-A No. 10-62899, on page 21, lines 23 to 48 of EP-A No. 0803764, JP-A Nos. 2000-356317, and 2000-187298. In particular, preferred are phthalazinones (phthalazinone, phthalazinone derivatives, or metal salts; e.g., 4-(1-naphthyl)phthalazinone, 6-chlorophthalazinone, 5,7-dimethoxyphthalazinone, and 2,3-dihydro-1,4-phthalazinedione); combinations of phthalazinones and phthalic acids (e.g., phthalic acid, 4-methylphthalic acid, 4-nitrophthalic acid, diammonium phthalate, sodium phthalate, potassium phthalate, and tetrachlorophthalic anhydride); phthalazines (phthalazine, phthalazine derivatives, or metal salts; e.g., 4-(1-naphthyl) phthalazine, 6-isopropyl phthalazine, 6-t-butyl phthalazine, 6-chlorophthalazine, 5,7-dimethoxy phthalazine, and 2,3-dihydrophthalazine); and combinations of phthalazines and phthalic acids. Particularly, combinations of phthalazines and phthalic acids are preferred. Out of these, a particularly preferred combination is a combination of 6-isopropyl phthalazine and phthalic acid or 4-methylphthalic acid.

3) Plasticizers and Lubricants

The plasticizers and the lubricants usable for the photosensitive layer of the invention are described in paragraph No. 0117 of JP-A No. 11-65021. The slipping agents are described in paragraph Nos. 0061 to 0064 of JP-A No. 11-84573 and in JP-A No. 2001-083679.

4) Dyes and Pigments

For the photosensitive layer of the invention, various dyes and pigments (e.g., C.I. Pigment Blue 60, C.I. Pigment Blue 64, and C.I. Pigment Blue 15:6) can be used from the viewpoints of improving the color tone, preventing the formation of interference fringes during laser exposure, and preventing the irradiation. These are described in details in WO98/36322, and JP-A Nos. 10-268465 and 11-338098.

5) Ultra-Hard Gradation Enhancing Agent

It is preferable to add an ultra-hard gradation enhancing agent to the image forming layer in order to form ultra-hard gradation images suitable for printing plate making. The ultra-hard gradation enhancing agents and the incorporation processes and the amounts thereof are described in paragraph No. 0118 of JP-A No. 11-65021, paragraph Nos. 0136 to 0193 of JP-A No. 11-223898, as the compounds of formula (H), formulae (1) to (3), and formulae (A) and (B) of JP-A No. 2000-284399, and as the compounds of formulae (III) to (V) described in JP-A 2000-347345 (specific compounds: chemical formulae 21 to 24). The ultra-hard gradation enhancement promoters are described in paragraph No. 0102 of JP-A NO. 11-65021, and paragraph Nos. 0194 and 0195 of JP-A No. 11-223898.

In order to use formic acid or a formic acid salt as a strongly fogging substance, it is preferably contained in an amount of 5 mmol or less, and more preferably 1 mmol or less, per mole of silver on the side having the image-forming layer containing a photosensitive silver halide.

When the ultra-hard gradation enhancing agent is used in the photothermographic material of the invention, an acid formed by hydration of diphosphorus pentoxide or a salt thereof is preferably used in combination. Examples of the acid formed by hydration of diphosphorus pentoxide or a salt thereof may include metaphosphoric acid (salt), pyrophosphoric acid (salt), orthophosphoric acid (salt), triphosphoric acid (salt), tetraphosphoric acid (salt), and hexametaphosphoric acid (salt). Examples of acids formed by hydration of diphosphorus pentoxide or salts thereof, to be in particular preferably used may include orthophosphoric acid (salt) and hexametaphosphoric acid (salt). Specific examples of the salt include sodium orthophosphate, sodium dihydrogen orthophosphate, sodium hexametaphosphate, and ammonium hexametaphosphate.

The amount of the acid formed by hydration of diphosphorus pentoxide or a salt thereof to be added (the coating amount per square meter of the photosensitive material) may be a desired amount according to the performances including sensitivity, fog, and the like. However, it is preferably 0.1 to 500 mg/m², and more preferably 0.5 to 100 mg/m².

The reducing agent, the hydrogen bonding compound, the development accelerator, and the polyhalogen compound of the invention are each preferably used in a solid dispersion form. The preferred manufacturing methods of the solid dispersions are described in JP-A No. 2002-55405.

(Preparation and Coating of Coating Solution)

The preparation temperature of the image forming layer coating solution of the invention is desirably 30° C. or more and 65° C. or less, the further preferable temperature is 35° C. or more and less than 60° C., and the more preferable temperature is 35° C. or more and 55° C. or less. The temperature of the image forming layer coating solution immediately after the addition of a polymer latex is preferably kept at 30° C. or more and 65° C. or less.

(Layer Structure and Structural Ingredients)

The image forming layer of the invention may be composed of a single layer or of multiple layers on a support. When it is composed of a single layer, the layer comprises an organic silver salt, a photosensitive silver halide, a reducing agent, and a binder, and if required, contains desired additional materials such as a color toning agent, a coating aid, and other auxiliary agents. When the layer is composed of two or more layers, a first image-forming layer (in many cases, the layer adjacent to the support) contain therein an organic silver salt and a photosensitive silver halide, and a second image-forming layer or the both layers contain therein some other ingredients. A multicolor photosensitive photothermographic material is configured such that it may contain a combination of these two layers for each color, or may contain all ingredients in a single layer as described in U.S. Pat. No. 4,708,928. As for multiple-dye multicolor photosensitive photothermographic material, respective emulsion layers are generally kept in such a relation as to be distinct from each other by using a functional or non-functional barrier layer between the respective photosensitive layers as described in U.S. Pat. No. 4,460,681.

The photothermographic materials of the invention may have non-photosensitive layers in addition to the image forming layers. The non-photosensitive layers can be classified according to their positions into (a) a surface protective layer to be provided on an image forming layer (more distant from the support); (b) an intermediate layer to be provided between a plurality of image forming layers or between an image forming layer and a protective layer; (c) an undercoat layer to be provided between a image forming layer and a support; and (d) a back layer to be provided on the side opposite to the image forming layer.

Further, a layer serving as an optical filter may be provided, and it is provided as the layer (a) or (b). The antihalation layer is provided in the photosensitive material as the layer (c) or (d).

1) Surface Protective Layer

The photothermographic material in the invention may be provided with a surface protective layer for the purpose of preventing adhesion of the image forming layer, and for other purposes. The surface protective layer may be formed in a monolayered structure or in a multilayered structure. The surface protective layer is described in paragraph Nos. 0119 to 0120 of JP-A No. 11-65021, and JP-A No. 2000-171936.

As the binder for the surface protective layer of the invention, gelatin is preferred. It is also preferably to use polyvinyl alcohol (PVA), or to use it in combination. Usable gelatin is inert gelatin (e.g., Nitta gelatin 750), phthalated gelatin (e.g., Nitta gelatin 801), or the like. As PVA, mention may be made of the ones described in paragraph Nos. 0009 to 0020 of JP-A No. 2000-171936. Preferably, mention may be made of PVA-105 of a completely saponified product, PVA-205 and PVA-335 of partially saponified products, and MP-203 of modified polyvinyl alcohol (all are trade names from Kuraray Co., Ltd.), and the like. The coating amount (per square meter of the support) of polyvinyl alcohol of the protective layer (per one layer) is preferably 0.3 to 4.0 g/m², and more preferably 0.3 to 2.0 g/m².

The coating amount (per square meter of the support) of the whole binder (including a water-soluble polymer and a latex polymer) of the surface protective layer (per one layer) is preferably 0.3 to 5.0 g/m², and more preferably 0.3 to 2.0 g/m².

2) Antihalation Layer

In the photothermographic material of the invention, an antihalation layer can be disposed in a more distant position from a light source relative to the photosensitive layer.

The antihalation layer is described in paragraph Nos. 0123 to 0124 of JP-A No. 11-65021, JP-A Nos. 11-223898, 9-230531, 10-36695, 10-104779, 11-231457, 11-352625, and 11-352626, and the like.

The antihalation layer contains an antihalation dye having an absorption in the exposure wavelength. When the exposure wavelength falls within the infrared region, an infrared-absorbing dye is desirably used. In such a case, the dye having no absorption in the visible region is preferred.

When antihalation is achieved using a dye having an absorption in the visible region, it is preferably configured such that the color of the dye will not substantially remain after image formation; a means for performing decolorizing by the heat from heat development is preferably used; and in particular, a heat decolorizable dye and a base precursor are preferably added to a non-photosensitive layer so that the layer functions as an antihalation layer. These techniques are described in JP-A No. 11-231457, and the like.

The amount of the decolorizable dye to be added is determined according to the intended purpose of the dye. In general, the dye is used in an amount such that the optical density (absorbance) measured at an intended wavelength is more than 0.1. The optical density is preferably 0.15 to 2, and more preferably 0.2 to 1. The amount of the dye to be used for obtaining such an optical density is generally about 0.001 to about 1 g/m².

Incidentally, when the dye is decolorized in this manner, it is possible to lower the optical density after heat development to 0.1 or less. Two or more kinds of decolorizable dyes may also be used in combination in the heat decolorizing type recording materials or the photothermographic materials. Similarly, two or more kinds of base precursors may also be used in combination.

In heat decolorization using such a decolorizable dye and the base precursor, it is preferable to use a substance (e.g., diphenylsulfone, or 4-chlorophenyl (phenyl) sulfone) which decreases the melting point by 3° C. or more when mixed with the base precursor as described in JP-A No. 11-352626, 2-naphtyl benzoate, or the like, in combination, from the viewpoint of the heat decolorization property, and the like.

3) Back Layer

The back layer applicable to the invention is described in paragraph Nos. 0128 to 0130 of JP-A No. 11-65021.

In the invention, a coloring agent having an absorption maximum at 300 to 450 nm can be added for the purposes of improving the silver color tone, and the change with time of images. Such coloring agents are described in JP-A Nos. 62-210458, 63-104046, 63-103235, 63-208846, 63-306436, 63-314535, 01-61745, and 2001-100363, and the like.

Such a coloring agent is generally added in an amount in the range of 0.1 mg/m² to 1 g/m². As a layer to which it is added, a back layer disposed on the opposite side of the photosensitive layer is preferred.

Dyes each having an absorption peak at 580 to 680 nm is preferably used in order to control the base color tone. The dyes for this purpose are preferably azomethine type oil-soluble dyes described in JP-A Nos. 4-359967 and 4-359968, and phthalocyanine type water-soluble dyes described in JP-A No. 2003-295388, each having a small absorption intensity on the shorter wavelength side. The dyes for this purpose may be added to any of the layers. However, they are preferably added to the non-photosensitive layer on the emulsion surface side or the layer on the back surface side.

The photothermographic material in the invention is preferably a so-called one-sided photosensitive material having at least one layer of a photosensitive layer containing a silver halide emulsion on one side of the support and having a back layer on the other side.

4) Matting Agent

In the invention, it is preferable to add a matting agent for improving the transportability. The matting agents are described in paragraph Nos. 0126 to 0127 of JP-A No. 11-65021. The matting agent is coated in an amount of preferably 1 to 400 mg/m², and more preferably 5 to 300 mg/m² when expressed in terms of the coating amount per square meter of the photosensitive material.

In the invention, the matting agent may be shaped either in a definite form or in an indefinite form. However, it is preferably shaped in a definite form, and the spherical form is preferably employed. The average particle diameter is in the range of preferably 0.5 to 10 μm, more preferably 1.0 to 8.0 μm, and furthermore preferably 2.0 to 6.0 μm. The variation coefficient of the size distribution is preferably 50% or less, more preferably 40% or less, and furthermore preferably 30% or less. Herein, the variation coefficient denotes the value expressed as: (Standard deviation of particle diameter)/(average value of particle diameter)×100. Further, it is also preferable to use two kinds of matting agents each having a small variation coefficient, and an average particle diameter ratio of more than 3 in combination.

Further, any matting degree of the emulsion surface is acceptable so long as stardust defects will not occur. However, Bekk smoothness is preferably 30 seconds or more and 2000 seconds or less, and in particular preferably 40 seconds or more and 1500 seconds or less. Bekk smoothness can be determined with ease by Japanese Industrial Standard (JIS) P8119: “Testing Method for Smoothness of Paper and Paperboard by Bekk Tester” and TAPPI Standard Method T479.

As the matting degree of the back layer in the invention, the Bekk smoothness is preferably 1200 seconds or less and 10 seconds or more, more preferably 800 seconds or less and 20 seconds or more, and furthermore preferably 500 seconds or less and 40 seconds or more.

In the invention, the matting agent is preferably contained in the outermost surface layer or a layer functioning as the outermost surface layer of the photosensitive material, or in a layer near the outer surface thereof, or preferably contained in a layer serving as a so-called protective layer.

5) Polymer Latex

When the photothermographic material of the invention is used for printing use in which dimensional change is critical, polymer latex is preferably used in a surface protective layer or a back layer. Such a polymer latex is described in Gosei Jushi Emulsion, compiled by Taira Okuda and Hiroshi Inagaki, issued by Kobunshi Kanko Kai (1978); Gosei Latex no Oyo, compiled by Takaaki Sugimura, Yasuo Kataoka, Souichi Suzuki, and Keishi Kasahara, issued by Kobunshi Kanko Kai (1993); Gosei Latekkusu no Kagaku (written by Soichi Muroi, issued by Kobunshi Kanko Kai (1970)), and the like. Specific examples thereof may include latex of methyl methacrylate (33.5 mass %)/ethyl acrylate (50 mass %)/methacrylic acid (16.5 mass %) copolymer, latex of methyl methacrylate (47.5 mass %)/butadiene (47.5 mass %)/itaconic acid (5 mass %) copolymer, latex of ethyl acrylate/methacrylic acid copolymer, latex of methyl methacrylate (58.9 mass %)/2-ethylhexyl acrylate (25.4 mass %)/styrene (8.6 mass %)/2-hydroxyethyl methacrylate (5.1 mass %)/acrylic acid (2.0 mass %) copolymer, and latex of methyl methacrylate (64.0 mass %)/styrene (9.0 mass %)/butyl acrylate (20.0 mass %)/2-hydroxyethyl methacrylate (5.0 mass %)/acrylic acid (2.0 mass %) copolymer. Further, as the binder for the surface protective layer, the combination of polymer latexes described in JP-A 2000-267226, the technique described in paragraph Nos. 0021 to 0025 of JP-A No. 2000-267226, the technique described in JP-A 2000-267226, and the technique described paragraph Nos. 0023 to 0041 of JP-A No. 2000-19678 may also be applied. The ratio of the polymer latex of the surface protective layer is preferably 10 mass % or more and 90 mass % or less, and in particular preferably 20 mass % or more and 80 mass % or less based on the total amount of binder.

6) Film Surface pH

The photothermographic material of the invention preferably has a film surface pH of 7.0 or less, and more preferably 6.6 or less, before heat development processing. The film surface pH has no particular restriction on the lower limit, but it is about 3. The pH is most preferably in the range of 4 to 6.2. For controlling the film surface pH, an organic acid such as a phthalic acid derivative or a nonvolatile acid such as sulfuric acid, and a volatile base such as ammonia are preferably used from the viewpoint of reducing the film surface pH. In particular, ammonia is preferred to achieve a low film surface pH, because it tends to volatilize, and therefore it can be removed before the coating step or heat development.

The process in which a nonvolatile base such as sodium hydroxide, potassium hydroxide, or lithium hydroxide and ammonia are used in combination is also preferably employed. Incidentally, a method for measuring the film surface pH is described in paragraph No. 0123 of JP-A No. 2000-284399.

7) Hardening Agent

A hardening agent may also be used for respective layers such as the photosensitive layer, the protective layer, and the back layer of the invention. Examples of the hardening agent are mentioned in each method described in, THE THEORY OF THE PHOTOGRAPHIC PROCESS, FOURTH EDITION, written by T. H. James, (published by Macmillan Publishing Co., Inc., published in 1977, pp. 77-87). Other than chrome alum, 2,4-dichloro-6-hydroxy-s-triazine sodium salt, N,N-ethylenebis(vinylsulfonacetamide), and N,N-propylenebis(vinylsulfonacetamide), the polyvalent metal ions described on page 78 of the above article, and the like, polyisocyanates described in U.S. Pat. No. 4,281,060 and JP-A No. 6-208193; epoxy compounds described in U.S. Pat. No. 4,791,042; vinylsulfone type compounds described in JP-A No. 62-89048 and the like may preferably be used.

The hardening agent is added in the form of a solution. The timing of adding the solution into a protective layer coating solution is from 180 minutes before to immediately before coating, and preferably from 60 minutes before to 10 seconds before coating. However, there is no particular restriction as to the mixing process and the mixing conditions so long as the effects of the invention satisfactorily occur. As a specific mixing process, there are a method in which the mixing is performed in a tank configured such that the mean residence time therein calculated from the addition flow rate and the feeding amount to a coater becomes a desirable time; and a method using a static mixer described in Chapter 8 of Ekitai Kongo Gijutsu written by N. Harnby, M. F. Edwards, and A. W. Nienow, translated by Koji Takahashi, (published by Nikkan Kogyo Shinbunsha, 1989), and the like.

8) Surfactant

The surfactants applicable to the invention are described in paragraph No. 0132 of JP-A No. 11-65021; the solvents, in paragraph No. 0133 of the same publication; the support, in paragraph No. 0134 of the same publication; the antistatic or conductive layer, in paragraph No. 0135 of the same publication; the method for obtaining color images, in paragraph No. 0136 of the same publication; and the slipping agents, in paragraph Nos. 0061 to 0064 of JP-A No. 11-84573, and in JP-A No. 2001-083679.

In the invention, a fluorine-containing surfactant is preferably used. Specific examples of the fluorine-containing surfactant may include the compounds described in JP-A Nos. 10-197985, 2000-19680, and 2000-214554. Further, the polymer fluorine-containing surfactants described in JP-A No. 9-281636 is also preferably used. For the photothermographic material of the invention, the fluorine-containing surfactants described in JP-A Nos. 2002-82411, 2003-057780 and 2003-149766 are preferably used. In particular, the fluorine-containing surfactants described in JP-A Nos. 2003-057780 and 2003-149766 are preferred in terms of the charging control ability, the stability of the coated surface conditions, and the slipping property when coated in the form of an aqueous coating solution for production. The fluorine-containing surfactants described in JP-A No. 2003-149766 are most preferred in terms of its high charging control ability and small required amount.

In the invention, the fluorine-containing surfactant can be used on either side of the emulsion surface and the back surface, and preferably used on both the surface sides. Further, it is in particular preferably used in combination with the above-described conductive layer containing the metal oxide. In this case, even when the amount of the fluorine-containing surfactant to be used for the side having the conductive layer is reduced or nulled, it is possible to obtain satisfactory performances.

The fluorine-containing surfactant is used in an amount preferably in the range of 0.1 mg/m² to 100 mg/m², more preferably in the range of 0.3 mg/m² to 30 mg/m², and furthermore preferably in the range of 1 mg/m² to 10 mg/m², respectively for the emulsion surface and the back surface. In particular, the fluorine-containing surfactants described in JP-A 2003-149766 produce large effects, so that each of them is used in an amount of preferably in the range of 0.01 mg/m² to 10 mg/m², and more preferably in the range of 0.1 mg/m² to 5 mg/m².

9) Antistatic Agent

In the invention, the photothermographic material preferably has a conductive layer containing a metal oxide or a conductive polymer. An antistatic layer may also serve as an undercoat layer, a back layer surface protective layer, or the like, or may also be separately provided. As the conductive material of the antistatic layer, a metal oxide increased in conductivity by introducing an oxygen defect or a different kind of metal atoms in the metal oxide is preferably used. Preferred examples of the metal oxide include ZnO, TiO₂, and SnO₂. Addition of Al or In to ZnO, addition of Sb, Nb, P, a halogen element, or the like to SnO₂, addition of Nb, Ta, or the like to TiO₂ are preferred. In particular, SnO₂ incorporated with Sb is preferred. The amount of a different kind of atoms is preferably in the range of 0.01 to 30 mol %, and more preferably in the range of 0.1 to 10 mol %. The metal oxide may be shaped in any of the forms of sphere, needle, and tablet. However, a needle-shaped particles each having a ratio of the major axis/the minor axis of 2.0 or more, and preferably 3.0 to 50 are desirable in terms of the effect of imparting the conductivity. The amount of the metal oxide to be added is preferably in the range of 1 mg/m² to 1000 mg/m², more preferably in the range of 10 mg/m² to 500 mg/m², and furthermore preferably in the range of 20 mg/m² to 200 mg/m². The antistatic layer of the invention may be disposed on any of the emulsion surface side and the back surface side. However, it is preferably disposed between the support and the back layer. The specific examples of the antistatic layer of the invention are described in paragraph No. 0135 of JP-A No. 11-65021, JP-A Nos. 56-143430, 56-143431, 58-62646, and 56-120519, paragraph Nos. 0040 to 0051 of JP-A No. 11-84573, U.S. Pat. No. 5,575,957, and paragraph Nos. 0078 to 0084 of JP-A No. 11-223898.

10) Support

For a transparent support, polyester, in particular, polyethylene terephthalate, subjected to a heat treatment at a temperature in the range of 130 to 185° C. is preferably used in order to relax the internal distortion remaining in the film during the biaxial stretching, and thereby to eliminate the thermal shrinkage distortion occurring during the heat development treatment. As for the photothermographic material for medical use, the transparent support may be colored by a blue dye (e.g., Dye-1 described in Example of JP-A No. 8-240877), or may be colorless. To the support, the undercoating techniques of the water-soluble polyester of JP-A No. 11-84574, the styrene-butadiene copolymer of JP-A No. 10-186565, the vinylidene chloride copolymer of JP-A Nos. 2000-39684 and 2001-083679, and the like are preferably applied. The water content of the support is preferably 0.5 wt % or less when the emulsion layer or the back layer is coated onto the support.

11) Other Additives

To the photothermographic material, further, an antioxidant, a stabilizer, a plasticizer, a UV absorber, or a coating aid may also be added. Various additives are added to any of photosensitive layers or non-photosensitive layers. With regard to these, WO 98/36322, EP-A No. 803764, JP-A Nos. 10-186567 and 10-18568, and the like can serve as references.

12) Coating Method

The photothermographic material in the invention may be coated by any method. Specifically, various coating operations including: extrusion coating, slide coating, curtain coating, dip coating, knife coating, flow coating, and extrusion coating using a hopper of the type described in U.S. Pat. No. 2,681,294 are used. Extrusion coating or slide coating described in LIQUID FILM COATING, written by Stephen F. Kistler, and Petert M. Schweizer, (published by CHAPMAN & HALL Co., Ltd., 1997), pp. 399 to 536 are preferably used. In particular, slide coating is preferably used. An example of the shape of a slide coater for use in the slide coating is shown in FIG. 11b. 1, on page 427 of the same reference. If desired, two layers or more layers may be formed at the same time with the method described from page 399 to page 536 of the same reference, and the methods described in U.S. Pat. No. 2,761,791 and GB No. 837,095. In the invention, the particularly preferred coating methods are the methods described in JP-A Nos. 2001-194748, 2002-153808, 2002-153803, and 2002-182333.

The organic silver salt-containing layer coating solution in the invention is preferably a so-called thixotropy fluid. With regard to this technique, JP-A No. 11-52509 can serve as a reference. The organic silver salt-containing layer coating solution in the invention has a viscosity at a shear rate of 0.1 S⁻¹ of preferably 400 mPa·s or more and 100,000 mPa·s or less, and more preferably 500 mPa·s or more and 20,000 mPa·s or less. At a shear rate of 1000 S-1, the viscosity is preferably 1 mPa·s or more and 200 mPa·s or less, and more preferably 5 mPa·s or more and 80 mPa·s or less.

When the coating solutions of the invention are prepared, known inline mixers or in-plant mixers are preferably used for mixing two types of solutions. The preferred inline mixers and in-plant mixers in the invention are described in JP-A Nos. 2002-85948 and 2002-90940, respectively.

The coating solution in the invention is preferably subjected to a defoaming treatment for keeping the resulting coated surface conditions favorable. The preferred defoaming treatment method of the invention is the method described in JP-A No. 2002-66431.

When the coating solution of the invention is coated, electric charge removal is preferably carried out in order to prevent the deposition of dust, dirt, and the like due to the charging of the support. In the invention, preferred examples of the charge removal method are described in JP-A No. 2002-143747.

In the invention, it is important to control the drying air and the drying temperature with precision in order to dry a non-setting image forming layer coating solution. The preferred drying methods in the invention are described in details in JP-A Nos. 2001-194749 and 2002-139814.

The photothermographic material of the invention is preferably heat treated immediately after coating and drying in order to improve the film-forming property. The temperature of the heat treatment is preferably within the range of 60° C. to 100° C. in terms of the film surface temperature, and the heating time is preferably within 1 second to 60 seconds. The more preferred ranges are 70 to 90° C. for the film surface temperature, and 2 to 10 seconds for the heating time. The preferred heat treatment methods of the invention are described in JP-A No. 2002-107872.

The manufacturing methods described in JP-A Nos. 2002-156728 and 2002-182333 are preferably used in order to continuously manufacture the photothermographic materials of the invention with stability.

The photothermographic material is preferably of a mono-sheet type (the type capable of forming images on the photothermographic material without using other sheets such as an image-receiving material).

13) Packaging Material

The photosensitive material of the invention is preferably packaged in a packaging material with a low oxygen permeability and/or moisture permeability in order to suppress the fluctuations in photographic performances during unprocessed stock storage, or in order to improve curling or rolling habit. The oxygen permeability is preferably 50 ml/atm·m²·day or less, more preferably 10 ml/atm·m²·day or less, and furthermore preferably 1.0 ml/atm·m²·day or less at 25° C. The moisture permeability is preferably 10 g/atm·m²·day or less, more preferably 5 g/atm·m²·day or less, and furthermore preferably 1 g/atm·m²·day or less.

Specific examples of the packaging material with a low oxygen permeability and/or moisture permeability are the packaging materials described in, for example, JP-A Nos. 8-254793 and 2000-206653.

14) Other Applicable Techniques

As the techniques usable for the photothermographic material of the invention, mention may also be made of: EP-A Nos. 803764 and 883022, WO98/36322, JP-A Nos. 56-62648, 58-62644, 9-43766, 9-281637, 9-297367, 9-304869, 9-311405, 9-329865, 10-10669, 10-62899, 10-69023, 10-186568, 10-90823, 10-171063, 10-186565, 10-186567, 10-186569 to 10-186572, 10-197974, 10-197982, 10-197983, 10-197985 to 10-197987, 10-207001, 10-207004, 10-221807, 10-282601, 10-288823, 10-288824, 10-307365, 10-312038, 10-339934, 11-7100, 11-15105, 11-24200, 11-24201, 11-30832, 11-84574, 11-65021, 11-109547, 11-125880, 11-129629, 11-133536 to 11-133539, 11-133542, 11-133543, 11-223898, 11-352627, 11-305377, 11-305378, 11-305384, 11-305380, 11-316435, 11-327076, 11-338096, 11-338098, 11-338099, 11-343420, 2000-187298, 2000-10229, 2000-47345, 2000-206642, 2000-98530, 2000-98531, 2000-112059, 2000-112060, 2000-112104, 2000-112064, and 2000-171936.

As for multicolor photothermographic material, respective emulsion layers are kept in such a relation as to be distinct from each other by using a functional or non-functional barrier layer between the respective photosensitive layers as described in U.S. Pat. No. 4,460,681.

A multicolor photothermographic material is configured such that it may contain a combination of these two layers for each color, or may contain all ingredients in a single layer as described in U.S. Pat. No. 4,708,928.

(Image Forming Method)

1) Exposure

The photosensitive material of the invention may be exposed with any method. However, it is preferably subjected to scanning exposure by a laser light. Lasers usable for the laser light are a He—Ne laser for red to infrared emission, a red semiconductor laser, an Ar⁺, He—Ne, and He—Cd lasers for blue to green emission, or a blue semiconductor laser. They are preferably red to infrared semiconductor lasers. The peak wavelength of the laser light falls within 600 nm to 900 nm, and preferably 620 nm to 850 nm. On the other hand, in recent years, particularly, a module integrally comprising a SHG (second harmonic generator) device and a semiconductor laser and a blue semiconductor laser have been developed, and a laser output apparatus for a short wavelength region has become a focus of attention. A blue semiconductor laser is capable of high definition image recording, the increase in recording density, and providing a long-life and stable output, and hence it is expected to grow in demand toward the future.

The laser light in particular preferably usable in the invention is the laser light from a blue semiconductor laser. The emission peak wavelength is 300 nm to 500 nm, preferably 350 nm to 450 nm, and more preferably 390 nm to 430 nm.

The laser light oscillated in longitudinal multimode by a process of high frequency superposition or the like is also preferably used.

2) Heat Development

The photothermographic material of the invention may be developed in any manner. However, in general, the imagewise exposed photothermographic material is developed by heating. The preferred development temperature is 80 to 250° C., preferably 100 to 140° C., and further preferably 110 to 130° C. The development time is preferably 1 to 60 seconds, more preferably 3 to 30 seconds, and furthermore preferably 5 to 15 seconds.

As a system for heat development, any of a drum type heater and a plate type heater may be used. However, the plate heater system is more preferred. For a heat development system by the plate heater system, the method described in JP-A No. 11-133572 is preferred. The system is a heat development apparatus whereby a photothermographic material on which a latent image has been formed is brought into contact with a heating unit in a heat development unit to obtain a visible image. The heat development apparatus is characterized in that the heating unit comprises a plate heater, a plurality of presser rollers are disposed along one surface of the plate heater and in positions opposite thereto, and that heat development is performed by allowing the photothermographic material to pass between the pressing rollers and the plate heater. Preferably, the plate heater is sectioned into 2 to 6 stages, and the tip is reduced in temperature by about 1 to 10° C. For example, mention may be made of the example in which 4 sets of plate heaters capable of independent temperature control are used, and the respective heaters are controlled so as to be at 112° C., 119° C., 121° C., and 120° C. Such a method is also described in JP-A No. 54-30032. This can remove the moisture and the organic solvent contained in the photothermographic material out of the system, and can suppress the change in shape of the support of the photothermographic material caused by rapidly heating the photothermographic material.

A heat development apparatus is preferably capable of more stable heater control for the size reduction thereof and the shortening of the heat development time. Further, desirably, exposure of one sheet of a sensitive material is started from the front end, and heat development is started before the completion of the exposure to the rear end. Preferred imagers capable of rapid processing in the invention are described in, for example, JP-A Nos. 2002-289804 and 2002-287668.

3) System

As a laser imager having an exposure part and a heat development part for the medical use, Fuji Medical Dry Laser Imager FM-DP L or DryPIX7000 can be mentioned. FM-DP L are described in Fuji Medical Review No. 8, pp. 39 to 55. It is needless to say that these techniques are applicable to the laser imager for the photothermographic material of the invention. These techniques are also applicable as the photothermographic material for the laser imager in “AD network” proposed by Fuji Medical Ltd., as a network system adapted to the DICOM Standards.

The photothermographic material of the invention forms a black and white image based on a silver image. It is preferably used as a photothermographic material for the medical diagnosis, as a photothermographic material for the industrial photography, as a photothermographic material for the printing use, and as a photothermographic material for the COM use.

Below, embodiments of the invention will be shown.

A first embodiment of the invention is a photothermographic material, comprising a support; an image forming layer disposed on the support and containing a photosensitive silver halide, a non-photosensitive organic silver salt, a reducing agent, and a binder; and a silver-saving agent, wherein silver iodide is contained in the photosensitive silver halide in an amount of 40 to 100 mol %.

A second embodiment of the invention is the photothermographic material according to the first embodiment, wherein the image forming layer has a multilayered structure comprising at least a first image forming layer and a second image forming layer, and at least the first image forming layer contains the silver-saving agent, and the second image forming layer does not contain the silver-saving agent.

A third embodiment of the invention is the photothermographic material according to the second embodiment, wherein the first image forming layer containing the silver-saving agent is disposed closer to the support, and the second image forming layer not containing the silver-saving agent is disposed more distant from the support.

A fourth embodiment of the invention is the photothermographic material according to the second embodiment, wherein the first image forming layer containing the silver-saving agent is disposed more distant from the support, and the second image forming layer not containing the silver-saving agent is disposed closer to the support.

A fifth embodiment of the invention is the photothermographic material according to any of the first to fourth embodiments, wherein the image gradation obtained by heat development is 2 to 4.

A sixth embodiment of the invention is the photothermographic material according to any of the first to fifth embodiments, wherein the reducing agent contains a compound represented by the following formula (R):

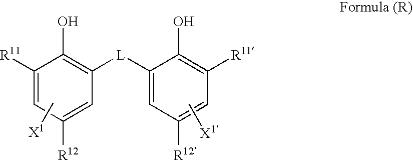

wherein R¹¹ and R^{11′} each independently represent an alkyl group having 3 to 20 carbon atoms, in which a carbon atom bonding with a benzene ring is secondary or tertiary; R¹² and R^{12′} each independently represent a hydrogen atom or a group capable of being substituted on the benzene ring; L represents —S— or —CHR¹³—; R¹³ represents a hydrogen atom or an alkyl group having 1 to 20 carbon atoms; and X¹ and X¹ each independently represent a hydrogen atom or a group capable of being substituted on the benzene ring.

A seventh embodiment of the invention is the photothermographic material according to any of the first to sixth embodiments, further containing a development accelerator.

An eighth embodiment of the invention is the photothermographic material according to any of the first to seventh embodiments, wherein the photothermographic material is capable of being exposed by a laser light source.

A ninth embodiment of the invention is the photothermographic material according to the eighth embodiment, wherein the laser light source has a wavelength of 350 nm to 450 nm.

A tenth embodiment of the invention is the photothermographic material according to the eighth or ninth embodiment, wherein the laser light source is a blue semiconductor laser.

### EXAMPLES

Below, the invention will be described specifically by way of examples, which should not be construed as limiting the scope of the invention.

### Example 1

1. Preparation of PET Support

1) Film Formation

PET having an intrinsic viscosity IV=0.66 (measured at 25° C. in phenol/tetrachloroethane=6/4 (weight ratio)) was obtained according to an ordinary method by using terephthalic acid and ethylene glycol. This was pelletized, and then dried at 130° C. for 4 hours, followed by melting at 300° C. Then, the molten PET was extruded through a T-die, and cooled rapidly to prepare an unstreched film having such a thickness as to provide a film thickness after heat fixing of 175 μm.

Using rolls different in circumferential speed, this was longitudinally stretched to 3.3 times, and then laterally stretched to 4.5 times by means of a tenter. The temperatures at this step were 110° C. and 130° C., respectively. Thereafter, the stretched film was thermally fixed at 240° C. for 20 seconds, and then subjected to relaxation in the lateral direction by 4% at the same temperature. Then, after slitting the chuck portion of the tenter, the opposite ends were subjected to knurl processing, and the film was wound at 4 kg/cm² to obtain a 175 μm-thick roll.

2) Surface Corona Discharge Treatment

Using a 6-KVA model of solid state corona treatment apparatus manufactured by Pillar Corporation, the opposite surfaces of the support were treated at 20 m/minute under room temperature. From the read values of current and voltage at this step, it was confirmed that the support was treated at 0.375 kV·A·minute/m². The treatment frequency at this step was 9.6 kHz, and the gap clearance between the electrode and a dielectric roll was 1.6 mm.

3) Undercoating
<Preparation of undercoat layer coating solution>
Formulation (1) (for undercoat layer on the photosensitive layer side)

| | | |
|---|---|---|
| PESRESIN A-520 (30 mass % solution) manufactured by | 59 | g |
| Takamatsu Oil & Fat Co., Ltd. | | |
| Polyethylene glycol monononylphenyl ether (average | 5.4 | g |
| ethylene oxide number = 8.5) 10 mass % solution | | |
| MP-1000 (polymer fine particles, average particle diameter = | 0.91 | g |
| 0.4 μm), manufactured by Soken Chemical & | | |
| Engineering Co., Ltd.) | | |
| Distilled water | 935 | ml |

Formulation (2) (for a first layer on the back surface side)

| | | |
|---|---|---|
| Styrene-butadiene copolymer latex (solid content: 40 | 158 | g |
| mass %, styrene/butadiene weight ratio = 68/32) | | |
| 2,4-Dichloro-6-hydroxy-S-triazine sodium salt 8 mass % | 20 | g |
| aqueous solution | | |
| 1 mass % aqueous solution of sodium | 10 | ml |
| laurylbenzenesulfonate | | |
| Distilled water | 854 | ml |

Formulation (3) (for a second layer on the back surface side)

| | | |
|---|---|---|
| SnO₂/SbO (9/1 mass ratio, average particle diameter: | 84 | g |
| 0.038 μm, 17 mass % dispersion) | | |
| Gelatin (10 mass % aqueous solution) | 89.2 | g |
| METOLOSE TC-5 (2 mass % aqueous solution) | 8.6 | g |
| manufactured by Shin-Etsu Chemical Co., Ltd. | | |
| MP-1000 manufactured by Soken Chemical & Engineering | 0.01 | g |
| Co., Ltd. | | |
| 1 mass % aqueous solution of sodium | 10 | ml |
| dodecylbenzenesulfonate | | |
| NaOH (1 mass %) | 6 | ml |
| Proxel (manufactured by ICI Co.) | 1 | ml |
| Distilled water | 805 | ml |

Both surfaces of the 175 μm-thick biaxially stretched polyethylene terephthalate support were respectively subjected to the corona discharge treatment. Then, one surface (photosensitive layer side) thereof was coated with the undercoating solution formulation (1) by a wire bar in a wet coating amount of 6.6 ml/m² (per side), and dried at 180° C. for 5 minutes. Then, the back surface (back side) thereof was coated with the undercoating solution formulation (2) by a wire bar in a wet coating amount of 5.7 ml/m², and dried at 180° C. for 5 minutes. The back surface (back side) was further coated with the undercoating solution formulation (3) by a wire bar in a wet coating amount of 7.7 ml/m², and dried at 180° C. for 6 minutes to prepare an undercoated support.

2. Back Layer

1) Preparation of Back Surface Coating Solution

<Preparation of Antihalation Layer Coating Solution>

60 g of gelatin, 24.5 g of polyacrylamide, 2.2 g of 1 mol/l sodium hydroxide, 2.4 g of monodispersed polymethyl methacrylate fine particles (average particle size 8 μm, particle diameter standard deviation 0.4), 0.08 g of benzisothiazolinone, 0.3 g of sodium polystyrene sulfonate, 0.21 g of Blue dye compound-1, 6.8 g of Ultraviolet absorber-1, and 8.3 g of an acrylic acid/ethyl acrylate copolymer latex (copolymerization ratio 5/95) were mixed. Water was added thereto to make the total volume 818 ml, thereby to prepare an antihalation layer coating solution.

(Preparation of Back-Side Protective Layer Coating Solution)

In a vessel kept at 40° C., 40 g of gelatin, a liquid paraffin emulsion in an amount of 1.5 g in terms of liquid paraffin, 35 mg of benzisothiazolinone, 6.8 g of caustic soda with a concentration of 1 mol/L, 0.5 g of sodium t-octylphenoxyethoxyethanesulfonate, 0.27 g of sodium polystyrenesulfonate, 5.4 mg of a 2% aqueous solution of Fluorinecontaining surfactant (F-1), 6.0 g of an acrylic acid/ethyl acrylate copolymer (copolymerization weight ratio: 5/95), and 2.0 g of N,N-ethylenebis(vinyl sulfonamide) were mixed. The resulting mixture was diluted to 1000 ml with water, resulting in a back side protective layer coating solution.

2) Coating of Back Layer

On the back surface side of the undercoated support, the antihalation layer coating solution and the back-side protective layer coating solution were simultaneously coated in multilayer so that the gelatin coating amount became 0.88 g/m² and the gelatin coating amount became 1.2 g/m², respectively, and dried, to prepare a back layer.

3. Image Forming Layer, Intermediate Layer, and Surface Protective Layer

3-1. Preparation of Coating Materials

1) Preparation of Silver halide Emulsion

(Preparation of Silver Halide Emulsion 1)

To 1420 ml of distilled water, 4.3 ml of a 1 mass % potassium iodide solution was added, and further, 3.5 ml of sulfuric acid with a concentration of 0.5 mol/L and 36.7 g of phthalated gelatin were added. The resulting solution was kept at a temperature of 42° C. with stirring in a reaction jar made of stainless steel. Solution A was prepared by diluting 22.22 g of silver nitrate with the addition of distilled water to 195.6 ml, and Solution B was prepared by diluting 21.8 g of potassium iodide with the addition of distilled water to a volume of 218 ml. The whole amount of Solutions A and B were added thereto at a constant flow rate over 9 minutes. Then, 10 ml of a 3.5 mass % hydrogen peroxide aqueous solution was added thereto, and further, 10.8 ml of a 10 mass % aqueous solution of benzimidazole was added thereto.

Further, Solution C was prepared by diluting 51.86 g of silver nitrate with the addition of distilled water to 317.5 ml, and Solution D was prepared by diluting 60 g of potassium iodide to a volume of 600 ml with distilled water. The whole amount of Solution C was added at a given flow rate over 120 minutes. Solution D was added while keeping the pAg at 8.1 with a controlled double jet method. Potassium hexachloroiridate (III) was added in an amount of 1×10⁻⁴ mol per mole of silver all at once after 10 minutes from the start of addition of Solutions C and D. An aqueous solution of potassium iron (II) hexacyanide was added in an amount of 3×10⁻⁴ mol per mole of silver all at once after 5 seconds from the completion of addition of Solution C. The pH was adjusted to 3.8 using sulfuric acid with a concentration of 0.5 mol/L, and stirring was stopped. Then, steps of sedimentation/desalting/washing with water were carried out. The resulting mixture was adjusted to pH 5.9 with sodium hydroxide with a concentration of 1 mol/L. Thus, a silver halide dispersion with a pAg 8.0 was prepared.

The silver halide dispersion was kept at 38° C. with stirring, to which was added 5 ml of a 0.34 mass % methanol solution of 1,2-benzisothiazolin-3-one, and the mixture was heated to 47° C. After 20 minutes from the heating, sodium benzenethiosulfonate was added in an amount of 7.6×10⁻⁵ per mole of silver in the form of methanol solution. Further, after 5 minutes, Tellurium sensitizer B was added thereto in an amount of 2.9×10⁻⁴ mol per mole of silver in the form of methanol solution, followed by aging for 91 minutes.

Then, 1.3 ml of a 0.8 mass % methanol solution of N,N′-dihydroxy-N-″-diethylmelamine was added thereto, and after another 4 minutes, thereto were added 5-methyl-2-mercaptobenzimidazole in the form of methanol solution in an amount of 4.8×10⁻³ mol per mole of silver, and 1-phenyl-2-heptyl-5-mercapto-1,3,4-triazole in the form of methanol solution in an amount of 5.4×10⁻³ mol per mole of silver. As a result, Silver halide emulsion 1 was prepared.

The grains in the prepared silver halide emulsion were pure silver iodide grains having a mean sphere equivalent diameter of 0.040 μm, and a variation coefficient of sphere equivalent diameter of 18%. Further, they were fourteen-hedron grains having (001), {100}, and {101} planes. They were measured using an X-ray powder diffraction analysis, and as a result, the proportion of the γ phase was found to be 30%. The grain size and the like were determined from the average of 1000 grains by using an electron microscope.

(Preparation of Silver Halide Emulsion 2)

Silver halide emulsion 2 was prepared in the same manner as in preparation of Silver halide emulsion 1, except that the temperature of the reaction solution was changed to 65° C., that 5 ml of a 5% methanol solution of 2,2′-(ethylenedithio)diethanol was added after addition of Solutions A and B, that Solution D was added while keeping the pAg at 10.5 with a controlled double jet method, and that during chemical sensitization, after 3 minutes from the addition of the Tellurium sensitizer, auric bromide in an amount of 5×10⁻⁴ mol per mole of silver, and potassium thiocyanate in an amount of 2×10⁻³ mol per mole of silver were added.

The grains in the prepared silver halide emulsion were pure silver iodide tabular grains having a mean circle equivalent diameter of projection area of 0.164 μm, a grain thickness of 0.032 μm, an average aspect ratio of 5, the mean sphere equivalent diameter of 0.1 μm, and a variation coefficient of sphere equivalent diameter of 23%. They were measured using an X-ray powder diffraction analysis, and as a result, the proportion of the γ phase was found to be 80%. The grain size and the like were determined from the average of 1000 grains by using an electron microscope.

(Preparation of Silver Halide Emulsion 3)

Silver halide emulsion 3 was prepared in entirely the same manner as in preparation of Silver halide emulsion 1, except that the temperature of the reaction solution was changed to 27° C., and that Solution D was added while keeping the pAg at 10.2 with a controlled double jet method.

The grains in the prepared silver halide emulsion were pure silver iodide grains having a mean sphere equivalent diameter of 0.022 μm, and a variation coefficient of sphere equivalent diameter of 17%. Further, they were twelve-hedron grains having (001), {1(−1)0}, and {101} planes. They were measured using an X-ray powder diffraction analysis, and as a result, they were found to be silver iodide grains almost comprising a β phase. The grain size and the like were determined from the average of 1000 grains by using an electron microscope.

(Preparation of Mixed Emulsion A for Coating Solution)

Silver halide emulsion 1, Silver halide emulsion 2, and Silver halide emulsion 3 were mixed and dissolved together in a silver molar ratio of 5:2:3. Thereto, benzothiazolium iodide was added in the form of a 1 mass % aqueous solution in an amount of 7×10⁻³ mol per mole of silver. Further, water was added so that the silver halide content per kilogram of the mixed emulsion for coating solution calculated in terms of silver was 38.2 g, and 1-(3-methylureidophenylphenyl)-5-mercaptotetrazole was added in an amount of 0.34 g per kilogram of the mixed emulsion for coating solution.

(Preparation of Comparative Silver Halide Emulsion C)

To 1421 ml of distilled water, 3.1 ml of a 1 mass % potassium bromide solution was added, and further, 3.5 ml of sulfuric acid with a concentration of 0.5 mol/L and 31.7 g of phthalated gelatin were added. The resulting solution was kept at a temperature of 30° C. with stirring in a reaction jar made of stainless steel. Solution A was prepared by diluting 22.22 g of silver nitrate with the addition of distilled water to 95.4 ml, and Solution B was prepared by diluting 15.3 g of potassium bromide and 0.8 g of potassium iodide with the addition of distilled water to a volume of 97.4 ml. The whole amount of Solutions A and B were added thereto at a constant flow rate over 45 seconds. Then, 10 ml of a 3.5 mass % hydrogen peroxide aqueous solution was added thereto, and further, 10.8 ml of a 10 mass % aqueous solution of benzimidazole was added thereto. Further, Solution C was prepared by diluting 51.86 g of silver nitrate with the addition of distilled water to 317.5 ml, and Solution D was prepared by diluting 44.2 g of potassium bromide and 2.2 g of potassium iodide to a volume of 400 ml with distilled water. The whole amount of Solution C was added at a given flow rate over 20 minutes. Solution D was added while keeping the pAg at 8.1 with a controlled double jet method. Potassium hexachloroiridate (III) was added in an amount of 1×10⁻⁴ mol per mole of silver all at once after 10 minutes from the start of addition of Solutions C and D. An aqueous solution of potassium iron (II) hexacyanide was added in an amount of 3×10⁻⁴ mol per mole of silver all at once after 5 seconds from the completion of addition of Solution C. The pH was adjusted to 3.8 using sulfuric acid with a concentration of 0.5 mol/L, and stirring was stopped. Then, steps of sedimentation/desalting/washing with water were carried out. The resulting mixture was adjusted to pH 5.9 with sodium hydroxide with a concentration of 1 mol/L. Thus, a silver halide dispersion with a pAg 8.0 was prepared.

The silver halide dispersion was kept at 38° C. with stirring, to which was added 5 ml of a 0.34 mass % methanol solution of 1,2-benzisothiazolin-3-one. After 40 minutes, the mixture was heated to 47° C. After 20 minutes from the heating, sodium benzenethiosulfonate was added in an amount of 7.6×10⁻⁵ mol per mole of silver in the form of methanol solution. Further, after 5 minutes, Tellurium sensitizer C was added thereto in an amount of 2.9×₁₀⁻⁴ mol per mole of silver in the form of methanol solution, followed by aging for 91 minutes. Then, 1.3 ml of a 0.8 mass % methanol solution of N,N′-dihydroxy-N″-diethylmelamine was added thereto, and after another 4 minutes, thereto were added 5-methyl-2-mercaptobenzimidazole in the form of methanol solution in an amount of 4.8×10⁻³ mol per mole of silver, 1-phenyl-2-heptyl-5-mercapto-1,3,4-triazole in the form of methanol solution in an amount of 5.4×10⁻³ mol per mole of silver, and 1-(3-methylureidophenyl)-5-mercaptotetrazole in the form of aqueous solution in an amount of 8.5×10⁻³ mol per mole of silver. As a result, Silver halide emulsion A was prepared.

The grains in the prepared silver halide emulsion were silver iodobromide grains uniformly containing iodine in an amount of 3.5 mol %, and having a mean sphere equivalent diameter of 0.042 μm, and a variation coefficient of sphere equivalent diameter of 20%. The grain size and the like were determined from the average of 1000 grains by using an electron microscope. The [100] plane proportion of these grains was determined to be 80% by using the Kubelka-Munk method.

(Preparation of Diluted Emulsion C for Coating Solution)

Silver halide emulsion C was dissolved, and benzothiazolium iodide was added thereto in the form of a 1 mass % aqueous solution in amount of 7×10⁻³ mol per mole of silver. Further, water was added so that the silver halide content per kilogram of Diluted emulsion C for coating solution calculated in terms of silver was 38.2 g, and 1-(3-methylureidophenylphenyl)-5-mercaptotetrazole was added in an amount of 0.34 g per kilogram of the mixed emulsion for coating solution.

2) Preparation of Fatty Acid Silver dispersion

(Preparation of Recrystallized Behenic Acid)

100 Kg of behenic acid (trade name: Edenor C22-85R) manufactured by Henckel Co., was mixed with 1200 Kg of isopropyl alcohol, and dissolved at 50° C. The resulting mixture was filtrated through a 10-μm filter, and then cooled to 30° C. to perform recrystallization. The cooling speed for performing recrystallization was controlled to 3° C./hour. The obtained crystals were subjected to centrifugal filtration, and applied and washed with 100 Kg of isopropyl alcohol, followed by drying. The obtained crystals were subjected to esterification and a GC-FID measurement. This indicated that the silver behenate content was 96%, and that, other than this, lignoceric acid in an amount of 2%, arachidic acid in an amount of 2%, and erucic acid in an amount of 0.001% were contained therein.

(Preparation of Fatty Acid Silver Salt Dispersion)

88 Kg of recrystallized behenic acid, 422 L of distilled water, 49.2 L of an aqueous solution of NaOH with a concentration of 5 mol/L, and 120 L of t-butyl alcohol were mixed, and stirred at 75° C. for 1 hour to effect the reaction, thereby obtaining Sodium behenate solution B. Separately, 206.2 L of an aqueous solution of 40.4 kg of silver nitrate (pH 4.0) was prepared, and kept at a temperature of 10° C. A reaction vessel containing 635 L of distilled water and 30 L of t-butyl alcohol therein was kept at a temperature of 30° C., and the whole amount of Sodium behenate solution previously prepared and the whole amount of the aqueous solution of silver nitrate were added with sufficient stirring thereto at a constant flow rate over 93 minutes and 15 seconds and over 90 minutes, respectively. This step was carried out in the following manner. Only the aqueous solution of silver nitrate was added for 11 minutes after the start of addition of the aqueous solution of silver nitrate. Thereafter, addition of the sodium behenate solution was started, and only the sodium behenate solution was added for 14 minute and 15 seconds after completion of the addition of the aqueous solution of silver nitrate. At this step, the temperature in the reaction vessel was set at 30° C., and the temperature of the outside was controlled so that the liquid temperature was maintained constant.

Further, the piping of the addition system for the sodium behenate solution was heat-insulated by circulating warm water outside the double pipe, and adjusted so that the liquid temperature at the outlet of the tip of the addition nozzle became 75° C. The piping of the addition system for the aqueous solution of silver nitrate was heat-insulated by circulating cool water outside the double pipe. The position of adding the sodium behenate solution and the position of adding the aqueous solution of silver nitrate were arranged symmetrically with respect to the stirring shaft as the center, and adjusted at such a height as not to cause contact with the reaction solution.

After completion of the addition of the sodium behenate solution, the mixture was allowed to stand with stirring for 20 minutes with the temperature unchanged, and heated to 35° C. over 30 minutes, followed by aging for 210 minutes. Immediately after completion of aging, the solid content was separated by centrifugal filtration, and then the solid content was washed with water until the conductivity of the filtrate water became 30 μS/cm. A fatty acid silver salt was obtained in this manner. The obtained solid content was not dried, and stored in the form of a wet cake.

The shapes of the obtained silver behenate grains were evaluated by an electron microscopic photography, so that the grains were found to be crystals having a=0.21 μm, b=0.4 μm, and c=0.4 μm, in average values, an average aspect ratio of 2.1, and a variation coefficient of sphere equivalent diameter of 11% (a, b, and c are defined in this specification).

To the wet cake corresponding to 260 kg of the dry solid content, 19.3 Kg of polyvinyl alcohol (trade name: PVA-217) and water were added to make the total amount 1000 Kg. Then, the resulting mixture was made into a slurry by means of a dissolver blade, and further pre-dispersed by means of a pipeline mixer (PM-10 model: manufactured by MIZUHO Industrial Co., Ltd.).

Then, the pre-dispersed stock dispersion was treated three times by means of a dispersing machine (trade name: Microfluidizer-M-610, manufactured by Microfluidex International Corporation, using Z model interaction chamber) with the pressure controlled to be 1150 kg/cm² to obtain a silver behenate dispersion. During the cooling operation, the dispersion temperature was set at 18° C. by providing coiled heat exchangers fixed before and after the interaction chamber, and controlling the temperature of the refrigerant.

3) Preparation of Reducing Agent Dispersion

(Preparation of Reducing Agent-1 Dispersion)

To 10 Kg of Reducing agent-1 (2,2′-methylenebis-(4-ethyl-6-tert-butylphenol)), and 16 Kg of a 10 mass % aqueous solution of modified polyvinyl alcohol (POVAL MP203 manufactured by Kuraray Co., Ltd.), 10 Kg of water was added, and well mixed, resulting in a slurry. The slurry was fed through a diaphragm pump to a sand mill of horizontal type (UVM-2: manufactured by Imex Co., Ltd.) filled with zirconia beads having an average diameter of 0.5 mm, and dispersed therein for 3 hours. Then, 0.2 g of benzothiazolinone sodium salt and water were added thereto, so that the concentration of the reducing agent was adjusted to 25 mass %. The resulting dispersion was heat treated at 60° C. for 5 hours to obtain Reducing agent-1 dispersion. The reducing agent grains contained in the reducing agent dispersion thus obtained had a median diameter of 0.40 μm and a maximum grain diameter of 1.4 μm or less. The reducing agent dispersion obtained was filtered through a filter made of polypropylene, having a pore size of 3.0 μm, to remove foreign matters such as dusts, and stored.

(Preparation of Reducing Agent-2 Dispersion)

To 10 Kg of Reducing agent-2 (6,6′-di-t-butyl-4,4′-dimethyl-2,2′-butylidene diphenol), and 16 Kg of a 10 mass % aqueous solution of modified polyvinyl alcohol (POVAL MP203 manufactured by Kuraray Co., Ltd.), 10 Kg of water was added, and well mixed, resulting in a slurry. The slurry was fed through a diaphragm pump to a sand mill of horizontal type (UVM-2: manufactured by Imex Co., Ltd.) filled with zirconia beads having an average diameter of 0.5 mm, and dispersed therein for 3 hours and 30 minutes. Then, 0.2 g of benzothiazolinone sodium salt and water were added thereto, so that the concentration of the reducing agent was adjusted to 25 mass %. The resulting dispersion was heat treated at 40° C. for 1 hour, and subsequently further heat treated at 80° C. for another hour to obtain Reducing agent-2 dispersion. The reducing agent grains contained in the reducing agent dispersion thus obtained had a median diameter of 0.50 μm and a maximum grain diameter of 1.6 μm or less. The reducing agent dispersion obtained was filtered through a filter made of polypropylene, having a pore size of 3.0 μm, to remove foreign matters such as dusts, and stored.

4) Preparation of Hydrogen Bonding Compound Dispersion

To 10 Kg of Hydrogen bonding compound-1 (tri(4-t-butylphenyl)phosphine oxide), and 16 Kg of a 10 mass % aqueous solution of modified polyvinyl alcohol (POVAL MP203 manufactured by Kuraray Co., Ltd.), 10 Kg of water was added, and well mixed, resulting in a slurry. The slurry was fed through a diaphragm pump to a sand mill of horizontal type (UVM-2: manufactured by Imex Co., Ltd.) filled with zirconia beads having an average diameter of 0.5 mm, and dispersed therein for 4 hours. Then, 0.2 g of benzothiazolinone sodium salt and water were added thereto, so that the concentration of the hydrogen bonding compound was adjusted to 25 mass %. The dispersion was heated at 40° C. for 1 hour, and subsequently further warmed at 80° C. for another hour to obtain Hydrogen bonding compound-1 dispersion. The hydrogen bonding compound grains contained in the hydrogen bonding compound dispersion thus obtained had a median diameter of 0.45 μm and a maximum grain diameter of 1.3 μm or less. The hydrogen bonding compound dispersion obtained was filtered through a filter made of polypropylene, having a pore size of 3.0 μm, to remove foreign matters such as dusts, and stored.

5) Preparation of Development Accelerator Dispersion and Color Toning Agent Dispersion

(Preparation of Development Accelerator-1 Dispersion)

To 10 Kg of Development accelerator-1, and 20 Kg of a 10 mass % aqueous solution of modified polyvinyl alcohol (POVAL MP203 manufactured by Kuraray Co., Ltd.), 10 Kg of water was added, and well mixed, resulting in a slurry. The slurry was fed through a diaphragm pump to a sand mill of horizontal type (UVM-2, manufactured by Imex Co., Ltd.) filled with zirconia beads having an average diameter of 0.5 mm, and dispersed therein for 3 hours and 30 minutes. Then, 0.2 g of benzothiazolinone sodium salt and water were added thereto, so that the concentration of the development accelerator was adjusted to 20 mass %. Thus, Development accelerator-1 dispersion was obtained. The development accelerator grains contained in the development accelerator dispersion thus obtained had a median diameter of 0.48 μm and a maximum grain diameter of 1.4 μm or less. The development accelerator dispersion obtained was filtered through a filter made of polypropylene, having a pore size of 3.0 μm, to remove foreign matters such as dusts, and stored.

(Solid Dispersions of Development Accelerator-2 and Color Toning Agent-1)

Also the solid dispersions of Development accelerator-2 and Color toning agent-1, dispersion was carried out in the same manner as with Development accelerator-1, to obtain 20 mass % and 15 mass % dispersions, respectively.

6) Preparation of Dispersion of Silver-Saving Agent

To 10 Kg of Silver-saving agent No. 5-1-5, and 20 Kg of a 10 mass % aqueous solution of modified polyvinyl alcohol (POVAL MP203 manufactured by Kuraray Co., Ltd.), 10 Kg of water was added, and well mixed, resulting in a slurry. The slurry was fed through a diaphragm pump to a sand mill of horizontal type (UVM-2: manufactured by Imex Co., Ltd.) filled with zirconia beads having an average diameter of 0.5 mm, and dispersed therein for 3 hours and 30 minutes. Then, 0.2 g of benzothiazolinone sodium salt and water were added thereto, so that the concentration of the silver-saving agent was adjusted to 20 mass %. The silver-saving agent grains contained in the dispersion thus obtained had a median diameter of 0.35 to 0.55 μm and a maximum grain diameter of 2.0 μm or less. The silver-saving agent dispersion obtained was filtered through a filter made of polypropylene, having a pore size of 3.0 μm, to remove foreign matters such as dusts, and stored.

7) Preparation of Polyhalogen Compound dispersion

(Preparation of Organic Polyhalogen Compound-1 Dispersion)

10 Kg of Organic polyhalogen compound-1 (tribromomethane sulfonylbenzene), 10 Kg of a 20 mass % aqueous solution of modified polyvinyl alcohol (POVAL MP203 manufactured by Kuraray Co., Ltd.), 0.4 Kg of a 20 mass % aqueous solution of sodium triisopropyl naphthalene sulfonate, and 14 Kg of water were added together, and well mixed, resulting in a slurry. The slurry was fed through a diaphragm pump to a sand mill of horizontal type (UVM-2, manufactured by Imex Co., Ltd.) filled with zirconia beads having an average diameter of 0.5 mm, and dispersed therein for 5 hours. Then, 0.2 g of benzothiazolinone sodium salt and water were added thereto, so that the concentration of the organic polyhalogen compound was adjusted to 30 mass %. Thus, Organic polyhalogen compound-1 dispersion was obtained. The organic polyhalogen compound grains contained in the organic polyhalogen compound dispersion thus obtained had a median diameter of 0.41 μm and a maximum grain diameter of 2.0 μm or less. The organic polyhalogen compound dispersion obtained was filtered through a filter made of polypropylene having a pore size of 10.0 μm to remove foreign matters such as dusts, and stored.

(Preparation of Organic Polyhalogen Compound-2 Dispersion)

10 Kg of Organic polyhalogen compound-2 (N-butyl-3-tribromomethane sulfonyl benzamide), 20 Kg of a 10 mass % aqueous solution of modified polyvinyl alcohol (POVAL MP203 manufactured by Kuraray Co., Ltd.), and 0.4 Kg of a 20 mass % aqueous solution of sodium triisopropyl naphthalene sulfonate, were added together, and well mixed, resulting in a slurry. The slurry was fed through a diaphragm pump to a sand mill of horizontal type (UVM-2, manufactured by Imex Co., Ltd.) filled with zirconia beads having an average diameter of 0.5 mm, and dispersed therein for 5 hours. Then, 0.2 g of benzothiazolinone sodium salt and water were added thereto, so that the concentration of the organic polyhalogen compound was adjusted to 30 mass %. The resulting dispersion was warmed at 40° C. for 5 hours to obtain Organic polyhalogen compound-2 dispersion. The organic polyhalogen compound grains contained in the organic polyhalogen compound dispersion thus obtained had a median diameter of 0.40 μm and a maximum grain diameter of 1.3 μm or less. The organic polyhalogen compound dispersion obtained was filtered through a filter made of polypropylene, having a pore size of 3.0 μm, to remove foreign matters such as dusts, and stored.

8) Preparation of Phthalazine Compound Solution

8 Kg of modified polyvinyl alcohol MP203 manufactured by Kuraray Co., Ltd., was dissolved in 174.57 Kg of water. Then, 3.15 Kg of a 20 mass % aqueous solution of sodium triisopropyl naphthalene sulfonate and 14.28 Kg of a 70 mass % aqueous solution of Phthalazine compound-1 (6-isopropyl phthalazine) were added thereto to prepare a 5 mass % solution of Phthalazine compound-1.

9) Preparation of Mercapto Compound

(Preparation of Mercapto Compound-1 Aqueous Solution)

7 g of Mercapto compound-1 (1-(3-sulfophenyl)-5-mercaptotetrazole sodium salt) was dissolved in 993 g of water, resulting in a 0.7 mass % aqueous solution.

(Preparation of Mercapto Compound-2 Aqueous Solution)

20 g of Mercapto compound-2 (1-(3-methylureide)-5-mercaptotetrazole) was dissolved in 980 g of water, resulting in a 2.0 mass % aqueous solution.

10) Preparation of Pigment-1 Dispersion

To 64 g of C.I. Pigment Blue 60 and 6.4 g of Demol N manufactured by Kao Corp., Ltd., 250 g of water was added, and well mixed, resulting in a slurry. 800 g of zirconia beads with an average diameter of 0.5 mm were prepared, and injected together with the slurry in a vessel. Dispersion was carried out for 25 hours by means of a disperser (¼ sand grinder mill: manufactured by Imex Co., Ltd.). To the resulting dispersion, water was added so that the concentration of pigment was adjusted to 5 mass %, to obtain Pigment-1 dispersion. The pigment grains contained in the pigment dispersion thus obtained had an average grain diameter of 0.21 μm.

11) Preparation of Dispersions of Adsorptive Redox Compound and a Compound Capable of Releasing Electrons by Oxidation

Respective dispersions were prepared in the same manner as with the Pigment-1 dispersion using Additives S-1 and S-2.

12) Preparation of SBR Latex Solution

A polymerizer of a gas monomer reaction apparatus (TAS-2J model, manufactured by TAIATSU TECHNO CORPORATION) was charged with 287 g of distilled water, 7.73 g of a surfactant (PAIONIN A-43-S (produced by TAKEMOTO Oil & Fat Co., Ltd.): solid content 48.5 mass %), 14.06 ml of 1 mol/l NaOH, 0.15 g of tetrasodium ethylenediaminetetraacetate, 255 g of styrene, 11.25 g of acrylic acid, and 3.0 g of tert-dodecylmercaptane. The reaction vessel was closed, and the contents were stirred at a stirring rate of 200 rpm. Degassing was carried out by a vacuum pump to repeat nitrogen gas replacement several times. Then, 108.75 g of 1,3-butadiene was injected therein, and the internal temperature was raised up to 60° C. A solution of 1.875 g of ammonium persulfate dissolved in 50 ml of water was added thereto, and stirred as it was for 5 hours. Further, the temperature was raised up to 90° C. Stirring was carried out for 3 hours, and the internal temperature was decreased down to room temperature after the completion of the reaction. Then, 1 mol/1 NaOH and NH₄OH were added in a molar ratio of Na⁺ ions: NH₄⁺ ions=1:5:3 to adjust the pH to 8.4. Thereafter, the solution was filtered through a filter made of polypropylene, having a pore size of 1.0 μm, to remove foreign matters such as dusts, and stored. As a result, 774.7 g of SBR latex was obtained. The resulting latex was analyzed for halogen ions with ion chromatography, and as a result, the chloride ion concentration was found to be 3 ppm. The chelating agent concentration was determined with high performance liquid chromatography, and as a result, it was found to be 145 ppm.

The above-described latex has the following characteristics: average particle diameter, 90 nm; Tg=17° C.; solid content concentration, 44 mass %; equilibrium moisture content at 25° C. and 60% RH, 0.6 mass %; ionic conductivity, 4.80 mS/cm (the ionic conductivity measurement was carried out for a latex stock solution (44 mass %) at 25° C. using a conductivity meter CM-30S manufactured by TOA Electronics Ltd.); and pH, 8.4

SBR latexes mutually different in Tg can be prepared in the same manner by appropriately changing the ratio of styrene and butadiene.

3-2 Preparation of Coating Solution

1) Preparation of First Image Forming Layer Coating Solutions-1 to 3

To 1000 g of the fatty acid silver dispersion obtained above, 276 ml of water, Pigment-1 dispersion, Organic polyhalogen compound-1 dispersion, Organic polyhalogen compound-2 dispersion, Phthalazine compound-1 solution, SBR latex (Tg: 17° C.) solution, Reducing agent-1 dispersion, Reducing agent-2 dispersion, Hydrogen bonding compound-1 dispersion, Development accelerator-1 dispersion, Development accelerator-2 dispersion, Silver-saving agent (shown in Table 1), Color toning agent-1 dispersion, Mercapto compound-1 aqueous solution, Mercapto compound-2 aqueous solution, Adsorptive redox compound, and Dispersion of Compound capable of releasing electrons by oxidation were successively added. Immediately before coating, to the resulting mixture, Silver halide mixed emulsion A was added, and well mixed to prepare an image forming layer coating solution. The resulting solution was fed as it was to a coating die for coating.

The viscosity of the image forming layer coating solution was determined by means of a B-model viscometer from Tokyo Instrument Co., Ltd., and was found to be 25 [mPa·s] at 40° C. (No. 1 rotor, 60 rpm).

The viscosities of the coating solution at 25° C. determined by means of a RFS fluid spectrometer produced by Rheometrics Far East Co., Ltd., were 242, 65, 48, 26, and 20 [mPa·s] at shear rates of 0.1, 1, 10, 100, and 1000 [1/sec], respectively.

The amount of zirconium in the coating solution was 0.52 mg per gram of silver.

2) Preparation of Second Image Forming Layer Coating Solution A coating solution for the second image forming layer was prepared in the same manner as with a coating solution for the first image forming layer except for removing the silver-saving agent from the first image forming layer coating solution.

3) Preparation of Intermediate Layer Coating Solution

To 1000 g of polyvinyl alcohol PVA-205 (manufactured by Kuraray Co., Ltd.), 272 g of Pigment-1 dispersion, 4200 ml of a 19 mass % solution of methyl methacrylate/styrene/butyl acrylate/hydroxyethyl methacrylate/acrylic acid copolymer (copolymerization weight ratio 64/9/20/5/2) latex, 27 ml of a 5 mass % aqueous solution of Aerosol OT (manufactured by American Cyanamide Co.), and 135 ml of diammonium phthalate, water was added to make the total amount 10000 g. The mixture was adjusted to pH 7.5 with NaOH, resulting in an intermediate layer coating solution. The solution was fed to a coating die so as to achieve 9.1 ml/m².

The viscosity of the coating solution was determined by means of a B-model viscometer, and found to be 58 [mPa·s] at 40° C. (No. 1 rotor, 60 rpm).

4) Preparation of Surface Protective-Layer First Layer Coating Solution

64 g of inert gelatin was dissolved in water. To the resulting solution, 112 g of a 19.0 mass % solution of methyl methacrylate/styrene /butyl acrylate/hydroxyethyl methacrylate/acrylic acid copolymer (copolymerization weight ratio 64/9/20/5/2) latex, 30 ml of a 15 mass % methanol solution of phthalic acid, 23 ml of a 10 mass % aqueous solution of 4-methylphthalic acid, 28 ml of sulfuric acid with a concentration of 0.5 ml/L, 5 ml of a 5 mass % aqueous solution of Aerosol OT (manufactured by American Cyanamide Co.), 0.5 g of phenoxy ethanol, and 0.1 g of benzisothiazolinone were added. To the mixture, water was added to make the total amount 750 g, resulting in a coating solution. 26 ml of 4 mass % chrome alum was mixed therein by a static mixer immediately before coating. The resulting mixture was fed to a coating die so as to achieve 18.6 ml/m².

The viscosity of the coating solution was determined by means of a B-model viscometer, and found to be 20 [mPa·s] at 40° C. (No. 1 rotor, 60 rpm).

5) Preparation of Surface Protective-Layer Second Layer Coating Solution

80 g of inert gelatin was dissolved in water. To the resulting solution, 102 g of a 27.5 mass % solution of methyl methacrylate/styrene /butyl acrylate/hydroxyethyl methacrylate/acrylic acid copolymer (copolymerization weight ratio 64/9/20/5/2) latex, 5.4 ml of a 2 mass % solution of fluorine-containing surfactant (F-1), 5.4 ml of a 2 mass % aqueous solution of fluorine-containing surfactant (F-2), 23 ml of a mass % aqueous solution of Aerosol OT (manufactured by American Cyanamide Co.), 4 g of polymethyl methacrylate fine particles (average particle diameter 0.7 μm), 21 g of polymethyl methacrylate fine particles (average particle diameter 4.5 μm), 1.6 g of 4-methylphthalic acid, 4.8 g of phthalic acid, 44 ml of sulfuric acid with a concentration of 0.5 mol/L, and mg of benzisothiazolinone were added. To the mixture, water was added to make the total amount 650 g. 445 ml of an aqueous solution containing 4 mass % chrome alum and 0.67 mass % phthalic acid were mixed therein by a static mixer immediately before coating, resulting in a surface-protective-layer second layer coating solution. The solution was fed to a coating die so as to achieve 8.3 ml/m².

The viscosity of the coating solution was determined by means of a B-model viscometer, and found to be 19 [mPa·s] at 40° C. (No. 1 rotor, 60 rpm).

3-3. Preparation of Photothermographic Materials-1 to 3

On the surface opposite to the back surface, the first image forming layer, the second image forming layer, the intermediate layer, the surface protective-layer first layer, and the surface protective-layer second layer were simultaneously coated in multilayer by a slide bead coating process in this order, thereby to prepare a sample of the photothermographic material. At this step, the image forming layers and the intermediate layer were temperature controlled to 31° C.; the surface protective-layer first layer, 36° C.; and the surface protective-layer second layer, 37° C. The first image forming layer and the second image forming layer were made equal to each other in amount of silver coated.

Photothermographic material-1 was coated at a coating flow rate such that the total amount of silver coated on the two image forming layers was 2.2 g/m². Photothermographic materials-2 and -3 were controlled in coating flow rate to be coated so that the total amount of silver coated was 1.5 g/m².

The coating amount (g/m²) of each compound of the image forming layer of Photothermographic material-2 is as follows.

| | |
|---|---|
| Fatty acid silver | 4.58 |
| Pigment (C.I. Pigment Blue 60) | 0.031 |
| Polyhalogen compound-1 | 0.078 |
| Polyhalogen compound-2 | 0.12 |
| Phthalazine compound-1 | 0.16 |
| SBR latex | 8.20 |
| Reducing agent-1 | 0.48 |
| Reducing agent-2 | 0.19 |
| Hydrogen bonding compound-1 | 0.24 |
| Development accelerator-1 | 0.016 |
| Development accelerator-2 | 0.014 |
| Silver-saving agent | (shown in Table 1) |
| Color toning agent-1 | 0.007 |
| Mercapto compound-1 | 0.0017 |
| Mercapto compound-2 | 0.0052 |
| Additive S-1 | 0.00087 |
| Additive S-2 | 0.0017 |
| Silver halide (in terms of Ag) | 0.040 |

3-4 Preparation of Photothermographic Materials-4 to -6

Photothermographic materials-4 to -6 were prepared in the same manner as with Photothermographic materials-1 to -3, except that Silver halide mixed emulsion A was changed to Silver halide mixed emulsion C.

TABLE 1

| | | | | Total | |
|---|---|---|---|---|---|
| | | | | coating | |
| | Silver | Silver-saving agent | | silver | |
| Sample | halide | Compound | Amount | amount | |
| No. | emulsion | No. | (mol/Agmol) | (g/m²) | Remark |
| 1 | A | — | — | 2.2 | Comparative |
| | | | | | Example |
| 2 | A | — | — | 1.5 | Comparative |
| | | | | | Example |
| 3 | A | 5-1-5 | 0.02 | 1.5 | Invention |
| 4 | C | — | — | 2.2 | Comparative |
| | | | | | Example |
| 5 | C | — | — | 1.5 | Comparative |
| | | | | | Example |
| 6 | C | 5-1-5 | 0.02 | 1.5 | Comparative |
| | | | | | Example |

The coating and drying conditions were as follows.

Electrostatic charges were eliminated from the support by ionic air before coating. The coating was carried out at a speed of 160 m/min. The coating and drying conditions were controlled in the following ranges for each sample, and set at conditions capable of providing most stable surface conditions.

The clearance between the tip of the coating die and the support was set at 0.10 to 0.30 mm;

The pressure in a reduced pressure chamber was set at a pressure lower than atmospheric pressure by 196 to 882 Pa;

In a subsequent chilling zone, the coating solutions applied were cooled by air having a dry-bulb temperature of 10 to 20° C.;

By non-contact type transfer, the sample was dried by dry air having a dry-bulb temperature of 23 to 45° C., and a wet-bulb temperature of 15 to 21° C. in a helical non-contact type drying apparatus;

After drying, the sample was subjected to moisture conditioning at 25° C. and humidify 40% to 60% RH; and

Subsequently, the sample was heated so that the temperature of the film surface was elevated to 70 to 90° C., and after heating, the film surface was cooled to 25° C.

The prepared photothermographic material showed matting degrees of 550 seconds for the image forming layer surface side, and 130 seconds for the back surface side, in terms of Bekk smoothness. The pH of the film surface on the image forming layer surface side was determined, and found to be 6.0.

Below, the chemical structure of the compounds used in Examples of the invention will be shown.

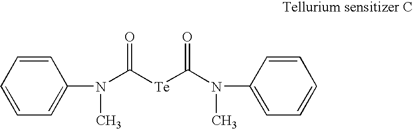

Compound 2 capable of being one-electron oxidized to become a one-electron oxidation product, and releasing one or more electrons:

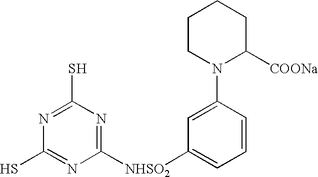

Compound 20 capable of being one-electron oxidized to become a one-electron oxidation product, and releasing one or more electrons:

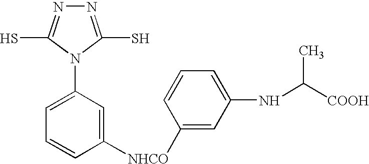

Compound 26 capable of being one-electron oxidized to become a one-electron oxidation product, and releasing one or more electrons:

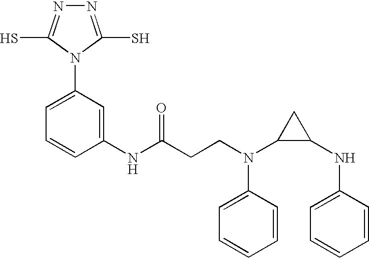

Compound having an adsorbing group and a reducing group (19)

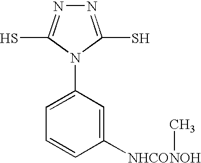

Compound having an adsorbing group and a reducing group (49)

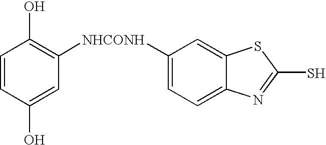

Compound having an adsorbing group and a reducing group (71)

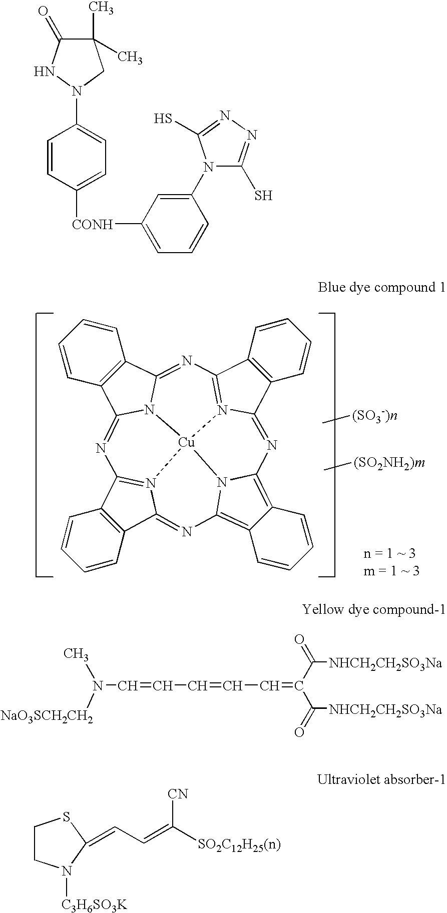

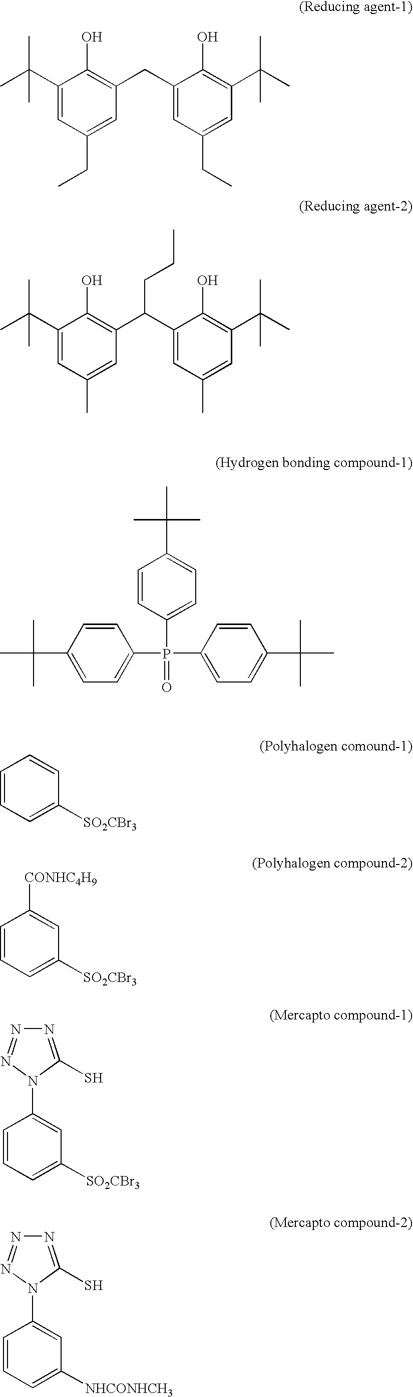

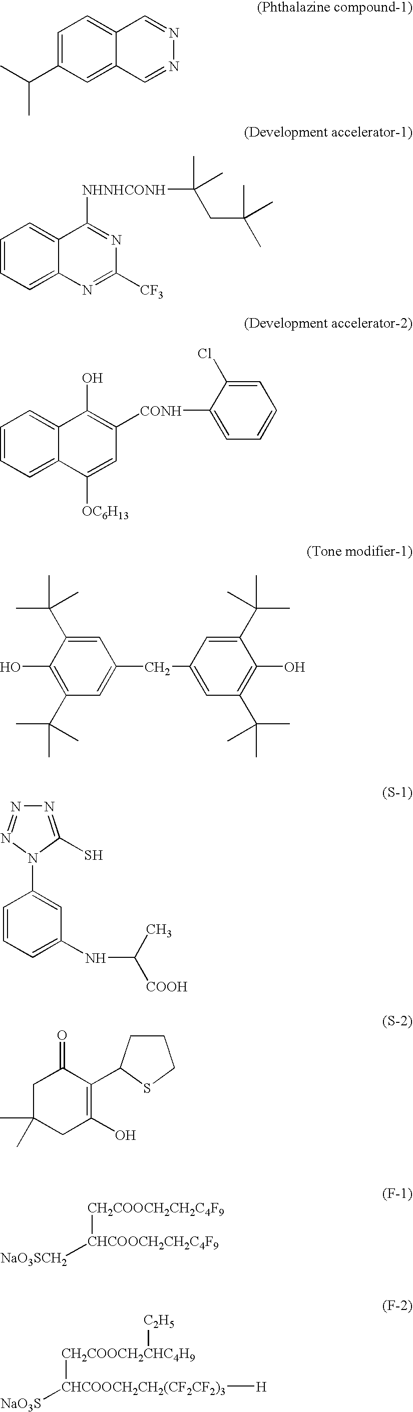

4. Evaluation of Photographic Performances

1) Preparation

Each sample obtained was cut into a half size, and each cut sample was packaged in the following packaging material under the environment of 25° C. and 50% RH, and stored at ordinary temperatures for 2 weeks. Then, the following evaluations were carried out.

(Packaging Material)

PET 10 μm/PE 12 μm/aluminum foil 9 μm/Ny 15 μm/3 mass % carbon-containing polyethylene 50 μm

Oxygen permeability: 0.02 ml/atm·m²·25° C.·day, moisture permeability: 0.10 g/atm·m² 25° C.·day.

2) Exposure and Heat Development

In the exposure unit of FUJI Medical Dry Laser Imager FM-DPL, NLHV3000E semiconductor laser from NICHIA CORPORATION was mounted as a semiconductor laser light source, and the beam diameter was reduced to 100 μm. Thus, exposure was carried out for 10⁻⁶ second with an illuminance on the photosensitive material surface varying between 1 mW/mm² to 1000 mW/mm². The oscillation wavelength of the laser light was 405 nm. Heat development was carried out by 4 panel heaters respectively set at 112° C.-118° C.-120° C.-120° C. at a transfer rate controlled such that the total development time was 14 seconds. Each resulting image was evaluated by means of a densitometer.

(Gradation)

Gradation is expressed as the gradient between optical densities 2.0 and 0.25 of a characteristic curve as represented by the following equation:

Gamma=(Optical density 2.0−Optical density 0.25)/(log (Fog density+Exposure amount providing an optical density of 2.0)−log (fog density+Exposure amount providing an optical density of 0.25)

(Dmax)

The maximum density saturated with an increase in exposure is taken as Dmax.

(Evaluation of Silver Tone)

The silver tone of each sample obtained above was subjected to sensory evaluation on a scale of 5 levels as follows:

O: Pure black tone

OΔ: Slightly yellowish black

Δ: Yellowish black

Δ×: Slightly brownish black

×: Brown.

The mark O or OΔ denotes the practically allowable level.

(Evaluation of Image Storability)

The print-out resistance was evaluated under the following conditions.

Each sample after heat development was allowed to stand for 3 days in a room (under conditions of 30° C. and 70% R.H.) under a fluorescent lamp (illuminance 6000 lux). Then, the change in fog density was determined. A sample which has shown less increase in fog density is a sample superior in image storability.

3) Evaluation of Brittleness

The processing brittleness was evaluated under the following conditions.

Each sample before heat development was cut using an upper blade with a shear angle of 1° and a nose angle of 89°, and a lower blade with a shear angle of 0° and a nose angle of 90°, with the lower blade fixed, and at a cutting speed of the upper blade of 1 m/sec with respect to the lower blade. Both the cut surfaces of the cut sample were observed by an optical microscope at a magnification of 100, and subjected to sensory evaluation according to the following criteria.

OO: No film peeling occurs at all, and the cut surface is smooth;

O: No film peeling occurs, but the cut surface is not smooth and rough;

Δ: Film peeling occurs. However, even when the cut surface is rubbed with fingers, chips do not peel off, so that it can be practically used;

×: Peeling occurs, and when the cut surface is touched, chips peel off.

4) Evaluation of Unprocessed Stock Storability

Each sample was stored in the form packaged in the packaging material under the environment of 40° C. for 30 days, and then subjected to a heat development. Thus, it was evaluated based on the difference in fog (Dmin) before and after storing.

ΔDmin=Dmin after storage−Dmin before storage

A sample with a smaller absolute value of ΔDmin denotes a sample superior in storage stability.

The results are shown in Table 2.

TABLE 2

| | | | | Film | Unprocessed | | |
|---|---|---|---|---|---|---|---|
| | Photographic | | | physical | stock | Image | |
| Sample | performances | | | property | storability | storability | |
| No. | Dmax | Gradation | Tone | (Brittleness) | (ΔDmin) | (Print-out) | Remark |
| 1 | 4.0 | 2.6 | Δ | x | 0.01 | 0 | Comparative |
| | | | | | | | Example |
| 2 | 2.7 | 1.4 | Δx | ∘ | 0 | 0 | Comparative |
| | | | | | | | Example |
| 3 | 4.0 | 2.6 | ∘ | ∘ | 0 | 0 | Invention |
| 4 | 4.0 | 2.7 | ∘Δ | x | 0.02 | 0.11 | Comparative |
| | | | | | | | Example |
| 5 | 2.7 | 1.5 | Δ | ∘ | 0.01 | 0.11 | Comparative |
| | | | | | | | Example |
| 6 | 4.0 | 2.7 | ∘ | ∘ | 0.06 | 0.14 | Comparative |
| | | | | | | | Example |

The results of Table 2 indicates that the sample of the invention is excellent in all respects. Particularly, an unexpected result is that the degradation of the tone of a silver image, which occurs when a silver iodide emulsion is used, is improved by using a silver-saving agent. Further, another unexpected result is that the degradation of unprocessed stock storability due to the use of a silver-saving agent, which is a problem with respect to a silver bromide emulsion agent, is improved by using a silver iodide emulsion agent.

### Example 2

Samples 21 to 26 were prepared in the same manner as the sample 3 of Example 1, except that the compounds shown in Table 3 were respectively used as silver-saving agents.

The samples were evaluated in the same manner as in Example 1. The results are shown in Table 3.

TABLE 3

| | | | | | Film | Unprocessed | Image | |
|---|---|---|---|---|---|---|---|---|
| | Silver- | Photographic | | | physical | stock | storability | |
| Sample | saving | performances | | | property | storability | (Print- | |
| No. | agent | Dmax | Gradation | Tone | (Brittleness) | (ΔDmin) | out) | Remark |
| 21 | 5-34 | 4.0 | 2.6 | ∘ | ∘ | 0 | 0 | Invention |
| 22 | 5-2-1 | 4.0 | 2.6 | ∘ | ∘ | 0 | 0 | Invention |
| 23 | 5-36 | 4.0 | 2.6 | ∘ | ∘ | 0 | 0 | Invention |
| 24 | 5-37 | 4.0 | 2.6 | ∘ | ∘ | 0 | 0 | Invention |
| 25 | 7-17 | 4.0 | 2.6 | ∘ | ∘ | 0 | 0 | Invention |
| 26 | 6-72-15 | 4.0 | 2.6 | ∘ | ∘ | 0 | 0 | Invention |

As for Example 1, all the samples of the invention show favorable performances.

### Example 3

Samples 31 to 36 were prepared in the same manner as the sample 3 of Example 1, except that each reducing agent was changed as shown in Table 4.

The samples were evaluated in the same manner as in Example 1. The results are shown in Table 4.

TABLE 4

| | Reducing | | | | Film | Unprocessed | | |
|---|---|---|---|---|---|---|---|---|
| | agent | Photographic | | | physical | stock | Image | |
| Sample | (Compound | performances | | | property | storability | storability | |
| No. | No.) | Dmax | Gradation | Tone | (Brittleness) | (ΔDmin) | (Print-out) | Remark |
| 31 | R-3 | 4.2 | 2.7 | ∘ | ∘ | 0 | 0 | Invention |
| 32 | R-2 | 3.8 | 2.4 | ∘ | ∘ | 0 | 0 | Invention |
| 33 | R-1 | 3.8 | 2.4 | ∘ | ∘ | 0 | 0 | Invention |
| 34 | R-4 | 4.2 | 2.7 | ∘ | ∘ | 0 | 0 | Invention |
| 35 | R-6 | 4.2 | 2.7 | ∘ | ∘ | 0 | 0 | Invention |
| 36 | R-7 | 4.2 | 2.7 | ∘ | ∘ | 0 | 0 | Invention |

As indicated from the results of Table 4, all the samples of the invention shows favorable performances, and particularly, R-3, R-4, R-6, and R-7 provide preferred gradations and high Dmax, and show more preferred performances as reducing agents.

### Example 4

(Preparation of Sample 41)

Sample 41 was prepared in the same manner as Sample 3 of Example 1, except that the coating order of the first image forming layer and the second image forming layer was changed, so that the second image forming layer was arranged closer to the support, and the first image forming layer was arranged more distant from the support.

(Preparation of Sample 42)

Sample 42 was prepared in the same manner as Sample 3 of Example 1, except that coating was carried out so as to achieve the following configuration. The second image forming layer was removed, and the coating amount of the first image forming layer was doubled, so that the total amount of silver coated was made equal to that of Sample 3, and only the amount of the silver-saving agent was unchanged.

Evaluation was carried out in the same manner as in Example 1, and the results are shown in Table 5.

TABLE 5

| | | | | Film | Unprocessed | | |
|---|---|---|---|---|---|---|---|
| | Photographic | | | physical | stock | Image | |
| Sample | performances | | | property | storability | storability | |
| No. | Dmax | Gradation | Tone | (Brittleness) | (ΔDmin) | (Print-out) | Remark |
| 3 | 4.0 | 2.6 | ∘ | ∘ | 0 | 0 | Invention |
| 41 | 3.8 | 2.4 | ∘ | ∘ | 0 | 0 | Invention |
| 42 | 3.7 | 2.3 | ∘Δ | ∘ | 0 | 0 | Invention |

As indicated from the results of Table 5, use of the two layers of the first image forming layer containing a silver-saving agent and the second image forming layer not containing a silver-saving agent is more preferable for providing preferred gradation and high Dmax. Further, the arrangement in which the first image forming layer is disposed closer to the support and the second image forming layer is disposed more distant from the support provides more preferred results.

In accordance with the invention, a photothermographic material excellent in image storability and improved in film physical properties is provided.

What is claimed is:

1. A photothermographic material, comprising:
a support;
an image forming layer disposed on the support and containing a photosensitive silver halide, a non-photosensitive organic silver salt, a reducing agent, and a binder; and
a silver-saving agent,
wherein silver iodide is contained in the photosensitive silver halide in an amount of 40 to 100 mol %.

2. The photothermographic material of claim 1, wherein the image forming layer has a multilayered structure comprising at least a first image forming layer and a second image forming layer, and at least the first image forming layer contains the silver-saving agent, and the second image forming layer does not contain the silver-saving agent.

3. The photothermographic material of claim 2, wherein the first image forming layer containing the silver-saving agent is disposed closer to the support, and the second image forming layer not containing the silver-saving agent is disposed more distant from the support.

4. The photothermographic material of claim 2, wherein the first image forming layer containing the silver-saving agent is disposed more distant from the support, and the second image forming layer not containing the silver-saving agent is disposed closer to the support.

5. The photothermographic material of claim 1, wherein an image gradation obtained by heat development is 2 to 4.

6. The photothermographic material of claim 1, wherein the reducing agent contains a compound represented by the following formula (R): 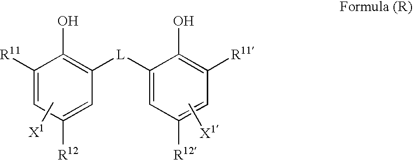
wherein R¹¹ and R^{11′} each independently represent an alkyl group having 3 to 20 carbon atoms, in which a carbon atom bonding with a benzene ring is secondary or tertiary; R¹² and R^{12′} each independently represent a hydrogen atom or a group capable of being substituted on the benzene ring; L represents —S— or —CHR¹³, in which R¹³ represents a hydrogen atom or an alkyl group having 1 to 20 carbon atoms; and X¹ and X^{1′} each independently represent a hydrogen atom or a group capable of being substituted on the benzene ring.

7. The photothermographic material of claim 1, further comprising a development accelerator.

8. The photothermographic material of claim 1, wherein the photothermographic material is capable of being exposed by a laser light source.

9. The photothermographic material of claim 8, wherein the laser light source has a wavelength of 350 nm to 450 nm.

10. The photothermographic material of claim 8, wherein the laser light source is a blue semiconductor laser.

11. The photothermographic material of claim 1, wherein a total amount of coated silver including the photosensitive silver halide and the non-photosensitive organic silver salt is 0.1 to 3.0 g/m².

12. The photothermographic material of claim 1, wherein the reducing agent is contained in an amount of 0.1 to 3.0 g/m².

13. The photothermographic material of claim 1, wherein the reducing agent is contained in the image forming layer in an amount of 5 to 50 mol % per mole of silver on a surface having the image forming layer.

14. The photothermographic material of claim 1, wherein the silver-saving agent is a hydrazine derivative compound represented by the following formula (V): 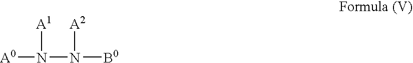
wherein A⁰ represents an aliphatic group, an aromatic group, a heterocyclic group, or -G⁰-D⁰, each of which may have a substituent; B⁰ represents a blocking group; one of A¹ and A² represents a hydrogen atom and the other represents a hydrogen atom, an acyl group, a sulfonyl group, or an oxalyl group; G⁰ represents —CO—, —COCO—, —CS—, —C(═NG¹D¹)-, —SO—, —SO₂—, or —P(O)(G¹D¹)-, in which G¹ represents a single bond, —O—, —S—, or N(D¹)-, and D¹ represents an aliphatic group, an aromatic group, a heterocyclic group, or a hydrogen atom; and D¹ represents one selected from the group consisting of a hydrogen atom, an aliphatic group, an aromatic group, a heterocyclic group, an amino group, an alkoxy group, an aryloxy group, an alkylthio group, and an arylthio group.

15. The photothermographic material of claim 1, wherein the silver-saving agent is a vinyl compound represented by the following formula (VI): 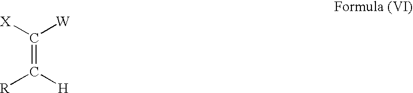
wherein X represents an electron attracting group; W represents one selected from the group consisting of a hydrogen atom, an alkyl group, an alkenyl group, an alkynyl group, an aryl group, a heterocyclic group, a halogen atom, an acyl group, a thioacyl group, an oxalyl group, an oxyoxalyl group, a thiooxalyl group, an oxamoyl group, an oxycarbonyl group, a thiocarbonyl group, a carbamoyl group, a thiocarbamoyl group, a sulfonyl group, a sulfinyl group, an oxysulfinyl group, a thiosulfinyl group, a sulfamoyl group, an oxysulfinyl group, a thiosulfinyl group, a sulfinamoyl group, a phosphoryl group, a nitro group, an imino group, an N-carbonylimino group, an N-sulfinylimino group, a dicyanoethylene group, an ammonium group, a sulfonium group, a phosphonium group, a pyrylium group, and an immonium group; R represents one selected from the group consisting of a halogen atom, a hydroxyl group, an alkoxy group, an aryloxy group, a heterocyclic oxy group, an alkenyloxy group, an acyloxy group, an alkoxycarbonyloxy group, an aminocarbonyloxy group, a mercapto group, an alkylthio group, an arylthio group, a heterocyclic thio group, an alkenylthio group, an acylthio group, an alkoxycarbonylthio group, an aminocarbonylthio group, an organic or inorganic salt of a hydroxyl group or a mercapto group, an amino group, an alkylamino group, a cyclic amino group, an acylamino group, an oxycarbonylamino group, a heterocyclic group, a ureido group, and a sulfonamido group; and X and W, and X and R may bond with each other to form a ring.

16. The photothermographic material of claim 1, wherein the silver-saving agent is a quaternary onium compound represented by the following formula (VII): 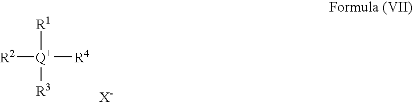
wherein Q represents a nitrogen atom or a phosphorus atom; R¹, R², R³, and R⁴ each independently represent one selected from the group consisting of a hydrogen atom, an alkyl group, an alkenyl group, an alkynyl group, an aryl group, a heterocyclic group, and an amino group; X⁻ represents an anion; and R¹ to R⁴ may bond with each other to form a ring.

17. The photothermographic material of claim 1, wherein the silver-saving agent is contained in the image forming layer or a layer adjacent to the image forming layer in an amount of 10⁻⁵ to 1 mol per mole of the non-photosensitive organic silver salt.
